(19) United States
(12) Patent Application Publication
(10) Pub. No.: US 2023/0086193 A1
(43) Pub. Date: Mar. 23, 2023

(54) OPTICAL GLASS, OPTICAL ELEMENT, LIGHT GUIDE PLATE AND IMAGE DISPLAY DEVICE

(71) Applicant: HOYA CORPORATION, Tokyo (JP)

(72) Inventors: Yutaro NAKATSUKA, Tokyo (JP); Tomoaki NEGISHI, Tokyo (JP)

(73) Assignee: HOYA CORPORATION, Tokyo (JP)

(21) Appl. No.: 17/801,617

(22) PCT Filed: Feb. 26, 2021
(86) PCT No.: PCT/JP2021/007231

§ 371 Date: Aug. 23, 2022

(30) Foreign Application Priority Data
Feb. 28, 2020 (JP) 2020-034271
Feb. 28, 2020 (JP) 2020-034272
Feb. 28, 2020 (JP) 2020-034273

(51) Int. Cl. C03C 3/068

(52) U.S. Cl. CPC C03C 3/068; G02B 27/0172

(57) ABSTRACT

Provided is an optical glass, wherein, based on mass, an SiO₂ content is 10.00% or more, a CaO content is 5.00% or more, a total content (La₂O₃+Gd₂O₃+Y₂O₃) of La₂O₃, Gd₂O₃ and Y₂O₃ is more than 0%, a total content (BaO+La₂O₃+Gd₂O₃+Y₂O₃) of BaO, La₂O₃, Gd₂O₃ and Y₂O₃ is 30.00% or less, and a mass ratio ((SiO₂+B₂O₃)/(TiO₂+Nb₂O₅+Ta₂O₅+WO₃+Bi₂O₃)) of a total content of SiO₂ and B₂O₃ relative to a total content of TiO₂, Nb₂O₅, Ta₂O₅, WO₃ and Bi₂O₃ is 0.75 or less.

The present invention relates to an optical glass, an optical element, a light guide plate and an image display device

A lens made of an optical glass having a high refractive index is disclosed in, for example, PTL 1.

### CITATION LIST

### Patent Literature

[PTL 1] Japanese Patent Application Publication No. 2017-105702

### SUMMARY OF INVENTION

### Technical Problem

An optical glass having a high refractive index can make an optical system compact while correcting chromatic aberration, for example, by combining a lens made of such a glass with other lenses made of glasses with different dispersibilities to form a cemented lens. Therefore, such an optical glass is useful as an optical element material constituting a projection optical system such as an imaging optical system and a projector.

As physical properties desired for the optical glass, a low specific gravity is exemplified. This is because a lightweight optical element can then be provided using an optical glass having a low specific gravity. For example, in an autofocus-type optical system, when the optical element is lightweight, power consumption during auto-focusing can be reduced.

In view of the above circumstance, an object of one aspect of the present invention is to provide an optical glass having a high refractive index and a low specific gravity.

### Solution to Problem

One aspect of the present invention relates to an optical glass (hereinafter referred to as “Glass 1”) in which, based on mass, the SiO₂ content is 10.00% or more, the CaO content is 5.00% or more, a total content (La₂O₃+Gd₂O₃+Y₂O₃) of La₂O₃, Gd₂O₃ and Y₂O₃ is more than 0%, a total content (BaO+La₂O₃+Gd₂O₃+Y₂O₃) of BaO, La₂O₃, Gd₂O₃ and Y₂O₃ is 30.00% or less, and a mass ratio ((SiO₂+B₂O₃)/(TiO₂+Nb₂O₅+Ta₂O₅+WO₃+Bi₂O₃)) of a total content of SiO₂ and B₂O₃ relative to a total content of TiO₂, Nb₂O₅, Ta₂O₅, WO₃ and Bi₂O₃ is 0.75 or less.

Another aspect of the present invention relates to an optical glass (hereinafter referred to as “Glass 2”) in which, based on mass, the SiO₂ content is 10.00% or more, the CaO content is 5.00% or more, a total content (La₂O₃+Gd₂O₃+Y₂O₃) of La₂O₃, Gd₂O₃ and Y₂O₃ is 2.96% or more, a total content (BaO+La₂O₃+Gd₂O₃+Y₂O₃) of BaO, La₂O₃, Gd₂O₃ and Y₂O₃ is 30.00% or less, a mass ratio ((SiO₂+B₂O₃)/(TiO₂+Nb₂O₅+Ta₂O₅+WO₃+Bi₂O₃)) of a total content of SiO₂ and B₂O₃ relative to a total content of TiO₂, Nb₂O₅, Ta₂O₅, WO₃ and Bi₂O₃ is 0.75 or less, and a mass ratio ((SiO₂+CaO)/(TiO₂+Nb₂O₅+Ta₂O₅+WO₃+Bi₂O₃)) of a total content of SiO₂ and CaO relative to a total content of TiO₂, Nb₂O₅, Ta₂O₅, WO₃ and Bi₂O₃ is less than 1.09.

Another aspect of the present invention relates to an optical glass (hereinafter referred to as “Glass 3”) in which, based on mass, the ZrO₂ content is 7.63% or less, a mass ratio (ZrO₂/(La₂O₃+Gd₂O₃+Y₂O₃)) of the ZrO₂ content relative to a total content of La₂O₃, Gd₂O₃ and Y₂O₃ is 3.30 or less, a mass ratio (B₂O₃/SiO₂) of the B₂O₃ content relative to the SiO₂ content is less than 1.00, a mass ratio ((SiO₂+CaO)/(TiO₂+Nb₂O₅+Ta₂O₅+WO₃+Bi₂O₃)) of a total content of SiO₂ and CaO relative to a total content of TiO₂, Nb₂O₅, Ta₂O₅, WO₃ and Bi₂O₃ is 1.09 or less, and a mass ratio ((ZnO+SrO+BaO)/(MgO+CaO)) of a total content of ZnO, SrO and BaO relative to a total content of MgO and CaO is 1.98 or less.

Glasses 1 to 3 each have the above glass compositions. Thereby, Glasses 1 to 3 can be glasses that have a high refractive index and a low specific gravity. In addition, in one embodiment, Glasses 1 to 3 can be glasses that have a high refractive index, low dispersibility and a low specific gravity.

### Effects of Invention

According to one aspect of the present invention, it is possible to provide an optical glass having a low specific gravity and a high refractive index. In addition, according to one aspect of the present invention, it is possible to provide an optical element made of such an optical glass.

### BRIEF DESCRIPTION OF DRAWINGS

FIG. 1 is a diagram schematically showing a differential scanning calorimetry curve (DSC curve).

FIG. 2 is a schematic configuration diagram of an example (head mounted display) of an imaging device including an image display element and a light guide plate.

FIG. 3 is a side view schematically showing a configuration of a head mounted display 1 shown in FIG. 2.

### DESCRIPTION OF EMBODIMENTS

[Optical Glass]

In the present invention and this specification, the glass composition is represented by an oxide-based glass composition. Here, “oxide-based glass composition” refers to a glass composition obtained by decomposing all glass raw materials during melting and converting them into oxides in glass. In addition, unless otherwise specified, the glass composition is represented based on mass (mass %, mass ratio).

The glass composition in the present invention and this specification can be obtained by, for example, an ICP-AES (Inductively Coupled Plasma-Atomic Emission Spectrometry) method. Quantitative analysis is performed for each element using ICP-AES. Then, the analysis value is converted into the oxide notation. The analysis value by ICP-AES may include, for example, a measurement error of about ±5% of the analysis value. Therefore, similarly, the value of the oxide notation converted from the analysis value may also include an error of about ±5%.

In addition, in the present invention and this specification, when the content of a constituent component is 0% or the constituent component is not contained or introduced, this indicates that the constituent component is not substantially contained, and the content of the constituent component is about the impurity level or below. About the impurity level or below means, for example, less than 0.01%.

Unless otherwise specified, the description regarding Glass 1 in this specification can also be applied to Glass 2 and Glass 3. Unless otherwise specified, the description regarding Glass 2 in this specification can also be applied to Glass 1 and Glass 3. Unless otherwise specified, the description regarding Glass 3 in this specification can be applied to Glass 1 and Glass 2.

<Glass Composition of Glass 1>

Hereinafter, the glass composition of Glass 1 will be described in more detail.

SiO₂, as a network formation component of the glass, has an effect of improving the thermal stability, chemical durability and weather resistance of the glass, increasing the viscosity of molten glass, and facilitating molding of molten glass. For the above reason, the SiO₂ content of Glass 1 is 10.00% or more, preferably 11.00% or more, and more preferably 12.00% or more, 13.00% or more, 14.00% or more, 14.50% or more, 15.00% or more, 15.50% or more, 16.00% or more, 16.50% or more, and 16.60% or more in that order. In order to improve devitrification resistance of the glass, improve the meltability and improve partial dispersion characteristics, the SiO₂ content is preferably 50.00% or less, and more preferably 45.00% or less, 40.00% or less, 35.00% or less, 30.00% or less, 28.00% or less, 26.00% or less, 25.00% or less, 24.50% or less, 24.00% or less, 23.50% or less, 23.00% or less, 22.75% or less, 22.50% or less, and 22.00% or less in that order.

In order to improve the thermal stability of the glass, further reduce the specific gravity, and obtain a more desirable optical constant, the total content (SiO₂+B₂O₃) of SiO₂ and B₂O₃ is preferably 10.00% or more and more preferably 12.00% or more, 14.00% or more, 15.00% or more, 16.00% or more, 17.00% or more, 17.75% or more, 18.00% or more, 18.25% or more, 18.50% or more, and 18.60% or more in that order, and preferably 35.00% or less and more preferably 32.00% or less, 30.00% or less, 28.00% or less, 27.00% or less, 26.50% or less, 26.00% or less, 25.50% or less, 25.00% or less, 24.50% or less, 24.40% or less, and 24.30% or less in that order.

SiO₂ and B₂O₃ have an effect of improving the thermal stability of the glass, but the meltability of the glass tends to decrease when the content of SiO₂ increases. For the above reason, the mass ratio (SiO₂/(SiO₂+B₂O₃)) of SiO₂ relative to a total content of SiO₂ and B₂O₃ is preferably 0.50 or more and more preferably 0.55 or more, 0.60 or more, 0.65 or more, 0.70 or more, 0.75 or more, 0.77 or more, and 0.80 or more in that order, and preferably 1.00 or less and more preferably 0.99 or less, 0.98 or less, 0.97 or less, 0.96 or less, 0.95 or less, 0.94 or less, 0.93 or less, 0.92 or less, 0.91 or less, 0.90 or less, 0.89 or less, and 0.88 or less in that order.

In order to improve chemical durability, the mass ratio (B₂O₃/SiO₂) of the B₂O₃ content relative to the SiO₂ content is preferably 1.00 or less and more preferably 0.90 or less, 0.80 or less, 0.70 or less, 0.60 or less, 0.50 or less, 0.40 or less, 0.35 or less, 0.32 or less, 0.31 or less, 0.30 or less, 0.29 or less, 0.28 or less, 0.27 or less, 0.26 or less, and 0.25 or less in that order. In order to improve the thermal stability, the mass ratio (B₂O₃/SiO₂) is preferably 0.00 or more and more preferably 0.01 or more, 0.02 or more, 0.03 or more, 0.04 or more, 0.05 or more, 0.06 or more, 0.07 or more, 0.08 or more, 0.09 or more, 0.10 or more, 0.11 or more, 0.12 or more, 0.13 or more, 0.14 or more, and 0.15 or more in that order.

The B₂O₃ content is preferably 0.00% or more, more preferably more than 0.00%, and more preferably 0.10% or more, 0.20% or more, 0.30% or more, 0.35% or more, 0.37% or more, 0.39% or more, 0.40% or more, 0.41% or more, 0.42% or more, 0.43% or more, 0.44% or more, 0.45% or more, 0.46% or more, 0.47% or more, 0.48% or more, and 0.49% or more in that order. In addition, the B₂O₃ content is preferably 30.00% or less and more preferably 25.00% or less, 20.00% or less, 18.00% or less, 16.00% or less, 14.00% or less, 12.00% or less, 10.00% or less, 9.00% or less, 8.00% or less, 7.00% or less, 6.00% or less, 5.50% or less, 5.20% or less, 5.10% or less, 5.00% or less, 4.90% or less, and 4.80% or less in that order. When the B₂O₃ content is set to be within the above range, it is possible to further reduce the specific gravity of the glass and improve the thermal stability of the glass.

In order to improve the meltability and thermal stability of the glass, the CaO content is 5.00% or more, preferably 5.10% or more, and more preferably 5.20% or more, 5.30% or more, 5.40% or more, 5.50% or more, 5.60% or more, 5.70% or more, 5.80% or more, and 5.90% or more in that order. In addition, for the same reason, the CaO content is preferably 40.00% or less and more preferably 35.00% or less, 30.00% or less, 28.00% or less, 26.00% or less, 24.00% or less, 22.00% or less, 21.50% or less, 21.00% or less, 20.50% or less, 20.25% or less, 20.00% or less, and 19.50% or less in that order.

A total content (MgO+CaO+SrO+BaO+ZnO) of the alkaline earth metal oxides MgO, CaO, SrO, and BaO, and ZnO is preferably 5.00% or more, and more preferably 7.00% or more, 10.00% or more, 11.00% or more, 12.00% or more, 13.00% or more, 13.50% or more, 14.00% or more, 14.50% or more, 15.00% or more, 15.30% or more, 15.50% or more, and 16.00% or more in that order. In addition, a total content (MgO+CaO+SrO+BaO+ZnO) is preferably 50.00% or less and more preferably 45.00% or less, 40.00% or less, 39.00% or less, 38.00% or less, 37.00% or less, 36.50% or less, 36.00% or less, 35.50% or less, 35.00% or less, 34.50% or less, and 34.00% or less in that order. The total content (MgO+CaO+SrO+BaO+ZnO) is preferably set to be within the above range in order to further reduce the specific gravity and maintain the thermal stability without interfering with an increase in dispersion.

Among MgO, CaO, SrO, BaO and ZnO, MgO and CaO are more effective components for reducing the specific gravity of the glass as compared with SrO, BaO, and ZnO. Therefore, in order to further reduce an increase in specific gravity, a mass ratio ((ZnO+SrO+BaO)/(MgO+CaO)) of a total content of ZnO, SrO and BaO relative to a total content of MgO and CaO is preferably 2.78 or less and more preferably 2.77 or less, 2.76 or less, 2.75 or less, 2.74 or less, and 2.73 or less in that order.

On the other hand, SrO, BaO, and ZnO have a stronger effect of improving partial dispersion characteristics than MgO and CaO. Therefore, in order to improve partial dispersion characteristics, a mass ratio ((ZnO+SrO+BaO)/(MgO+CaO)) is preferably 0.17 or more and more preferably 0.18 or more, 0.19 or more, and 0.20 or more in that order.

In order to further increase the refractive index and further reduce the specific gravity, a mass ratio (CaO/(MgO+CaO+SrO+BaO+ZnO)) of the CaO content relative to a total content of MgO, CaO, SrO, BaO and ZnO is preferably 0.00 or more and more preferably 0.10 or more, 0.15 or more, 0.16 or more, 0.17 or more, 0.18 or more, 0.19 or more, 0.20 or more, 0.21 or more, 0.22 or more, 0.23 or more, 0.24 or more, 0.25 or more, 0.26 or more, and 0.27 or more in that order. In order to improve the thermal stability, the mass ratio (CaO/(MgO+CaO+SrO+BaO+ZnO)) is preferably 1.00 or less, and more preferably 0.95 or less, 0.90 or less, 0.89 or less, 0.88 or less, 0.87 or less, 0.86 or less, 0.85 or less, 0.84 or less, and 0.83 or less in that order.

In order to further reduce the specific gravity, a mass ratio ((CaO+MgO)/(MgO+CaO+SrO+BaO+ZnO)) of a total content of CaO and MgO relative to a total content of MgO, CaO, SrO, BaO and ZnO is preferably 0.00 or more and more preferably 0.10 or more, 0.15 or more, 0.16 or more, 0.17 or more, 0.18 or more, 0.19 or more, 0.20 or more, 0.21 or more, 0.22 or more, 0.23 or more, 0.24 or more, 0.25 or more, 0.26 or more, and 0.27 or more in that order. In order to improve the thermal stability, the mass ratio ((CaO+MgO)/(MgO+CaO+SrO+BaO+ZnO)) is preferably 1.00 or less and more preferably 0.95 or less, 0.90 or less, 0.89 or less, 0.88 or less, 0.87 or less, 0.86 or less, 0.85 or less, 0.84 or less, and 0.83 or less in that order.

The alkaline earth metal oxides MgO, CaO, SrO, and BaO, and ZnO have an effect of lowering a liquidus temperature and improving the thermal stability. On the other hand, when the content thereof is large, chemical durability and/or weather resistance tends to decrease. On the other hand, SiO₂ and B₂O₃ have an effect of improving the thermal stability, but if the content thereof is large, the meltability tends to decrease. For the above reason, a mass ratio (SiO₂+B₂O₃)/(MgO+CaO+SrO+BaO+ZnO) of a total content of SiO₂ and B₂O₃ relative to a total content of MgO, CaO, SrO, BaO and ZnO is preferably 0.40 or more and more preferably 0.45 or more, 0.50 or more, 0.52 or more, 0.54 or more, 0.56 or more, 0.57 or more, 0.58 or more, 0.59 or more, 0.60 or more, and 0.61 or more in that order, and is preferably 2.00 or less and more preferably 1.80 or less, 1.60 or less, 1.55 or less, 1.50 or less, 1.45 or less, 1.40 or less, and 1.35 or less in that order.

The MgO content is preferably 0.00% or more. In addition, the MgO content is preferably 15.00% or less and more preferably 12.00% or less, 9.00% or less, 7.00% or less, 6.00% or less, 5.00% or less, 4.00% or less, 3.50% or less, 3.00% or less, 2.50% or less, and 2.10% or less in that order.

The SrO content is preferably 0.00% or more and more preferably 0.10% or more, 0.20% or more, 0.25% or more, 0.26% or more, 0.27% or more, 0.28% or more, 0.29% or more, 0.30%% or more, and 0.31% or more in that order. In addition, the SrO content is preferably 15.00% or less and more preferably 12.00% or less, 10.00% or less, 9.00% or less, 8.50% or less, 8.00% or less, 7.50% or less, 7.00% or less, 6.50% or less, and 6.00% or less in that order.

The BaO content is preferably 0.00% or more and more preferably 0.10% or more, 0.20% or more, 0.30% or more, 0.40% or more, 0.50% or more, 0.60% or more, 0.70% or more, 0.80% or more, 0.90% or more, 1.00% or more, 1.10% or more, 1.20% or more, and 1.30% or more in that order. In addition, the BaO content is preferably 25.00% or less and more preferably 22.00% or less, 20.00% or less, 19.00% or less, 18.00% or less, 17.00% or less, 16.50% or less, 16.00% or less, 15.50% or less, 15.25% or less, and 15.00% or less in that order.

MgO, CaO, SrO and BaO are all glass components having an effect of improving the thermal stability and devitrification resistance of the glass. In order to increase the dispersibility and further reduce the specific gravity, and in order to improve the thermal stability and devitrification resistance of the glass, the content of each of these glass components is preferably in the above range.

The ZnO content is preferably 0.00% or more. In addition, the ZnO content is preferably 10.00% or less and more preferably 9.00% or less, 8.00% or less, 7.00% or less, 6.00% or less, 5.00% or less, 4.00% or less, 3.00% or less, and 2.00% or less in that order. ZnO is a glass component having an effect of improving the thermal stability of the glass. In order to further reduce the specific gravity, to improve the thermal stability of the glass, and obtain a more desirable optical constant, the ZnO content is preferably in the above range.

In Glass 1, in order to increase the refractive index and reduce the dispersibility, a total content (La₂O₃+Gd₂O₃+Y₂O₃) of rare earth oxides La₂O₃, Gd₂O₃ and Y₂O₃ is more than 0%, preferably 0.50% or more, and more preferably 1.00% or more, 1.33% or more, 1.50% or more, 2.00% or more, 2.50% or more, and 3.00% or more in that order. In order to further reduce the specific gravity, a total content (La₂O₃+Gd₂O₃+Y₂O₃) of La₂O₃, Gd₂O₃ and Y₂O₃ is preferably 30.00% or less and more preferably 29.00% or less, 28.00% or less, 26.00% or less, 24.00% or less, 22.00% or less, 20.00% or less, 18.00% or less, 16.00% or less, 15.00% or less, 14.50% or less, 14.00% or less, 13.50% or less, 13.00% or less, 12.50% or less, and 12.00% or less in that order.

BaO and rare earth oxides La₂O₃, Gd₂O₃ and Y₂O₃ are all components that contribute to low dispersibility (that is, increase the Abbe number vd), but when the content thereof is large, the specific gravity of the glass tends to increase. For the above reason, in Glass 1, a total content (BaO+La₂O₃+Gd₂O₃+Y₂O₃) of BaO and rare earth oxides La₂O₃, Gd₂O₃ and Y₂O₃ is 30.00% or less, preferably 29.00% or less, and more preferably 28.00% or less, 27.00% or less, 26.00% or less, 25.00% or less, 24.50% or less, 24.00% or less, 23.50% or less, and 23.00% or less in that order. In addition, in order to further increase the Abbe number vd, a total content (BaO+La₂O₃+Gd₂O₃+Y₂O₃) of BaO, La₂O₃, Gd₂O₃ and Y₂O₃ is preferably more than 0%, and more preferably 1.00% or more, 2.00% or more, 3.00% or more, 4.00% or more, 5.00% or more, 6.00% or more, 7.00% or more, 7.50% or more, 8.00% or more, and 8.50% or more in that order.

Both BaO and La₂O₃ are low-dispersion components, but BaO has a weaker effect of increasing the refractive index than La₂O₃. Therefore, in order to increase the refractive index, a mass ratio (BaO/La₂O₃) of the BaO content relative to the La₂O₃ content is preferably 8.30 or less and more preferably 8.00 or less, 7.50 or less, 7.00 or less, 6.50 or less, 6.00 or less, 5.50 or less, 5.40 or less, 5.30 or less, 5.20 or less, 5.10 or less, 5.00 or less, 4.90 or less, 4.80 or less, and 4.70 or less in that order.

The mass ratio (BaO/La₂O₃) may be 0 or may be 0.00 or more. In order to maintain the thermal stability of the glass, the mass ratio (BaO/La₂O₃) is preferably more than 0.00 and more preferably 0.01 or more, 0.02 or more, 0.03 or more, 0.04 or more, 0.05 or more, 0.06 or more, 0.07 or more, 0.08 or more, 0.09 or more, 0.10 or more, and 0.11 or more in that order.

Rare earth oxides La₂O₃, Gd₂O₃ and Y₂O₃ can contribute to increasing the refractive index and reducing dispersibility, but if the content thereof is large, the thermal stability tends to decrease. In addition, SiO₂ and B₂O₃ have an effect of improving the thermal stability, but if the content thereof is large, the meltability tends to decrease and the refractive index tends to decrease. For the above reason, a mass ratio ((SiO₂+B₂O₃)/(La₂O₃+Gd₂O₃+Y₂O₃)) of a total content of SiO₂ and B₂O₃ relative to a total content of La₂O₃, Gd₂O₃ and Y₂O₃ is preferably more than 0.00 and more preferably 0.25 or more, 0.50 or more, 0.75 or more, 1.00 or more, 1.25 or more, 1.50 or more, 1.75 or more, 1.80 or more, and 1.85 or more in that order and preferably 7.47 or less and more preferably 7.40 or less, 7.35 or less, 7.30 or less, and 7.25 or less in that order.

La₂O₃, Gd₂O₃ and Y₂O₃ are all components that can increase the refractive index of the glass, but Gd₂O₃ and Y₂O₃ are components that increase the specific gravity as compared with La₂O₃. Therefore, in order to further reduce the specific gravity, a mass ratio (La₂O₃/(La₂O₃+Gd₂O₃+Y₂O₃)) of the La₂O₃ content relative to a total content of La₂O₃, Gd₂O₃ and Y₂O₃ is preferably more than 0.00 and more preferably 0.10 or more, 0.20 or more, 0.30 or more, 0.40 or more, 0.50 or more, 0.60 or more, 0.70 or more, and 0.75 or more in that order. The mass ratio (La₂O₃/(La₂O₃+Gd₂O₃+Y₂O₃)) can be 1.00 or less.

For the same reason, a mass ratio (Gd₂O₃/(La₂O₃+Gd₂O₃+Y₂O₃)) of the Gd₂O₃ content relative to a total content of La₂O₃, Gd₂O₃ and Y₂O₃ is preferably less than 1.00 and more preferably 0.90 or less, 0.80 or less, 0.70 or less, 0.60 or less, 0.50 or less, 0.40 or less, 0.30 or less, 0.25 or less, and 0.20 or less in that order. The mass ratio (Gd₂O₃/(La₂O₃+Gd₂O₃+Y₂O₃)) can be 0.00 or more.

In addition, for the same reason, a mass ratio (Y₂O₃/(La₂O₃+Gd₂O₃+Y₂O₃)) of the Y₂O₃ content relative to a total content of La₂O₃, Gd₂O₃ and Y₂O₃ is preferably less than 1.00 and more preferably 0.90 or less, 0.80 or less, 0.70 or less, 0.60 or less, 0.50 or less, 0.40 or less, 0.30 or less, and 0.25 or less in that order. The mass ratio (Y₂O₃/(La₂O₃+Gd₂O₃+Y₂O₃)) can be 0.00 or more.

For the above reason, the contents of the above components which are rare earth oxides are preferably in the following ranges.

The La₂O₃ content is preferably 0.00% or more and more preferably more than 0.00%, 0.50% or more, 1.00% or more, 1.33% or more, 1.50% or more, 2.00% or more, 2.50% or more, 2.75% or more, and 3.00% or more in that order. In addition, the La₂O₃ content is preferably 30.00% or less and more preferably 25.00% or less, 20.00% or less, 18.00% or less, 16.00% or less, 15.00% or less, 14.00% or less, 13.50% or less, 13.00% or less, 12.50% or less, and 12.00% or less in that order.

The Gd₂O₃ content is preferably 0.00% or more. In addition, the Gd₂O₃ content is preferably 10.00% or less and more preferably 9.00% or less, 8.00% or less, 7.00% or less, 6.00% or less, 5.00% or less, 4.00% or less, 3.00% or less, and 2.00% or less in that order.

The Y₂O₃ content is preferably 0.00% or more. In addition, the Y₂O₃ content is preferably 10.00% or less and more preferably 9.00% or less, 8.00% or less, 7.00% or less, 6.00% or less, 5.00% or less, 4.00% or less, 3.00% or less, and 2.00% or less in that order.

La₂O₃ has an effect of increasing the refractive index of the glass, and B₂O₃ tends to decrease the refractive index of the glass. Therefore, in order to further increase the refractive index, a mass ratio (La₂O₃/B₂O₃) of the La₂O₃ content relative to the B₂O₃ content is preferably 1.30 or more and more preferably 1.35 or more, 1.40 or more, 1.45 or more, 1.50 or more, 1.55 or more, 1.60 or more, 1.65 or more, 1.70 or more, and 1.72 or more in that order. In order to further reduce the specific gravity, the mass ratio (La₂O₃/B₂O₃) is preferably 20.00 or less and more preferably 18.00 or less, 16.00 or less, 14.00 or less, 13.00 or less, 12.00 or less, 11.50 or less, 11.00 or less, 10.50 or less, and 10.00 or less in that order.

A mass ratio (B₂O₃/La₂O₃) of the B₂O₃ content relative to the La₂O₃ content is preferably 0.79 or less and more preferably 0.78 or less, 0.77 or less, 0.76 or less, 0.75 or less, 0.70 or less, 0.65 or less, 0.64 or less, 0.62 or less, 0.61 or less, 0.60 or less, 0.59 or less, 0.58 or less, 0.57 or less, and 0.50 or less in that order. The mass ratio (La₂O₃/B₂O₃) is preferably 0.00 or more and more preferably more than 0.00.

Rare earth oxides can increase the refractive index of the glass, but if the content of rare earth oxides is large, the thermal stability tends to decrease and the meltability of the glass tends to decrease. Therefore, in order to maintain the thermal stability of the glass and further increase the refractive index, a mass ratio ((La₂O₃+Gd₂O₃+Y₂O₃)/(BaO+La₂O₃+Gd₂O₃+Y₂O₃)) of a total content of La₂O₃, Gd₂O₃ and Y₂O₃ relative to a total content of BaO, La₂O₃, Gd₂O₃ and Y₂O₃ is preferably 1.00 or less and more preferably less than 1.00, 0.99 or less, 0.98 or less, 0.97 or less, 0.96 or less, 0.95 or less, 0.94 or less, 0.93 or less, 0.92 or less, 0.91 or less, and 0.90 or less in that order. The mass ratio ((La₂O₃+Gd₂O₃+Y₂O₃)/(BaO+La₂O₃+Gd₂O₃+Y₂O₃)) is preferably more than 0.00 and more preferably 0.05 or more, 0.06 or more, 0.07 or more, 0.08 or more, 0.09 or more, 0.10 or more, 0.11 or more, 0.12 or more, 0.13 or more, 0.14 or more, 0.15 or more, 0.16 or more, 0.17 or more, 0.18 or more, and 0.20 or more in that order.

Rare earth oxides can increase the refractive index of the glass, but if the content thereof is large, the meltability of the glass tends to decrease. On the other hand, alkaline earth metal oxides can improve the meltability of the glass, but if the content thereof is large, the refractive index tends to decrease. Therefore, in order to maintain the meltability of the glass and further increase the refractive index, a mass ratio ((La₂O₃+Gd₂O₃+Y₂O₃)/(MgO+CaO+SrO+BaO+ZnO+La₂O₃+Gd₂O₃+Y₂O₃)) of a total content of La₂O₃, Gd₂O₃ and Y₂O₃ relative to a total content of MgO, CaO, SrO, BaO, ZnO, La₂O₃, Gd₂O₃ and Y₂O₃ is preferably more than 0.00 and more preferably 0.01 or more, 0.02 or more, 0.03 or more, 0.04 or more, 0.05 or more, 0.06 or more, 0.07 or more, and 0.08 or more in that order, and preferably 0.85 or less and more preferably 0.80 or less, 0.75 or less, 0.70 or less, 0.65 or less, 0.60 or less, 0.55 or less, 0.50 or less, 0.45 or less, 0.44 or less, 0.43 or less, 0.42 or less, 0.41 or less, and 0.40 or less in that order.

Rare earth oxides can increase the refractive index of the glass, but if the content thereof is large, the thermal stability of the glass tends to decrease. On the other hand, B₂O₃ can improve the thermal stability of the glass, but if the content thereof is large, the refractive index tends to decrease. Therefore, in order to maintain the thermal stability of the glass and further increase the refractive index, a mass ratio (B₂O₃/(BaO+La₂O₃+Gd₂O₃+Y₂O₃)) of the B₂O₃ content relative to a total content of BaO, La₂O₃, Gd₂O₃ and Y₂O₃ is preferably 0.00 or more and more preferably more than 0.00, 0.01 or more, 0.02 or more, and 0.03 or more in that order, and preferably 1.00 or less and more preferably 0.90 or less, 0.80 or less, 0.70 or less, 0.60 or less, 0.55 or less, 0.50 or less, 0.45 or less, 0.40 or less, and 0.35 or less in that order.

La₂O₃, Gd₂O₃ and Y₂O₃ have an effect of increasing the refractive index of the glass, but if a total content thereof is large, the thermal stability tends to decrease. On the other hand, B₂O₃ has an effect of improving the thermal stability of the glass, but it tends to reduce the refractive index. Therefore, in order to increase the refractive index while maintaining the thermal stability of the glass, a mass ratio ((La₂O₃+Gd₂O₃+Y₂O₃)/(B₂O₃+La₂O₃+Gd₂O₃+Y₂O₃)) of a total content of La₂O₃, Gd₂O₃ and Y₂O₃ relative to a total content of B₂O₃, La₂O₃, Gd₂O₃ and Y₂O₃ is preferably 0.57 or more and more preferably 0.58 or more, 0.59 or more, 0.60 or more, 0.61 or more, 0.62 or more, 0.63 or more, and 0.64 or more in that order. In order to further reduce the specific gravity, the mass ratio (La₂O₃+Gd₂O₃+Y₂O₃/(B₂O₃+La₂O₃+Gd₂O₃+Y₂O₃)) is preferably 1.00 or less and more preferably less than 1.00, 0.99 or less, 0.98 or less, 0.97 or less, 0.96 or less, 0.95 or less, 0.94 or less, 0.93 or less, 0.92 or less, 0.91 or less, 0.90 or less, 0.89 or less, 0.88 or less, 0.87 or less, 0.86 or less, and 0.85 or less in that order.

La₂O₃, Gd₂O₃, Y₂O₃ and ZrO₂ have an effect of increasing the refractive index and improving partial dispersion characteristics, but if the content of ZrO₂ is large, the meltability of the glass tends to decrease. For the above reason, a mass ratio (ZrO₂/(La₂O₃+Gd₂O₃+Y₂O₃+ZrO₂)) of the ZrO₂ content relative to a total content of La₂O₃, Gd₂O₃, Y₂O₃ and ZrO₂ is preferably 0.01 or more and more preferably 0.02 or more, 0.03 or more, and 0.04 or more in that order, and preferably 5.00 or less and more preferably 4.00 or less, 3.00 or less, and 2.00 or less in that order.

La₂O₃, Gd₂O₃, Y₂O₃ and ZrO₂ are all components that increase the refractive index, but ZrO₂ has a stronger effect of increasing the refractive index and a stronger effect of increasing dispersion (effect of reducing the Abbe number) than La₂O₃, Gd₂O₃, and Y₂O₃. In order to keep dispersion low, a mass ratio (ZrO₂/(La₂O₃+Gd₂O₃+Y₂O₃)) of the ZrO₂ content relative to a total content of La₂O₃, Gd₂O₃ and Y₂O₃ is preferably 2.00 or less and more preferably 1.90 or less, 1.80 or less, 1.70 or less, 1.60 or less, 1.50 or less, 1.40 or less, 1.30 or less, 1.25 or less, and 1.20 or less in that order. The mass ratio (ZrO₂/(La₂O₃+Gd₂O₃+Y₂O₃)) can be 0.00 or more, and in order to further increase the refractive index, it is preferably more than 0.00 and more preferably 0.01 or more, 0.02 or more, 0.03 or more, 0.04 or more, 0.05 or more, and 0.06 or more in that order.

The ZrO₂ content is preferably 0.00% or more and more preferably more than 0.00%, 0.10% or more, 0.20% or more, 0.30% or more, 0.40% or more, 0.50% or more, 0.60% or more, and 0.65% or more in that order. In addition, the ZrO₂ content is preferably 15.00% or less and more preferably 12.00% or less, 10.40% or less, 10.00% or less, 9.00% or less, 8.50% or less, 8.00% or less, 7.50% or less, 7.20% or less, 7.10% or less, 7.00% or less, 6.50% or less, 6.00% or less, and 5.90% or less in that order. The ZrO₂ content is preferably set to be within the above range in order to achieve a more desirable optical constant and improve partial dispersion characteristics.

MgO, CaO, SrO, BaO and ZnO have an effect of improving the thermal stability of the glass, but if the content thereof is large, the refractive index tends to decrease. On the other hand, La₂O₃, Gd₂O₃ and Y₂O₃ have an effect of increasing the refractive index, but if the content thereof is large, the thermal stability tends to decrease. For the above reason, a mass ratio ((MgO+CaO+SrO+BaO+ZnO)/(La₂O₃+Gd₂O₃+Y₂O₃)) of a total content of MgO, CaO, SrO, BaO and ZnO relative to a total content of La₂O₃, Gd₂O₃ and Y₂O₃ is preferably more than 0.00 and more preferably 0.10 or more, 0.20 or more, 0.30 or more, 0.40 or more, 0.50 or more, 0.60 or more, 0.70 or more, 0.80 or more, 0.90 or more, 1.00 or more, 1.10 or more, 1.20 or more, 1.30 or more, and 1.40 or more in that order, and preferably 20.00 or less and more preferably 18.00 or less, 16.00 or less, 14.00 or less, 11.09 or less, 11.08 or less, 11.07 or less, 11.06 or less, 11.05 or less, 11.04 or less, 11.03 or less, 11.02 or less, 11.01 or less, and 11.00 or less in that order.

SrO, BaO, La₂O₃, Gd₂O₃ and Y₂O₃ are all effective components for maintaining low dispersibility. Therefore, in order to maintain lower dispersibility, a total content (SrO+BaO+La₂O₃+Gd₂O₃+Y₂O₃) of SrO, BaO, La₂O₃, Gd₂O₃ and Y₂O₃ is preferably 9.00% or more and more preferably 9.50% or more, 10.00% or more, 10.50% or more, 11.00% or more, 11.50% or more, 12.00% or more, 12.50% or more, 13.00% or more, and 13.50% or more in that order.

In addition, in order to further reduce the specific gravity, the total content (SrO+BaO+La₂O₃+Gd₂O₃+Y₂O₃) is preferably 45.00% or less and more preferably 40.00% or less, 35.00% or less, 30.00% or less, 29.00% or less, 28.00% or less, 27.00% or less, 26.00% or less, and 25.00% or less in that order.

La₂O₃, Gd₂O₃ and Y₂O₃ are components having an effect of increasing the refractive index, and SiO₂ is a component that maintains the thermal stability of the glass. In order to further increase the refractive index, a mass ratio ((La₂O₃+Gd₂O₃+Y₂O₃)/(La₂O₃+Gd₂O₃+Y₂O₃+SiO₂)) of a total content of La₂O₃, Gd₂O₃ and Y₂O₃ relative to a total content of La₂O₃, Gd₂O₃, Y₂O₃ and SiO₂ is preferably 0.12 or more and more preferably 0.13 or more. In order to maintain the thermal stability of the glass, the mass ratio ((La₂O₃+Gd₂O₃+Y₂O₃)/(La₂O₃+Gd₂O₃+Y₂O₃+SiO₂)) is preferably 0.70 or less and more preferably 0.60 or less, 0.50 or less, 0.49 or less, 0.48 or less, 0.47 or less, 0.46 or less, 0.45 or less, 0.44 or less, 0.43 or less, 0.42 or less, and 041 or less in that order.

Regarding a mass ratio ((SiO₂+CaO)/(TiO₂+Nb₂O₅+Ta₂O₅+WO₃+Bi₂O₃)) of a total content of SiO₂ and CaO relative to a total content of TiO₂, Nb₂O₅, Ta₂O₅, WO₃ and Bi₂O₃, the denominator is a total content of components that have a strong effect of increasing the refractive index, and the numerator is a total content of components effective for reducing dispersion and decreasing specific gravity. In order to maintain low dispersibility, further reduce the specific gravity and maintain the thermal stability, the mass ratio ((SiO₂+CaO)/(TiO₂+Nb₂O₅+Ta₂O₅+WO₃+Bi₂O₃)) is preferably 0.25 or more and more preferably 0.30 or more, 0.35 or more, 0.40 or more, 0.42 or more, 0.44 or more, 0.46 or more, 0.48 or more, 0.50 or more, 0.52 or more, 0.54 or more, and 0.55 or more in that order. The mass ratio ((SiO₂+CaO)/(TiO₂+Nb₂O₅+Ta₂O₅+WO₃+Bi₂O₃)) is preferably 1.20 or less and more preferably 1.19 or less, 1.18 or less, 1.17 or less, 1.16 or less, 1.15 or less, 1.14 or less, 1.13 or less, 1.12 or less, 1.11 or less, 1.10 or less, 1.09 or less, 1.08 or less, 1.07 or less, 1.06 or less, 1.05 or less, 1.04 or less, 1.03 or less, 1.02 or less, and 1.01 or less in that order.

Among ZrO₂, TiO₂, Nb₂O₅, Ta₂O₅, WO₃, and Bi₂O₃ which are components that increase the refractive index, ZrO₂ has a relatively weak effect of increasing dispersion. Therefore, in order to maintain lower dispersibility, a mass ratio (ZrO₂/(TiO₂+Nb₂O₅+Ta₂O₅+WO₃+Bi₂O₃)) of the ZrO₂ content relative to a total content of TiO₂, Nb₂O₅, Ta₂O₅, WO₃ and Bi₂O₃ is preferably 0.00 or more and more preferably 0.01 or more, and 0.02 or more in that order. In order to maintain the thermal stability of the glass and maintain devitrification resistance (stability during reheat press molding: also called reheat press moldability) when glass is heated and softened and press-molded, the mass ratio (ZrO₂/(TiO₂+Nb₂O₅+Ta₂O₅+WO₃+Bi₂O₃)) is preferably 0.21 or less and more preferably 0.20 or less, 0.19 or less, 0.18 or less, 0.17 or less, 0.16 or less, and 0.15 or less in that order.

The alkali metal oxides Li₂O, Na₂O, K₂O and Cs₂O have an effect of improving partial dispersion characteristics and also have an effect of lowering a liquidus temperature and improving the thermal stability of the glass. For these reasons, a total content (Li₂O+Na₂O+K₂O+Cs₂O) of Li₂O, Na₂O, K₂O and Cs₂O is preferably 0.00% or more and more preferably more than 0.00%, 0.05% or more, 0.10% or more, 0.15% or more, 0.20% or more, 0.25% or more, and 0.28% or more in that order. In order to improve chemical durability and weather resistance, the total content (Li₂O+Na₂O+K₂O+Cs₂O) is preferably 20.00% or less and more preferably 18.00% or less, 16.00% or less, 14.00% or less, 12.00% or less, 10.00% or less, 9.00% or less, 8.00% or less, 7.00% or less, 6.50% or less, 6.00% or less, 5.50% or less, 5.00% or less, and 4.50% or less in that order.

Alkali metal oxides and alkaline earth metal oxides can contribute to maintaining the meltability and thermal stability of the glass, but if the content thereof is large, the meltability and thermal stability of the glass tend to decrease. Therefore, in order to maintain the meltability and thermal stability of the glass, a total content (Li₂O+Na₂O+K₂O+Cs₂O+MgO+CaO+SrO+BaO) of the alkali metal oxides Li₂O, Na₂O, K₂O and Cs₂O and the alkaline earth metal oxides MgO, CaO, SrO and BaO is preferably 5.00% or more and more preferably 7.00% or more, 9.00% or more, 10.00% or more, 12.00% or more, 14.00% or more, 15.00% or more, 16.00% or more, 17.00% or more, 18.00% or more, and 18.50% or more in that order, and preferably 50.00% or less and more preferably 48.00% or less, 46.00% or less, 44.00% or less, 43.00% or less, 42.00% or less, 41.00% or less, 40.00% or less, 39.00% or less, 38.00% or less, 37.00% or less, 36.00% or less, 35.00% or less, 34.50% or less, and 34.00% or less in that order.

Alkali metal oxides and alkaline earth metal oxides have effect of lowering a liquidus temperature and improving the thermal stability, but if the content thereof with respect to a network formation component of the glass is large, chemical durability and weather resistance tend to decrease. In addition, SiO₂ and B₂O₃ have an effect of improving the thermal stability, but if the content thereof is large, the meltability tends to decrease. For these reasons, a mass ratio ((Li₂O+Na₂O+K₂O+Cs₂O+MgO+CaO+SrO+BaO)/(SiO₂+B₂O₃)) of a total content of Li₂O, Na₂O, K₂O, Cs₂₀, MgO, CaO, SrO and BaO relative to a total content of SiO₂ and B₂O₃ is preferably 0.50 or more and more preferably 0.52 or more, 0.54 or more, 0.56 or more, 0.58 or more, 0.60 or more, 0.62 or more, 0.64 or more, 0.66 or more, 0.68 or more, 0.70 or more, 0.72 or more, 0.74 or more, 0.75 or more, 0.76 or more, 0.77 or more, 0.78 or more, and 0.79 or more in that order and preferably 5.00 or less and more preferably 4.50 or less, 4.00 or less, 3.50 or less, 3.00 or less, 2.50 or less, 2.00 or less, 1.90 or less, 1.80 or less, 1.70 or less, 1.65 or less, and 1.60 or less in that order.

Among Li₂O, Na₂O and K₂O, Li₂O is the component which is least likely to lower the refractive index. Therefore, in order to further increase the refractive index, a mass ratio (Li₂O/(Li₂O+Na₂O+K₂O)) of the Li₂O content relative to a total content of Li₂O, Na₂O and K₂O is preferably 0.00 or more and more preferably more than 0.00, 0.10 or more, 0.20 or more, 0.30 or more, 0.40 or more, and 0.45 or more in that order. The mass ratio (Li₂O/(Li₂O+Na₂O+K₂O)) can be, for example, 1.00 or less.

Li₂O, Na₂O, K₂O, MgO, CaO, SrO, BaO and ZnO are components that can increase the specific resistance of the glass and facilitate electric heating without increasing a melting temperature and a liquidus temperature of the glass. In addition, since Li₂O, Na₂O, K₂O, MgO, CaO, SrO, BaO and ZnO are components that can improve the thermal stability of the glass, the glass can be kept in a molten state at a lower temperature. That is, they have an effect of improving the meltability of the glass. On the other hand, if small amounts of Li₂O, Na₂O and K₂O are introduced, the melting temperature of the glass decreases and fusion of other high melting point components is promoted, but if a total content thereof is large, the specific resistance in a molten state of the glass decreases and the efficiency of electric heating tends to decrease. In addition, if a total content of Li₂O, Na₂O and K₂O is large, since the viscosity of the glass decreases and the thermal stability also deteriorates, the meltability of the glass tends to decrease. In addition, if a total content of Li₂O, Na₂O and K₂O is large, dispersibility of the glass tends to be higher. Therefore, in order to obtain more desirable meltability and optical characteristics, a mass ratio ((Li₂O+Na₂O+K₂O)/(MgO+CaO+SrO+BaO+ZnO)) of a total content of Li₂O, Na₂O, and K₂O relative to a total content of MgO, CaO, SrO, BaO and ZnO is preferably 0.00 or more and more preferably more than 0.00, 0.01 or more, 0.02 or more, 0.03 or more, 0.04 or more, and 0.05 or more in that order, and preferably 4.00 or less and more preferably 3.50 or less, 3.00 or less, 2.50 or less, 2.00 or less, 1.50 or less, 1.00 or less, 0.90 or less, 0.80 or less, 0.70 or less, 0.60 or less, 0.50 or less, 0.40 or less, and 0.35 or less in that order.

In order to maintain the thermal stability and/or reheat press moldability, a mass ratio ((Li₂O+Na₂O+K₂O)/(SiO₂+B₂O₃)) of a total content of Li₂O, Na₂O and K₂O relative to a total content of SiO₂ and B₂O₃ is preferably 1.00 or less and more preferably 0.90 or less, 0.80 or less, 0.70 or less, 0.60 or less, 0.50 or less, 0.40 or less, 0.35 or less, 0.30 or less, and 0.25 or less in that order. In order to maintain the meltability and/or reduce a partial dispersion ratio to provide a glass suitable for high-order chromatic aberration correction, the mass ratio ((Li₂O+Na₂O+K₂O)/(SiO₂+B₂O₃)) is preferably 0.00 or more and more preferably more than 0.00, 0.01 or more, 0.02 or more, 0.03 or more, 0.04 or more, and 0.05 or more in that order.

The Li₂O content is preferably 0.00% or more and more preferably 0.05% or more, 0.10% or more, 0.15% or more, 0.20% or more, 0.25% or more, 0.30% or more, 0.40% or more, 0.50% or more, and 0.60% or more in that order. In addition, the Li₂O content is preferably 14.00% or less and more preferably 12.00% or less, 10.00% or less, 8.00% or less, 7.00% or less, 6.50% or less, 6.00% or less, 5.50% or less, and 5.00% or less in that order. It is preferable that the Li₂O content be set to be within the above range in order to achieve a more desirable optical constant and in order to maintain chemical durability, weather resistance, and stability during reheating.

The Na₂O content is preferably 0.00% or more. In addition, the Na₂O content is preferably 10.00% or less, and more preferably 8.00% or less, 7.00% or less, 6.00% or less, 5.00% or less, 4.00% or less, 3.00% or less, and 2.00% or less in that order. In order to improve partial dispersion characteristics, the Na₂O content is preferably set to be within the above range.

The K₂O content is preferably 0.00% or more. In addition, the K₂O content is preferably 10.00% or less and more preferably 8.00% or less, 7.00% or less, 6.00% or less, 5.00% or less, 4.00% or less, 3.00% or less, and 2.00% or less in that order. In order to improve the thermal stability of the glass, the K₂O content is preferably set to be within the above range.

The Cs₂O content is preferably 5.00% or less and more preferably 4.00% or less, 3.00% or less, 2.00% or less, 1.00% or less, and 0.50% or less in that order, and may be 0%.

In order to further increase the refractive index, a total content (TiO₂+Nb₂O₅+Ta₂O₅+WO₃+Bi₂O₃) of TiO₂, Nb₂O₅, Ta₂O₅, WO₃ and Bi₂O₃ is preferably 30.00% or more and more preferably 31.00% or more, 32.00% or more, 33.00% or more, 34.00% or more, 35.00% or more, 36.00% or more, 36.50% or more, 37.00% or more, and 37.55% or more in that order. In order to further reduce the specific gravity and in order to improve the thermal stability, the total content (TiO₂+Nb₂O₅+Ta₂O₅+WO₃+Bi₂O₃) of TiO₂, Nb₂O₅, Ta₂O₅, WO₃ and Bi₂O₃ is preferably 60.00% or less and more preferably 58.00% or less, 56.00% or less, 54.00% or less, 52.00% or less, 51.00% or less, 50.00% or less, 49.50% or less, 49.00% or less, and 48.50% or less in that order.

In order to obtain a glass having a high refractive index while an increase in specific gravity is reduced, a mass ratio ((SiO₂+B₂O₃)/(TiO₂+Nb₂O₅+Ta₂O₅+WO₃+Bi₂O₃)) of a total content of SiO₂ and B₂O₃ relative to a total content of TiO₂, Nb₂O₅, Ta₂O₅, WO₃ and Bi₂O₃ is 0.75 or less. In addition to the above, in order to achieve a desirable Abbe number vd and improve partial dispersion characteristics and improve the devitrification resistance, the mass ratio ((SiO₂+B₂O₃)/(TiO₂+Nb₂O₅+Ta₂O₅+WO₃+Bi₂O₃)) is preferably 0.16 or more and more preferably 0.20 or more, 0.25 or more, 0.30 or more, 0.35 or more, 0.36 or more, 0.37 or more, 0.38 or more, 0.39 or more, 0.40 or more, 0.41 or more, and 0.42 or more in that order, and preferably 0.75 or less and more preferably 0.74 or less, 0.73 or less, 0.72 or less, 0.71 or less, 0.70 or less, 0.69 or less, 0.68 or less, 0.67 or less, 0.66 or less, 0.65 or less, and 0.64 or less in that order.

SiO₂ and B₂O₃ have an effect of reducing the refractive index and reducing dispersion (increasing the Abbe number). On the other hand, TiO₂, Nb₂O₅, Ta₂O₅, WO₃, Bi₂O₃, and ZrO₂ are high-refractive-index and high-dispersion components. In order to further increase the refractive index, a mass ratio ((SiO₂+B₂O₃)/(TiO₂+Nb₂O₅+Ta₂O₅+WO₃+Bi₂O₃+ZrO₂)) of a total content of SiO₂ and B₂O₃ relative to a total content of TiO₂, Nb₂O₅, Ta₂O₅, WO₃, Bi₂O₃ and ZrO₂ is preferably 0.64 or less and more preferably 0.63 or less, 0.62 or less, 0.61 or less, 0.60 or less, 0.59 or less, and 0.58 or less in that order.

On the other hand, in order to reduce an increase in dispersion, the mass ratio ((SiO₂+B₂O₃)/(TiO₂+Nb₂O₅+Ta₂O₅+WO₃+Bi₂O₃+ZrO₂)) is preferably 0.13 or more and more preferably 0.15 or more, 0.20 or more, 0.25 or more, 0.26 or more, 0.27 or more, 0.28 or more, 0.29 or more, 0.30 or more, 0.31 or more, 0.32 or more, 0.33 or more, 0.34 or more, 0.35 or more, 0.36 or more, 0.37 or more, and 0.38 or more in that order.

In order to improve partial dispersion characteristics and the transmittance, the mass ratio ((Li₂O+Na₂O+K₂O)/(TiO₂+Nb₂O₅+Ta₂O₅+WO₃+Bi₂O₃)) of a total content of Li₂O, Na₂O and K₂O relative to a total content of TiO₂, Nb₂O₅, Ta₂O₅, WO₃ and Bi₂O₃ is preferably 0.00 or more and more preferably 0.01 or more. In order to maintain the thermal stability and/or reheat press moldability of the glass, the mass ratio ((Li₂O+Na₂O+K₂O)/(TiO₂+Nb₂O₅+Ta₂O₅+WO₃+Bi₂O₃)) is preferably 0.67 or less and more preferably 0.60 or less, 0.50 or less, 0.40 or less, 0.30 or less, 0.20 or less, 0.15 or less, and 0.10 or less in that order.

MgO, CaO, SrO, BaO and ZnO have an effect of improving the thermal stability of the glass, but if the content thereof is large, the refractive index tends to decrease and the glass tends to have lower dispersibility. On the other hand, TiO₂, Nb₂O₅, WO₃ and Bi₂O₃ tend to increase the refractive index and tend to make dispersibility of the glass higher, but if the content thereof is large, the thermal stability tends to decrease. For the above reason, the mass ratio ((MgO+CaO+SrO+BaO+ZnO)/(TiO₂+Nb₂O₅+Ta₂O₅+WO₃+Bi₂O₃)) of a total content of MgO, CaO, SrO, BaO and ZnO relative to a total content of TiO₂, Nb₂O₅, Ta₂O₅, WO₃ and Bi₂O₃ is preferably 0.09 or more and more preferably 0.10 or more, 0.15 or more, 0.20 or more, 0.21 or more, 0.22 or more, 0.23 or more, 0.24 or more, 0.25 or more, 0.26 or more, 0.27 or more, 0.28 or more, 0.29 or more, 0.30 or more, 0.31 or more, and 0.32 or more in that order, and preferably 1.66 or less and more preferably 1.60 or less, 1.50 or less, 1.40 or less, 1.30 or less, 1.20 or less, 1.10 or less, 1.00 or less, 0.95 or less, 0.90 or less, and 0.88 or less in that order.

In terms of contribution to dispersibility, comparing TiO₂, Nb₂O₅, Ta₂O₅, WO₃ and Bi₂O₃ to La₂O₃, Gd₂O₃ and Y₂O₃, TiO₂, Nb₂O₅, Ta₂O₅, WO₃ and Bi₂O₃ tend to make dispersibility of the glass lower, and La₂O₃, Gd₂O₃ and Y₂O₃ tend to make dispersibility of the glass higher. In order to obtain desirable dispersibility, a mass ratio ((La₂O₃+Gd₂O₃+Y₂O₃)/(TiO₂+Nb₂O₅+Ta₂O₅+WO₃+Bi₂O₃)) of a total content of La₂O₃, Gd₂O₃ and Y₂O₃ relative to a total content of TiO₂, Nb₂O₅, Ta₂O₅, WO₃ and Bi₂O₃ is preferably more than 0.00 and more preferably 0.01 or more, 0.02 or more, 0.03 or more, 0.04 or more, 0.05 or more, 0.06 or more, and 0.07 or more in that order, and preferably 1.00 or less and more preferably 0.90 or less, 0.80 or less, 0.70 or less, 0.60 or less, 0.50 or less, 0.45 or less, 0.40 or less, 0.35 or less, and 0.32 or less in that order.

In order to improve partial dispersion characteristics, the mass ratio (TiO₂/(TiO₂+Nb₂O₅+Ta₂O₅+WO₃+Bi₂O₃)) of the TiO₂ content relative to a total content of TiO₂, Nb₂O₅, Ta₂O₅, WO₃ and Bi₂O₃ is preferably 0.00 or more and more preferably more than 0.00, 0.01 or more, 0.02 or more, 0.03 or more, 0.04 or more, 0.05 or more, 0.06 or more, 0.07 or more, 0.08 or more, and 0.09 or more in that order, and preferably 1.00 or less and more preferably less than 1.00, 0.95 or less, 0.90 or less, 0.85 or less, 0.80 or less, 0.75 or less, and 0.73 or less in that order.

In order to improve partial dispersion characteristics, the mass ratio (Nb₂O₅/(TiO₂+Nb₂O₅+Ta₂O₅+WO₃+Bi₂O₃)) of the Nb₂O₅ content relative to a total content of TiO₂, Nb₂O₅, Ta₂O₅, WO₃ and Bi₂O₃ is preferably 0.00 or more and more preferably more than 0.00, 0.01 or more, 0.05 or more, 0.10 or more, 0.15 or more, 0.20 or more, 0.21 or more, 0.22 or more, 0.23 or more, 0.24 or more, 0.25 or more, 0.26 or more, and 0.27 or more in that order, and preferably 1.00 or less and more preferably less than 1.00, 0.99 or less, 0.98 or less, 0.97 or less, 0.96 or less, 0.95 or less, 0.94 or less, 0.93 or less, 0.92 or less, and 0.91 or less in that order.

In order to reduce the raw material cost of the glass and further reduce the specific gravity, the mass ratio (Ta₂O₅/(TiO₂+Nb₂O₅+Ta₂O₅+WO₃+Bi₂O₃)) of the Ta₂O₅ content relative to a total content of TiO₂, Nb₂O₅, Ta₂O₅, WO₃ and Bi₂O₃ is preferably 1.00 or less, more preferably 0.80 or less, 0.60 or less, 0.40 or less, 0.30 or less, 0.20 or less, and 0.10 or less in that order, and particularly preferably 0.

Among high-refractive-index and high-dispersion components TiO₂, Nb₂O₅, Ta₂O₅, WO₃ and Bi₂O₃, WO₃ and Bi₂O₃ have a strong effect of increasing the specific gravity. Therefore, in order to further reduce the specific gravity, the mass ratio (WO₃/(TiO₂+Nb₂O₅+Ta₂O₅+WO₃+Bi₂O₃)) of the WO₃ content relative to a total content of TiO₂, Nb₂O₅, Ta₂O₅, WO₃ and Bi₂O₃ is preferably 1.00 or less, more preferably 0.80 or less, 0.60 or less, 0.40 or less, 0.30 or less, 0.20 or less, and 0.10 or less in that order, and particularly preferably 0.

For the same reason, the mass ratio (Bi₂O₃/(TiO₂+Nb₂O₅+Ta₂O₅+WO₃+Bi₂O₃)) of the Bi₂O₃ content relative to a total content of TiO₂, Nb₂O₅, Ta₂O₅, WO₃ and Bi₂O₃ is preferably 1.00 or less, more preferably 0.80 or less, 0.60 or less, 0.40 or less, 0.30 or less, 0.20 or less, and 0.10 or less in that order, and particularly preferably 0.

Li₂O, La₂O₃, Gd₂O₃, Y₂O₃, ZrO₂, TiO₂, Nb₂O₅, Ta₂O₅, WO₃ and Bi₂O₃ have an effect of increasing the refractive index. On the other hand, SiO₂, B₂O₃, Na₂O, K₂O, MgO, CaO, SrO, BaO and ZnO tend to reduce the refractive index. In order to further increase the refractive index, the mass ratio ((SiO₂+B₂O₃+Na₂O+K₂O+MgO+CaO+SrO+BaO+ZnO)/(Li₂O+La₂O₃+Gd₂O₃+Y₂O₃+ZrO₂+TiO₂+Nb₂O₅+Ta₂O₅+WO₃+Bi₂O₃)) of SiO₂, B₂O₃, Na₂O, K₂O, MgO, CaO, SrO, BaO and ZnO relative to a total content of Li₂O, La₂O₃, Gd₂O₃, Y₂O₃, ZrO₂, TiO₂, Nb₂O₅, Ta₂O₅, WO₃ and Bi₂O₃ is preferably 0.12 or more and more preferably 0.15 or more, 0.20 or more, 0.30 or more, 0.35 or more, 0.40 or more, 0.45 or more, 0.50 or more, and 0.55 or more in that order, and preferably 2.83 or less and more preferably 2.80 or less, 2.60 or less, 2.40 or less, 2.20 or less, 2.00 or less, 1.80 or less, 1.70 or less, 1.60 or less, 1.50 or less, 1.40 or less, 1.30 or less, 1.26 or less, 1.25 or less, and 1.24 or less in that order.

TiO₂, Nb₂O₅, Ta₂O₅, WO₃, Bi₂O₃ and ZrO₂ have an effect of increasing the refractive index of the glass, but if the ZrO₂ content is large, the meltability of the glass tends to decrease. For the above reason, the mass ratio (ZrO₂/(TiO₂+Nb₂O₅+Ta₂O₅+WO₃+Bi₂O₃+ZrO₂)) of the ZrO₂ content relative to a total content of TiO₂, Nb₂O₅, Ta₂O₅, WO₃, Bi₂O₃ and ZrO₂ is preferably 0.00 or more and more preferably 0.01 or more, and 0.02 or more in that order, and is preferably 0.17 or less and more preferably 0.16 or less, 0.15 or less, 0.14 or less, and 0.13 or less in that order.

TiO₂, Nb₂O₅, WO₃ and ZnO tend to increase the refractive index and tend to make dispersibility of the glass higher, but if the content thereof is large, the thermal stability of the glass tends to decrease. On the other hand, MgO, CaO, SrO and BaO tend to make dispersibility of the glass lower and have an effect of improving the thermal stability, but if the content thereof is large, the refractive index tends to decrease. For the above reason, the mass ratio ((MgO+CaO+SrO+BaO)/(TiO₂+Nb₂O₅+WO₃+ZnO)) of a total content of MgO, CaO, SrO and BaO relative to a total content of TiO₂, Nb₂O₅, WO₃ and ZnO is preferably 0.10 or more and more preferably 0.15 or more, 0.20 or more, 0.25 or more, 0.26 or more, 0.27 or more, 0.28 or more, 0.29 or more, 0.30 or more, 0.31 or more, and 0.32 or more in that order, and is preferably 1.50 or less and more preferably 1.30 or less, 1.20 or less, 1.10 or less, 1.00 or less, 0.95 or less, 0.90 or less, and 0.87 or less in that order.

The TiO₂ content is preferably 0.00% or more, and more preferably more than 0.00%, 0.50% or more, 1.00% or more, 1.50% or more, 2.00% or more, 2.50% or more, 3.00% or more, 3.50% or more, and 4.00% or more in that order, and is preferably 50.00% or less, and more preferably 45.0% or less, 40.00% or less, 38.00% or less, 36.00% or less, 36.00% or less, 34.00% or less, 32.00% or less, 31.00% or less, 30.00% or less, 29.50% or less, and 29.00% or less in that order. The TiO₂ content is preferably set to be within the above range in order to achieve a more desirable optical constant and reduce the raw material cost of the glass.

The Nb₂O₅ content is preferably 0.00% or more, and more preferably more than 0.00%, 1.00% or more, 2.00% or more, 3.00% or more, 4.00% or more, 5.00% or more, 6.00% or more, 7.00% or more, 8.00% or more, 9.00% or more, 10.00% or more, and 10.50% or more in that order. In addition, the Nb₂O₅ content is preferably 60.00% or less, and more preferably 58.00% or less, 56.00% or less, 54.00% or less, 52.00% or less, 50.00% or less, 49.00% or less, 48.00% or less, 47.00% or less, 46.00% or less, 45.00% or less, and 44.00% or less in that order. The Nb₂O₅ content is preferably set to be within the above range in order to achieve a more desirable optical constant, further reduce the specific gravity and improve partial dispersion characteristics.

The Ta₂O₅ content can be 0.00% or more. In addition, the Ta₂O₅ content is preferably 5.00% or less, and more preferably 4.00% or less, 3.00% or less, 2.00% or less, 1.00% or less, and 0.50% or less in that order. The Ta₂O₅ content is preferably set to be within the above range in order to improve the thermal stability of the glass, improve the meltability, and further reduce the specific gravity.

The WO₃ content can be 0.00% or more. In addition, the WO₃ content is preferably 5.00% or less, and more preferably 4.00% or less, 3.00% or less, 2.00% or less, 1.00% or less, and 0.50% or less in that order. The WO₃ content is preferably set to be within the above range in order to improve the transmittance of the glass, improve partial dispersion characteristics, and further reduce the specific gravity.

The Bi₂O₃ content can be 0.00% or more. In addition, the Bi₂O₃ content is preferably 5.00% or less, and more preferably 4.00% or less, 3.00% or less, 2.00% or less, 1.00% or less, and 0.50% or less in that order. The Bi₂O₃ content is preferably set to be within the above range in order to improve the thermal stability of the glass, improve partial dispersion characteristics, and further reduce the specific gravity.

GeO₂ has an effect of increasing the refractive index, but is a very expensive component. In order to reduce glass production cost, the GeO₂ content can be 0.00% or more and is preferably 2.00% or less and more preferably 1.50% or less, 1.00% or less, and 0.50% or less in that order.

Glass 1 and Glasses 2 and 3 to be described below in detail may further contain one or more of P₂O₅, Al₂O₃ and the like in addition to the above components.

The P₂O₅ content can be 0.00% or more and is preferably 10.00% or less and more preferably 8.00% or less, 6.00% or less, 4.00% or less, 2.00% or less, 1.00% or less, and 0.50% or less in that order. The P₂O₅ content is preferably set to be within the above range in order to improve thermal stability of the glass and improve partial dispersion characteristics.

The Al₂O₃ content can be 0.00% or more and is preferably 10.00% or less and more preferably 8.00% or less, 6.00% or less, 4.00% or less, 2.00% or less, 1.00% or less, and 0.50% or less in that order. The Al₂O₃ content is preferably set to be within the above range in order to improve the devitrification resistance and thermal stability of the glass.

Pb, As, Cd, Tl, Be, and Se each are toxic. Therefore, it is preferable not to contain these elements, that is, not to introduce these elements as glass components into glass.

U, Th, and Ra are all radioactive elements. Therefore, it is preferable not to contain these elements, that is, not to introduce these elements as glass components into glass.

V, Cr, Mn, Fe, Co, Ni, Cu, Pr, Nd, Pm, Sm, Eu, Tb, Dy, Ho, Er, Tm, and Ce increase coloring of the glass and become a fluorescence generation source, and are not preferable as elements contained in the glass for an optical element. Therefore, it is preferable not to contain these elements, that is, not to introduce these elements as glass components into glass.

Sb and Sn are elements that function as a clarifying agent and can be added optionally.

The amount of Sb added is preferably in a range of 0 to 0.11 mass %, more preferably in a range of 0.01 to 0.08 mass %, and still more preferably in a range of 0.02 to 0.05 mass % in terms of Sb₂O₃ when a total content of glass components other than Sb₂O₃ is set as 100 mass %.

The amount of Sn added is preferably in a range of 0 to 0.50 mass %, more preferably in a range of 0 to 0.20 mass %, and still more preferably in a range of 0 mass % in terms of SnO₂ when a total content of glass components other than SnO₂ is set as 100 mass %.

<Glass Composition of Glass 2>

Hereinafter, the glass composition of Glass 2 will be described in more detail.

SiO₂, as a network formation component of the glass, has an effect of improving the thermal stability, chemical durability and weather resistance of the glass, increasing the viscosity of molten glass, and facilitating molding of molten glass. For the above reason, the SiO₂ content of Glass 2 is 10.00% or more, preferably 11.00% or more, and more preferably 12.00% or more, 13.00% or more, 14.00% or more, 14.50% or more, 15.00% or more, 15.50% or more, 16.00% or more, 16.50% or more, and 16.60% or more in that order. In order to improve devitrification resistance of the glass, improve the meltability and improve partial dispersion characteristics, the SiO₂ content is preferably 50.00% or less, and more preferably 45.00% or less, 40.00% or less, 35.00% or less, 30.00% or less, 28.00% or less, 26.00% or less, 25.00% or less, 24.50% or less, 24.00% or less, 23.50% or less, 23.00% or less, 22.75% or less, 22.50% or less, and 22.00% or less in that order.

In order to improve the thermal stability of the glass, further reduce the specific gravity, and obtain a more desirable optical constant, the total content (SiO₂+B₂O₃) of SiO₂ and B₂O₃ is preferably 10.00% or more and more preferably 12.00% or more, 14.00% or more, 15.00% or more, 16.00% or more, 17.00% or more, 17.75% or more, 18.00% or more, 18.25% or more, 18.50% or more, and 18.60% or more in that order, and preferably 35.00% or less and more preferably 32.00% or less, 30.00% or less, 28.00% or less, 27.00% or less, 26.50% or less, 26.00% or less, 25.50% or less, 25.00% or less, 24.50% or less, 24.40% or less, and 24.30% or less in that order.

SiO₂ and B₂O₃ have an effect of improving the thermal stability of the glass, but the meltability of the glass tends to decrease when the content of SiO₂ increases. For the above reason, the mass ratio (SiO₂/(SiO₂+B₂O₃)) of the SiO₂ content relative to a total content of SiO₂ and B₂O₃ is preferably 0.50 or more and more preferably 0.55 or more, 0.60 or more, 0.65 or more, 0.70 or more, 0.75 or more, 0.77 or more, and 0.80 or more in that order, and preferably 1.00 or less and more preferably 0.99 or less, 0.98 or less, 0.97 or less, 0.96 or less, 0.95 or less, 0.94 or less, 0.93 or less, 0.92 or less, 0.91 or less, 0.90 or less, 0.89 or less, and 0.88 or less in that order.

In order to improve chemical durability, the mass ratio (B₂O₃/SiO₂) of the B₂O₃ content relative to the SiO₂ content is preferably 1.00 or less and more preferably 0.90 or less, 0.80 or less, 0.70 or less, 0.60 or less, 0.50 or less, 0.40 or less, 0.35 or less, 0.32 or less, 0.31 or less, 0.30 or less, 0.29 or less, 0.28 or less, 0.27 or less, 0.26 or less, and 0.25 or less in that order. In order to improve the thermal stability, the mass ratio (B₂O₃/SiO₂) is preferably 0.00 or more and more preferably 0.01 or more, 0.02 or more, 0.03 or more, 0.04 or more, 0.05 or more, 0.06 or more, 0.07 or more, 0.08 or more, 0.09 or more, 0.10 or more, 0.11 or more, 0.12 or more, 0.13 or more, 0.14 or more, and 0.15 or more in that order.

The B₂O₃ content is preferably 0.00% or more, more preferably more than 0.00%, and more preferably 0.10% or more, 0.20% or more, 0.30% or more, 0.35% or more, 0.37% or more, 0.39% or more, 0.40% or more, 0.41% or more, 0.42% or more, 0.43% or more, 0.44% or more, 0.45% or more, 0.46% or more, 0.47% or more, 0.48% or more, and 0.49% or more in that order. In addition, the B₂O₃ content is preferably 30.00% or less and more preferably 25.00% or less, 20.00% or less, 18.00% or less, 16.00% or less, 14.00% or less, 12.00% or less, 10.00% or less, 9.00% or less, 8.00% or less, 7.00% or less, 6.00% or less, 5.50% or less, 5.20% or less, 5.10% or less, 5.00% or less, 4.90% or less, and 4.80% or less in that order. When the B₂O₃ content is set to be within the above range, it is possible to further reduce the specific gravity of the glass and improve the thermal stability of the glass.

In order to improve the meltability and thermal stability of the glass, the CaO content is 5.00% or more, preferably 5.10% or more, and more preferably 5.20% or more, 5.30% or more, 5.40% or more, 5.50% or more, 5.60% or more, 5.70% or more, 5.80% or more, and 5.90% or more in that order. In addition, for the same reason, the CaO content is preferably 40.00% or less and more preferably 35.00% or less, 30.00% or less, 28.00% or less, 26.00% or less, 24.00% or less, 22.00% or less, 21.50% or less, 21.00% or less, 20.50% or less, 20.25% or less, 20.00% or less, and 19.50% or less in that order.

A total content (MgO+CaO+SrO+BaO+ZnO) of the alkaline earth metal oxides MgO, CaO, SrO, and BaO and ZnO is preferably 5.00% or more, and more preferably 7.00% or more, 10.00% or more, 11.00% or more, 12.00% or more, 13.00% or more, 13.50% or more, 14.00% or more, 14.50% or more, 15.00% or more, 15.30% or more, 15.50% or more, and 16.00% or more in that order. In addition, a total content (MgO+CaO+SrO+BaO+ZnO) is preferably 50.00% or less and more preferably 45.00% or less, 40.00% or less, 39.00% or less, 38.00% or less, 37.00% or less, 36.50% or less, 36.00% or less, 35.50% or less, 35.00% or less, 34.50% or less, and 34.00% or less in that order. The total content (MgO+CaO+SrO+BaO+ZnO) is preferably set to be within the above range in order to further reduce the specific gravity and maintain the thermal stability without interfering with an increase in dispersion.

Among MgO, CaO, SrO, BaO and ZnO, MgO and CaO are more effective components for reducing the specific gravity of the glass as compared with SrO, BaO, and ZnO. Therefore, in order to further reduce an increase in specific gravity, a mass ratio ((ZnO+SrO+BaO)/(MgO+CaO)) of a total content of ZnO, SrO and BaO relative to a total content of MgO and CaO is preferably 2.78 or less and more preferably 2.77 or less, 2.76 or less, 2.75 or less, 2.74 or less, and 2.73 or less in that order.

On the other hand, SrO, BaO, and ZnO have a stronger effect of improving partial dispersion characteristics than MgO and CaO. Therefore, in order to improve partial dispersion characteristics, the mass ratio ((ZnO+SrO+BaO)/(MgO+CaO)) is preferably 0.17 or more and more preferably 0.18 or more, 0.19 or more, and 0.20 or more in that order.

In order to further increase the refractive index and further reduce the specific gravity, a mass ratio (CaO/(MgO+CaO+SrO+BaO+ZnO)) of the CaO content relative to a total content of MgO, CaO, SrO, BaO and ZnO is preferably 0.00 or more and more preferably 0.10 or more, 0.15 or more, 0.16 or more, 0.17 or more, 0.18 or more, 0.19 or more, 0.20 or more, 0.21 or more, 0.22 or more, 0.23 or more, 0.24 or more, 0.25 or more, 0.26 or more, and 0.27 or more in that order. In order to improve the thermal stability, the mass ratio (CaO/(MgO+CaO+SrO+BaO+ZnO)) is preferably 1.00 or less, and more preferably 0.95 or less, 0.90 or less, 0.89 or less, 0.88 or less, 0.87 or less, 0.86 or less, 0.85 or less, 0.84 or less, and 0.83 or less in that order.

In order to further reduce the specific gravity, a mass ratio ((CaO+MgO)/(MgO+CaO+SrO+BaO+ZnO)) of a total content of CaO and MgO relative to a total content of MgO, CaO, SrO, BaO and ZnO is preferably 0.00 or more and more preferably 0.10 or more, 0.15 or more, 0.16 or more, 0.17 or more, 0.18 or more, 0.19 or more, 0.20 or more, 0.21 or more, 0.22 or more, 0.23 or more, 0.24 or more, 0.25 or more, 0.26 or more, and 0.27 or more in that order. In order to improve the thermal stability, the mass ratio ((CaO+MgO)/(MgO+CaO+SrO+BaO+ZnO)) is preferably 1.00 or less and more preferably 0.95 or less, 0.90 or less, 0.89 or less, 0.88 or less, 0.87 or less, 0.86 or less, 0.85 or less, 0.84 or less, and 0.83 or less in that order.

The alkaline earth metal oxides MgO, CaO, SrO, and BaO and ZnO have an effect of lowering a liquidus temperature and improving the thermal stability. On the other hand, when the content thereof is large, chemical durability and/or weather resistance tends to decrease. On the other hand, SiO₂ and B₂O₃ have an effect of improving the thermal stability, but if the content thereof is large, the meltability tends to decrease. For the above reason, a mass ratio (SiO₂+B₂O₃)/(MgO+CaO+SrO+BaO+ZnO) of a total content of SiO₂ and B₂O₃ relative to a total content of MgO, CaO, SrO, BaO and ZnO is preferably 0.40 or more and more preferably 0.45 or more, 0.50 or more, 0.52 or more, 0.54 or more, 0.56 or more, 0.57 or more, 0.58 or more, 0.59 or more, 0.60 or more, and 0.61 or more in that order, and is preferably 2.00 or less and more preferably 1.80 or less, 1.60 or less, 1.55 or less, 1.50 or less, 1.45 or less, 1.40 or less, and 1.35 or less in that order.

The MgO content is preferably 0.00% or more. In addition, the MgO content is preferably 15.00% or less and more preferably 12.00% or less, 9.00% or less, 7.00% or less, 6.00% or less, 5.00% or less, 4.00% or less, 3.50% or less, 3.00% or less, 2.50% or less, and 2.10% or less in that order.

The SrO content is preferably 0.00% or more and more preferably 0.10% or more, 0.20% or more, 0.25% or more, 0.26% or more, 0.27% or more, 0.28% or more, 0.29% or more, 0.30%% or more, and 0.31% or more in that order. In addition, the SrO content is preferably 15.00% or less and more preferably 12.00% or less, 10.00% or less, 9.00% or less, 8.50% or less, 8.00% or less, 7.50% or less, 7.00% or less, 6.50% or less, and 6.00% or less in that order.

The BaO content is preferably 0.00% or more and more preferably 0.10% or more, 0.20% or more, 0.30% or more, 0.40% or more, 0.50% or more, 0.60% or more, 0.70% or more, 0.80% or more, 0.90% or more, 1.00% or more, 1.10% or more, 1.20% or more, and 1.30% or more in that order. In addition, the BaO content is preferably 25.00% or less and more preferably 22.00% or less, 20.00% or less, 19.00% or less, 18.00% or less, 17.00% or less, 16.50% or less, 16.00% or less, 15.50% or less, 15.25% or less, and 15.00% or less in that order.

MgO, CaO, SrO and BaO are all glass components having an effect of improving the thermal stability and devitrification resistance of the glass. In order to increase the dispersibility and further reduce the specific gravity, and in order to improve the thermal stability and devitrification resistance of the glass, the content of each of these glass components is preferably in the above range.

The ZnO content is preferably 0.00% or more. In addition, the ZnO content is preferably 10.00% or less and more preferably 9.00% or less, 8.00% or less, 7.00% or less, 6.00% or less, 5.00% or less, 4.00% or less, 3.00% or less, and 2.00% or less in that order. ZnO is a glass component having an effect of improving the thermal stability of the glass. In order to further reduce the specific gravity, to improve the thermal stability of the glass, and obtain a more desirable optical constant, the ZnO content is preferably in the above range.

In Glass 2, in order to increase the refractive index and reduce the dispersibility, a total content (La₂O₃+Gd₂O₃+Y₂O₃) of rare earth oxides La₂O₃, Gd₂O₃ and Y₂O₃ is 2.96% or more, preferably 2.97% or more, and more preferably 2.98% or more, 2.99% or more, and 3.00% or more in that order. In order to further reduce the specific gravity, a total content (La₂O₃+Gd₂O₃+Y₂O₃) of La₂O₃, Gd₂O₃ and Y₂O₃ is preferably 30.00% or less and more preferably 29.00% or less, 28.00% or less, 26.00% or less, 24.00% or less, 22.00% or less, 20.00% or less, 18.00% or less, 16.00% or less, 15.00% or less, 14.50% or less, 14.00% or less, 13.50% or less, 13.00% or less, 12.50% or less, and 12.00% or less in that order.

BaO and rare earth oxides La₂O₃, Gd₂O₃ and Y₂O₃ are all components that contribute to low dispersibility (that is, increase the Abbe number vd), but when the content thereof is large, the specific gravity of the glass tends to increase. For the above reason, in Glass 2, a total content (BaO+La₂O₃+Gd₂O₃+Y₂O₃) of BaO and rare earth oxides La₂O₃, Gd₂O₃ and Y₂O₃ is 30.00% or less, preferably 29.00% or less, and more preferably 28.00% or less, 27.00% or less, 26.00% or less, 25.00% or less, 24.50% or less, 24.00% or less, 23.50% or less, and 23.00% or less in that order. In addition, in order to further increase the Abbe number vd, a total content (BaO+La₂O₃+Gd₂O₃+Y₂O₃) of BaO, La₂O₃, Gd₂O₃ and Y₂O₃ is preferably 2.96% or more and more preferably 3.00% or more, 4.00% or more, 5.00% or more, 6.00% or more, 7.00% or more, 7.50% or more, 8.00% or more, and 8.50% or more in that order.

Both BaO and La₂O₃ are low-dispersion components, but BaO has a weaker effect of increasing the refractive index than La₂O₃. Therefore, in order to increase the refractive index, a mass ratio (BaO/La₂O₃) of the BaO content relative to the La₂O₃ content is preferably 8.30 or less and more preferably 8.00 or less, 7.50 or less, 7.00 or less, 6.50 or less, 6.00 or less, 5.50 or less, 5.40 or less, 5.30 or less, 5.20 or less, 5.10 or less, 5.00 or less, 4.90 or less, 4.80 or less, and 4.70 or less in that order.

The mass ratio (BaO/La₂O₃) may be 0 and may be 0.00 or more. In order to maintain the thermal stability of the glass, the mass ratio (BaO/La₂O₃) is preferably more than 0.00 and more preferably 0.01 or more, 0.02 or more, 0.03 or more, 0.04 or more, 0.05 or more, 0.06 or more, 0.07 or more, 0.08 or more, 0.09 or more, 0.10 or more, and 0.11 or more in that order.

Rare earth oxides La₂O₃, Gd₂O₃ and Y₂O₃ can contribute to increasing the refractive index and reducing dispersibility, but if the content thereof is large, the thermal stability tends to decrease. In addition, SiO₂ and B₂O₃ have an effect of improving the thermal stability, but if the content thereof is large, the meltability tends to decrease and the refractive index tends to decrease. For the above reason, a mass ratio ((SiO₂+B₂O₃)/(La₂O₃+Gd₂O₃+Y₂O₃)) of a total content of SiO₂ and B₂O₃ relative to a total content of La₂O₃, Gd₂O₃ and Y₂O₃ is preferably more than 0.00 and more preferably 0.25 or more, 0.50 or more, 0.75 or more, 1.00 or more, 1.25 or more, 1.50 or more, 1.75 or more, 1.80 or more, and 1.85 or more in that order and preferably 7.47 or less and more preferably 7.40 or less, 7.35 or less, 7.30 or less, and 7.25 or less in that order.

La₂O₃, Gd₂O₃ and Y₂O₃ are all components that can increase the refractive index of the glass, but Gd₂O₃ and Y₂O₃ are components that increase the specific gravity as compared with La₂O₃. Therefore, in order to further reduce the specific gravity, a mass ratio (La₂O₃/(La₂O₃+Gd₂O₃+Y₂O₃)) of the La₂O₃ content relative to a total content of La₂O₃, Gd₂O₃ and Y₂O₃ is preferably more than 0.00 and more preferably 0.10 or more, 0.20 or more, 0.30 or more, 0.40 or more, 0.50 or more, 0.60 or more, 0.70 or more, and 0.75 or more in that order. The mass ratio (La₂O₃/(La₂O₃+Gd₂O₃+Y₂O₃)) can be 1.00 or less.

For the same reason, a mass ratio (Gd₂O₃/(La₂O₃+Gd₂O₃+Y₂O₃)) of the Gd₂O₃ content relative to a total content of La₂O₃, Gd₂O₃ and Y₂O₃ is preferably less than 1.00 and more preferably 0.90 or less, 0.80 or less, 0.70 or less, 0.60 or less, 0.50 or less, 0.40 or less, 0.30 or less, 0.25 or less, and 0.20 or less in that order. The mass ratio (Gd₂O₃/(La₂O₃+Gd₂O₃+Y₂O₃)) can be 0.00 or more.

In addition, for the same reason, a mass ratio (Y₂O₃/(La₂O₃+Gd₂O₃+Y₂O₃)) of the Y₂O₃ content relative to a total content of La₂O₃, Gd₂O₃ and Y₂O₃ is preferably less than 1.00 and more preferably 0.90 or less, 0.80 or less, 0.70 or less, 0.60 or less, 0.50 or less, 0.40 or less, 0.30 or less, and 0.25 or less in that order. The mass ratio (Y₂O₃/(La₂O₃+Gd₂O₃+Y₂O₃)) can be 0.00 or more.

For the above reason, the contents of the above components which are rare earth oxides are preferably in the following ranges.

The La₂O₃ content is preferably 0.00% or more and more preferably more than 0.00%, 0.50% or more, 1.00% or more, 1.33% or more, 1.50% or more, 2.00% or more, 2.50% or more, 2.75% or more, and 3.00% or more in that order. In addition, the La₂O₃ content is preferably 30.00% or less and more preferably 25.00% or less, 20.00% or less, 18.00% or less, 16.00% or less, 15.00% or less, 14.00% or less, 13.50% or less, 13.00% or less, 12.50% or less, and 12.00% or less in that order.

The Gd₂O₃ content is preferably 0.00% or more. In addition, the Gd₂O₃ content is preferably 10.00% or less and more preferably 9.00% or less, 8.00% or less, 7.00% or less, 6.00% or less, 5.00% or less, 4.00% or less, 3.00% or less, and 2.00% or less in that order.

The Y₂O₃ content is preferably 0.00% or more. In addition, the Y₂O₃ content is preferably 10.00% or less and more preferably 9.00% or less, 8.00% or less, 7.00% or less, 6.00% or less, 5.00% or less, 4.00% or less, 3.00% or less, and 2.00% or less in that order.

La₂O₃ has an effect of increasing the refractive index of the glass, and B₂O₃ tends to decrease the refractive index of the glass. Therefore, in order to further increase the refractive index, a mass ratio (La₂O₃/B₂O₃) of the La₂O₃ content relative to the B₂O₃ content is preferably 1.30 or more and more preferably 1.35 or more, 1.40 or more, 1.45 or more, 1.50 or more, 1.55 or more, 1.60 or more, 1.65 or more, 1.70 or more, and 1.72 or more in that order. In order to further reduce the specific gravity, the mass ratio (La₂O₃/B₂O₃) is preferably 20.00 or less and more preferably 18.00 or less, 16.00 or less, 14.00 or less, 13.00 or less, 12.00 or less, 11.50 or less, 11.00 or less, 10.50 or less, and 10.00 or less in that order.

A mass ratio (B₂O₃/La₂O₃) of the B₂O₃ content relative to the La₂O₃ content is preferably 0.79 or less and more preferably 0.78 or less, 0.77 or less, 0.76 or less, 0.75 or less, 0.70 or less, 0.65 or less, 0.64 or less, 0.62 or less, 0.61 or less, 0.60 or less, 0.59 or less, 0.58 or less, 0.57 or less, and 0.50 or less in that order. The mass ratio (La₂O₃/B₂O₃) is preferably 0.00 or more and more preferably more than 0.00.

Rare earth oxides can increase the refractive index of the glass, but if the content of rare earth oxides is large, the thermal stability tends to decrease and the meltability of the glass tends to decrease. Therefore, in order to maintain the thermal stability of the glass and further increase the refractive index, a mass ratio ((La₂O₃+Gd₂O₃+Y₂O₃)/(BaO+La₂O₃+Gd₂O₃+Y₂O₃)] of a total content of La₂O₃, Gd₂O₃ and Y₂O₃ relative to a total content of BaO, La₂O₃, Gd₂O₃ and Y₂O₃ is preferably 1.00 or less and more preferably less than 1.00, 0.99 or less, 0.98 or less, 0.97 or less, 0.96 or less, 0.95 or less, 0.94 or less, 0.93 or less, 0.92 or less, 0.91 or less, and 0.90 or less in that order. The mass ratio ((La₂O₃+Gd₂O₃+Y₂O₃)/(BaO+La₂O₃+Gd₂O₃+Y₂O₃)) is preferably more than 0.00 and more preferably 0.05 or more, 0.06 or more, 0.07 or more, 0.08 or more, 0.09 or more, 0.10 or more, 0.11 or more, 0.12 or more, 0.13 or more, 0.14 or more, 0.15 or more, 0.16 or more, 0.17 or more, 0.18 or more, and 0.20 or more in that order.

Rare earth oxides can increase the refractive index of the glass, but if the content thereof is large, the meltability of the glass tends to decrease. On the other hand, alkaline earth metal oxides can improve the meltability of the glass, but if the content thereof is large, the refractive index tends to decrease. Therefore, in order to maintain the meltability of the glass and further increase the refractive index, a mass ratio ((La₂O₃+Gd₂O₃+Y₂O₃)/(MgO+CaO+SrO+BaO+ZnO+La₂O₃+Gd₂O₃+Y₂O₃)) of a total content of La₂O₃, Gd₂O₃ and Y₂O₃ relative to a total content of MgO, CaO, SrO, BaO, ZnO, La₂O₃, Gd₂O₃ and Y₂O₃ is preferably more than 0.00 and more preferably 0.01 or more, 0.02 or more, 0.03 or more, 0.04 or more, 0.05 or more, 0.06 or more, 0.07 or more, and 0.08 or more in that order, and preferably 0.85 or less and more preferably 0.80 or less, 0.75 or less, 0.70 or less, 0.65 or less, 0.60 or less, 0.55 or less, 0.50 or less, 0.45 or less, 0.44 or less, 0.43 or less, 0.42 or less, 0.41 or less, and 0.40 or less in that order.

Rare earth oxides can increase the refractive index of the glass, but if the content thereof is large, the thermal stability of the glass tends to decrease. On the other hand, B₂O₃ can improve the thermal stability of the glass, but if the content thereof is large, the refractive index tends to decrease. Therefore, in order to maintain the thermal stability of the glass and further increase the refractive index, a mass ratio (B₂O₃/(BaO+La₂O₃+Gd₂O₃+Y₂O₃)) of the B₂O₃ content relative to a total content of BaO, La₂O₃, Gd₂O₃ and Y₂O₃ is preferably 0.00 or more and more preferably more than 0.00, 0.01 or more, 0.02 or more, and 0.03 or more in that order, and preferably 1.00 or less and more preferably 0.90 or less, 0.80 or less, 0.70 or less, 0.60 or less, 0.55 or less, 0.50 or less, 0.45 or less, 0.40 or less, and 0.35 or less in that order.

La₂O₃, Gd₂O₃ and Y₂O₃ have an effect of increasing the refractive index of the glass, but if a total content thereof is large, the thermal stability tends to decrease. On the other hand, B₂O₃ has an effect of improving the thermal stability of the glass, but it tends to reduce the refractive index. Therefore, in order to increase the refractive index while maintaining the thermal stability of the glass, a mass ratio ((La₂O₃+Gd₂O₃+Y₂O₃)/(B₂O₃+La₂O₃+Gd₂O₃+Y₂O₃)) of a total content of La₂O₃, Gd₂O₃ and Y₂O₃ relative to a total content of B₂O₃, La₂O₃, Gd₂O₃ and Y₂O₃ is preferably 0.57 or more and more preferably 0.58 or more, 0.59 or more, 0.60 or more, 0.61 or more, 0.62 or more, 0.63 or more, and 0.64 or more in that order. In order to further reduce the specific gravity, the mass ratio (La₂O₃+Gd₂O₃+Y₂O₃/(B₂O₃+La₂O₃+Gd₂O₃+Y₂O₃)) is preferably 1.00 or less and more preferably less than 1.00, 0.99 or less, 0.98 or less, 0.97 or less, 0.96 or less, 0.95 or less, 0.94 or less, 0.93 or less, 0.92 or less, 0.91 or less, 0.90 or less, 0.89 or less, 0.88 or less, 0.87 or less, 0.86 or less, and 0.85 or less in that order.

La₂O₃, Gd₂O₃, Y₂O₃ and ZrO₂ have an effect of increasing the refractive index and improving partial dispersion characteristics, but if the content of ZrO₂ is large, the meltability of the glass tends to decrease. For the above reason, a mass ratio (ZrO₂/(La₂O₃+Gd₂O₃+Y₂O₃+ZrO₂)) of the ZrO₂ content relative to a total content of La₂O₃, Gd₂O₃, Y₂O₃ and ZrO₂ is preferably 0.01 or more and more preferably 0.02 or more, 0.03 or more, and 0.04 or more in that order, and preferably 5.00 or less and more preferably 4.00 or less, 3.00 or less, and 2.00 or less in that order.

La₂O₃, Gd₂O₃, Y₂O₃ and ZrO₂ are all components that increase the refractive index, but ZrO₂ has a stronger effect of increasing the refractive index and a stronger effect of increasing dispersion (effect of reducing the Abbe number) than La₂O₃, Gd₂O₃, and Y₂O₃. In order to keep dispersion low, a mass ratio (ZrO₂/(La₂O₃+Gd₂O₃+Y₂O₃)) of the ZrO₂ content relative to a total content of La₂O₃, Gd₂O₃ and Y₂O₃ is preferably 2.00 or less and more preferably 1.90 or less, 1.80 or less, 1.70 or less, 1.60 or less, 1.50 or less, 1.40 or less, 1.30 or less, 1.25 or less, and 1.20 or less in that order. The mass ratio (ZrO₂/(La₂O₃+Gd₂O₃+Y₂O₃)) can be 0.00 or more, and in order to further increase the refractive index, it is preferably more than 0.00 and more preferably 0.01 or more, 0.02 or more, 0.03 or more, 0.04 or more, 0.05 or more, and 0.06 or more in that order.

The ZrO₂ content is preferably 0.00% or more and more preferably more than 0.00%, 0.10% or more, 0.20% or more, 0.30% or more, 0.40% or more, 0.50% or more, 0.60% or more, and 0.65% or more in that order. In addition, the ZrO₂ content is preferably 15.00% or less and more preferably 12.00% or less, 10.40% or less, 10.00% or less, 9.00% or less, 8.50% or less, 8.00% or less, 7.50% or less, 7.20% or less, 7.10% or less, 7.00% or less, 6.50% or less, 6.00% or less, and 5.90% or less in that order. The ZrO₂ content is preferably set to be within the above range in order to achieve a more desirable optical constant and improve partial dispersion characteristics.

MgO, CaO, SrO, BaO and ZnO have an effect of improving the thermal stability of the glass, but if the content thereof is large, the refractive index tends to decrease. On the other hand, La₂O₃, Gd₂O₃ and Y₂O₃ have an effect of increasing the refractive index, but if the content thereof is large, the thermal stability tends to decrease. For the above reason, a mass ratio ((MgO+CaO+SrO+BaO+ZnO)/(La₂O₃+Gd₂O₃+Y₂O₃)) of a total content of MgO, CaO, SrO, BaO and ZnO relative to a total content of La₂O₃, Gd₂O₃ and Y₂O₃ is preferably more than 0.00 and more preferably 0.10 or more, 0.20 or more, 0.30 or more, 0.40 or more, 0.50 or more, 0.60 or more, 0.70 or more, 0.80 or more, 0.90 or more, 1.00 or more, 1.10 or more, 1.20 or more, 1.30 or more, and 1.40 or more in that order, and preferably 20.00 or less and more preferably 18.00 or less, 16.00 or less, 14.00 or less, 11.09 or less, 11.08 or less, 11.07 or less, 11.06 or less, 11.05 or less, 11.04 or less, 11.03 or less, 11.02 or less, 11.01 or less, and 11.00 or less in that order.

SrO, BaO, La₂O₃, Gd₂O₃ and Y₂O₃ are all effective components for maintaining low dispersibility. Therefore, in order to maintain lower dispersibility, a total content (SrO+BaO+La₂O₃+Gd₂O₃+Y₂O₃) of SrO, BaO, La₂O₃, Gd₂O₃ and Y₂O₃ is preferably 9.00% or more and more preferably 9.50% or more, 10.00% or more, 10.50% or more, 11.00% or more, 11.50% or more, 12.00% or more, 12.50% or more, 13.00% or more, and 13.50% or more in that order.

In addition, in order to further reduce the specific gravity, the total content (SrO+BaO+La₂O₃+Gd₂O₃+Y₂O₃) is preferably 45.00% or less and more preferably 40.00% or less, 35.00% or less, 30.00% or less, 29.00% or less, 28.00% or less, 27.00% or less, 26.00% or less, and 25.00% or less in that order.

La₂O₃, Gd₂O₃ and Y₂O₃ are components having an effect of increasing the refractive index, and SiO₂ is a component that maintains the thermal stability of the glass. In order to further increase the refractive index, a mass ratio ((La₂O₃+Gd₂O₃+Y₂O₃)/(La₂O₃+Gd₂O₃+Y₂O₃+SiO₂)) of a total content of La₂O₃, Gd₂O₃ and Y₂O₃ relative to a total content of La₂O₃, Gd₂O₃, Y₂O₃ and SiO₂ is preferably 0.12 or more and more preferably 0.13 or more. In order to maintain the thermal stability of the glass, the mass ratio ((La₂O₃+Gd₂O₃+Y₂O₃)/(La₂O₃+Gd₂O₃+Y₂O₃+SiO₂)) is preferably 0.70 or less and more preferably 0.60 or less, 0.50 or less, 0.49 or less, 0.48 or less, 0.47 or less, 0.46 or less, 0.45 or less, 0.44 or less, 0.43 or less, 0.42 or less, and 041 or less in that order.

Regarding a mass ratio ((SiO₂+CaO)/(TiO₂+Nb₂O₅+Ta₂O₅+WO₃+Bi₂O₃)) of a total content of SiO₂ and CaO relative to a total content of TiO₂, Nb₂O₅, Ta₂O₅, WO₃ and Bi₂O₃, the denominator is a total content of components that have a strong effect of increasing the refractive index, and the numerator is a total content of components effective for reducing dispersion and decreasing specific gravity. In order to maintain low dispersibility, reduce the specific gravity and maintain the thermal stability, the mass ratio ((SiO₂+CaO)/(TiO₂+Nb₂O₅+Ta₂O₅+WO₃+Bi₂O₃)) is less than 1.09, preferably 1.08 or less, and more preferably 1.07 or less, 1.06 or less, 1.05 or less, 1.04 or less, 1.03 or less, 1.02 or less, and 1.01 or less in that order. In addition, for the above reason, the mass ratio ((SiO₂+CaO)/(TiO₂+Nb₂O₅+Ta₂O₅+WO₃+Bi₂O₃)) is preferably 0.25 or more and more preferably 0.30 or more, 0.35 or more, 0.40 or more, 0.42 or more, 0.44 or more, 0.46 or more, 0.48 or more, 0.50 or more, 0.52 or more, 0.54 or more, and 0.55 or more in that order.

Among ZrO₂, TiO₂, Nb₂O₅, Ta₂O₅, WO₃, and Bi₂O₃ which are components that increase the refractive index, ZrO₂ has a relatively weak effect of increasing dispersion. Therefore, in order to maintain lower dispersibility, a mass ratio (ZrO₂/(TiO₂+Nb₂O₅+Ta₂O₅+WO₃+Bi₂O₃)) of the ZrO₂ content relative to a total content of TiO₂, Nb₂O₅, Ta₂O₅, WO₃ and Bi₂O₃ is preferably 0.00 or more and more preferably 0.01 or more and 0.02 or more in that order. In order to maintain the thermal stability of the glass and maintain devitrification resistance (stability during reheat press molding: also called reheat press moldability) when glass is heated and softened and press-molded, the mass ratio (ZrO₂/(TiO₂+Nb₂O₅+Ta₂O₅+WO₃+Bi₂O₃)) is preferably 0.21 or less and more preferably 0.20 or less, 0.19 or less, 0.18 or less, 0.17 or less, 0.16 or less, and 0.15 or less in that order.

The alkali metal oxides Li₂O, Na₂O, K₂O and Cs₂O have an effect of improving partial dispersion characteristics and also have an effect of lowering a liquidus temperature and improving the thermal stability of the glass. For these reasons, a total content (Li₂O+Na₂O+K₂O+Cs₂O) of Li₂O, Na₂O, K₂O and Cs₂O is preferably 0.00% or more and more preferably more than 0.00%, 0.05% or more, 0.10% or more, 0.15% or more, 0.20% or more, 0.25% or more, and 0.28% or more in that order. In order to improve chemical durability and weather resistance, the total content (Li₂O+Na₂O+K₂O+Cs₂O) is preferably 20.00% or less and more preferably 18.00% or less, 16.00% or less, 14.00% or less, 12.00% or less, 10.00% or less, 9.00% or less, 8.00% or less, 7.00% or less, 6.50% or less, 6.00% or less, 5.50% or less, 5.00% or less, and 4.50% or less in that order.

Alkali metal oxides and alkaline earth metal oxides can contribute to maintaining the meltability and thermal stability of the glass, but if the content thereof is large, the meltability and thermal stability of the glass tend to decrease. Therefore, in order to maintain the meltability and thermal stability of the glass, a total content (Li₂O+Na₂O+K₂O+Cs₂₀+MgO+CaO+SrO+BaO) of the alkali metal oxides Li₂O, Na₂O, K₂O and Cs₂O and the alkaline earth metal oxides MgO, CaO, SrO and BaO is preferably 5.00% or more and more preferably 7.00% or more, 9.00% or more, 10.00% or more, 12.00% or more, 14.00% or more, 15.00% or more, 16.00% or more, 17.00% or more, 18.00% or more, and 18.50% or more in that order, and preferably 50.00% or less and more preferably 48.00% or less, 46.00% or less, 44.00% or less, 43.00% or less, 42.00% or less, 41.00% or less, 40.00% or less, 39.00% or less, 38.00% or less, 37.00% or less, 36.00% or less, 35.00% or less, 34.50% or less, and 34.00% or less in that order.

Alkali metal oxides and alkaline earth metal oxides have effect of lowering a liquidus temperature and improving the thermal stability, but if the content thereof with respect to a network formation component of the glass is large, chemical durability and weather resistance tend to decrease. In addition, SiO₂ and B₂O₃ have an effect of improving the thermal stability, but if the content thereof is large, the meltability tends to decrease. For these reasons, a mass ratio ((Li₂O+Na₂O+K₂O+Cs₂O+MgO+CaO+SrO+BaO)/(SiO₂+B₂O₃)) of a total content of Li₂O, Na₂O, K₂O, Cs₂₀, MgO, CaO, SrO and BaO relative to a total content of SiO₂ and B₂O₃ is preferably 0.50 or more and more preferably 0.52 or more, 0.54 or more, 0.56 or more, 0.58 or more, 0.60 or more, 0.62 or more, 0.64 or more, 0.66 or more, 0.68 or more, 0.70 or more, 0.72 or more, 0.74 or more, 0.75 or more, 0.76 or more, 0.77 or more, 0.78 or more, and 0.79 or more in that order and preferably 5.00 or less and more preferably 4.50 or less, 4.00 or less, 3.50 or less, 3.00 or less, 2.50 or less, 2.00 or less, 1.90 or less, 1.80 or less, 1.70 or less, 1.65 or less, and 1.60 or less in that order.

Among Li₂O, Na₂O and K₂O, Li₂O is the component which is least likely to lower the refractive index. Therefore, in order to further increase the refractive index, a mass ratio (Li₂O/(Li₂O+Na₂O+K₂O)) of the Li₂O content relative to a total content of Li₂O, Na₂O and K₂O is preferably 0.00 or more and more preferably more than 0.00, 0.10 or more, 0.20 or more, 0.30 or more, 0.40 or more, and 0.45 or more in that order. The mass ratio (Li₂O/(Li₂O+Na₂O+K₂O)) can be, for example, 1.00 or less.

Li₂O, Na₂O, K₂O, MgO, CaO, SrO, BaO and ZnO are components that can increase the specific resistance of the glass and facilitate electric heating without increasing a melting temperature and a liquidus temperature of the glass. In addition, since Li₂O, Na₂O, K₂O, MgO, CaO, SrO, BaO and ZnO are components that can improve the thermal stability of the glass, the glass can be kept in a molten state at a lower temperature. That is, they have an effect of improving the meltability of the glass. On the other hand, if small amounts of Li₂O, Na₂O and K₂O are introduced, the melting temperature of the glass decreases and fusion of other high melting point components is promoted, but if a total content thereof is large, the specific resistance in a molten state of the glass decreases and the efficiency of electric heating tends to decrease. In addition, if a total content of Li₂O, Na₂O and K₂O is large, since the viscosity of the glass decreases and the thermal stability also deteriorates, the meltability of the glass tends to decrease. In addition, if a total content of Li₂O, Na₂O and K₂O is large, the glass tends to be more dispersed. Therefore, in order to obtain more desirable meltability and optical characteristics, a mass ratio ((Li₂O+Na₂O+K₂O)/(MgO+CaO+SrO+BaO+ZnO)) of a total content of Li₂O, Na₂O, and K₂O relative to a total content of MgO, CaO, SrO, BaO and ZnO is preferably 0.00 or more and more preferably more than 0.00, 0.01 or more, 0.02 or more, 0.03 or more, 0.04 or more, and 0.05 or more in that order, and preferably 4.00 or less and more preferably 3.50 or less, 3.00 or less, 2.50 or less, 2.00 or less, 1.50 or less, 1.00 or less, 0.90 or less, 0.80 or less, 0.70 or less, 0.60 or less, 0.50 or less, 0.40 or less, and 0.35 or less in that order.

In order to maintain the thermal stability and/or reheat press moldability, a mass ratio ((Li₂O+Na₂O+K₂O)/(SiO₂+B₂O₃)) of a total content of Li₂O, Na₂O and K₂O relative to a total content of SiO₂ and B₂O₃ is preferably 1.00 or less and more preferably 0.90 or less, 0.80 or less, 0.70 or less, 0.60 or less, 0.50 or less, 0.40 or less, 0.35 or less, 0.30 or less, and 0.25 or less in that order. In order to maintain the meltability and/or reduce a partial dispersion ratio to provide a glass suitable for high-order chromatic aberration correction, the mass ratio ((Li₂O+Na₂O+K₂O)/(SiO₂+B₂O₃)) is preferably 0.00 or more and more preferably more than 0.00, 0.01 or more, 0.02 or more, 0.03 or more, 0.04 or more, and 0.05 or more in that order.

The Li₂O content is preferably 0.00% or more and more preferably 0.05% or more, 0.10% or more, 0.15% or more, 0.20% or more, 0.25% or more, 0.30% or more, 0.40% or more, 0.50% or more, and 0.60% or more in that order. In addition, the Li₂O content is preferably 14.00% or less and more preferably 12.00% or less, 10.00% or less, 8.00% or less, 7.00% or less, 6.50% or less, 6.00% or less, 5.50% or less, and 5.00% or less in that order. It is preferable that the Li₂O content be set to be within the above range in order to achieve a more desirable optical constant and in order to maintain chemical durability, weather resistance, and stability during reheating.

The Na₂O content is preferably 0.00% or more. In addition, the Na₂O content is preferably 10.00% or less, and more preferably 8.00% or less, 7.00% or less, 6.00% or less, 5.00% or less, 4.00% or less, 3.00% or less, and 2.00% or less in that order. In order to improve partial dispersion characteristics, the Na₂O content is preferably set to be within the above range.

The K₂O content is preferably 0.00% or more. In addition, the K₂O content is preferably 10.00% or less and more preferably 8.00% or less, 7.00% or less, 6.00% or less, 5.00% or less, 4.00% or less, 3.00% or less, and 2.00% or less in that order. In order to improve the thermal stability of the glass, the K₂O content is preferably set to be within the above range.

The Cs₂O content is preferably 5.00% or less and more preferably 4.00% or less, 3.00% or less, 2.00% or less, 1.00% or less, and 0.50% or less in that order, and may be 0%.

In order to further increase the refractive index, a total content (TiO₂+Nb₂O₅+Ta₂O₅+WO₃+Bi₂O₃) of TiO₂, Nb₂O₅, Ta₂O₅, WO₃ and Bi₂O₃ is preferably 30.00% or more and more preferably 31.00% or more, 32.00% or more, 33.00% or more, 34.00% or more, 35.00% or more, 36.00% or more, 36.50% or more, 37.00% or more, and 37.55% or more in that order. In order to further reduce the specific gravity and in order to improve the thermal stability, the total content (TiO₂+Nb₂O₅+Ta₂O₅+WO₃+Bi₂O₃) of TiO₂, Nb₂O₅, Ta₂O₅, WO₃ and Bi₂O₃ is preferably 60.00% or less and more preferably 58.00% or less, 56.00% or less, 54.00% or less, 52.00% or less, 51.00% or less, 50.00% or less, 49.50% or less, 49.00% or less, and 48.50% or less in that order.

In order to obtain a glass having a high refractive index while an increase in specific gravity is reduced, a mass ratio ((SiO₂+B₂O₃)/(TiO₂+Nb₂O₅+Ta₂O₅+WO₃+Bi₂O₃)) of a total content of SiO₂ and B₂O₃ relative to a total content of TiO₂, Nb₂O₅, Ta₂O₅, WO₃ and Bi₂O₃ is 0.75 or less. In addition to the above, in order to achieve a desirable Abbe number vd and improve partial dispersion characteristics and improve the devitrification resistance, the mass ratio ((SiO₂+B₂O₃)/(TiO₂+Nb₂O₅+Ta₂O₅+WO₃+Bi₂O₃)) is preferably 0.16 or more and more preferably 0.20 or more, 0.25 or more, 0.30 or more, 0.35 or more, 0.36 or more, 0.37 or more, 0.38 or more, 0.39 or more, 0.40 or more, 0.41 or more, and 0.42 or more in that order, and preferably 0.75 or less and more preferably 0.74 or less, 0.73 or less, 0.72 or less, 0.71 or less, 0.70 or less, 0.69 or less, 0.68 or less, 0.67 or less, 0.66 or less, 0.65 or less, and 0.64 or less in that order.

SiO₂ and B₂O₃ have an effect of reducing the refractive index and reducing dispersion (increasing the Abbe number). On the other hand, TiO₂, Nb₂O₅, Ta₂O₅, WO₃, Bi₂O₃, and ZrO₂ are high-refractive-index and high-dispersion components. In order to further increase the refractive index, a mass ratio ((SiO₂+B₂O₃)/(TiO₂+Nb₂O₅+Ta₂O₅+WO₃+Bi₂O₃+ZrO₂)) of a total content of SiO₂ and B₂O₃ relative to a total content of TiO₂, Nb₂O₅, Ta₂O₅, WO₃, Bi₂O₃ and ZrO₂ is preferably 0.64 or less and more preferably 0.63 or less, 0.62 or less, 0.61 or less, 0.60 or less, 0.59 or less, and 0.58 or less in that order.

On the other hand, in order to reduce an increase in dispersion, the mass ratio ((SiO₂+B₂O₃)/(TiO₂+Nb₂O₅+Ta₂O₅+WO₃+Bi₂O₃+ZrO₂)) is preferably 0.13 or more and more preferably 0.15 or more, 0.20 or more, 0.25 or more, 0.26 or more, 0.27 or more, 0.28 or more, 0.29 or more, 0.30 or more, 0.31 or more, 0.32 or more, 0.33 or more, 0.34 or more, 0.35 or more, 0.36 or more, 0.37 or more, and 0.38 or more in that order.

In order to improve partial dispersion characteristics and the transmittance, the mass ratio ((Li₂O+Na₂O+K₂O)/(TiO₂+Nb₂O₅+Ta₂O₅+WO₃+Bi₂O₃)) of a total content of Li₂O, Na₂O and K₂O relative to a total content of TiO₂, Nb₂O₅, Ta₂O₅, WO₃ and Bi₂O₃ is preferably 0.00 or more and more preferably 0.01 or more. In order to maintain the thermal stability and/or reheat press moldability of the glass, the mass ratio ((Li₂O+Na₂O+K₂O)/(TiO₂+Nb₂O₅+Ta₂O₅+WO₃+Bi₂O₃)) is preferably 0.67 or less and more preferably 0.60 or less, 0.50 or less, 0.40 or less, 0.30 or less, 0.20 or less, 0.15 or less, and 0.10 or less in that order.

MgO, CaO, SrO, BaO and ZnO have an effect of improving the thermal stability of the glass, but if the content thereof is large, the refractive index tends to decrease and the glass tends to have lower dispersibility. On the other hand, TiO₂, Nb₂O₅, WO₃ and Bi₂O₃ tend to increase the refractive index and tend to make dispersibility of the glass higher, but if the content thereof is large, the thermal stability tends to decrease. For the above reason, the mass ratio ((MgO+CaO+SrO+BaO+ZnO)/(TiO₂+Nb₂O₅+Ta₂O₅+WO₃+Bi₂O₃)) of a total content of MgO, CaO, SrO, BaO and ZnO relative to a total content of TiO₂, Nb₂O₅, Ta₂O₅, WO₃ and Bi₂O₃ is preferably 0.09 or more and more preferably 0.10 or more, 0.15 or more, 0.20 or more, 0.21 or more, 0.22 or more, 0.23 or more, 0.24 or more, 0.25 or more, 0.26 or more, 0.27 or more, 0.28 or more, 0.29 or more, 0.30 or more, 0.31 or more, and 0.32 or more in that order, and preferably 1.66 or less and more preferably 1.60 or less, 1.50 or less, 1.40 or less, 1.30 or less, 1.20 or less, 1.10 or less, 1.00 or less, 0.95 or less, 0.90 or less, and 0.88 or less in that order.

In terms of contribution to dispersibility, comparing TiO₂, Nb₂O₅, Ta₂O₅, WO₃ and Bi₂O₃ to La₂O₃, Gd₂O₃ and Y₂O₃, TiO₂, Nb₂O₅, Ta₂O₅, WO₃ and Bi₂O₃ tend to make dispersibility of the glass lower, and La₂O₃, Gd₂O₃ and Y₂O₃ tend to make dispersibility of the glass higher. In order to obtain desirable dispersibility, a mass ratio ((La₂O₃+Gd₂O₃+Y₂O₃)/(TiO₂+Nb₂O₅+Ta₂O₅+WO₃+Bi₂O₃)) of a total content of La₂O₃, Gd₂O₃ and Y₂O₃ relative to a total content of TiO₂, Nb₂O₅, Ta₂O₅, WO₃ and Bi₂O₃ is preferably more than 0.00 and more preferably 0.01 or more, 0.02 or more, 0.03 or more, 0.04 or more, 0.05 or more, 0.06 or more, and 0.07 or more in that order, and preferably 1.00 or less and more preferably 0.90 or less, 0.80 or less, 0.70 or less, 0.60 or less, 0.50 or less, 0.45 or less, 0.40 or less, 0.35 or less, and 0.32 or less in that order.

In order to improve partial dispersion characteristics, the mass ratio (TiO₂/(TiO₂+Nb₂O₅+Ta₂O₅+WO₃+Bi₂O₃)) of the TiO₂ content relative to a total content of TiO₂, Nb₂O₅, Ta₂O₅, WO₃ and Bi₂O₃ is preferably 0.00 or more and more preferably more than 0.00, 0.01 or more, 0.02 or more, 0.03 or more, 0.04 or more, 0.05 or more, 0.06 or more, 0.07 or more, 0.08 or more, and 0.09 or more in that order, and preferably 1.00 or less and more preferably less than 1.00, 0.95 or less, 0.90 or less, 0.85 or less, 0.80 or less, 0.75 or less, and 0.73 or less in that order.

In order to improve partial dispersion characteristics, the mass ratio (Nb₂O₅/(TiO₂+Nb₂O₅+Ta₂O₅+WO₃+Bi₂O₃)) of the Nb₂O₅ content relative to a total content of TiO₂, Nb₂O₅, Ta₂O₅, WO₃ and Bi₂O₃ is preferably 0.00 or more and more preferably more than 0.00, 0.01 or more, 0.05 or more, 0.10 or more, 0.15 or more, 0.20 or more, 0.21 or more, 0.22 or more, 0.23 or more, 0.24 or more, 0.25 or more, 0.26 or more, and 0.27 or more in that order, and preferably 1.00 or less and more preferably less than 1.00, 0.99 or less, 0.98 or less, 0.97 or less, 0.96 or less, 0.95 or less, 0.94 or less, 0.93 or less, 0.92 or less, and 0.91 or less in that order.

In order to reduce the raw material cost of the glass and further reduce the specific gravity, the mass ratio (Ta₂O₅/(TiO₂+Nb₂O₅+Ta₂O₅+WO₃+Bi₂O₃)) of the Ta₂O₅ content relative to a total content of TiO₂, Nb₂O₅, Ta₂O₅, WO₃ and Bi₂O₃ is preferably 1.00 or less, more preferably 0.80 or less, 0.60 or less, 0.40 or less, 0.30 or less, 0.20 or less, and 0.10 or less in that order, and particularly preferably 0.

Among high-refractive-index and high-dispersion components TiO₂, Nb₂O₅, Ta₂O₅, WO₃ and Bi₂O₃, WO₃ and Bi₂O₃ have a strong effect of increasing the specific gravity. Therefore, in order to further reduce the specific gravity, the mass ratio (WO₃/(TiO₂+Nb₂O₅+Ta₂O₅+WO₃+Bi₂O₃)) of the WO₃ content relative to a total content of TiO₂, Nb₂O₅, Ta₂O₅, WO₃ and Bi₂O₃ is preferably 1.00 or less, more preferably 0.80 or less, 0.60 or less, 0.40 or less, 0.30 or less, 0.20 or less, and 0.10 or less in that order, and particularly preferably 0.

For the same reason, the mass ratio (Bi₂O₃/(TiO₂+Nb₂O₅+Ta₂O₅+WO₃+Bi₂O₃)) of the Bi₂O₃ content relative to a total content of TiO₂, Nb₂O₅, Ta₂O₅, WO₃ and Bi₂O₃ is preferably 1.00 or less, more preferably 0.80 or less, 0.60 or less, 0.40 or less, 0.30 or less, 0.20 or less, and 0.10 or less in that order, and particularly preferably 0.

Li₂O, La₂O₃, Gd₂O₃, Y₂O₃, ZrO₂, TiO₂, Nb₂O₅, Ta₂O₅, WO₃ and Bi₂O₃ have an effect of increasing the refractive index. On the other hand, SiO₂, B₂O₃, Na₂O, K₂O, MgO, CaO, SrO, BaO and ZnO tend to reduce the refractive index. In order to further increase the refractive index, Li₂O, the mass ratio ((SiO₂+B₂O₃+Na₂O+K₂O+MgO+CaO+SrO+BaO+ZnO)/(Li₂O+La₂O₃+Gd₂O₃+Y₂O₃+ZrO₂+TiO₂+Nb₂O₅+Ta₂O₅+WO₃+Bi₂O₃)) of SiO₂, B₂O₃, Na₂O, K₂O, MgO, CaO, SrO, BaO and ZnO relative to a total content of Li₂O, La₂O₃, Gd₂O₃, Y₂O₃, ZrO₂, TiO₂, Nb₂O₅, Ta₂O₅, WO₃ and Bi₂O₃ is preferably 0.12 or more and more preferably 0.15 or more, 0.20 or more, 0.30 or more, 0.35 or more, 0.40 or more, 0.45 or more, 0.50 or more, and 0.55 or more in that order, and preferably 2.83 or less and more preferably 2.80 or less, 2.60 or less, 2.40 or less, 2.20 or less, 2.00 or less, 1.80 or less, 1.70 or less, 1.60 or less, 1.50 or less, 1.40 or less, 1.30 or less, 1.26 or less, 1.25 or less, and 1.24 or less in that order.

TiO₂, Nb₂O₅, Ta₂O₅, WO₃, Bi₂O₃ and ZrO₂ have an effect of increasing the refractive index of the glass, but if the ZrO₂ content is large, the meltability of the glass tends to decrease. For the above reason, the mass ratio (ZrO₂/(TiO₂+Nb₂O₅+Ta₂O₅+WO₃+Bi₂O₃+ZrO₂)) of the ZrO₂ content relative to a total content of TiO₂, Nb₂O₅, Ta₂O₅, WO₃, Bi₂O₃ and ZrO₂ is preferably 0.00 or more and more preferably 0.01 or more, and 0.02 or more in that order, and is preferably 0.17 or less and more preferably 0.16 or less, 0.15 or less, 0.14 or less, and 0.13 or less in that order.

TiO₂, Nb₂O₅, WO₃ and ZnO tend to increase the refractive index and tend to make dispersibility of the glass higher, but if the content thereof is large, the thermal stability of the glass tends to decrease. On the other hand, MgO, CaO, SrO and BaO tend to make dispersibility of the glass lower and have an effect of improving the thermal stability, but if the content thereof is large, the refractive index tends to decrease. For the above reason, the mass ratio ((MgO+CaO+SrO+BaO)/(TiO₂+Nb₂O₅+WO₃+ZnO)) of a total content of MgO, CaO, SrO and BaO relative to a total content of TiO₂, Nb₂O₅, WO₃ and ZnO is preferably 0.10 or more and more preferably 0.15 or more, 0.20 or more, 0.25 or more, 0.26 or more, 0.27 or more, 0.28 or more, 0.29 or more, 0.30 or more, 0.31 or more, and 0.32 or more in that order, and is preferably 1.50 or less and more preferably 1.30 or less, 1.20 or less, 1.10 or less, 1.00 or less, 0.95 or less, 0.90 or less, and 0.87 or less in that order.

The TiO₂ content is preferably 0.00% or more, and more preferably more than 0.00%, 0.50% or more, 1.00% or more, 1.50% or more, 2.00% or more, 2.50% or more, 3.00% or more, 3.50% or more, and 4.00% or more in that order, and is preferably 50.00% or less, and more preferably 45.0% or less, 40.00% or less, 38.00% or less, 36.00% or less, 36.00% or less, 34.00% or less, 32.00% or less, 31.00% or less, 30.00% or less, 29.50% or less, and 29.00% or less in that order. The TiO₂ content is preferably set to be within the above range in order to achieve a more desirable optical constant and reduce the raw material cost of the glass.

The Nb₂O₅ content is preferably 0.00% or more, and more preferably more than 0.00%, 1.00% or more, 2.00% or more, 3.00% or more, 4.00% or more, 5.00% or more, 6.00% or more, 7.00% or more, 8.00% or more, 9.00% or more, 10.00% or more, and 10.50% or more in that order. In addition, the Nb₂O₅ content is preferably 60.00% or less, and more preferably 58.00% or less, 56.00% or less, 54.00% or less, 52.00% or less, 50.00% or less, 49.00% or less, 48.00% or less, 47.00% or less, 46.00% or less, 45.00% or less, and 44.00% or less in that order. The Nb₂O₅ content is preferably set to be within the above range in order to achieve a more desirable optical constant, further reduce the specific gravity and improve partial dispersion characteristics.

The Ta₂O₅ content can be 0.00% or more. In addition, the Ta₂O₅ content is preferably 5.00% or less, and more preferably 4.00% or less, 3.00% or less, 2.00% or less, 1.00% or less, and 0.50% or less in that order. The Ta₂O₅ content is preferably set to be within the above range in order to improve the thermal stability of the glass, improve the meltability, and further reduce the specific gravity.

The WO₃ content can be 0.00% or more. In addition, the WO₃ content is preferably 5.00% or less, and more preferably 4.00% or less, 3.00% or less, 2.00% or less, 1.00% or less, and 0.50% or less in that order. The WO₃ content is preferably set to be within the above range in order to improve the transmittance of the glass, improve partial dispersion characteristics, and further reduce the specific gravity.

The Bi₂O₃ content can be 0.00% or more. In addition, the Bi₂O₃ content is preferably 5.00% or less, and more preferably 4.00% or less, 3.00% or less, 2.00% or less, 1.00% or less, and 0.50% or less in that order. The Bi₂O₃ content is preferably set to be within the above range in order to improve the thermal stability of the glass, improve partial dispersion characteristics, and further reduce the specific gravity.

GeO₂ has an effect of increasing the refractive index, but is a very expensive component. In order to reduce glass production cost, the GeO₂ content can be 0.00% or more and is preferably 2.00% or less and more preferably 1.50% or less, 1.00% or less, and 0.50% or less in that order.

<Glass Composition of Glass 3>

Hereinafter, the glass composition of Glass 3 will be described in more detail.

In order to achieve a desirable optical constant and improve partial dispersion characteristics, the ZrO₂ content is 7.63% or less, preferably less than 7.63%, and more preferably 7.60 or less, 7.50 or less, 7.40 or less, 7.30 or less, 7.20 or less, 7.10 or less, 7.00 or less, 6.90 or less, 6.80 or less, 6.70 or less, 6.60 or less, 6.50 or less, 6.40 or less, 6.30 or less, 6.20 or less, 6.10 or less, 6.00 or less, 5.95 or less, and 5.90 or less in that order. In addition, in order to achieve a more desirable optical constant and further improve partial dispersion characteristics, the ZrO₂ content is preferably 0.00% or more and more preferably more than 0.00%, 0.10% or more, 0.20% or more, 0.30% or more, 0.40% or more, 0.50% or more, 0.60% or more, and 0.65% or more in that order.

La₂O₃, Gd₂O₃, Y₂O₃ and ZrO₂ are all components that increase the refractive index, but ZrO₂ has a stronger effect of increasing the refractive index and a stronger effect of increasing dispersion (effect of reducing the Abbe number) than La₂O₃, Gd₂O₃, and Y₂O₃. In order to keep dispersion low, a mass ratio (ZrO₂/(La₂O₃+Gd₂O₃+Y₂O₃)) of the ZrO₂ content relative to a total content of La₂O₃, Gd₂O₃ and Y₂O₃ is 3.30 or less, preferably 3.00 or less and more preferably 2.90 or less, 2.80 or less, 2.70 or less, 2.60 or less, 2.50 or less, 2.40 or less, 2.30 or less, 2.20 or less, 2.10 or less, 2.00 or less, 1.90 or less, 1.80 or less, 1.70 or less, 1.60 or less, 1.50 or less, 1.40 or less, 1.30 or less, and 1.25 or less in that order. The mass ratio (ZrO₂/(La₂O₃+Gd₂O₃+Y₂O₃)) can be 0.00 or more, and in order to further increase the refractive index, it is preferably more than 0.00 and more preferably 0.01 or more, 0.02 or more, 0.03 or more, 0.04 or more, 0.05 or more, and 0.06 or more in that order.

In order to improve chemical durability, the mass ratio (B₂O₃/SiO₂) of the B₂O₃ content relative to the SiO₂ content is less than 1.00, preferably 0.90 or less, and more preferably 0.80 or less, 0.70 or less, 0.60 or less, 0.50 or less, 0.40 or less, 0.35 or less, 0.32 or less, 0.31 or less, 0.30 or less, 0.29 or less, 0.28 or less, 0.27 or less, 0.26 or less, and 0.25 or less in that order. In order to improve the thermal stability, the mass ratio (B₂O₃/SiO₂) is preferably 0.00 or more and more preferably 0.01 or more, 0.02 or more, 0.03 or more, 0.04 or more, 0.05 or more, 0.06 or more, 0.07 or more, 0.08 or more, 0.09 or more, 0.10 or more, 0.11 or more, 0.12 or more, 0.13 or more, 0.14 or more, and 0.15 or more in that order.

Regarding a mass ratio ((SiO₂+CaO)/(TiO₂+Nb₂O₅+Ta₂O₅+WO₃+Bi₂O₃)) of a total content of SiO₂ and CaO relative to a total content of TiO₂, Nb₂O₅, Ta₂O₅, WO₃ and Bi₂O₃, the denominator is a total content of components that have a strong effect of increasing the refractive index, and the numerator is a total content of components effective for reducing dispersion and decreasing specific gravity. In order to increase the refractive index, maintain low dispersibility, reduce the specific gravity and maintain the thermal stability, the mass ratio ((SiO₂+CaO)/(TiO₂+Nb₂O₅+Ta₂O₅+WO₃+Bi₂O₃)) is 1.09 or less, preferably 1.08 or less, and more preferably 1.07 or less, 1.06 or less, 1.05 or less, 1.04 or less, 1.03 or less, 1.02 or less, and 1.01 or less in that order. In addition, in order to further increase the refractive index, maintain lower dispersibility and further reduce the specific gravity, the mass ratio ((SiO₂+CaO)/(TiO₂+Nb₂O₅+Ta₂O₅+WO₃+Bi₂O₃)) is preferably 0.25 or more and more preferably 0.30 or more, 0.35 or more, 0.40 or more, 0.42 or more, 0.44 or more, 0.46 or more, 0.48 or more, 0.50 or more, 0.52 or more, 0.54 or more, and 0.55 or more in that order.

Among MgO, CaO, SrO, BaO and ZnO, MgO and CaO are more effective components for reducing the specific gravity of the glass as compared with SrO, BaO, and ZnO. Therefore, in order to reduce an increase in specific gravity, mass ratio ((ZnO+SrO+BaO)/(MgO+CaO)) of a total content of ZnO, SrO and BaO relative to a total content of MgO and CaO is 1.98 or less, preferably 1.96 or less and more preferably 1.94 or less, 1.92 or less, 1.90 or less, 1.88 or less, 1.86 or less, 1.85 or less, 1.84 or less, 1.83 or less, 1.82 or less, 1.81 or less, 1.80 or less, 1.79 or less, and 1.78 or less in that order.

On the other hand, SrO, BaO, and ZnO have a stronger effect of reducing dispersion than MgO and CaO. Therefore, in order to maintain low dispersibility, the mass ratio ((ZnO+SrO+BaO)/(MgO+CaO)) is preferably 0.17 or more and more preferably 0.18 or more, 0.19 or more, and 0.20 or more in that order.

The glass composition of Glass 3 will be described below in more detail.

SiO₂, as a network formation component of the glass, has an effect of improving the thermal stability, chemical durability and weather resistance of the glass, increasing the viscosity of molten glass, and facilitating molding of molten glass. For the above reason, the SiO₂ content is preferably larger than a total content of B₂O₃ and P₂O₅ in terms of mass %. Glass 3 is preferably a silicate glass. The SiO₂ content of Glass 3 is preferably 8.0% or more, and more preferably 10.00% or more, 11.00% or more, 12.00% or more, 13.00% or more, 14.00% or more, 14.50% or more, 15.00% or more, 15.50% or more, 16.00% or more, 16.50% or more, and 16.60% or more in that order.

In order to improve devitrification resistance of the glass, improve the meltability and improve partial dispersion characteristics, the SiO₂ content is preferably 50.00% or less, and more preferably 45.00% or less, 40.00% or less, 35.00% or less, 30.00% or less, 28.00% or less, 26.00% or less, 25.00% or less, 24.50% or less, 24.00% or less, 23.50% or less, 23.00% or less, 22.75% or less, 22.50% or less, and 22.00% or less in that order.

In order to improve the thermal stability of the glass, further reduce the specific gravity, and obtain a more desirable optical constant, the total content (SiO₂+B₂O₃) of SiO₂ and B₂O₃ is preferably 10.00% or more and more preferably 12.00% or more, 14.00% or more, 15.00% or more, 16.00% or more, 17.00% or more, 17.75% or more, 18.00% or more, 18.25% or more, 18.50% or more, and 18.60% or more in that order, and preferably 35.00% or less and more preferably 32.00% or less, 30.00% or less, 28.00% or less, 27.00% or less, 26.50% or less, 26.00% or less, 25.50% or less, 25.00% or less, 24.50% or less, 24.40% or less, and 24.30% or less in that order.

SiO₂ and B₂O₃ have an effect of improving the thermal stability of the glass, but the meltability of the glass tends to decrease when the content of SiO₂ increases. For the above reason, the mass ratio (SiO₂/(SiO₂+B₂O₃)) of the SiO₂ content and a total content of SiO₂ and B₂O₃ is preferably 0.50 or more and more preferably 0.55 or more, 0.60 or more, 0.65 or more, 0.70 or more, 0.75 or more, 0.77 or more, and 0.80 or more in that order, and preferably 1.00 or less and more preferably 0.99 or less, 0.98 or less, 0.97 or less, 0.96 or less, 0.95 or less, 0.94 or less, 0.93 or less, 0.92 or less, 0.91 or less, 0.90 or less, 0.89 or less, and 0.88 or less in that order.

The B₂O₃ content is preferably 0.00% or more, more preferably more than 0.00%, and more preferably 0.10% or more, 0.20% or more, 0.30% or more, 0.35% or more, 0.37% or more, 0.39% or more, 0.40% or more, 0.41% or more, 0.42% or more, 0.43% or more, 0.44% or more, 0.45% or more, 0.46% or more, 0.47% or more, 0.48% or more, and 0.49% or more in that order. In addition, the B₂O₃ content is preferably 30.00% or less and more preferably 25.00% or less, 20.00% or less, 18.00% or less, 16.00% or less, 14.00% or less, 12.00% or less, 10.00% or less, 9.00% or less, 8.00% or less, 7.00% or less, 6.00% or less, 5.50% or less, 5.20% or less, 5.10% or less, 5.00% or less, 4.90% or less, and 4.80% or less in that order. When the B₂O₃ content is set to be within the above range, it is possible to further reduce the specific gravity of the glass and improve the thermal stability of the glass.

In order to improve the meltability and thermal stability of the glass, the CaO content is preferably 3.00% or more, more preferably 4.00% or more, and more preferably 5.00% or more, 5.10%, 5.20% or more, 5.30% or more, 5.40% or more, 5.50% or more, 5.60% or more, 5.70% or more, 5.80% or more, and 5.90% or more in that order. In addition, for the same reason, the CaO content is preferably 40.00% or less and more preferably 35.00% or less, 30.00% or less, 28.00% or less, 26.00% or less, 24.00% or less, 22.00% or less, 21.50% or less, 21.00% or less, 20.50% or less, 20.25% or less, 20.00% or less, and 19.50% or less in that order.

A total content (MgO+CaO+SrO+BaO+ZnO) of the alkaline earth metal oxides MgO, CaO, SrO, and BaO and ZnO is preferably 5.00% or more, and more preferably 7.00% or more, 10.00% or more, 11.00% or more, 12.00% or more, 13.00% or more, 13.50% or more, 14.00% or more, 14.50% or more, 15.00% or more, 15.30% or more, 15.50% or more, and 16.00% or more in that order. In addition, a total content (MgO+CaO+SrO+BaO+ZnO) is preferably 50.00% or less and more preferably 45.00% or less, 40.00% or less, 39.00% or less, 38.00% or less, 37.00% or less, 36.50% or less, 36.00% or less, 35.50% or less, 35.00% or less, 34.50% or less, and 34.00% or less in that order. The total content (MgO+CaO+SrO+BaO+ZnO) is preferably set to be within the above range in order to further reduce the specific gravity and maintain the thermal stability without interfering with an increase in dispersion.

Among MgO, CaO, SrO, BaO and ZnO, MgO and CaO are more effective components for reducing the specific gravity of the glass as compared with SrO, BaO, and ZnO. Therefore, in order to further reduce an increase in specific gravity, a mass ratio ((ZnO+SrO+BaO)/(MgO+CaO)) of a total content of ZnO, SrO and BaO relative to a total content of MgO and CaO is preferably 2.78 or less and more preferably 2.77 or less, 2.76 or less, 2.75 or less, 2.74 or less, and 2.73 or less in that order.

On the other hand, SrO, BaO, and ZnO have a stronger effect of improving partial dispersion characteristics than MgO and CaO. Therefore, in order to improve partial dispersion characteristics, the mass ratio ((ZnO+SrO+BaO)/(MgO+CaO)) is preferably 0.17 or more and more preferably 0.18 or more, 0.19 or more, and 0.20 or more in that order.

In order to further increase the refractive index and further reduce the specific gravity, a mass ratio (CaO/(MgO+CaO+SrO+BaO+ZnO)) of the CaO content relative to d a total content of MgO, CaO, SrO, BaO and ZnO is preferably 0.35 or more and more preferably 0.36 or more, 0.37 or more, 0.38 or more, 0.39 or more, 0.40 or more, 0.41 or more, and 0.42 or more in that order. In order to improve the thermal stability, the mass ratio (CaO/(MgO+CaO+SrO+BaO+ZnO)) is preferably 1.00 or less, and more preferably 0.95 or less, 0.90 or less, 0.89 or less, 0.88 or less, 0.87 or less, 0.86 or less, 0.85 or less, 0.84 or less, and 0.83 or less in that order.

In order to further reduce the specific gravity, a mass ratio ((CaO+MgO)/(MgO+CaO+SrO+BaO+ZnO)) of a total content of CaO and MgO relative to a total content of MgO, CaO, SrO, BaO and ZnO is preferably 0.35 or more and more preferably 0.36 or more, 0.37 or more, 0.38 or more, 0.39 or more, 0.40 or more, 0.41 or more, and 0.42 or more in that order. In order to improve the thermal stability, the mass ratio ((CaO+MgO)/(MgO+CaO+SrO+BaO+ZnO)) is preferably 1.00 or less and more preferably 0.95 or less, 0.90 or less, 0.89 or less, 0.88 or less, 0.87 or less, 0.86 or less, 0.85 or less, 0.84 or less, and 0.83 or less in that order.

The alkaline earth metal oxides MgO, CaO, SrO, and BaO and ZnO have an effect of lowering a liquidus temperature and improving the thermal stability. On the other hand, when the content thereof is large, chemical durability and/or weather resistance tends to decrease. On the other hand, SiO₂ and B₂O₃ have an effect of improving the thermal stability, but if the content thereof is large, the meltability tends to decrease. For the above reason, a mass ratio (SiO₂+B₂O₃)/(MgO+CaO+SrO+BaO+ZnO) of a total content of SiO₂ and B₂O₃ relative to a total content of MgO, CaO, SrO, BaO and ZnO is preferably 0.40 or more and more preferably 0.45 or more, 0.50 or more, 0.52 or more, 0.54 or more, 0.56 or more, 0.57 or more, 0.58 or more, 0.59 or more, 0.60 or more, and 0.61 or more in that order, and is preferably 2.00 or less and more preferably 1.80 or less, 1.60 or less, 1.55 or less, 1.50 or less, 1.45 or less, 1.40 or less, and 1.35 or less in that order.

The MgO content is preferably 0.00% or more. In addition, the MgO content is preferably 15.00% or less and more preferably 12.00% or less, 9.00% or less, 7.00% or less, 6.00% or less, 5.00% or less, 4.00% or less, 3.50% or less, 3.00% or less, 2.50% or less, and 2.10% or less in that order.

The SrO content is preferably 0.00% or more and more preferably 0.10% or more, 0.20% or more, 0.25% or more, 0.26% or more, 0.27% or more, 0.28% or more, 0.29% or more, 0.30%% or more, and 0.31% or more in that order. In addition, the SrO content is preferably 15.00% or less and more preferably 12.00% or less, 10.00% or less, 9.00% or less, 8.50% or less, 8.00% or less, 7.50% or less, 7.00% or less, 6.50% or less, and 6.00% or less in that order.

The BaO content is preferably 0.00% or more and more preferably 0.10% or more, 0.20% or more, 0.30% or more, 0.40% or more, 0.50% or more, 0.60% or more, 0.70% or more, 0.80% or more, 0.90% or more, 1.00% or more, 1.10% or more, 1.20% or more, and 1.30% or more in that order. In addition, the BaO content is preferably 25.00% or less and more preferably 22.00% or less, 20.00% or less, 19.00% or less, 18.00% or less, 17.00% or less, 16.50% or less, 16.00% or less, 15.50% or less, 15.25% or less, and 15.00% or less in that order.

MgO, CaO, SrO and BaO are all glass components having an effect of improving the thermal stability and devitrification resistance of the glass. In order to increase the dispersibility and further reduce the specific gravity, and in order to improve the thermal stability and devitrification resistance of the glass, the content of each of these glass components is preferably in the above range.

The ZnO content is preferably 0.00% or more. In addition, the ZnO content is preferably 10.00% or less and more preferably 9.00% or less, 8.00% or less, 7.00% or less, 6.00% or less, 5.00% or less, 4.00% or less, 3.00% or less, and 2.00% or less in that order. ZnO is a glass component having an effect of improving the thermal stability of the glass. In order to further reduce the specific gravity, to improve the thermal stability of the glass, and obtain a more desirable optical constant, the ZnO content is preferably in the above range.

In Glass 3, in order to increase the refractive index and reduce the dispersibility, a total content (La₂O₃+Gd₂O₃+Y₂O₃) of rare earth oxides La₂O₃, Gd₂O₃ and Y₂O₃ is preferably more than 0%, preferably 0.50% or more, and more preferably 1.00% or more, 1.33% or more, 1.50% or more, 2.00% or more, 2.50% or more, and 3.00% or more in that order. In order to further reduce the specific gravity, a total content (La₂O₃+Gd₂O₃+Y₂O₃) of La₂O₃, Gd₂O₃ and Y₂O₃ is preferably 30.00% or less and more preferably 29.00% or less, 28.00% or less, 26.00% or less, 24.00% or less, 22.00% or less, 20.00% or less, 18.00% or less, 16.00% or less, 15.00% or less, 14.50% or less, 14.00% or less, 13.50% or less, 13.00% or less, 12.50% or less, and 12.00% or less in that order.

BaO and rare earth oxides La₂O₃, Gd₂O₃ and Y₂O₃ are all components that contribute to low dispersibility (that is, increase the Abbe number vd), but when the content thereof is large, the specific gravity of the glass tends to increase. For the above reason, in Glass 3, a total content (BaO+La₂O₃+Gd₂O₃+Y₂O₃) of BaO and rare earth oxides La₂O₃, Gd₂O₃ and Y₂O₃ is preferably 30.00% or less and more preferably 29.00% or less, 28.00% or less, 27.00% or less, 26.00% or less, 25.00% or less, 24.50% or less, 24.00% or less, 23.50% or less, and 23.00% or less in that order. In addition, in order to further increase the Abbe number vd, a total content (BaO+La₂O₃+Gd₂O₃+Y₂O₃) of BaO, La₂O₃, Gd₂O₃ and Y₂O₃ is preferably more than 0%, and more preferably 1.00% or more, 2.00% or more, 3.00% or more, 4.00% or more, 5.00% or more, 6.00% or more, 7.00% or more, 7.50% or more, 8.00% or more, and 8.50% or more in that order.

Both BaO and La₂O₃ are low-dispersion components, but BaO has a weaker effect of increasing the refractive index than La₂O₃. Therefore, in order to increase the refractive index, a mass ratio (BaO/La₂O₃) of the BaO content relative to the La₂O₃ content is preferably 8.30 or less and more preferably 8.00 or less, 7.50 or less, 7.00 or less, 6.50 or less, 6.00 or less, 5.50 or less, 5.40 or less, 5.30 or less, 5.20 or less, 5.10 or less, 5.00 or less, 4.90 or less, 4.80 or less, and 4.70 or less in that order.

The mass ratio (BaO/La₂O₃) may be 0 and may be 0.00 or more. In order to maintain the thermal stability of the glass, the mass ratio (BaO/La₂O₃) is preferably more than 0.00 and more preferably 0.01 or more, 0.02 or more, 0.03 or more, 0.04 or more, 0.05 or more, 0.06 or more, 0.07 or more, 0.08 or more, 0.09 or more, 0.10 or more, and 0.11 or more in that order.

Rare earth oxides La₂O₃, Gd₂O₃ and Y₂O₃ can contribute to increasing the refractive index and reducing dispersibility, but if the content thereof is large, the thermal stability tends to decrease. In addition, SiO₂ and B₂O₃ have an effect of improving the thermal stability, but if the content thereof is large, the meltability tends to decrease and the refractive index tends to decrease. For the above reason, a mass ratio ((SiO₂+B₂O₃)/(La₂O₃+Gd₂O₃+Y₂O₃)) of a total content of SiO₂ and B₂O₃ relative to a total content of La₂O₃, Gd₂O₃ and Y₂O₃ is preferably more than 0.00 and more preferably 0.25 or more, 0.50 or more, 0.75 or more, 1.00 or more, 1.25 or more, 1.50 or more, 1.75 or more, 1.80 or more, and 1.85 or more in that order and preferably 7.47 or less and more preferably 7.40 or less, 7.35 or less, 7.30 or less, and 7.25 or less in that order.

La₂O₃, Gd₂O₃ and Y₂O₃ are all components that can increase the refractive index of the glass, but Gd₂O₃ and Y₂O₃ are components that increase the specific gravity as compared with La₂O₃. Therefore, in order to further reduce the specific gravity, a mass ratio (La₂O₃/(La₂O₃+Gd₂O₃+Y₂O₃)) of the La₂O₃ content relative to a total content of La₂O₃, Gd₂O₃ and Y₂O₃ is preferably more than 0.00 and more preferably 0.10 or more, 0.20 or more, 0.30 or more, 0.40 or more, 0.50 or more, 0.60 or more, 0.70 or more, and 0.75 or more in that order. The mass ratio (La₂O₃/(La₂O₃+Gd₂O₃+Y₂O₃)) can be 1.00 or less.

For the same reason, a mass ratio (Gd₂O₃/(La₂O₃+Gd₂O₃+Y₂O₃)) of the Gd₂O₃ content relative to a total content of La₂O₃, Gd₂O₃ and Y₂O₃ is preferably less than 1.00 and more preferably 0.90 or less, 0.80 or less, 0.70 or less, 0.60 or less, 0.50 or less, 0.40 or less, 0.30 or less, 0.25 or less, and 0.20 or less in that order. The mass ratio (Gd₂O₃/(La₂O₃+Gd₂O₃+Y₂O₃)) can be 0.00 or more.

In addition, for the same reason, a mass ratio (Y₂O₃/(La₂O₃+Gd₂O₃+Y₂O₃)) of the Y₂O₃ content relative to a total content of La₂O₃, Gd₂O₃ and Y₂O₃ is preferably less than 1.00 and more preferably 0.90 or less, 0.80 or less, 0.70 or less, 0.60 or less, 0.50 or less, 0.40 or less, 0.30 or less, and 0.25 or less in that order. The mass ratio (Y₂O₃/(La₂O₃+Gd₂O₃+Y₂O₃)) can be 0.00 or more.

For the above reason, the contents of the above components which are rare earth oxides are preferably in the following ranges.

The La₂O₃ content is preferably 0.00% or more and more preferably more than 0.00%, 0.50% or more, 1.00% or more, 1.33% or more, 1.50% or more, 2.00% or more, 2.50% or more, 2.75% or more, and 3.00% or more in that order. In addition, the La₂O₃ content is preferably 30.00% or less and more preferably 25.00% or less, 20.00% or less, 18.00% or less, 16.00% or less, 15.00% or less, 14.00% or less, 13.50% or less, 13.00% or less, 12.50% or less, and 12.00% or less in that order.

The Gd₂O₃ content is preferably 0.00% or more. In addition, the Gd₂O₃ content is preferably 10.00% or less and more preferably 9.00% or less, 8.00% or less, 7.00% or less, 6.00% or less, 5.00% or less, 4.00% or less, 3.00% or less, and 2.00% or less in that order.

The Y₂O₃ content is preferably 0.00% or more. In addition, the Y₂O₃ content is preferably 10.00% or less and more preferably 9.00% or less, 8.00% or less, 7.00% or less, 6.00% or less, 5.00% or less, 4.00% or less, 3.00% or less, and 2.00% or less in that order.

La₂O₃ has an effect of increasing the refractive index of the glass, and B₂O₃ tends to decrease the refractive index of the glass. Therefore, in order to further increase the refractive index, a mass ratio (La₂O₃/B₂O₃) of the La₂O₃ content relative to the B₂O₃ content is preferably 1.30 or more and more preferably 1.35 or more, 1.40 or more, 1.45 or more, 1.50 or more, 1.55 or more, 1.60 or more, 1.65 or more, 1.70 or more, and 1.72 or more in that order. In order to further reduce the specific gravity, the mass ratio (La₂O₃/B₂O₃) is preferably 20.00 or less and more preferably 18.00 or less, 16.00 or less, 14.00 or less, 13.00 or less, 12.00 or less, 11.50 or less, 11.00 or less, 10.50 or less, and 10.00 or less in that order.

A mass ratio (B₂O₃/La₂O₃) of the B₂O₃ content relative to the La₂O₃ content is preferably 0.79 or less and more preferably 0.78 or less, 0.77 or less, 0.76 or less, 0.75 or less, 0.70 or less, 0.65 or less, 0.64 or less, 0.62 or less, 0.61 or less, 0.60 or less, 0.59 or less, 0.58 or less, 0.57 or less, and 0.50 or less in that order. The mass ratio (La₂O₃/B₂O₃) is preferably 0.00 or more and more preferably more than 0.00.

Rare earth oxides can increase the refractive index of the glass, but if the content of rare earth oxides is large, the thermal stability tends to decrease and the meltability of the glass tends to decrease. Therefore, in order to maintain the thermal stability of the glass and further increase the refractive index, a mass ratio ((La₂O₃+Gd₂O₃+Y₂O₃)/(BaO+La₂O₃+Gd₂O₃+Y₂O₃)) of a total content of La₂O₃, Gd₂O₃ and Y₂O₃ relative to a total content of BaO, La₂O₃, Gd₂O₃ and Y₂O₃ is preferably 1.00 or less and more preferably less than 1.00, 0.99 or less, 0.98 or less, 0.97 or less, 0.96 or less, 0.95 or less, 0.94 or less, 0.93 or less, 0.92 or less, 0.91 or less, and 0.90 or less in that order. The mass ratio ((La₂O₃+Gd₂O₃+Y₂O₃)/(BaO+La₂O₃+Gd₂O₃+Y₂O₃)) is preferably more than 0.00 and more preferably 0.05 or more, 0.06 or more, 0.07 or more, 0.08 or more, 0.09 or more, 0.10 or more, 0.11 or more, 0.12 or more, 0.13 or more, 0.14 or more, 0.15 or more, 0.16 or more, 0.17 or more, 0.18 or more, and 0.20 or more in that order.

Rare earth oxides can increase the refractive index of the glass, but if the content thereof is large, the meltability of the glass tends to decrease. On the other hand, alkaline earth metal oxides can improve the meltability of the glass, but if the content thereof is large, the refractive index tends to decrease. Therefore, in order to maintain the meltability of the glass and further increase the refractive index, a mass ratio ((La₂O₃+Gd₂O₃+Y₂O₃)/(MgO+CaO+SrO+BaO+ZnO+La₂O₃+Gd₂O₃+Y₂O₃)) of a total content of La₂O₃, Gd₂O₃ and Y₂O₃ relative to a total content of MgO, CaO, SrO, BaO, ZnO, La₂O₃, Gd₂O₃ and Y₂O₃ is preferably more than 0.00 and more preferably 0.01 or more, 0.02 or more, 0.03 or more, 0.04 or more, 0.05 or more, 0.06 or more, 0.07 or more, and 0.08 or more in that order, and preferably 0.85 or less and more preferably 0.80 or less, 0.75 or less, 0.70 or less, 0.65 or less, 0.60 or less, 0.55 or less, 0.50 or less, 0.45 or less, 0.44 or less, 0.43 or less, 0.42 or less, 0.41 or less, and 0.40 or less in that order.

Rare earth oxides can increase the refractive index of the glass, but if the content thereof is large, the thermal stability of the glass tends to decrease. On the other hand, B₂O₃ can improve the thermal stability of the glass, but if the content thereof is large, the refractive index tends to decrease. Therefore, in order to maintain the thermal stability of the glass and further increase the refractive index, a mass ratio (B₂O₃/(BaO+La₂O₃+Gd₂O₃+Y₂O₃)) of the B₂O₃ content relative to a total content of BaO, La₂O₃, Gd₂O₃ and Y₂O₃ is preferably 0.00 or more and more preferably more than 0.00, 0.01 or more, 0.02 or more, and 0.03 or more in that order, and preferably 1.00 or less and more preferably 0.90 or less, 0.80 or less, 0.70 or less, 0.60 or less, 0.55 or less, 0.50 or less, 0.45 or less, 0.40 or less, and 0.35 or less in that order.

La₂O₃, Gd₂O₃ and Y₂O₃ have an effect of increasing the refractive index of the glass, but if a total content thereof is large, the thermal stability tends to decrease. On the other hand, B₂O₃ has an effect of improving the thermal stability of the glass, but it tends to reduce the refractive index. Therefore, in order to increase the refractive index while maintaining the thermal stability of the glass, a mass ratio ((La₂O₃+Gd₂O₃+Y₂O₃)/(B₂O₃+La₂O₃+Gd₂O₃+Y₂O₃)) of a total content of La₂O₃, Gd₂O₃ and Y₂O₃ relative to a total content of B₂O₃, La₂O₃, Gd₂O₃ and Y₂O₃ is preferably 0.57 or more and more preferably 0.58 or more, 0.59 or more, 0.60 or more, 0.61 or more, 0.62 or more, 0.63 or more, and 0.64 or more in that order. In order to further reduce the specific gravity, the mass ratio (La₂O₃+Gd₂O₃+Y₂O₃/(B₂O₃+La₂O₃+Gd₂O₃+Y₂O₃)) is preferably 1.00 or less and more preferably less than 1.00, 0.99 or less, 0.98 or less, 0.97 or less, 0.96 or less, 0.95 or less, 0.94 or less, 0.93 or less, 0.92 or less, 0.91 or less, 0.90 or less, 0.89 or less, 0.88 or less, 0.87 or less, 0.86 or less, and 0.85 or less in that order.

La₂O₃, Gd₂O₃, Y₂O₃ and ZrO₂ have an effect of increasing the refractive index and improving partial dispersion characteristics, but if the content of ZrO₂ is large, the meltability of the glass tends to decrease. For the above reason, a mass ratio (ZrO₂/(La₂O₃+Gd₂O₃+Y₂O₃+ZrO₂)) of the ZrO₂ content relative to a total content of La₂O₃, Gd₂O₃, Y₂O₃ and ZrO₂ is preferably 0.01 or more and more preferably 0.02 or more, 0.03 or more, and 0.04 or more in that order, and preferably 5.00 or less and more preferably 4.00 or less, 3.00 or less, and 2.00 or less in that order.

MgO, CaO, SrO, BaO and ZnO have an effect of improving the thermal stability of the glass, but if the content thereof is large, the refractive index tends to decrease. On the other hand, La₂O₃, Gd₂O₃ and Y₂O₃ have an effect of increasing the refractive index, but if the content thereof is large, the thermal stability tends to decrease. For the above reason, a mass ratio ((MgO+CaO+SrO+BaO+ZnO)/(La₂O₃+Gd₂O₃+Y₂O₃)) of a total content of MgO, CaO, SrO, BaO and ZnO relative to a total content of La₂O₃, Gd₂O₃ and Y₂O₃ is preferably more than 0.00 and more preferably 0.10 or more, 0.20 or more, 0.30 or more, 0.40 or more, 0.50 or more, 0.60 or more, 0.70 or more, 0.80 or more, 0.90 or more, 1.00 or more, 1.10 or more, 1.20 or more, 1.30 or more, and 1.40 or more in that order, and preferably 20.00 or less and more preferably 18.00 or less, 16.00 or less, 14.00 or less, 11.09 or less, 11.08 or less, 11.07 or less, 11.06 or less, 11.05 or less, 11.04 or less, 11.03 or less, 11.02 or less, 11.01 or less, and 11.00 or less in that order.

SrO, BaO, La₂O₃, Gd₂O₃ and Y₂O₃ are all effective components for maintaining low dispersibility. Therefore, in order to maintain lower dispersibility, a total content (SrO+BaO+La₂O₃+Gd₂O₃+Y₂O₃) of SrO, BaO, La₂O₃, Gd₂O₃ and Y₂O₃ is preferably 9.00% or more and more preferably 9.50% or more, 10.00% or more, 10.50% or more, 11.00% or more, 11.50% or more, 12.00% or more, 12.50% or more, 13.00% or more, and 13.50% or more in that order.

In addition, in order to further reduce the specific gravity, the total content (SrO+BaO+La₂O₃+Gd₂O₃+Y₂O₃) is preferably 45.00% or less and more preferably 40.00% or less, 35.00% or less, 30.00% or less, 29.00% or less, 28.00% or less, 27.00% or less, 26.00% or less, and 25.00% or less in that order.

La₂O₃, Gd₂O₃ and Y₂O₃ are components having an effect of increasing the refractive index, and SiO₂ is a component that maintains the thermal stability of the glass. In order to further increase the refractive index, a mass ratio ((La₂O₃+Gd₂O₃+Y₂O₃)/(La₂O₃+Gd₂O₃+Y₂O₃+SiO₂)) of a total content of La₂O₃, Gd₂O₃ and Y₂O₃ relative to a total content of La₂O₃, Gd₂O₃, Y₂O₃ and SiO₂ is preferably 0.12 or more and more preferably 0.13 or more. In order to maintain the thermal stability of the glass, the mass ratio ((La₂O₃+Gd₂O₃+Y₂O₃)/(La₂O₃+Gd₂O₃+Y₂O₃+SiO₂)) is preferably 0.70 or less and more preferably 0.60 or less, 0.50 or less, 0.49 or less, 0.48 or less, 0.47 or less, 0.46 or less, 0.45 or less, 0.44 or less, 0.43 or less, 0.42 or less, and 041 or less in that order.

Among ZrO₂, TiO₂, Nb₂O₅, Ta₂O₅, WO₃, and Bi₂O₃ which are components that increase the refractive index, ZrO₂ has a relatively weak effect of increasing dispersion. Therefore, in order to maintain lower dispersibility, a mass ratio (ZrO₂/(TiO₂+Nb₂O₅+Ta₂O₅+WO₃+Bi₂O₃)) of the ZrO₂ content relative to a total content of TiO₂, Nb₂O₅, Ta₂O₅, WO₃ and Bi₂O₃ is preferably 0.00 or more and more preferably 0.01 or more and 0.02 or more in that order. In order to maintain the thermal stability of the glass and maintain devitrification resistance (stability during reheat press molding: also called reheat press moldability) when glass is heated and softened and press-molded, the mass ratio (ZrO₂/(TiO₂+Nb₂O₅+Ta₂O₅+WO₃+Bi₂O₃)) is preferably 0.21 or less and more preferably 0.20 or less, 0.19 or less, 0.18 or less, 0.17 or less, 0.16 or less, and 0.15 or less in that order.

The alkali metal oxides Li₂O, Na₂O, K₂O and Cs₂O have an effect of improving partial dispersion characteristics and also have an effect of lowering a liquidus temperature and improving the thermal stability of the glass. For these reasons, a total content (Li₂O+Na₂O+K₂O+Cs₂O) of Li₂O, Na₂O, K₂O and Cs₂O is preferably 0.00% or more and more preferably more than 0.00%, 0.05% or more, 0.10% or more, 0.15% or more, 0.20% or more, 0.25% or more, and 0.28% or more in that order. In order to improve chemical durability and weather resistance, the total content (Li₂O+Na₂O+K₂O+Cs₂O) is preferably 20.00% or less and more preferably 18.00% or less, 16.00% or less, 14.00% or less, 12.00% or less, 10.00% or less, 9.00% or less, 8.00% or less, 7.00% or less, 6.50% or less, 6.00% or less, 5.50% or less, 5.00% or less, and 4.50% or less in that order.

Alkali metal oxides and alkaline earth metal oxides can contribute to maintaining the meltability and thermal stability of the glass, but if the content thereof is large, the meltability and thermal stability of the glass tend to decrease. Therefore, in order to maintain the meltability and thermal stability of the glass, a total content (Li₂O+Na₂O+K₂O+Cs₂₀+MgO+CaO+SrO+BaO) of the alkali metal oxides Li₂O, Na₂O, K₂O and Cs₂O and the alkaline earth metal oxides MgO, CaO, SrO and BaO is preferably 5.00% or more and more preferably 7.00% or more, 9.00% or more, 10.00% or more, 12.00% or more, 14.00% or more, 15.00% or more, 16.00% or more, 17.00% or more, 18.00% or more, and 18.50% or more in that order, and preferably 50.00% or less and more preferably 48.00% or less, 46.00% or less, 44.00% or less, 43.00% or less, 42.00% or less, 41.00% or less, 40.00% or less, 39.00% or less, 38.00% or less, 37.00% or less, 36.00% or less, 35.00% or less, 34.50% or less, and 34.00% or less in that order.

Alkali metal oxides and alkaline earth metal oxides have effect of lowering a liquidus temperature and improving the thermal stability, but if the content thereof with respect to a network formation component of the glass is large, chemical durability and weather resistance tend to decrease. In addition, SiO₂ and B₂O₃ have an effect of improving the thermal stability, but if the content thereof is large, the meltability tends to decrease. For these reasons, a mass ratio ((Li₂O+Na₂O+K₂O+Cs₂O+MgO+CaO+SrO+BaO)/(SiO₂+B₂O₃)) of a total content of Li₂O, Na₂O, K₂O, Cs₂₀, MgO, CaO, SrO and BaO relative to a total content of SiO₂ and B₂O₃ is preferably 0.50 or more and more preferably 0.52 or more, 0.54 or more, 0.56 or more, 0.58 or more, 0.60 or more, 0.62 or more, 0.64 or more, 0.66 or more, 0.68 or more, 0.70 or more, 0.72 or more, 0.74 or more, 0.75 or more, 0.76 or more, 0.77 or more, 0.78 or more, and 0.79 or more in that order and preferably 5.00 or less and more preferably 4.50 or less, 4.00 or less, 3.50 or less, 3.00 or less, 2.50 or less, 2.00 or less, 1.90 or less, 1.80 or less, 1.70 or less, 1.65 or less, and 1.60 or less in that order.

Among Li₂O, Na₂O and K₂O, Li₂O is the component which is least likely to lower the refractive index. Therefore, in order to further increase the refractive index, a mass ratio (Li₂O/(Li₂O+Na₂O+K₂O)) of the Li₂O content relative to a total content of Li₂O, Na₂O and K₂O is preferably 0.00 or more and more preferably more than 0.00, 0.10 or more, 0.20 or more, 0.30 or more, 0.40 or more, and 0.45 or more in that order. The mass ratio (Li₂O/(Li₂O+Na₂O+K₂O)) can be, for example, 1.00 or less.

Li₂O, Na₂O, K₂O, MgO, CaO, SrO, BaO and ZnO are components that can increase the specific resistance of the glass and facilitate electric heating without increasing a melting temperature and a liquidus temperature of the glass. In addition, since Li₂O, Na₂O, K₂O, MgO, CaO, SrO, BaO and ZnO are components that can improve the thermal stability of the glass, the glass can be kept in a molten state at a lower temperature. That is, they have an effect of improving the meltability of the glass. On the other hand, if small amounts of Li₂O, Na₂O and K₂O are introduced, the melting temperature of the glass decreases and fusion of other high melting point components is promoted, but if a total content thereof is large, the specific resistance in a molten state of the glass decreases and the efficiency of electric heating tends to decrease. In addition, if a total content of Li₂O, Na₂O and K₂O is large, since the viscosity of the glass decreases and the thermal stability also deteriorates, the meltability of the glass tends to decrease. In addition, if a total content of Li₂O, Na₂O and K₂O is large, dispersibility of the glass tends to be higher. Therefore, in order to obtain more desirable meltability and optical characteristics, a mass ratio ((Li₂O+Na₂O+K₂O)/(MgO+CaO+SrO+BaO+ZnO)) of a total content of Li₂O, Na₂O, and K₂O relative to a total content of MgO, CaO, SrO, BaO and ZnO is preferably 0.00 or more and more preferably more than 0.00, 0.01 or more, 0.02 or more, 0.03 or more, 0.04 or more, and 0.05 or more in that order, and preferably 4.00 or less and more preferably 3.50 or less, 3.00 or less, 2.50 or less, 2.00 or less, 1.50 or less, 1.00 or less, 0.90 or less, 0.80 or less, 0.70 or less, 0.60 or less, 0.50 or less, 0.40 or less, and 0.35 or less in that order.

In order to maintain the thermal stability and/or reheat press moldability, a mass ratio ((Li₂O+Na₂O+K₂O)/(SiO₂+B₂O₃)) of a total content of Li₂O, Na₂O and K₂O relative to a total content of SiO₂ and B₂O₃ is preferably 1.00 or less and more preferably 0.90 or less, 0.80 or less, 0.70 or less, 0.60 or less, 0.50 or less, 0.40 or less, 0.35 or less, 0.30 or less, and 0.25 or less in that order. In order to maintain the meltability and/or reduce a partial dispersion ratio to provide a glass suitable for high-order chromatic aberration correction, the mass ratio ((Li₂O+Na₂O+K₂O)/(SiO₂+B₂O₃)) is preferably 0.00 or more and more preferably more than 0.00, 0.01 or more, 0.02 or more, 0.03 or more, 0.04 or more, and 0.05 or more in that order.

The Li₂O content is preferably 0.00% or more and more preferably 0.05% or more, 0.10% or more, 0.15% or more, 0.20% or more, 0.25% or more, 0.30% or more, 0.40% or more, 0.50% or more, and 0.60% or more in that order. In addition, the Li₂O content is preferably 14.00% or less and more preferably 12.00% or less, 10.00% or less, 8.00% or less, 7.00% or less, 6.50% or less, 6.00% or less, 5.50% or less, and 5.00% or less in that order. It is preferable that the Li₂O content be set to be within the above range in order to achieve a more desirable optical constant and in order to maintain chemical durability, weather resistance, and stability during reheating.

The Na₂O content is preferably 0.00% or more. In addition, the Na₂O content is preferably 10.00% or less, and more preferably 8.00% or less, 7.00% or less, 6.00% or less, 5.00% or less, 4.00% or less, 3.00% or less, and 2.00% or less in that order. In order to improve partial dispersion characteristics, the Na₂O content is preferably set to be within the above range.

The K₂O content is preferably 0.00% or more. In addition, the K₂O content is preferably 10.00% or less and more preferably 8.00% or less, 7.00% or less, 6.00% or less, 5.00% or less, 4.00% or less, 3.00% or less, and 2.00% or less in that order. In order to improve the thermal stability of the glass, the K₂O content is preferably set to be within the above range.

The Cs₂O content is preferably 5.00% or less and more preferably 4.00% or less, 3.00% or less, 2.00% or less, 1.00% or less, and 0.50% or less in that order, and may be 0%.

In order to further increase the refractive index, a total content (TiO₂+Nb₂O₅+Ta₂O₅+WO₃+Bi₂O₃) of TiO₂, Nb₂O₅, Ta₂O₅, WO₃ and Bi₂O₃ is preferably 30.00% or more and more preferably 31.00% or more, 32.00% or more, 33.00% or more, 34.00% or more, 35.00% or more, 36.00% or more, 36.50% or more, 37.00% or more, and 37.55% or more in that order. In order to further reduce the specific gravity and in order to improve the thermal stability, the total content (TiO₂+Nb₂O₅+Ta₂O₅+WO₃+Bi₂O₃) of TiO₂, Nb₂O₅, Ta₂O₅, WO₃ and Bi₂O₃ is preferably 60.00% or less and more preferably 58.00% or less, 56.00% or less, 54.00% or less, 52.00% or less, 51.00% or less, 50.00% or less, 49.50% or less, 49.00% or less, and 48.50% or less in that order.

In order to obtain a glass having a high refractive index while an increase in specific gravity is reduced, a mass ratio ((SiO₂+B₂O₃)/(TiO₂+Nb₂O₅+Ta₂O₅+WO₃+Bi₂O₃)) of a total content of SiO₂ and B₂O₃ relative to a total content of TiO₂, Nb₂O₅, Ta₂O₅, WO₃ and Bi₂O₃ is 0.75 or less. In addition to the above, in order to achieve a desirable Abbe number vd and improve partial dispersion characteristics and improve the devitrification resistance, the mass ratio ((SiO₂+B₂O₃)/(TiO₂+Nb₂O₅+Ta₂O₅+WO₃+Bi₂O₃)) is preferably 0.16 or more and more preferably 0.20 or more, 0.25 or more, 0.30 or more, 0.35 or more, 0.36 or more, 0.37 or more, 0.38 or more, 0.39 or more, 0.40 or more, 0.41 or more, and 0.42 or more in that order, and preferably 0.75 or less and more preferably 0.74 or less, 0.73 or less, 0.72 or less, 0.71 or less, 0.70 or less, 0.69 or less, 0.68 or less, 0.67 or less, 0.66 or less, 0.65 or less, and 0.64 or less in that order.

SiO₂ and B₂O₃ have an effect of reducing the refractive index and reducing dispersion (increasing the Abbe number). On the other hand, TiO₂, Nb₂O₅, Ta₂O₅, WO₃, Bi₂O₃, and ZrO₂ are high-refractive-index and high-dispersion components. In order to further increase the refractive index, a mass ratio ((SiO₂+B₂O₃)/(TiO₂+Nb₂O₅+Ta₂O₅+WO₃+Bi₂O₃+ZrO₂)) of a total content of SiO₂ and B₂O₃ relative to a total content of TiO₂, Nb₂O₅, Ta₂O₅, WO₃, Bi₂O₃ and ZrO₂ is preferably 0.64 or less and more preferably 0.63 or less, 0.62 or less, 0.61 or less, 0.60 or less, 0.59 or less, and 0.58 or less in that order.

On the other hand, in order to reduce an increase in dispersion, the mass ratio ((SiO₂+B₂O₃)/(TiO₂+Nb₂O₅+Ta₂O₅+WO₃+Bi₂O₃+ZrO₂)) is preferably 0.13 or more and more preferably 0.15 or more, 0.20 or more, 0.25 or more, 0.26 or more, 0.27 or more, 0.28 or more, 0.29 or more, 0.30 or more, 0.31 or more, 0.32 or more, 0.33 or more, 0.34 or more, 0.35 or more, 0.36 or more, 0.37 or more, and 0.38 or more in that order.

In order to improve partial dispersion characteristics and the transmittance, the mass ratio ((Li₂O+Na₂O+K₂O)/(TiO₂+Nb₂O₅+Ta₂O₅+WO₃+Bi₂O₃)) of a total content of Li₂O, Na₂O and K₂O relative to a total content of TiO₂, Nb₂O₅, Ta₂O₅, WO₃ and Bi₂O₃ is preferably 0.00 or more and more preferably 0.01 or more. In order to maintain the thermal stability and/or reheat press moldability of the glass, the mass ratio ((Li₂O+Na₂O+K₂O)/(TiO₂+Nb₂O₅+Ta₂O₅+WO₃+Bi₂O₃)) is preferably 0.67 or less and more preferably 0.60 or less, 0.50 or less, 0.40 or less, 0.30 or less, 0.20 or less, 0.15 or less, and 0.10 or less in that order.

MgO, CaO, SrO, BaO and ZnO have an effect of improving the thermal stability of the glass, but if the content thereof is large, the refractive index tends to decrease and the glass tends to have lower dispersibility. On the other hand, TiO₂, Nb₂O₅, WO₃ and Bi₂O₃ tend to increase the refractive index and tend to make dispersibility of the glass higher, but if the content thereof is large, the thermal stability tends to decrease. For the above reason, the mass ratio ((MgO+CaO+SrO+BaO+ZnO)/(TiO₂+Nb₂O₅+Ta₂O₅+WO₃+Bi₂O₃)) of a total content of MgO, CaO, SrO, BaO and ZnO relative to a total content of TiO₂, Nb₂O₅, Ta₂O₅, WO₃ and Bi₂O₃ is preferably 0.09 or more and more preferably 0.10 or more, 0.15 or more, 0.20 or more, 0.21 or more, 0.22 or more, 0.23 or more, 0.24 or more, 0.25 or more, 0.26 or more, 0.27 or more, 0.28 or more, 0.29 or more, 0.30 or more, 0.31 or more, and 0.32 or more in that order, and preferably 1.66 or less and more preferably 1.60 or less, 1.50 or less, 1.40 or less, 1.30 or less, 1.20 or less, 1.10 or less, 1.00 or less, 0.95 or less, 0.90 or less, and 0.88 or less in that order.

In terms of contribution to dispersibility, comparing TiO₂, Nb₂O₅, Ta₂O₅, WO₃ and Bi₂O₃ to La₂O₃, Gd₂O₃ and Y₂O₃, TiO₂, Nb₂O₅, Ta₂O₅, WO₃ and Bi₂O₃ tend to make dispersibility of the glass lower, and La₂O₃, Gd₂O₃ and Y₂O₃ tend to make dispersibility of the glass higher. In order to obtain desirable dispersibility, a mass ratio ((La₂O₃+Gd₂O₃+Y₂O₃)/(TiO₂+Nb₂O₅+Ta₂O₅+WO₃+Bi₂O₃)) of a total content of La₂O₃, Gd₂O₃ and Y₂O₃ relative to a total content of TiO₂, Nb₂O₅, Ta₂O₅, WO₃ and Bi₂O₃ is preferably more than 0.00 and more preferably 0.01 or more, 0.02 or more, 0.03 or more, 0.04 or more, 0.05 or more, 0.06 or more, and 0.07 or more in that order, and preferably 1.00 or less and more preferably 0.90 or less, 0.80 or less, 0.70 or less, 0.60 or less, 0.50 or less, 0.45 or less, 0.40 or less, 0.35 or less, and 0.32 or less in that order.

In order to improve partial dispersion characteristics, the mass ratio (TiO₂/(TiO₂+Nb₂O₅+Ta₂O₅+WO₃+Bi₂O₃)) of the TiO₂ content relative to a total content of TiO₂, Nb₂O₅, Ta₂O₅, WO₃ and Bi₂O₃ is preferably 0.00 or more and more preferably more than 0.00, 0.01 or more, 0.02 or more, 0.03 or more, 0.04 or more, 0.05 or more, 0.06 or more, 0.07 or more, 0.08 or more, and 0.09 or more in that order, and preferably 1.00 or less and more preferably less than 1.00, 0.95 or less, 0.90 or less, 0.85 or less, 0.80 or less, 0.75 or less, and 0.73 or less in that order.

In order to improve partial dispersion characteristics, the mass ratio (Nb₂O₅/(TiO₂+Nb₂O₅+Ta₂O₅+WO₃+Bi₂O₃)) of the Nb₂O₅ content relative to a total content of TiO₂, Nb₂O₅, Ta₂O₅, WO₃ and Bi₂O₃ is preferably 0.00 or more and more preferably more than 0.00, 0.01 or more, 0.05 or more, 0.10 or more, 0.15 or more, 0.20 or more, 0.21 or more, 0.22 or more, 0.23 or more, 0.24 or more, 0.25 or more, 0.26 or more, and 0.27 or more in that order, and preferably 1.00 or less and more preferably less than 1.00, 0.99 or less, 0.98 or less, 0.97 or less, 0.96 or less, 0.95 or less, 0.94 or less, 0.93 or less, 0.92 or less, and 0.91 or less in that order.

In order to reduce the raw material cost of the glass and further reduce the specific gravity, the mass ratio (Ta₂O₅/(TiO₂+Nb₂O₅+Ta₂O₅+WO₃+Bi₂O₃)) of the Ta₂O₅ content relative to a total content of TiO₂, Nb₂O₅, Ta₂O₅, WO₃ and Bi₂O₃ is preferably 1.00 or less, more preferably 0.80 or less, 0.60 or less, 0.40 or less, 0.30 or less, 0.20 or less, and 0.10 or less in that order, and particularly preferably 0.

Among high-refractive-index and high-dispersion components TiO₂, Nb₂O₅, Ta₂O₅, WO₃ and Bi₂O₃, WO₃ and Bi₂O₃ have a strong effect of increasing the specific gravity. Therefore, in order to further reduce the specific gravity, the mass ratio (WO₃/(TiO₂+Nb₂O₅+Ta₂O₅+WO₃+Bi₂O₃)) of the WO₃ content relative to a total content of TiO₂, Nb₂O₅, Ta₂O₅, WO₃ and Bi₂O₃ is preferably 1.00 or less, more preferably 0.80 or less, 0.60 or less, 0.40 or less, 0.30 or less, 0.20 or less, and 0.10 or less in that order, and particularly preferably 0.

For the same reason, the mass ratio (Bi₂O₃/(TiO₂+Nb₂O₅+Ta₂O₅+WO₃+Bi₂O₃)) of the Bi₂O₃ content relative to a total content of TiO₂, Nb₂O₅, Ta₂O₅, WO₃ and Bi₂O₃ is preferably 1.00 or less, more preferably 0.80 or less, 0.60 or less, 0.40 or less, 0.30 or less, 0.20 or less, and 0.10 or less in that order, and particularly preferably 0.

Li₂O₃, La₂O₃, Gd₂O₃, Y₂O₃, ZrO₂, TiO₂, Nb₂O₅, Ta₂O₅, WO₃ and Bi₂O₃ have an effect of increasing the refractive index. On the other hand, SiO₂, B₂O₃, Na₂O, K₂O, MgO, CaO, SrO, BaO and ZnO tend to reduce the refractive index. In order to further increase the refractive index, the mass ratio ((SiO₂+B₂O₃+Na₂O+K₂O+MgO+CaO+SrO+BaO+ZnO)/(Li₂O+La₂O₃+Gd₂O₃+Y₂O₃+ZrO₂+TiO₂+Nb₂O₅+Ta₂O₅+WO₃+Bi₂O₃)) of SiO₂, B₂O₃, Na₂O, K₂O, MgO, CaO, SrO, BaO and ZnO relative to a total content of Li₂O₃, La₂O₃, Gd₂O₃, Y₂O₃, ZrO₂, TiO₂, Nb₂O₅, Ta₂O₅, WO₃ and Bi₂O₃ is preferably 0.12 or more and more preferably 0.15 or more, 0.20 or more, 0.30 or more, 0.35 or more, 0.40 or more, 0.45 or more, 0.50 or more, and 0.55 or more in that order, and preferably 2.83 or less and more preferably 2.80 or less, 2.60 or less, 2.40 or less, 2.20 or less, 2.00 or less, 1.80 or less, 1.70 or less, 1.60 or less, 1.50 or less, 1.40 or less, 1.30 or less, 1.26 or less, 1.25 or less, and 1.24 or less in that order.

TiO₂, Nb₂O₅, Ta₂O₅, WO₃, Bi₂O₃ and ZrO₂ have an effect of increasing the refractive index of the glass, but if the ZrO₂ content is large, the meltability of the glass tends to decrease. For the above reason, the mass ratio (ZrO₂/(TiO₂+Nb₂O₅+Ta₂O₅+WO₃+Bi₂O₃+ZrO₂)) of the ZrO₂ content relative to a total content of TiO₂, Nb₂O₅, Ta₂O₅, WO₃, Bi₂O₃ and ZrO₂ is preferably 0.00 or more and more preferably 0.01 or more, and 0.02 or more in that order, and is preferably 0.17 or less and more preferably 0.16 or less, 0.15 or less, 0.14 or less, and 0.13 or less in that order.

TiO₂, Nb₂O₅, WO₃ and ZnO tend to increase the refractive index and tend to make dispersibility of the glass higher, but if the content thereof is large, the thermal stability of the glass tends to decrease. On the other hand, MgO, CaO, SrO and BaO tend to make dispersibility of the glass lower and have an effect of improving the thermal stability, but if the content thereof is large, the refractive index tends to decrease. For the above reason, the mass ratio ((MgO+CaO+SrO+BaO)/(TiO₂+Nb₂O₅+WO₃+ZnO)) of a total content of MgO, CaO, SrO and BaO relative to a total content of TiO₂, Nb₂O₅, WO₃ and ZnO is preferably 0.10 or more and more preferably 0.15 or more, 0.20 or more, 0.25 or more, 0.26 or more, 0.27 or more, 0.28 or more, 0.29 or more, 0.30 or more, 0.31 or more, and 0.32 or more in that order, and is preferably 1.50 or less and more preferably 1.30 or less, 1.20 or less, 1.10 or less, 1.00 or less, 0.95 or less, 0.90 or less, and 0.87 or less in that order.

The TiO₂ content is preferably 0.00% or more, and more preferably more than 0.00%, 0.50% or more, 1.00% or more, 1.50% or more, 2.00% or more, 2.50% or more, 3.00% or more, 3.50% or more, and 4.00% or more in that order, and is preferably 50.00% or less, and more preferably 45.0% or less, 40.00% or less, 38.00% or less, 36.00% or less, 36.00% or less, 34.00% or less, 32.00% or less, 31.00% or less, 30.00% or less, 29.50% or less, and 29.00% or less in that order. The TiO₂ content is preferably set to be within the above range in order to achieve a more desirable optical constant and reduce the raw material cost of the glass.

The Nb₂O₅ content is preferably 0.00% or more, and more preferably more than 0.00%, 1.00% or more, 2.00% or more, 3.00% or more, 4.00% or more, 5.00% or more, 6.00% or more, 7.00% or more, 8.00% or more, 9.00% or more, 10.00% or more, and 10.50% or more in that order. In addition, the Nb₂O₅ content is preferably 60.00% or less, and more preferably 58.00% or less, 56.00% or less, 54.00% or less, 52.00% or less, 50.00% or less, 49.00% or less, 48.00% or less, 47.00% or less, 46.00% or less, 45.00% or less, and 44.00% or less in that order. The Nb₂O₅ content is preferably set to be within the above range in order to achieve a more desirable optical constant, further reduce the specific gravity and improve partial dispersion characteristics.

The Ta₂O₅ content can be 0.00% or more. In addition, the Ta₂O₅ content is preferably 5.00% or less, and more preferably 4.00% or less, 3.00% or less, 2.00% or less, 1.00% or less, and 0.50% or less in that order. The Ta₂O₅ content is preferably set to be within the above range in order to improve the thermal stability of the glass, improve the meltability, and further reduce the specific gravity.

The WO₃ content can be 0.00% or more. In addition, the WO₃ content is preferably 5.00% or less, and more preferably 4.00% or less, 3.00% or less, 2.00% or less, 1.00% or less, and 0.50% or less in that order. The WO₃ content is preferably set to be within the above range in order to improve the transmittance of the glass, improve partial dispersion characteristics, and further reduce the specific gravity.

The Bi₂O₃ content can be 0.00% or more. In addition, the Bi₂O₃ content is preferably 5.00% or less, and more preferably 4.00% or less, 3.00% or less, 2.00% or less, 1.00% or less, and 0.50% or less in that order. The Bi₂O₃ content is preferably set to be within the above range in order to improve the thermal stability of the glass, improve partial dispersion characteristics, and further reduce the specific gravity.

GeO₂ has an effect of increasing the refractive index, but is a very expensive component. In order to reduce glass production cost, the GeO₂ content can be 0.00% or more and is preferably 2.00% or less and more preferably 1.50% or less, 1.00% or less, and 0.50% or less in that order.

<Glass Physical Properties of Glasses 1 to 3>

(Refractive Index nd)

Glasses 1 to 3 can be a glass having a high refractive index. The refractive index nd of the optical glass is preferably 1.860 or more and more preferably 1.865 or more, 1.870 or more, 1.875 or more, 1.880 or more, 1.885 or more, 1.890 or more, 1.895 or more, and 1.900 or more in that order. The refractive index nd of Glasses 1 to 3 can be, for example, 1.950 or less, 1.945 or less, 1.940 or less, 1.935 or less, 1.930 or less or 1.925 or less. In the present invention and this specification, the “refractive index” is a “refractive index nd.”

(Abbe Number vd)

The Abbe number vd is a value representing the property relating to dispersibility, and is expressed as vd=(nd−1)/(nF−nC) using refractive indexes nd, nF, and nC in the d-line, F-line, and C-line. In consideration of usefulness for an optical element material, the Abbe number vd of Glasses 1 to 3 is preferably 22.00 or more and more preferably 22.50 or more, 23.00 or more, 23.50 or more, 24.00 or more, 24.20 or more, 24.40 or more, 24.60 or more, 24.70 or more, 24.80 or more, 25.00 or more, 25.50 or more, 25.60 or more, 25.80 or more, and 26.00 or more in that order. For the same reason, the Abbe number vd is preferably 30.00 or less and more preferably 29.50 or less, 29.00 or less, 28.50 or less, 28.40 or less, 28.30 or less, 28.20 or less, 28.10 or less, 28.00 or less, 27.90 or less, 27.80 or less, and 27.70 or less in that order.

In addition, in consideration of usefulness for an optical element material, it is preferable that the refractive index nd and the Abbe number vd of Glasses 1 to 3 satisfy one or more of the following relational expressions.

nd≥−0.0025vd+1.925

nd≥−0.0025vd+1.935

nd≥−0.0025vd+1.995

nd≥−0.0025vd+2.005

(Specific Gravity d)

In the optical element constituting an optical system, the refractive power is determined by a refractive index of the glass constituting the optical element and a curvature of an optical function surface (a surface that a light beam to be controlled enters and emits) of the optical element. If an attempt is made to increase the curvature of the optical function surface, the thickness of the optical element also increases. As a result, the optical element becomes heavy. On the other hand, if a glass having a high refractive index is used, a large refractive power can be obtained without increasing the curvature of the optical function surface.

Thereby, if the refractive index can be increased while an increase in the specific gravity of the glass is reduced, the weight of the optical element having a certain refractive power can be reduced.

For the above reason, the specific gravity d of Glasses 1 to 3 is preferably 4.100 or less and more preferably 4.095 or less, 4.090 or less, 4.085 or less, 4.080 or less, 4.050 or less, 4.000 or less, 3.995 or less, 3.990 or less, and 3.985 or less in that order. Since a lower specific gravity is preferable in order to reduce the weight of the optical element, the lower limit of the specific gravity of Glasses 1 to 3 is not particularly limited. In one embodiment, the specific gravity can be 3.400 or more, 3.450 or more, 3.500 or more, 3.550 or more, 3.600 or more, 3.650 or more, 3.700 or more or 3.750 or more.

(d/nd)

For the same reason as the above mentioned points regarding the specific gravity d, a value (d/nd) obtained by dividing the specific gravity d by the refractive index nd of Glasses 1 to 3 is preferably 4.35 or less and more preferably 4.00 or less, 3.50 or less, 3.00 or less, 2.90 or less, 2.80 or less, 2.70 or less, 2.60 or less, 2.50 or less, 2.40 or less, 2.30 or less, 2.20 or less, and 2.15 or less in that order. Since a smaller value of “d/nd” is more preferable in order to reduce the weight of the optical element, the lower limit of “d/nd” of the optical glass is not particularly limited. In one embodiment, “d/nd” can be, for example, 1.74 or more, 1.76 or more, 1.78 or more, 1.80 or more, 1.82 or more, 1.84 or more, 1.85 or more, 1.86 or more, 1.87 or more, 1.88 or more, 1.89 or more, 1.90 or more, 1.91 or more, 1.92 or more, 1.93 or more, 1.94 or more or 1.95 or more.

In general, since the refractive index of the glass is larger as the density (specific gravity) of the glass is larger, it has not been easy to achieve a low specific gravity while increasing the refractive index in the past. In particular, when the refractive index is 1.90 or more, in the past, it has been difficult to obtain a glass that is optically uniform, has a high visible light transmittance and is thermally stable and it has been difficult to reduce the value of the specific gravity, which is a tradeoff relationship with a high refractive index. In contrast, Glasses 1 to 3 can be optical glasses having both a high refractive index and a low specific gravity. In addition, in one embodiment, Glasses 1 to 3 can be glasses that are optically uniform, have a high visible light transmittance, and are thermally stable.

(Degree of Coloration λ5)

The light transmittance of the glass, specifically, the property of preventing the wavelength from increasing at the light absorption end on the short wavelength side, can be evaluated by the degree of coloration λ5. The degree of coloration λ5 indicates a wavelength at which the spectral transmittance (including surface reflection loss) of a glass having a thickness of 10 mm is 5% from the ultraviolet range to the visible range. λ5 shown in Examples to be described below is a value measured in a wavelength range of 250 to 700 nm. The spectral transmittance is, for example, more specifically, a spectral transmittance obtained with light entering the polished surface in a vertical direction using a glass sample having parallel planes polished to a thickness of 10.0±0.1 mm, that is, Iout/Iin when the intensity of light incident on the glass sample is lin, and the intensity of light that had passed through the glass sample is Iout.

According to the degree of coloration λ5, the absorption end of the spectral transmittance on the short wavelength side can be quantitatively evaluated. When lenses are bonded to each other with a UV curable adhesive in order to produce a cemented lens, ultraviolet rays are emitted to the adhesive through an optical element and the adhesive is cured. In order to cure the UV curable adhesive with high efficiency, the absorption end of the spectral transmittance on the short wavelength side is preferably in a short wavelength range. The degree of coloration λ5 can be used as an index for quantitatively evaluating the absorption end on the short wavelength side. Glasses 1 to 3 can preferably exhibit λ5 of 400 nm or less. λ5 is more preferably 395 nm or less, 390 nm or less, 385 nm or less, and 380 nm or less in that order. A lower λ5 is preferable, and the lower limit thereof is not particularly limited.

(Glass Transition Temperature Tg)

The glass transition temperature Tg of Glasses 1 to 3 is preferably 560° C. or higher in consideration of machinability. A glass having a high glass transition temperature is preferable because it tends to be less likely to be damaged when glass machining such as cutting, machining, grinding, and polishing is performed. In consideration of machinability, the glass transition temperature Tg is more preferably 570° C. or higher, and still more preferably 580° C. or higher, 590° C. or higher, and 600° C. or higher in that order. On the other hand, in order to reduce the burden on an annealing furnace and a molding die, the glass transition temperature Tg is preferably 800° C. or lower and more preferably 790° C. or lower, 780° C. or lower, 770° C. or lower, 760° C. or lower, 750° C. or lower, and 740° C. or lower in that order.

The glass transition temperature Tg is obtained as follows. In differential scanning calorimetry analysis, when the temperature of the glass sample is raised, the heat absorption behavior accompanying the change in specific heat, that is, the endothermic peak, appears, and when the temperature is further raised, the exothermic peak appears. In differential scanning calorimetry analysis, a differential scanning calorimetry curve (DSC curve) in which the horizontal axis represents temperature and the vertical axis represents an amount corresponding to the heat generation and heat absorption of the sample is obtained. The intersection of the tangent line and the base line at a point at which the tilt when the endothermic peak appears from the base line in this curve becomes a maximum is defined as the glass transition temperature Tg. The glass transition temperature Tg can be measured using a sample obtained by sufficiently crushing glass with a mortar or the like and using differential scanning calorimetry at a temperature rise rate of 10° C./min.

(Liquidus Temperature)

The thermal stability of the glass includes devitrification resistance when a glass melt is molded and devitrification resistance when once solidified glass is re-heated.

For the devitrification resistance when a glass melt is molded, the liquidus temperature LT can be used as a guide. It can be said that a lower liquidus temperature corresponds to better devitrification resistance. In a glass having a high liquidus temperature, in order to prevent devitrification, the temperature of the glass melt, that is, the molten glass, should be maintained at a high temperature, and phenomena such as occurrence of volatilization of highly volatile components, promotion of erosion of the crucible, and particularly in the case of a noble metal crucible, dissolution of noble metal ions in the glass melt that color the glass, the viscosity during molding becoming low, and difficulty in molding a glass with high uniformity can occur. Therefore, the liquidus temperature is preferably 1,400° C. or lower and more preferably 1,370° C. or lower, 1,340° C. or lower, 1,310° C. or lower, 1,280° C. or lower, 1,270° C. or lower, 1,260° C. or lower, and 1,250° C. or lower in that order. In addition, the liquidus temperature can be, for example, 1,000° C. or higher, 1,050° C. or higher or 1,100° C. or higher, but can exceed the values exemplified above.

The “liquidus temperature” in the present invention and this specification is obtained by the following method.

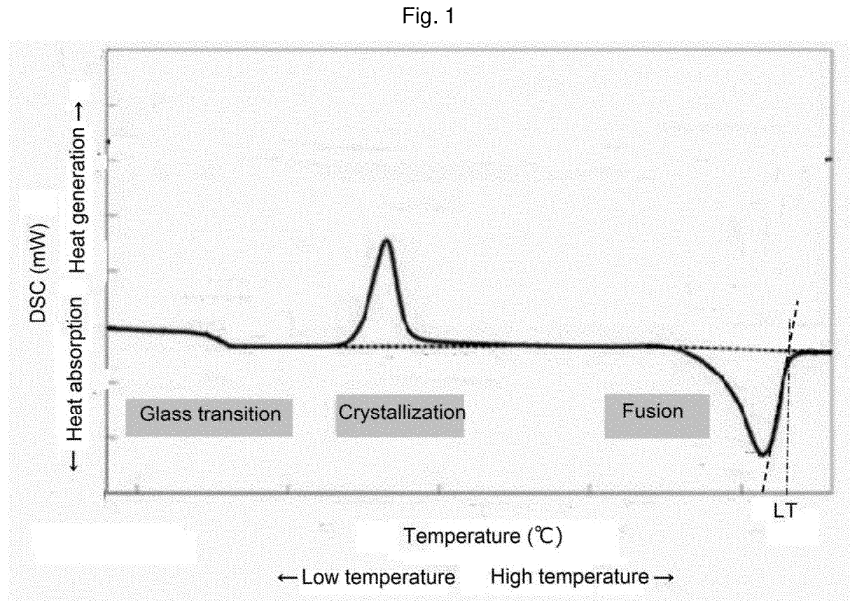

Using differential scanning calorimetry, in a nitrogen atmosphere while flowing nitrogen at a flow rate of 300 ml/min, when the temperature of the glass sample is raised to 1,350° C. at a temperature rise rate of 10° C./min, the end point of the endothermic peak occurring when crystals in the glass generated in a temperature rise procedure fuse in a temperature range higher than the glass transition temperature or the crystallization temperature is defined as the liquidus temperature. FIG. 1 is a diagram schematically showing a differential scanning calorimetry curve (DSC curve). The horizontal axis represents temperature, and on the horizontal axis, the temperature is higher toward the right and the temperature is lower toward the left. The vertical axis corresponds to heat generation/heat absorption of the sample, and the upper side of the base line (dotted line) indicates heat generation, and the lower side thereof indicates heat absorption. Crystal precipitation in the temperature rise procedure corresponds to the exothermic peak, and fusion of the precipitated crystals corresponds to the endothermic peak. The temperature at which crystals fuse and melt is the liquidus temperature. The liquidus temperature is obtained as a temperature at the intersection of the tangent line of the endothermic peak on the high temperature side and the base line.

(Specific Resistance)

Examples of glass physical properties include specific resistance. The unit of the specific resistance is “Ωcm,” and the numerical value thereof can change depending on the temperature.

In order to improve the meltability of the glass, in one embodiment, for example, the lower limit of the value (unit: Ωcm) of a preferable specific resistance at 1,250° C. can be 1.1 or more, 1.5 or more, 2.0 or more, 2.5 or more, 3.0 or more or 3.2 or more. On the other hand, in order to reduce the specific gravity while increasing the refractive index of the glass, the upper limit of the value (unit: Ωcm) of a preferable specific resistance can be 8.0 or less, 7.0 or less, 6.0 or less, 5.0 or less, 4.5 or less or 4.2 or less.

In addition, in one embodiment, it is possible to measure the specific resistance at 1,200° C.

In order to improve the meltability of the glass, in one embodiment, the lower limit of a preferable specific resistance value (unit: Ωcm) at 1,200° C. can be 1.3 or more, 1.7 or more, 2.2 or more, 2.7 or more, 3.2 or more, 3.7 or more, 4.2 or more, 4.7 or more or 5.0 or more. On the other hand, in order to reduce the specific gravity while increasing the refractive index of the glass, the upper limit of a preferable specific resistance value (unit: Ωcm) can be 9.0 or less, 8.0 or less, 7.0 or less, 6.5 or less, 6.0 or less, or 5.5 or less.

The specific resistance of the glass can be measured using a known two-electrode method. For such a measurement method, for example, reference document 1 (T. P. Seward III and T. Vascott (Ed), High Temperature Glass Melt Property Database for Process Modeling, published by Wiley (2005)) can be referred to. Specifically, from a relational expression of a regression line obtained by measuring specific resistances ρ₁(T₁), ρ₂(T₂), . . . ρN(T_{N}) at respective temperatures T₁, T₂, . . . T_{N} (unit: K) while changing the temperature of the glass melt, plotting the inverse of the specific resistances at the measurement temperatures with respect to the inverse of the absolute temperature, and applying the least squares method to the plot:

1/ρ(T)=exp(A+B×(1/T)) Formula 1,

the specific resistance ρ(T) at a certain temperature T (for example, 1,250(° C.)=1,523 (K), 1,200(° C.)=1,473 (K)) can be calculated. Here, A and B are constants.

In order to obtain a relational expression between the inverse of the absolute temperature and the specific resistance more accurately while the influence on the measurement error is reduced, the temperature at which measurement is performed (measurement temperature) is preferably 7 points or more and more preferably 8 points or more, 10 points or more or 12 points or more. In addition, in order to confirm the reproducibility of the measured value, the process from measurement at the first measurement temperature to measurement at the final measurement temperature may be repeated twice or more for one sample. A temperature range between a certain measurement temperature and the next measurement temperature is not particularly limited, but in consideration of temperature measurement accuracy, for example, a temperature range of about 10° C. to 50° C. (10 K to 30 K) or a temperature range of about 20° C. to 40° C. (20 K to 30 K) can be appropriately determined. As a container into which glass is put during measurement, a container made of a material such as platinum that is not eroded by glass can be used. Similarly, for electrodes, a metal such as a platinum wire that is not eroded by glass can be used. The distance between electrodes can be 15 mm, and the glass capacity can be about 70 to 100 ml. The melting temperature can be 900° C. or higher and 1,450° C. or lower, or 1,000° C. or higher and 1,550° C. or lower, and it is desirable to perform measurement at a temperature at which crystals do not precipitate on the glass.

When specific resistances at a plurality of measurement temperatures are measured, in order from the highest measurement temperatures, the measurement can be performed while gradually lowering the inside of the furnace in a range in which glass does not crystallize or solidify. The glass cooling rate is not particularly limited, and can be, for example, 1° C./min to 5° C./min, and is preferably 1° C./min to 3° C./min and appropriately about 2° C./min.

In order to stabilize the temperature of the glass, after the temperature reaches a certain measurement temperature, at the measurement temperature, a soaking time of at least 4 minutes or longer, preferably 5 minutes or longer, 8 minutes or longer or 10 minutes or longer is set. On the other hand, in order to achieve both minimization of volatilization due to the prolonged melting time of the glass and the above temperature stabilization, the soaking time is preferably 20 minutes or shorter or 15 minutes or shorter, and when the amount of the glass is small, the soaking time is more preferably 12 minutes or shorter. The time required for measurement at a certain measurement temperature (that is, the time required from measurement start to measurement end after the soaking time) can be, for example, 30 seconds or longer, and preferably 1 minute or longer. On the other hand, in order to achieve both minimization of volatilization due to the prolonged melting time of the glass and the above temperature stabilization, the time required for measurement at a certain measurement temperature is desirably, for example, 5 minutes or shorter, 3 minutes or shorter or 2 minutes or shorter. In addition, in order to minimize deterioration of the glass, the time from the melting of the glass until measurement at the final measurement temperature ends is preferably about 12 hours or shorter, and more preferably 10 hours or shorter, 8 hours or shorter or 6 hours or shorter.

Glasses 1 to 3 described above are useful as glass materials for an optical element. In addition, by adjusting the composition described above, the specific gravity of the glass can be reduced. Therefore, Glasses 1 to 3 are suitable as optical glasses for providing a lighter optical element.

<Method of Producing Glass>

Glasses 1 to 3 can be obtained by weighing out and mixing raw materials such as oxides, carbonates, sulfates, nitrates, and hydroxides so that a desired glass composition is obtained, sufficiently mixing them to form a mixed batch, performing heating, melting, defoaming, and stirring in a melting container to produce a uniform and foam-free molten glass, and molding it. Specifically, a known melting method can be used for production. Since Glasses 1 to 3 are high-refractive-index and low-dispersion glasses having the above optical characteristics and have excellent thermal stability, they can be stably produced using a known melting method and molding method.

[Glass Material for Press Molding, Optical Element Blank, and Method of Producing the Same]

Another aspect of the present invention relates to:

a glass material for press molding comprised of any of the optical glasses, Glasses 1 to 3; and

an optical element blank comprised of any of the optical glasses, Glasses 1 to 3.

According to another aspect of the present invention, there are provided:

a method of producing a glass material for press molding including a process of molding the optical glass into a glass material for press molding;

a method of producing an optical element blank including a process of producing an optical element blank by press-molding the glass material for optical glass press molding with a press molding die; and

a method of producing an optical element blank including a process of molding the optical glass into an optical element blank.

The optical element blank is an optical element base material that approximates the shape of the desired optical element and has a polishing allowance (surface layer to be removed by polishing) and, if necessary, a grinding allowance (surface layer to be removed by grinding) added to the shape of the optical element. The optical element is finished by grinding and polishing the surface of the optical element blank. In one aspect, an optical element blank can be produced by a method of press-molding a molten glass obtained by melting an appropriate amount of the above glass (called a direct press method). In another aspect, an optical element blank can be produced by solidifying the molten glass obtained by melting an appropriate amount of the above glass.

In addition, in another aspect, an optical element blank can be produced by producing a glass material for press molding and press-molding the produced glass material for press molding.

The glass material for press molding can be press-molded by a known method of pressing a heated and softened glass material for press molding with a press molding die. Both heating and press molding can be performed in air. By reducing distortion inside the glass by annealing after press molding, a uniform optical element blank can be obtained.

The glass material for press molding includes not only a material called a glass gob for press molding that is subjected to press molding for producing an optical element blank without change but also a material that is subjected to machining such as cutting, grinding, and polishing and then subjected to press molding via a glass gob for press molding. Examples of a cutting method include a method in which a groove is formed in a part of the surface of a glass plate to be cut by a method called scribing, a local pressure is applied to the groove part from the back on the surface on which the groove is formed, and the glass plate is broken at the groove part, and a method of cutting a glass plate with a cutting blade. In addition, examples of grinding and polishing methods include barrel polishing.

A glass material for press molding can be produced, for example, by molding a molten glass on a cast glass plate in a mold, and cutting this glass plate into a plurality of glass pieces. In addition, a glass gob for press molding can be produced by molding an appropriate amount of molten glass. An optical element blank can also be produced by re-heat, softening, and press-molding a glass gob for press molding for production. A method of producing an optical element blank by re-heating, softening and press-molding glass is called a reheat press method as opposed to a direct press method.

[Optical Element and Method of Producing the Same]

Another aspect of the present invention relates to an optical element comprised of any of the optical glasses, Glasses 1 to 3.

The optical element is produced using the above optical glass. In the optical element, one or more coatings such as a multilayer film, for example, an antireflection film, may be formed on the surface of the glass.

In addition, according to one aspect of the present invention, there is provided a method of producing an optical element including a process of producing an optical element by grinding and/or polishing the above optical element blank.

In the above method of producing an optical element, a known grinding and polishing method may be applied, and when the surface of the optical element after processing is sufficiently washed and dried, an optical element having high internal quality and surface quality can be obtained. Accordingly, an optical element comprised of the above glass can be obtained. Examples of optical elements include various lenses such as a spherical lens, an aspherical lens, and a microlens, and prisms.

In addition, the optical element comprised of the above optical glass is also suitable as a lens constituting a cemented optical element. Examples of cemented optical elements include those in which lenses are bonded to each other (cemented lens) and those in which a lens and a prism are bonded. For example, the cemented optical element can be produced by performing precise processing (for example, spherical polishing processing) so that the shapes of bonding surfaces of two optical elements to be bonded are inverted, applying a UV curable adhesive used for adhering the cemented lens, performing bonding and then emitting ultraviolet rays through the lens, and curing the adhesive. The above glass is preferable for producing the cemented optical element in this manner. A plurality of optical elements to be bonded can be produced using a plurality of types of glasses having different Abbe numbers vd, and bonding them to obtain an element suitable for correcting chromatic aberration.

[Light Guide Plate, Image Display Device]

Another aspect of the present invention relates to an image display device including:

a light guide plate comprised of any of the optical glasses, Glasses 1 to 3; and

an image display element and a light guide plate that guides light emitted from the image display element,

wherein the light guide plate is a light guide plate comprised of any of the optical glasses, Glasses 1 to 3.

A specific embodiment of the image display device will be described below.

### EXAMPLES

Hereinafter, the present invention will be described in more detail with reference to Examples. However, the present invention is not limited to embodiments shown in Examples.

### Example 1

Raw materials were weighed out using corresponding nitrates, sulfates, carbonates, hydroxides, oxides, boric acid and the like as raw materials for introducing respective components and sufficiently mixed to form formulated raw materials so that glass compositions shown in the following table were obtained. The formulated raw materials were put into a platinum crucible, heated, and melted. After melting, the molten glasses were poured into a mold, allowed to cool to near the glass transition temperature, and then immediately placed in an annealing furnace, annealed in a glass transition temperature range for about 1 hour, and then allowed to cool to room temperature in the furnace, and thereby optical glasses shown in the following table were obtained.

Various physical properties of the optical glass obtained in this manner are shown in the following table. Glasses Nos. 3 to 39, 41 to 113, 115 to 118 and 120 to 192 are optical glasses corresponding to Glass 1. Glasses No. 1 to 192 are optical glasses corresponding to Glass 2 and Glass 3.

Various physical properties of the optical glass were measured by the following methods.

<Evaluation of Physical Properties of Optical Glass>

(1) Refractive Index nd and Abbe Number vd

For the glass obtained by lowering the temperature at a temperature drop rate of −30° C./hour, the refractive index nd and the Abbe number vd were measured by the refractive index measurement method in Japan Optical Glass Manufacturers' Association Standards.

(2) Glass Transition Temperature Tg

Using a sample obtained by sufficiently crushing glass with a mortar, the glass transition temperature Tg was measured at a temperature rise rate of 10° C./min using a differential scanning calorimetry analysis device (DSC3300SA, commercially available from NETZSCH).

(3) Liquidus Temperature

The liquidus temperature was obtained by the method described above using a differential scanning calorimetry analysis device (DSC3300SA, commercially available from NETZSCH). In the table, the liquidus temperature is expressed as “LT.”

(4) Specific Gravity d, d/nd

The specific gravity was measured by the Archimedes method.

A value (d/nd) obtained by dividing the measured specific gravity d by the refractive index nd obtained in the above (1) was calculated.

(5) Degree of Coloration λ5

Using a glass sample having two optically polished planes facing each other and having a thickness of 10±0.1 mm, light with an intensity lin was incident on the polished surface in a vertical direction, the intensity Iout of light that had passed through the glass sample was measured by a spectrophotometer, the spectral transmittance Iout/Iin was calculated, and the wavelength at which the spectral transmittance was 5% was defined as λ5.

In the following table, “Re₂O₃” indicates “La₂O₃+Gd₂O₃+Y₂O₃.”

TABLE 1

| No. | P₂O₅ | SiO₂ | Al₂O₃ | B₂O₃ | Li₂O | Na₂O | K₂O | Cs₂O | MgO | CaO | SrO | BaO | ZnO | La₂O₃ | ZrO₂ | Nb₂O₅ | TiO₂ | Y₂O₃ | Gd₂O₃ | Ta₂O₅ | WO₃ | Bi₂O₃ | total | Sb₂O₃ |
|---|---|---|---|---|---|---|---|---|---|---|---|---|---|---|---|---|---|---|---|---|---|---|---|---|
| 1 | 0.00 | 20.67 | 0.00 | 1.41 | 1.46 | 1.59 | 0.00 | 0.00 | 0.00 | 11.87 | 1.69 | 13.36 | 0.00 | 3.28 | 2.33 | 22.18 | 20.16 | 0.00 | 0.00 | 0.00 | 0.00 | 0.00 | 100.00 | 0.02 |
| 2 | 0.00 | 22.27 | 0.00 | 2.07 | 1.16 | 0.68 | 0.00 | 0.00 | 0.00 | 16.35 | 0.72 | 7.48 | 0.00 | 7.66 | 3.29 | 23.35 | 14.97 | 0.00 | 0.00 | 0.00 | 0.00 | 0.00 | 100.00 | 0.02 |
| 3 | 0.00 | 20.96 | 0.00 | 1.43 | 1.48 | 1.61 | 0.00 | 0.00 | 0.00 | 12.04 | 1.72 | 13.55 | 0.00 | 3.32 | 2.37 | 18.97 | 22.56 | 0.00 | 0.00 | 0.00 | 0.00 | 0.00 | 100.00 | 0.02 |
| 4 | 0.00 | 20.39 | 0.00 | 1.39 | 1.44 | 1.57 | 0.00 | 0.00 | 0.00 | 11.71 | 1.67 | 13.18 | 0.00 | 3.23 | 2.30 | 25.30 | 17.82 | 0.00 | 0.00 | 0.00 | 0.00 | 0.00 | 100.00 | 0.02 |
| 5 | 0.00 | 20.11 | 0.00 | 1.37 | 1.42 | 1.54 | 0.00 | 0.00 | 0.00 | 11.55 | 1.65 | 13.00 | 0.00 | 3.19 | 2.27 | 28.34 | 15.55 | 0.00 | 0.00 | 0.00 | 0.00 | 0.00 | 100.00 | 0.02 |
| 6 | 0.00 | 19.59 | 0.00 | 1.34 | 1.38 | 1.50 | 0.00 | 0.00 | 0.00 | 11.25 | 1.60 | 12.67 | 0.00 | 3.10 | 2.21 | 34.17 | 11.19 | 0.00 | 0.00 | 0.00 | 0.00 | 0.00 | 100.00 | 0.02 |
| 7 | 0.00 | 21.73 | 0.00 | 1.48 | 1.53 | 1.67 | 0.00 | 0.00 | 0.00 | 12.47 | 1.77 | 14.06 | 0.00 | 3.44 | 2.45 | 10.52 | 28.87 | 0.00 | 0.00 | 0.00 | 0.00 | 0.00 | 100.00 | 0.02 |
| 8 | 0.00 | 20.74 | 0.00 | 1.42 | 1.46 | 1.59 | 0.00 | 0.00 | 0.00 | 12.64 | 1.69 | 13.42 | 0.00 | 3.28 | 2.34 | 22.24 | 19.17 | 0.00 | 0.00 | 0.00 | 0.00 | 0.00 | 100.00 | 0.02 |
| 9 | 0.00 | 20.80 | 0.00 | 1.42 | 1.47 | 1.60 | 0.00 | 0.00 | 0.00 | 13.42 | 1.70 | 13.46 | 0.00 | 3.29 | 2.35 | 22.31 | 18.18 | 0.00 | 0.00 | 0.00 | 0.00 | 0.00 | 100.00 | 0.02 |
| 10 | 0.00 | 20.60 | 0.00 | 1.41 | 1.46 | 0.77 | 0.00 | 0.00 | 0.00 | 14.02 | 1.68 | 13.33 | 0.00 | 3.26 | 2.33 | 22.10 | 19.05 | 0.00 | 0.00 | 0.00 | 0.00 | 0.00 | 100.00 | 0.02 |
| 11 | 0.00 | 20.48 | 0.00 | 1.40 | 1.45 | 0.00 | 0.00 | 0.00 | 0.00 | 15.32 | 1.67 | 13.25 | 0.00 | 3.24 | 2.31 | 21.96 | 18.93 | 0.00 | 0.00 | 0.00 | 0.00 | 0.00 | 100.00 | 0.02 |
| 12 | 0.00 | 18.94 | 0.00 | 1.40 | 1.45 | 0.00 | 0.00 | 0.00 | 0.00 | 16.79 | 1.67 | 13.26 | 0.00 | 3.24 | 2.32 | 21.98 | 18.95 | 0.00 | 0.00 | 0.00 | 0.00 | 0.00 | 100.00 | 0.02 |
| 13 | 0.00 | 20.36 | 0.00 | 0.49 | 1.44 | 0.00 | 0.00 | 0.00 | 0.00 | 16.68 | 1.66 | 13.17 | 0.00 | 3.22 | 2.30 | 21.84 | 18.83 | 0.00 | 0.00 | 0.00 | 0.00 | 0.00 | 100.00 | 0.02 |
| 14 | 0.00 | 20.26 | 0.00 | 1.38 | 1.05 | 0.00 | 0.00 | 0.00 | 0.00 | 16.60 | 1.65 | 13.11 | 0.00 | 3.20 | 2.29 | 21.73 | 18.73 | 0.00 | 0.00 | 0.00 | 0.00 | 0.00 | 100.00 | 0.02 |
| 15 | 0.00 | 20.20 | 0.00 | 1.38 | 1.43 | 0.00 | 0.00 | 0.00 | 0.00 | 15.12 | 1.65 | 13.07 | 0.00 | 3.19 | 2.28 | 25.06 | 16.63 | 0.00 | 0.00 | 0.00 | 0.00 | 0.00 | 100.00 | 0.02 |
| 16 | 0.00 | 20.07 | 0.00 | 1.37 | 1.42 | 1.54 | 0.00 | 0.00 | 0.00 | 12.95 | 1.64 | 9.09 | 0.00 | 3.17 | 2.27 | 35.02 | 11.46 | 0.00 | 0.00 | 0.00 | 0.00 | 0.00 | 100.00 | 0.02 |
| 17 | 0.00 | 21.58 | 0.00 | 1.37 | 1.42 | 1.54 | 0.00 | 0.00 | 0.00 | 11.51 | 1.64 | 9.09 | 0.00 | 3.17 | 2.26 | 34.98 | 11.45 | 0.00 | 0.00 | 0.00 | 0.00 | 0.00 | 100.00 | 0.02 |
| 18 | 0.00 | 20.74 | 0.00 | 1.42 | 1.46 | 0.00 | 0.00 | 0.00 | 0.00 | 16.25 | 1.69 | 11.41 | 0.00 | 3.28 | 2.34 | 22.24 | 19.17 | 0.00 | 0.00 | 0.00 | 0.00 | 0.00 | 100.00 | 0.02 |
| 19 | 0.00 | 21.00 | 0.00 | 1.43 | 1.48 | 0.00 | 0.00 | 0.00 | 0.00 | 17.21 | 1.71 | 9.52 | 0.00 | 3.32 | 2.37 | 22.53 | 19.42 | 0.00 | 0.00 | 0.00 | 0.00 | 0.00 | 100.00 | 0.02 |
| 20 | 0.00 | 21.51 | 0.00 | 1.41 | 1.46 | 0.00 | 0.00 | 0.00 | 0.00 | 15.51 | 1.69 | 11.40 | 0.00 | 3.28 | 2.34 | 22.23 | 19.16 | 0.00 | 0.00 | 0.00 | 0.00 | 0.00 | 100.00 | 0.02 |
| 21 | 0.00 | 22.58 | 0.00 | 1.43 | 1.48 | 0.00 | 0.00 | 0.00 | 0.00 | 15.70 | 1.71 | 9.51 | 0.00 | 3.32 | 2.37 | 22.50 | 19.40 | 0.00 | 0.00 | 0.00 | 0.00 | 0.00 | 100.00 | 0.02 |
| 22 | 0.00 | 20.05 | 0.00 | 1.37 | 0.66 | 0.00 | 0.00 | 0.00 | 0.00 | 17.85 | 1.64 | 12.97 | 0.00 | 3.17 | 2.26 | 21.50 | 18.53 | 0.00 | 0.00 | 0.00 | 0.00 | 0.00 | 100.00 | 0.02 |
| 23 | 0.00 | 20.45 | 0.00 | 1.40 | 1.44 | 0.00 | 0.00 | 0.00 | 0.00 | 15.30 | 1.67 | 11.25 | 0.00 | 5.34 | 2.31 | 21.93 | 18.91 | 0.00 | 0.00 | 0.00 | 0.00 | 0.00 | 100.00 | 0.02 |
| 24 | 0.00 | 20.42 | 0.00 | 1.39 | 1.44 | 0.00 | 0.00 | 0.00 | 0.00 | 15.29 | 1.67 | 9.25 | 0.00 | 7.44 | 2.31 | 21.90 | 18.88 | 0.00 | 0.00 | 0.00 | 0.00 | 0.00 | 100.00 | 0.02 |
| 25 | 0.00 | 20.20 | 0.00 | 1.38 | 1.43 | 0.00 | 0.00 | 0.00 | 0.00 | 14.40 | 1.65 | 13.07 | 0.00 | 5.27 | 2.28 | 21.66 | 18.67 | 0.00 | 0.00 | 0.00 | 0.00 | 0.00 | 100.00 | 0.02 |
| 26 | 0.00 | 20.30 | 0.00 | 1.39 | 1.43 | 0.00 | 0.00 | 0.00 | 0.00 | 14.47 | 1.66 | 13.13 | 0.00 | 3.21 | 3.87 | 21.77 | 18.77 | 0.00 | 0.00 | 0.00 | 0.00 | 0.00 | 100.00 | 0.02 |
| 27 | 0.00 | 20.37 | 0.00 | 1.39 | 1.44 | 0.00 | 0.00 | 0.00 | 0.00 | 15.25 | 1.66 | 13.18 | 0.00 | 5.32 | 0.71 | 21.85 | 18.83 | 0.00 | 0.00 | 0.00 | 0.00 | 0.00 | 100.00 | 0.02 |
| 28 | 0.00 | 20.35 | 0.00 | 1.39 | 1.44 | 0.00 | 0.00 | 0.00 | 0.00 | 14.51 | 2.99 | 13.17 | 0.00 | 3.22 | 2.30 | 21.82 | 18.81 | 0.00 | 0.00 | 0.00 | 0.00 | 0.00 | 100.00 | 0.02 |
| 29 | 0.00 | 20.61 | 0.00 | 1.41 | 1.46 | 0.00 | 0.00 | 0.00 | 0.00 | 15.42 | 3.03 | 11.33 | 0.00 | 3.26 | 2.33 | 22.10 | 19.05 | 0.00 | 0.00 | 0.00 | 0.00 | 0.00 | 100.00 | 0.02 |
| 30 | 0.00 | 20.22 | 0.00 | 1.38 | 1.43 | 0.00 | 0.00 | 0.00 | 0.00 | 14.42 | 1.65 | 15.04 | 0.00 | 3.20 | 2.28 | 21.69 | 18.69 | 0.00 | 0.00 | 0.00 | 0.00 | 0.00 | 100.00 | 0.02 |
| 31 | 0.00 | 19.92 | 0.00 | 1.36 | 1.41 | 0.00 | 0.00 | 0.00 | 0.00 | 13.50 | 1.63 | 12.89 | 0.00 | 7.25 | 2.25 | 21.37 | 18.42 | 0.00 | 0.00 | 0.00 | 0.00 | 0.00 | 100.00 | 0.02 |
| 32 | 0.00 | 19.76 | 0.00 | 1.85 | 1.45 | 0.00 | 0.00 | 0.00 | 0.00 | 15.37 | 1.68 | 13.29 | 0.00 | 3.25 | 2.32 | 22.03 | 18.99 | 0.00 | 0.00 | 0.00 | 0.00 | 0.00 | 100.00 | 0.02 |
| 33 | 0.00 | 21.18 | 0.00 | 0.94 | 1.44 | 0.00 | 0.00 | 0.00 | 0.00 | 15.27 | 1.67 | 13.20 | 0.00 | 3.23 | 2.31 | 21.89 | 18.87 | 0.00 | 0.00 | 0.00 | 0.00 | 0.00 | 100.00 | 0.02 |
| 34 | 0.00 | 20.41 | 0.00 | 1.39 | 1.44 | 0.00 | 0.00 | 0.00 | 0.00 | 14.55 | 1.67 | 13.20 | 1.05 | 3.23 | 2.31 | 21.89 | 18.87 | 0.00 | 0.00 | 0.00 | 0.00 | 0.00 | 100.00 | 0.02 |
| 35 | 0.00 | 21.22 | 0.00 | 1.39 | 1.44 | 0.00 | 0.00 | 0.00 | 0.00 | 14.57 | 1.67 | 11.24 | 0.00 | 5.34 | 2.31 | 21.92 | 18.90 | 0.00 | 0.00 | 0.00 | 0.00 | 0.00 | 100.00 | 0.02 |
| 36 | 0.00 | 20.51 | 0.00 | 1.85 | 1.45 | 0.00 | 0.00 | 0.00 | 0.00 | 14.62 | 1.67 | 11.28 | 0.00 | 5.36 | 2.32 | 21.99 | 18.96 | 0.00 | 0.00 | 0.00 | 0.00 | 0.00 | 100.00 | 0.02 |
| 37 | 0.00 | 20.52 | 0.00 | 1.40 | 1.45 | 0.40 | 0.00 | 0.00 | 0.00 | 14.63 | 1.67 | 11.28 | 0.00 | 5.36 | 2.32 | 22.00 | 18.97 | 0.00 | 0.00 | 0.00 | 0.00 | 0.00 | 100.00 | 0.02 |
| 38 | 0.00 | 20.70 | 0.00 | 1.41 | 1.85 | 0.00 | 0.00 | 0.00 | 0.00 | 14.02 | 1.69 | 13.39 | 0.00 | 3.27 | 2.34 | 22.20 | 19.13 | 0.00 | 0.00 | 0.00 | 0.00 | 0.00 | 100.00 | 0.02 |
| 39 | 0.00 | 19.84 | 0.00 | 1.35 | 0.28 | 0.00 | 0.00 | 0.00 | 0.00 | 19.07 | 1.62 | 12.84 | 0.00 | 3.14 | 2.24 | 21.28 | 18.34 | 0.00 | 0.00 | 0.00 | 0.00 | 0.00 | 100.00 | 0.02 |
| 40 | 0.00 | 19.69 | 0.00 | 1.34 | 0.00 | 0.00 | 0.00 | 0.00 | 0.00 | 19.96 | 1.61 | 12.74 | 0.00 | 3.11 | 2.22 | 21.12 | 18.20 | 0.00 | 0.00 | 0.00 | 0.00 | 0.00 | 100.00 | 0.02 |
| 41 | 0.00 | 19.78 | 0.00 | 1.35 | 0.65 | 0.00 | 0.00 | 0.00 | 0.00 | 16.91 | 1.61 | 12.80 | 0.00 | 5.17 | 2.23 | 21.21 | 18.29 | 0.00 | 0.00 | 0.00 | 0.00 | 0.00 | 100.00 | 0.02 |
| 42 | 0.00 | 19.26 | 0.00 | 2.03 | 1.41 | 0.00 | 0.00 | 0.00 | 0.00 | 14.99 | 1.63 | 11.01 | 0.00 | 5.23 | 2.26 | 28.20 | 13.96 | 0.00 | 0.00 | 0.00 | 0.00 | 0.00 | 100.00 | 0.02 |
| 43 | 0.00 | 19.52 | 0.00 | 1.33 | 0.64 | 0.00 | 0.00 | 0.00 | 0.00 | 15.99 | 1.59 | 12.63 | 0.00 | 7.11 | 2.20 | 20.93 | 18.05 | 0.00 | 0.00 | 0.00 | 0.00 | 0.00 | 100.00 | 0.02 |
| 44 | 0.00 | 19.55 | 0.00 | 1.33 | 0.64 | 0.00 | 0.00 | 0.00 | 0.00 | 15.32 | 4.16 | 12.65 | 0.00 | 5.10 | 2.21 | 20.96 | 18.07 | 0.00 | 0.00 | 0.00 | 0.00 | 0.00 | 100.00 | 0.02 |
| 45 | 0.00 | 19.32 | 0.00 | 1.32 | 0.63 | 0.00 | 0.00 | 0.00 | 0.00 | 13.78 | 6.64 | 12.50 | 0.00 | 5.05 | 2.18 | 20.72 | 17.86 | 0.00 | 0.00 | 0.00 | 0.00 | 0.00 | 100.00 | 0.02 |
| 46 | 0.00 | 19.52 | 0.00 | 1.33 | 0.64 | 0.00 | 0.00 | 0.00 | 0.00 | 16.69 | 1.59 | 12.63 | 0.00 | 5.10 | 2.21 | 24.22 | 16.08 | 0.00 | 0.00 | 0.00 | 0.00 | 0.00 | 100.00 | 0.02 |
| 47 | 0.00 | 19.27 | 0.00 | 1.31 | 0.63 | 0.00 | 0.00 | 0.00 | 0.00 | 16.47 | 1.57 | 12.47 | 0.00 | 5.03 | 2.18 | 27.14 | 13.92 | 0.00 | 0.00 | 0.00 | 0.00 | 0.00 | 100.00 | 0.02 |
| 48 | 0.00 | 19.64 | 0.00 | 1.34 | 0.65 | 0.00 | 0.00 | 0.00 | 0.00 | 16.09 | 1.60 | 12.71 | 1.01 | 7.15 | 2.22 | 19.42 | 18.16 | 0.00 | 0.00 | 0.00 | 0.00 | 0.00 | 100.00 | 0.02 |
| 49 | 0.00 | 19.52 | 0.00 | 1.33 | 0.64 | 0.00 | 0.00 | 0.00 | 0.00 | 15.99 | 1.59 | 12.63 | 1.00 | 7.11 | 2.20 | 20.93 | 17.06 | 0.00 | 0.00 | 0.00 | 0.00 | 0.00 | 100.00 | 0.02 |
| 50 | 0.00 | 19.27 | 0.00 | 1.31 | 0.63 | 0.00 | 0.00 | 0.00 | 0.00 | 15.10 | 1.57 | 12.46 | 0.00 | 9.00 | 2.18 | 20.66 | 17.81 | 0.00 | 0.00 | 0.00 | 0.00 | 0.00 | 100.00 | 0.02 |
| 51 | 0.00 | 19.02 | 0.00 | 1.30 | 0.62 | 0.00 | 0.00 | 0.00 | 0.00 | 14.23 | 1.55 | 12.30 | 0.00 | 10.84 | 2.15 | 20.40 | 17.58 | 0.00 | 0.00 | 0.00 | 0.00 | 0.00 | 100.00 | 0.02 |
| 52 | 0.00 | 19.62 | 0.00 | 1.34 | 0.64 | 0.00 | 0.00 | 0.00 | 0.00 | 16.08 | 1.60 | 12.69 | 1.01 | 7.14 | 0.69 | 21.04 | 18.14 | 0.00 | 0.00 | 0.00 | 0.00 | 0.00 | 100.00 | 0.02 |
| 53 | 0.00 | 19.64 | 0.00 | 1.56 | 0.65 | 0.00 | 0.00 | 0.00 | 0.00 | 16.09 | 1.60 | 12.71 | 0.00 | 7.15 | 2.22 | 20.24 | 18.16 | 0.00 | 0.00 | 0.00 | 0.00 | 0.00 | 100.00 | 0.02 |
| 54 | 0.00 | 19.57 | 0.00 | 1.55 | 0.64 | 0.00 | 0.00 | 0.00 | 0.00 | 16.04 | 1.60 | 12.66 | 0.00 | 7.13 | 2.21 | 20.99 | 17.60 | 0.00 | 0.00 | 0.00 | 0.00 | 0.00 | 100.00 | 0.02 |
| 55 | 0.00 | 19.63 | 0.00 | 1.56 | 0.64 | 0.00 | 0.00 | 0.00 | 0.00 | 16.08 | 1.60 | 12.70 | 0.00 | 7.15 | 1.45 | 21.05 | 18.15 | 0.00 | 0.00 | 0.00 | 0.00 | 0.00 | 100.00 | 0.02 |
| 56 | 0.00 | 19.02 | 0.00 | 1.30 | 0.62 | 0.00 | 0.00 | 0.00 | 0.00 | 15.58 | 1.55 | 12.31 | 0.00 | 6.93 | 2.15 | 26.79 | 13.74 | 0.00 | 0.00 | 0.00 | 0.00 | 0.00 | 100.00 | 0.02 |
| 57 | 0.00 | 19.01 | 0.00 | 2.00 | 1.40 | 0.00 | 0.00 | 0.00 | 0.00 | 14.09 | 1.61 | 10.87 | 0.00 | 7.19 | 2.23 | 27.83 | 13.78 | 0.00 | 0.00 | 0.00 | 0.00 | 0.00 | 100.00 | 0.02 |
| 58 | 0.00 | 19.13 | 0.00 | 2.01 | 1.40 | 0.00 | 0.00 | 0.00 | 0.00 | 14.17 | 1.62 | 10.94 | 0.00 | 5.19 | 2.25 | 28.00 | 13.86 | 1.42 | 0.00 | 0.00 | 0.00 | 0.00 | 100.00 | 0.02 |
| 59 | 0.00 | 19.06 | 0.00 | 2.22 | 1.40 | 0.00 | 0.00 | 0.00 | 0.00 | 14.13 | 1.62 | 10.90 | 0.00 | 7.21 | 2.24 | 27.91 | 13.32 | 0.00 | 0.00 | 0.00 | 0.00 | 0.00 | 100.00 | 0.02 |
| 60 | 0.00 | 19.41 | 0.00 | 2.00 | 1.40 | 0.00 | 0.00 | 0.00 | 0.00 | 14.10 | 1.61 | 10.88 | 0.00 | 7.20 | 2.23 | 27.86 | 13.29 | 0.00 | 0.00 | 0.00 | 0.00 | 0.00 | 100.00 | 0.02 |
| 61 | 0.00 | 19.13 | 0.00 | 2.01 | 1.40 | 0.00 | 0.00 | 0.00 | 0.00 | 14.17 | 2.93 | 9.01 | 0.00 | 7.24 | 2.25 | 28.00 | 13.86 | 0.00 | 0.00 | 0.00 | 0.00 | 0.00 | 100.00 | 0.02 |
| 62 | 0.00 | 19.12 | 0.00 | 2.23 | 1.40 | 0.00 | 0.00 | 0.00 | 0.00 | 14.17 | 1.62 | 10.93 | 0.00 | 7.24 | 2.25 | 27.16 | 13.86 | 0.00 | 0.00 | 0.00 | 0.00 | 0.00 | 100.00 | 0.02 |
| 63 | 0.00 | 19.47 | 0.00 | 2.01 | 1.40 | 0.00 | 0.00 | 0.00 | 0.00 | 14.15 | 1.62 | 10.92 | 0.00 | 7.23 | 2.24 | 27.12 | 13.84 | 0.00 | 0.00 | 0.00 | 0.00 | 0.00 | 100.00 | 0.02 |
| 64 | 0.00 | 19.11 | 0.00 | 2.23 | 1.40 | 0.00 | 0.00 | 0.00 | 0.00 | 14.16 | 1.62 | 10.93 | 0.00 | 7.23 | 1.47 | 27.98 | 13.85 | 0.00 | 0.00 | 0.00 | 0.00 | 0.00 | 100.00 | 0.02 |
| 65 | 0.00 | 19.46 | 0.00 | 2.01 | 1.40 | 0.00 | 0.00 | 0.00 | 0.00 | 14.14 | 1.62 | 10.91 | 0.00 | 7.22 | 1.47 | 27.94 | 13.83 | 0.00 | 0.00 | 0.00 | 0.00 | 0.00 | 100.00 | 0.02 |
| 66 | 0.00 | 19.04 | 0.00 | 2.00 | 1.40 | 0.00 | 0.00 | 0.00 | 0.50 | 13.41 | 1.62 | 10.89 | 0.00 | 7.21 | 2.24 | 27.88 | 13.80 | 0.00 | 0.00 | 0.00 | 0.00 | 0.00 | 100.00 | 0.02 |
| 67 | 0.00 | 19.16 | 0.00 | 2.02 | 1.41 | 0.00 | 0.00 | 0.00 | 0.51 | 14.20 | 0.32 | 10.95 | 0.00 | 7.25 | 2.25 | 28.05 | 13.89 | 0.00 | 0.00 | 0.00 | 0.00 | 0.00 | 100.00 | 0.02 |
| 68 | 0.00 | 19.28 | 0.00 | 2.03 | 1.42 | 0.00 | 0.00 | 0.00 | 0.51 | 14.29 | 1.64 | 9.08 | 0.00 | 7.30 | 2.26 | 28.23 | 13.97 | 0.00 | 0.00 | 0.00 | 0.00 | 0.00 | 100.00 | 0.02 |
| 69 | 0.00 | 19.10 | 0.00 | 2.01 | 1.40 | 0.00 | 0.00 | 0.00 | 0.00 | 14.16 | 1.62 | 9.00 | 0.00 | 7.23 | 2.24 | 27.97 | 13.85 | 1.42 | 0.00 | 0.00 | 0.00 | 0.00 | 100.00 | 0.02 |
| 70 | 0.00 | 19.08 | 0.00 | 2.01 | 1.40 | 0.00 | 0.00 | 0.00 | 1.01 | 12.74 | 1.62 | 10.91 | 0.00 | 7.22 | 2.24 | 27.94 | 13.83 | 0.00 | 0.00 | 0.00 | 0.00 | 0.00 | 100.00 | 0.02 |
| 71 | 0.00 | 19.16 | 0.00 | 2.02 | 1.41 | 0.00 | 0.00 | 0.00 | 2.03 | 11.37 | 1.63 | 10.95 | 0.00 | 7.25 | 2.25 | 28.05 | 13.89 | 0.00 | 0.00 | 0.00 | 0.00 | 0.00 | 100.00 | 0.02 |
| 72 | 0.00 | 19.56 | 0.00 | 2.06 | 1.44 | 0.00 | 0.00 | 0.00 | 1.04 | 14.50 | 1.66 | 7.24 | 0.00 | 7.40 | 2.30 | 28.64 | 14.18 | 0.00 | 0.00 | 0.00 | 0.00 | 0.00 | 100.00 | 0.02 |
| 73 | 0.00 | 19.85 | 0.00 | 2.09 | 1.46 | 0.00 | 0.00 | 0.00 | 1.58 | 14.71 | 1.68 | 5.35 | 0.00 | 7.51 | 2.33 | 29.06 | 14.39 | 0.00 | 0.00 | 0.00 | 0.00 | 0.00 | 100.00 | 0.02 |
| 74 | 0.00 | 18.97 | 0.00 | 2.00 | 1.39 | 0.00 | 0.00 | 0.00 | 0.00 | 14.06 | 1.61 | 7.98 | 0.00 | 10.23 | 2.23 | 27.78 | 13.75 | 0.00 | 0.00 | 0.00 | 0.00 | 0.00 | 100.00 | 0.02 |
| 75 | 0.00 | 18.96 | 0.00 | 2.00 | 1.39 | 0.00 | 0.00 | 0.00 | 0.00 | 14.05 | 1.61 | 7.02 | 0.00 | 11.24 | 2.23 | 27.76 | 13.74 | 0.00 | 0.00 | 0.00 | 0.00 | 0.00 | 100.00 | 0.02 |
| 76 | 0.00 | 18.86 | 0.00 | 1.98 | 1.38 | 0.00 | 0.00 | 0.00 | 0.00 | 13.63 | 1.60 | 8.88 | 0.00 | 10.17 | 2.21 | 27.61 | 13.67 | 0.00 | 0.00 | 0.00 | 0.00 | 0.00 | 100.00 | 0.02 |
| 77 | 0.00 | 19.67 | 0.00 | 2.03 | 1.80 | 0.00 | 0.00 | 0.00 | 0.00 | 12.88 | 1.64 | 11.03 | 0.00 | 7.30 | 2.27 | 27.40 | 13.98 | 0.00 | 0.00 | 0.00 | 0.00 | 0.00 | 100.00 | 0.02 |
| 78 | 0.00 | 18.74 | 0.00 | 1.97 | 1.38 | 0.00 | 0.00 | 0.00 | 0.00 | 13.19 | 1.59 | 8.82 | 0.00 | 11.10 | 2.20 | 27.43 | 13.58 | 0.00 | 0.00 | 0.00 | 0.00 | 0.00 | 100.00 | 0.02 |
| 79 | 0.00 | 18.85 | 0.00 | 1.98 | 1.38 | 0.00 | 0.00 | 0.00 | 0.00 | 13.62 | 1.60 | 7.93 | 0.00 | 11.17 | 2.21 | 27.59 | 13.66 | 0.00 | 0.00 | 0.00 | 0.00 | 0.00 | 100.00 | 0.02 |
| 80 | 0.00 | 18.81 | 0.00 | 1.98 | 1.38 | 0.00 | 0.00 | 0.00 | 0.00 | 13.60 | 1.60 | 8.86 | 0.00 | 11.15 | 1.45 | 27.54 | 13.64 | 0.00 | 0.00 | 0.00 | 0.00 | 0.00 | 100.00 | 0.02 |
| 81 | 0.00 | 18.82 | 0.00 | 1.98 | 1.38 | 0.00 | 0.00 | 0.00 | 0.00 | 13.60 | 1.60 | 8.87 | 0.00 | 11.15 | 2.21 | 26.74 | 13.64 | 0.00 | 0.00 | 0.00 | 0.00 | 0.00 | 100.00 | 0.02 |
| 82 | 0.00 | 19.54 | 0.00 | 2.95 | 1.43 | 0.00 | 0.00 | 0.00 | 0.00 | 14.48 | 1.66 | 3.30 | 0.00 | 11.58 | 2.29 | 28.61 | 14.16 | 0.00 | 0.00 | 0.00 | 0.00 | 0.00 | 100.00 | 0.02 |
| 83 | 0.00 | 20.95 | 0.00 | 2.04 | 1.43 | 0.00 | 0.00 | 0.00 | 0.00 | 14.39 | 1.65 | 3.28 | 0.00 | 11.50 | 2.28 | 28.42 | 14.07 | 0.00 | 0.00 | 0.00 | 0.00 | 0.00 | 100.00 | 0.02 |
| 84 | 0.00 | 19.26 | 0.00 | 2.03 | 1.41 | 0.00 | 0.00 | 0.00 | 0.00 | 14.99 | 1.63 | 11.01 | 0.00 | 5.23 | 2.26 | 28.20 | 13.96 | 0.00 | 0.00 | 0.00 | 0.00 | 0.00 | 100.00 | 0.02 |
| 85 | 0.00 | 19.01 | 0.00 | 2.00 | 1.40 | 0.00 | 0.00 | 0.00 | 0.00 | 14.09 | 1.61 | 10.87 | 0.00 | 7.19 | 2.23 | 27.83 | 13.78 | 0.00 | 0.00 | 0.00 | 0.00 | 0.00 | 100.00 | 0.02 |
| 86 | 0.00 | 20.30 | 0.00 | 2.95 | 1.43 | 0.00 | 0.00 | 0.00 | 0.00 | 13.75 | 1.66 | 3.30 | 0.00 | 11.57 | 2.29 | 28.59 | 14.15 | 0.00 | 0.00 | 0.00 | 0.00 | 0.00 | 100.00 | 0.02 |
| 87 | 0.00 | 21.06 | 0.00 | 2.95 | 1.43 | 0.00 | 0.00 | 0.00 | 0.00 | 13.03 | 1.66 | 3.29 | 0.00 | 11.57 | 2.29 | 28.58 | 14.15 | 0.00 | 0.00 | 0.00 | 0.00 | 0.00 | 100.00 | 0.02 |
| 88 | 0.00 | 19.59 | 0.00 | 3.41 | 1.44 | 0.00 | 0.00 | 0.00 | 0.00 | 13.80 | 1.66 | 3.31 | 0.00 | 11.61 | 2.30 | 28.69 | 14.20 | 0.00 | 0.00 | 0.00 | 0.00 | 0.00 | 100.00 | 0.02 |
| 89 | 0.00 | 19.65 | 0.00 | 3.87 | 1.44 | 0.00 | 0.00 | 0.00 | 0.00 | 13.11 | 1.67 | 3.32 | 0.00 | 11.64 | 2.31 | 28.76 | 14.24 | 0.00 | 0.00 | 0.00 | 0.00 | 0.00 | 100.00 | 0.02 |
| 90 | 0.00 | 19.70 | 0.00 | 4.33 | 1.45 | 0.00 | 0.00 | 0.00 | 0.00 | 12.42 | 1.67 | 3.32 | 0.00 | 11.67 | 2.31 | 28.84 | 14.28 | 0.00 | 0.00 | 0.00 | 0.00 | 0.00 | 100.00 | 0.02 |
| 91 | 0.00 | 19.30 | 0.00 | 2.91 | 1.42 | 0.00 | 0.00 | 0.00 | 0.00 | 13.59 | 1.64 | 5.20 | 0.00 | 11.44 | 2.27 | 28.25 | 13.99 | 0.00 | 0.00 | 0.00 | 0.00 | 0.00 | 100.00 | 0.02 |
| 92 | 0.00 | 19.06 | 0.00 | 2.88 | 1.40 | 0.00 | 0.00 | 0.00 | 0.00 | 12.72 | 1.62 | 7.06 | 0.00 | 11.30 | 2.24 | 27.91 | 13.82 | 0.00 | 0.00 | 0.00 | 0.00 | 0.00 | 100.00 | 0.02 |
| 93 | 0.00 | 18.83 | 0.00 | 2.84 | 1.38 | 0.00 | 0.00 | 0.00 | 0.00 | 11.88 | 1.60 | 8.87 | 0.00 | 11.16 | 2.21 | 27.57 | 13.65 | 0.00 | 0.00 | 0.00 | 0.00 | 0.00 | 100.00 | 0.02 |
| 94 | 0.00 | 20.19 | 0.00 | 2.93 | 1.24 | 0.00 | 0.00 | 0.00 | 0.00 | 14.40 | 1.65 | 3.28 | 0.00 | 11.51 | 2.28 | 28.44 | 14.08 | 0.00 | 0.00 | 0.00 | 0.00 | 0.00 | 100.00 | 0.02 |
| 95 | 0.00 | 18.88 | 0.00 | 2.97 | 1.64 | 0.00 | 0.00 | 0.00 | 0.00 | 14.56 | 1.67 | 3.32 | 0.00 | 11.65 | 2.31 | 28.77 | 14.24 | 0.00 | 0.00 | 0.00 | 0.00 | 0.00 | 100.00 | 0.02 |
| 96 | 0.00 | 19.49 | 0.00 | 3.39 | 1.24 | 0.00 | 0.00 | 0.00 | 0.00 | 14.44 | 1.65 | 3.29 | 0.00 | 11.55 | 2.29 | 28.53 | 14.13 | 0.00 | 0.00 | 0.00 | 0.00 | 0.00 | 100.00 | 0.02 |
| 97 | 0.00 | 19.44 | 0.00 | 3.82 | 1.05 | 0.00 | 0.00 | 0.00 | 0.00 | 14.41 | 1.65 | 3.28 | 0.00 | 11.52 | 2.28 | 28.46 | 14.09 | 0.00 | 0.00 | 0.00 | 0.00 | 0.00 | 100.00 | 0.02 |
| 98 | 0.00 | 19.39 | 0.00 | 4.26 | 0.85 | 0.00 | 0.00 | 0.00 | 0.00 | 14.37 | 1.65 | 3.27 | 0.00 | 11.49 | 2.28 | 28.39 | 14.05 | 0.00 | 0.00 | 0.00 | 0.00 | 0.00 | 100.00 | 0.02 |
| 99 | 0.00 | 19.59 | 0.00 | 2.51 | 1.63 | 0.00 | 0.00 | 0.00 | 0.00 | 14.52 | 1.66 | 3.31 | 0.00 | 11.61 | 2.30 | 28.68 | 14.20 | 0.00 | 0.00 | 0.00 | 0.00 | 0.00 | 100.00 | 0.02 |
| 100 | 0.00 | 19.41 | 0.00 | 2.93 | 1.42 | 0.00 | 0.00 | 0.00 | 0.00 | 14.38 | 1.65 | 3.27 | 0.00 | 11.50 | 2.28 | 30.11 | 13.05 | 0.00 | 0.00 | 0.00 | 0.00 | 0.00 | 100.00 | 0.02 |
| 101 | 0.00 | 19.28 | 0.00 | 2.91 | 1.42 | 0.00 | 0.00 | 0.00 | 0.00 | 14.29 | 1.64 | 3.25 | 0.00 | 11.42 | 2.26 | 31.59 | 11.95 | 0.00 | 0.00 | 0.00 | 0.00 | 0.00 | 100.00 | 0.02 |
| 102 | 0.00 | 19.15 | 0.00 | 2.89 | 1.41 | 0.00 | 0.00 | 0.00 | 0.00 | 14.19 | 1.62 | 3.23 | 0.00 | 11.35 | 2.25 | 33.05 | 10.86 | 0.00 | 0.00 | 0.00 | 0.00 | 0.00 | 100.00 | 0.02 |
| 103 | 0.00 | 19.67 | 0.00 | 2.97 | 1.44 | 0.00 | 0.00 | 0.00 | 0.00 | 14.58 | 1.67 | 3.32 | 0.00 | 11.66 | 2.31 | 27.09 | 15.29 | 0.00 | 0.00 | 0.00 | 0.00 | 0.00 | 100.00 | 0.02 |
| 104 | 0.00 | 19.81 | 0.00 | 2.99 | 1.45 | 0.00 | 0.00 | 0.00 | 0.00 | 14.68 | 1.68 | 3.34 | 0.00 | 11.74 | 2.33 | 25.54 | 16.44 | 0.00 | 0.00 | 0.00 | 0.00 | 0.00 | 100.00 | 0.02 |
| 105 | 0.00 | 19.95 | 0.00 | 3.01 | 1.46 | 0.00 | 0.00 | 0.00 | 0.00 | 14.78 | 1.69 | 3.37 | 0.00 | 11.82 | 2.34 | 23.98 | 17.60 | 0.00 | 0.00 | 0.00 | 0.00 | 0.00 | 100.00 | 0.02 |
| 106 | 0.00 | 19.84 | 0.00 | 3.00 | 1.65 | 0.00 | 0.00 | 0.00 | 0.00 | 14.70 | 1.68 | 3.35 | 0.00 | 11.76 | 2.33 | 27.31 | 14.38 | 0.00 | 0.00 | 0.00 | 0.00 | 0.00 | 100.00 | 0.02 |
| 107 | 0.00 | 19.79 | 0.00 | 2.99 | 1.45 | 0.00 | 0.00 | 0.00 | 0.00 | 15.39 | 1.68 | 1.35 | 0.00 | 11.72 | 2.32 | 28.97 | 14.34 | 0.00 | 0.00 | 0.00 | 0.00 | 0.00 | 100.00 | 0.02 |
| 108 | 0.00 | 19.66 | 0.00 | 2.97 | 1.44 | 0.00 | 0.00 | 0.00 | 0.00 | 14.57 | 3.01 | 1.34 | 0.00 | 11.65 | 2.31 | 28.79 | 14.25 | 0.00 | 0.00 | 0.00 | 0.00 | 0.00 | 100.00 | 0.02 |
| 109 | 0.00 | 19.66 | 0.00 | 2.97 | 1.44 | 0.00 | 0.00 | 0.00 | 0.00 | 15.29 | 0.33 | 3.32 | 0.00 | 11.65 | 2.31 | 28.78 | 14.25 | 0.00 | 0.00 | 0.00 | 0.00 | 0.00 | 100.00 | 0.02 |
| 110 | 0.00 | 18.11 | 0.00 | 3.87 | 1.44 | 0.00 | 0.00 | 0.00 | 0.00 | 14.57 | 1.67 | 3.32 | 0.00 | 11.65 | 2.31 | 28.79 | 14.25 | 0.00 | 0.00 | 0.00 | 0.00 | 0.00 | 100.00 | 0.02 |
| 111 | 0.00 | 16.67 | 0.00 | 4.80 | 1.45 | 0.00 | 0.00 | 0.00 | 0.00 | 14.67 | 1.68 | 3.34 | 0.00 | 11.73 | 2.32 | 28.98 | 14.35 | 0.00 | 0.00 | 0.00 | 0.00 | 0.00 | 100.00 | 0.02 |
| 112 | 0.00 | 20.95 | 0.00 | 2.04 | 1.43 | 0.00 | 0.00 | 0.00 | 0.00 | 14.39 | 1.65 | 3.28 | 0.00 | 11.50 | 2.28 | 28.42 | 14.07 | 0.00 | 0.00 | 0.00 | 0.00 | 0.00 | 100.00 | 0.02 |
| 113 | 0.00 | 22.33 | 0.00 | 1.15 | 1.42 | 0.00 | 0.00 | 0.00 | 0.00 | 14.29 | 1.64 | 3.25 | 0.00 | 11.43 | 2.26 | 28.24 | 13.98 | 0.00 | 0.00 | 0.00 | 0.00 | 0.00 | 100.00 | 0.02 |
| 114 | 0.88 | 18.65 | 0.00 | 0.00 | 3.90 | 0.00 | 0.00 | 0.00 | 0.00 | 5.54 | 0.00 | 15.16 | 0.00 | 6.93 | 4.67 | 40.20 | 4.07 | 0.00 | 0.00 | 0.00 | 0.00 | 0.00 | 100.00 | 0.00 |
| 115 | 0.90 | 19.36 | 0.00 | 2.92 | 1.42 | 0.00 | 0.00 | 0.00 | 0.00 | 14.35 | 1.64 | 3.27 | 0.00 | 11.47 | 2.27 | 28.35 | 14.03 | 0.00 | 0.00 | 0.00 | 0.00 | 0.00 | 100.00 | 0.02 |
| 116 | 1.79 | 19.19 | 0.00 | 2.90 | 1.41 | 0.00 | 0.00 | 0.00 | 0.00 | 14.22 | 1.63 | 3.24 | 0.00 | 11.37 | 2.25 | 28.09 | 13.91 | 0.00 | 0.00 | 0.00 | 0.00 | 0.00 | 100.00 | 0.02 |
| 117 | 0.00 | 20.36 | 0.00 | 2.96 | 1.44 | 0.00 | 0.00 | 0.00 | 0.00 | 14.52 | 1.66 | 3.31 | 0.00 | 11.61 | 2.30 | 28.68 | 13.17 | 0.00 | 0.00 | 0.00 | 0.00 | 0.00 | 100.00 | 0.02 |
| 118 | 0.00 | 19.65 | 0.00 | 3.42 | 1.44 | 0.00 | 0.00 | 0.00 | 0.00 | 14.56 | 1.67 | 3.32 | 0.00 | 11.65 | 2.31 | 28.77 | 13.21 | 0.00 | 0.00 | 0.00 | 0.00 | 0.00 | 100.00 | 0.02 |
| 119 | 0.94 | 19.85 | 0.00 | 0.00 | 4.83 | 0.00 | 0.00 | 0.00 | 0.00 | 5.90 | 0.00 | 11.77 | 0.00 | 4.64 | 4.97 | 42.78 | 4.33 | 0.00 | 0.00 | 0.00 | 0.00 | 0.00 | 100.00 | 0.00 |
| 120 | 0.00 | 19.46 | 0.00 | 2.94 | 1.24 | 0.00 | 0.60 | 0.00 | 0.00 | 14.42 | 1.65 | 3.28 | 0.00 | 11.53 | 2.28 | 28.49 | 14.10 | 0.00 | 0.00 | 0.00 | 0.00 | 0.00 | 100.00 | 0.02 |
| 121 | 0.00 | 19.32 | 0.00 | 2.92 | 1.23 | 0.00 | 0.00 | 0.00 | 0.00 | 14.32 | 2.95 | 3.26 | 0.00 | 11.45 | 2.27 | 28.28 | 14.00 | 0.00 | 0.00 | 0.00 | 0.00 | 0.00 | 100.00 | 0.02 |
| 122 | 0.00 | 19.50 | 0.00 | 2.94 | 1.24 | 0.40 | 0.00 | 0.00 | 0.00 | 14.45 | 1.65 | 3.29 | 0.00 | 11.55 | 2.29 | 28.55 | 14.13 | 0.00 | 0.00 | 0.00 | 0.00 | 0.00 | 100.00 | 0.02 |
| 123 | 0.00 | 19.41 | 0.00 | 2.93 | 1.42 | 0.00 | 0.00 | 0.00 | 0.00 | 14.38 | 1.65 | 3.27 | 0.00 | 11.50 | 2.28 | 30.11 | 13.05 | 0.00 | 0.00 | 0.00 | 0.00 | 0.00 | 100.00 | 0.02 |
| 124 | 0.00 | 19.70 | 0.00 | 2.97 | 1.64 | 0.00 | 0.00 | 0.00 | 0.00 | 14.60 | 1.67 | 3.32 | 0.00 | 11.68 | 2.31 | 28.85 | 13.25 | 0.00 | 0.00 | 0.00 | 0.00 | 0.00 | 100.00 | 0.02 |
| 125 | 0.00 | 20.39 | 0.00 | 3.08 | 1.50 | 0.00 | 0.00 | 0.00 | 0.54 | 15.11 | 1.73 | 1.39 | 0.00 | 12.08 | 2.39 | 22.73 | 19.06 | 0.00 | 0.00 | 0.00 | 0.00 | 0.00 | 100.00 | 0.02 |
| 126 | 0.95 | 20.11 | 0.00 | 0.00 | 4.89 | 0.00 | 0.00 | 0.00 | 0.00 | 5.98 | 2.72 | 7.90 | 0.00 | 4.70 | 5.03 | 43.34 | 4.38 | 0.00 | 0.00 | 0.00 | 0.00 | 0.00 | 100.00 | 0.00 |
| 127 | 0.00 | 20.50 | 0.00 | 2.98 | 1.45 | 0.00 | 0.00 | 0.00 | 0.00 | 14.62 | 1.67 | 3.33 | 0.00 | 11.69 | 2.32 | 27.15 | 14.30 | 0.00 | 0.00 | 0.00 | 0.00 | 0.00 | 100.00 | 0.02 |
| 128 | 0.00 | 19.79 | 0.00 | 3.44 | 1.45 | 0.00 | 0.00 | 0.00 | 0.00 | 14.67 | 1.68 | 3.34 | 0.00 | 11.73 | 2.32 | 27.24 | 14.34 | 0.00 | 0.00 | 0.00 | 0.00 | 0.00 | 100.00 | 0.02 |
| 129 | 0.00 | 19.57 | 0.00 | 2.95 | 1.63 | 0.00 | 0.00 | 0.00 | 0.00 | 14.50 | 4.32 | 1.33 | 0.00 | 11.59 | 2.30 | 28.65 | 13.15 | 0.00 | 0.00 | 0.00 | 0.00 | 0.00 | 100.00 | 0.02 |
| 130 | 0.96 | 20.38 | 0.00 | 0.00 | 4.96 | 0.00 | 0.00 | 0.00 | 0.00 | 6.06 | 5.50 | 3.94 | 0.00 | 4.76 | 5.10 | 43.91 | 4.44 | 0.00 | 0.00 | 0.00 | 0.00 | 0.00 | 100.00 | 0.00 |
| 131 | 0.00 | 19.97 | 0.00 | 3.02 | 1.66 | 0.00 | 0.00 | 0.00 | 0.00 | 14.80 | 3.05 | 1.36 | 0.00 | 11.83 | 2.34 | 27.49 | 14.47 | 0.00 | 0.00 | 0.00 | 0.00 | 0.00 | 100.00 | 0.02 |
| 132 | 0.00 | 20.06 | 0.00 | 3.03 | 1.67 | 0.00 | 0.00 | 0.00 | 0.00 | 14.86 | 3.99 | 0.00 | 0.00 | 11.89 | 2.35 | 27.61 | 14.54 | 0.00 | 0.00 | 0.00 | 0.00 | 0.00 | 100.00 | 0.02 |
| 133 | 0.00 | 19.98 | 0.00 | 3.02 | 1.66 | 0.00 | 0.00 | 0.00 | 0.00 | 14.81 | 1.70 | 3.37 | 0.00 | 11.84 | 2.35 | 25.76 | 15.53 | 0.00 | 0.00 | 0.00 | 0.00 | 0.00 | 100.00 | 0.02 |
| 134 | 0.00 | 20.12 | 0.00 | 3.04 | 1.67 | 0.00 | 0.00 | 0.00 | 0.00 | 14.91 | 1.71 | 3.39 | 0.00 | 11.92 | 2.36 | 24.18 | 16.69 | 0.00 | 0.00 | 0.00 | 0.00 | 0.00 | 100.00 | 0.02 |
| 135 | 0.47 | 19.65 | 0.00 | 3.03 | 1.67 | 0.00 | 0.00 | 0.00 | 0.00 | 14.85 | 3.99 | 0.00 | 0.00 | 11.88 | 2.35 | 27.59 | 14.53 | 0.00 | 0.00 | 0.00 | 0.00 | 0.00 | 100.00 | 0.02 |
| 136 | 0.47 | 20.01 | 0.00 | 2.79 | 1.67 | 0.00 | 0.00 | 0.00 | 0.00 | 14.83 | 3.98 | 0.00 | 0.00 | 11.86 | 2.35 | 27.55 | 14.50 | 0.00 | 0.00 | 0.00 | 0.00 | 0.00 | 100.00 | 0.02 |
| 137 | 0.00 | 19.79 | 0.00 | 2.99 | 1.65 | 0.00 | 0.00 | 0.00 | 0.00 | 14.66 | 5.28 | 0.00 | 0.00 | 11.73 | 2.32 | 27.24 | 14.34 | 0.00 | 0.00 | 0.00 | 0.00 | 0.00 | 100.00 | 0.02 |
| 138 | 0.00 | 20.17 | 0.00 | 3.04 | 1.88 | 0.00 | 0.00 | 0.00 | 0.00 | 14.20 | 4.01 | 0.00 | 0.00 | 11.95 | 2.37 | 27.76 | 14.62 | 0.00 | 0.00 | 0.00 | 0.00 | 0.00 | 100.00 | 0.02 |
| 139 | 0.00 | 19.86 | 0.00 | 3.00 | 1.65 | 0.00 | 0.00 | 0.00 | 0.00 | 14.72 | 1.69 | 3.35 | 0.00 | 11.77 | 3.94 | 25.61 | 14.40 | 0.00 | 0.00 | 0.00 | 0.00 | 0.00 | 100.00 | 0.02 |
| 140 | 0.00 | 19.81 | 0.00 | 2.99 | 1.65 | 0.00 | 0.00 | 0.00 | 0.00 | 14.68 | 1.68 | 3.34 | 0.00 | 11.74 | 0.72 | 29.01 | 14.36 | 0.00 | 0.00 | 0.00 | 0.00 | 0.00 | 100.00 | 0.02 |
| 141 | 0.00 | 19.73 | 0.00 | 2.98 | 1.45 | 0.00 | 0.00 | 0.00 | 0.00 | 15.35 | 1.67 | 3.33 | 0.00 | 11.69 | 2.32 | 27.17 | 14.30 | 0.00 | 0.00 | 0.00 | 0.00 | 0.00 | 100.00 | 0.02 |
| 142 | 0.00 | 19.49 | 0.00 | 2.94 | 1.43 | 0.00 | 0.00 | 0.00 | 0.00 | 14.44 | 1.65 | 5.25 | 0.00 | 11.55 | 2.29 | 26.83 | 14.12 | 0.00 | 0.00 | 0.00 | 0.00 | 0.00 | 100.00 | 0.02 |
| 143 | 0.00 | 20.56 | 0.00 | 2.53 | 1.65 | 0.00 | 0.00 | 0.00 | 0.00 | 14.65 | 1.68 | 3.34 | 0.00 | 11.72 | 2.32 | 27.22 | 14.33 | 0.00 | 0.00 | 0.00 | 0.00 | 0.00 | 100.00 | 0.02 |
| 144 | 0.00 | 21.27 | 0.00 | 2.07 | 1.64 | 0.00 | 0.00 | 0.00 | 0.00 | 14.61 | 1.67 | 3.33 | 0.00 | 11.68 | 2.31 | 27.14 | 14.29 | 0.00 | 0.00 | 0.00 | 0.00 | 0.00 | 100.00 | 0.02 |
| 145 | 0.00 | 19.12 | 0.00 | 3.46 | 1.66 | 0.00 | 0.00 | 0.00 | 0.00 | 14.75 | 1.69 | 3.36 | 0.00 | 11.80 | 2.34 | 27.40 | 14.43 | 0.00 | 0.00 | 0.00 | 0.00 | 0.00 | 100.00 | 0.02 |
| 146 | 0.00 | 18.39 | 0.00 | 3.93 | 1.66 | 0.00 | 0.00 | 0.00 | 0.00 | 14.80 | 1.69 | 3.37 | 0.00 | 11.83 | 2.34 | 27.50 | 14.47 | 0.00 | 0.00 | 0.00 | 0.00 | 0.00 | 100.00 | 0.02 |
| 147 | 0.00 | 19.89 | 0.00 | 3.00 | 1.66 | 0.00 | 0.00 | 0.00 | 0.00 | 14.74 | 1.69 | 3.36 | 0.00 | 11.79 | 5.56 | 23.91 | 14.42 | 0.00 | 0.00 | 0.00 | 0.00 | 0.00 | 100.00 | 0.02 |
| 148 | 0.00 | 19.15 | 0.00 | 2.89 | 1.22 | 0.00 | 0.00 | 0.00 | 0.00 | 14.19 | 1.62 | 7.09 | 0.00 | 11.35 | 2.25 | 26.36 | 13.88 | 0.00 | 0.00 | 0.00 | 0.00 | 0.00 | 100.00 | 0.02 |
| 149 | 0.00 | 20.12 | 0.00 | 3.04 | 1.67 | 0.00 | 0.62 | 0.00 | 0.00 | 14.91 | 1.71 | 1.37 | 0.00 | 11.92 | 2.36 | 27.70 | 14.58 | 0.00 | 0.00 | 0.00 | 0.00 | 0.00 | 100.00 | 0.02 |
| 150 | 0.00 | 19.70 | 0.00 | 2.97 | 1.64 | 0.00 | 0.00 | 0.00 | 0.00 | 15.32 | 1.67 | 3.32 | 0.00 | 11.67 | 2.31 | 27.12 | 14.28 | 0.00 | 0.00 | 0.00 | 0.00 | 0.00 | 100.00 | 0.02 |
| 151 | 0.00 | 19.45 | 0.00 | 2.94 | 1.62 | 0.00 | 0.00 | 0.00 | 0.00 | 14.41 | 1.65 | 5.24 | 0.00 | 11.53 | 2.28 | 26.78 | 14.10 | 0.00 | 0.00 | 0.00 | 0.00 | 0.00 | 100.00 | 0.02 |
| 152 | 0.00 | 19.46 | 0.33 | 3.00 | 1.65 | 0.00 | 0.00 | 0.00 | 0.00 | 14.71 | 1.68 | 3.35 | 0.00 | 11.76 | 2.33 | 27.33 | 14.39 | 0.00 | 0.00 | 0.00 | 0.00 | 0.00 | 100.00 | 0.02 |
| 153 | 0.00 | 19.82 | 0.33 | 2.77 | 1.65 | 0.00 | 0.00 | 0.00 | 0.00 | 14.69 | 1.68 | 3.34 | 0.00 | 11.74 | 2.33 | 27.29 | 14.36 | 0.00 | 0.00 | 0.00 | 0.00 | 0.00 | 100.00 | 0.02 |
| 154 | 0.00 | 19.55 | 0.00 | 2.95 | 1.63 | 0.00 | 0.00 | 0.00 | 0.00 | 15.93 | 1.66 | 3.30 | 0.00 | 11.59 | 2.30 | 26.92 | 14.17 | 0.00 | 0.00 | 0.00 | 0.00 | 0.00 | 100.00 | 0.02 |
| 155 | 0.00 | 20.79 | 0.00 | 3.02 | 1.66 | 0.00 | 0.00 | 0.00 | 0.00 | 14.83 | 1.70 | 3.38 | 0.00 | 11.85 | 0.73 | 27.54 | 14.50 | 0.00 | 0.00 | 0.00 | 0.00 | 0.00 | 100.00 | 0.02 |
| 156 | 0.00 | 18.90 | 0.00 | 2.97 | 1.64 | 0.00 | 0.00 | 0.00 | 0.00 | 14.58 | 1.67 | 3.32 | 0.00 | 11.66 | 3.90 | 27.09 | 14.26 | 0.00 | 0.00 | 0.00 | 0.00 | 0.00 | 100.00 | 0.02 |
| 157 | 0.00 | 19.70 | 0.00 | 3.00 | 1.65 | 0.00 | 0.00 | 0.00 | 0.00 | 14.72 | 1.68 | 3.35 | 0.00 | 11.77 | 5.87 | 23.87 | 14.39 | 0.00 | 0.00 | 0.00 | 0.00 | 0.00 | 100.00 | 0.02 |
| 158 | 0.00 | 19.53 | 0.00 | 3.24 | 1.66 | 0.00 | 0.00 | 0.00 | 0.00 | 14.76 | 1.69 | 3.36 | 0.00 | 11.81 | 5.57 | 23.94 | 14.44 | 0.00 | 0.00 | 0.00 | 0.00 | 0.00 | 100.00 | 0.02 |
| 159 | 0.00 | 19.75 | 0.00 | 2.98 | 1.55 | 0.00 | 0.00 | 0.00 | 0.00 | 14.64 | 1.68 | 3.33 | 0.00 | 11.70 | 6.32 | 23.74 | 14.31 | 0.00 | 0.00 | 0.00 | 0.00 | 0.00 | 100.00 | 0.02 |
| 160 | 0.00 | 20.17 | 0.00 | 3.05 | 1.68 | 0.00 | 0.00 | 0.00 | 0.00 | 14.95 | 1.71 | 3.40 | 0.00 | 11.95 | 5.63 | 20.72 | 16.74 | 0.00 | 0.00 | 0.00 | 0.00 | 0.00 | 100.00 | 0.02 |
| 161 | 0.00 | 20.00 | 0.00 | 3.02 | 1.86 | 0.00 | 0.00 | 0.00 | 0.00 | 14.08 | 1.70 | 3.37 | 0.00 | 11.85 | 5.59 | 24.04 | 14.49 | 0.00 | 0.00 | 0.00 | 0.00 | 0.00 | 100.00 | 0.02 |
| 162 | 0.00 | 20.05 | 0.00 | 3.03 | 1.96 | 0.00 | 0.00 | 0.00 | 0.00 | 13.75 | 1.70 | 3.38 | 0.00 | 11.88 | 5.60 | 24.12 | 14.53 | 0.00 | 0.00 | 0.00 | 0.00 | 0.00 | 100.00 | 0.02 |
| 163 | 0.00 | 19.85 | 0.00 | 3.00 | 1.65 | 0.00 | 0.00 | 0.00 | 0.00 | 14.57 | 1.68 | 3.35 | 0.00 | 11.77 | 5.87 | 23.87 | 14.39 | 0.00 | 0.00 | 0.00 | 0.00 | 0.00 | 100.00 | 0.02 |
| 164 | 0.00 | 19.51 | 0.00 | 2.99 | 1.65 | 0.00 | 0.00 | 0.00 | 0.00 | 14.69 | 1.68 | 3.35 | 0.00 | 11.75 | 6.18 | 23.83 | 14.37 | 0.00 | 0.00 | 0.00 | 0.00 | 0.00 | 100.00 | 0.02 |
| 165 | 0.00 | 19.14 | 0.00 | 2.89 | 1.59 | 0.00 | 0.00 | 0.00 | 0.00 | 14.18 | 1.62 | 3.23 | 0.00 | 11.34 | 2.25 | 26.34 | 11.86 | 0.00 | 0.00 | 5.56 | 0.00 | 0.00 | 100.00 | 0.02 |
| 166 | 0.00 | 19.39 | 0.00 | 2.93 | 1.61 | 0.00 | 0.00 | 0.00 | 0.00 | 14.37 | 1.65 | 3.27 | 0.00 | 11.49 | 2.28 | 23.32 | 14.06 | 0.00 | 0.00 | 5.63 | 0.00 | 0.00 | 100.00 | 0.02 |
| 167 | 0.00 | 19.08 | 0.00 | 2.88 | 1.59 | 0.00 | 0.00 | 0.00 | 0.00 | 14.14 | 1.62 | 3.22 | 0.00 | 11.31 | 2.24 | 26.28 | 11.83 | 0.00 | 0.00 | 0.00 | 5.81 | 0.00 | 100.00 | 0.02 |
| 168 | 0.00 | 19.34 | 0.00 | 2.92 | 1.61 | 0.00 | 0.00 | 0.00 | 0.00 | 14.33 | 1.64 | 3.26 | 0.00 | 11.46 | 2.27 | 23.26 | 14.02 | 0.00 | 0.00 | 0.00 | 5.89 | 0.00 | 100.00 | 0.02 |
| 169 | 0.00 | 19.99 | 0.00 | 3.02 | 1.76 | 0.00 | 0.00 | 0.00 | 0.00 | 14.82 | 1.70 | 3.37 | 0.00 | 11.85 | 2.35 | 26.65 | 14.49 | 0.00 | 0.00 | 0.00 | 0.00 | 0.00 | 100.00 | 0.02 |
| 170 | 0.00 | 19.81 | 0.00 | 2.99 | 1.65 | 0.00 | 0.00 | 0.00 | 0.00 | 14.68 | 1.68 | 4.34 | 0.00 | 11.74 | 2.33 | 26.42 | 14.36 | 0.00 | 0.00 | 0.00 | 0.00 | 0.00 | 100.00 | 0.02 |
| 171 | 0.00 | 19.94 | 0.00 | 3.01 | 1.66 | 0.00 | 0.00 | 0.00 | 0.00 | 15.14 | 1.69 | 3.36 | 0.00 | 11.82 | 2.34 | 26.59 | 14.45 | 0.00 | 0.00 | 0.00 | 0.00 | 0.00 | 100.00 | 0.02 |
| 172 | 0.00 | 19.97 | 0.00 | 3.24 | 1.66 | 0.00 | 0.00 | 0.00 | 0.00 | 14.80 | 1.69 | 3.37 | 0.00 | 11.83 | 2.34 | 26.63 | 14.47 | 0.00 | 0.00 | 0.00 | 0.00 | 0.00 | 100.00 | 0.02 |
| 173 | 0.00 | 19.61 | 0.00 | 3.05 | 1.98 | 0.00 | 0.00 | 0.00 | 0.00 | 14.95 | 1.71 | 3.40 | 0.00 | 11.95 | 2.37 | 26.36 | 14.62 | 0.00 | 0.00 | 0.00 | 0.00 | 0.00 | 100.00 | 0.02 |
| 174 | 0.00 | 19.77 | 0.00 | 3.02 | 1.76 | 0.00 | 0.00 | 0.00 | 0.00 | 14.80 | 1.69 | 3.37 | 0.00 | 11.83 | 3.96 | 25.33 | 14.47 | 0.00 | 0.00 | 0.00 | 0.00 | 0.00 | 100.00 | 0.02 |
| 175 | 0.00 | 19.93 | 0.00 | 2.86 | 1.76 | 0.00 | 0.00 | 0.00 | 0.00 | 14.77 | 1.69 | 3.36 | 0.00 | 11.81 | 3.95 | 25.42 | 14.45 | 0.00 | 0.00 | 0.00 | 0.00 | 0.00 | 100.00 | 0.02 |
| 176 | 0.00 | 19.67 | 0.00 | 3.03 | 1.87 | 0.00 | 0.00 | 0.00 | 0.00 | 14.87 | 1.70 | 3.39 | 0.00 | 11.89 | 3.17 | 25.87 | 14.54 | 0.00 | 0.00 | 0.00 | 0.00 | 0.00 | 100.00 | 0.02 |
| 177 | 0.00 | 19.37 | 0.00 | 3.06 | 2.08 | 0.00 | 0.00 | 0.00 | 0.00 | 15.01 | 1.72 | 3.42 | 0.00 | 12.00 | 2.38 | 26.28 | 14.68 | 0.00 | 0.00 | 0.00 | 0.00 | 0.00 | 100.00 | 0.02 |
| 178 | 0.00 | 19.18 | 0.00 | 3.07 | 2.19 | 0.00 | 0.00 | 0.00 | 0.00 | 15.08 | 1.73 | 3.43 | 0.00 | 12.05 | 2.39 | 26.14 | 14.74 | 0.00 | 0.00 | 0.00 | 0.00 | 0.00 | 100.00 | 0.02 |
| 179 | 0.00 | 19.64 | 0.00 | 3.01 | 1.76 | 0.00 | 0.00 | 0.00 | 0.00 | 14.79 | 1.69 | 3.37 | 0.00 | 11.82 | 4.77 | 24.69 | 14.46 | 0.00 | 0.00 | 0.00 | 0.00 | 0.00 | 100.00 | 0.02 |
| 180 | 0.00 | 19.55 | 0.00 | 3.01 | 1.76 | 0.00 | 0.00 | 0.00 | 0.00 | 14.78 | 1.69 | 3.37 | 0.00 | 11.82 | 5.57 | 23.99 | 14.46 | 0.00 | 0.00 | 0.00 | 0.00 | 0.00 | 100.00 | 0.02 |
| 181 | 0.00 | 19.51 | 0.00 | 3.04 | 1.92 | 0.00 | 0.00 | 0.00 | 0.00 | 14.90 | 1.71 | 3.39 | 0.00 | 11.91 | 3.58 | 25.47 | 14.57 | 0.00 | 0.00 | 0.00 | 0.00 | 0.00 | 100.00 | 0.02 |
| 182 | 0.00 | 19.34 | 0.00 | 3.04 | 1.97 | 0.00 | 0.00 | 0.00 | 0.00 | 14.92 | 1.71 | 3.40 | 0.00 | 11.93 | 3.99 | 25.10 | 14.60 | 0.00 | 0.00 | 0.00 | 0.00 | 0.00 | 100.00 | 0.02 |
| 183 | 0.00 | 19.18 | 0.00 | 3.05 | 2.03 | 0.00 | 0.00 | 0.00 | 0.00 | 14.95 | 1.71 | 3.40 | 0.00 | 11.96 | 4.41 | 24.69 | 14.62 | 0.00 | 0.00 | 0.00 | 0.00 | 0.00 | 100.00 | 0.02 |
| 184 | 0.00 | 19.01 | 0.00 | 3.05 | 2.08 | 0.00 | 0.00 | 0.00 | 0.00 | 14.98 | 1.71 | 3.41 | 0.00 | 11.98 | 4.83 | 24.30 | 14.65 | 0.00 | 0.00 | 0.00 | 0.00 | 0.00 | 100.00 | 0.02 |
| 185 | 0.00 | 19.02 | 0.00 | 2.87 | 1.58 | 0.00 | 0.00 | 0.00 | 0.00 | 12.70 | 1.61 | 3.21 | 0.00 | 11.27 | 2.23 | 26.20 | 13.79 | 0.00 | 0.00 | 5.52 | 0.00 | 0.00 | 100.00 | 0.02 |
| 186 | 0.00 | 19.39 | 0.00 | 2.93 | 1.61 | 0.00 | 0.00 | 0.00 | 0.00 | 14.37 | 1.65 | 3.27 | 0.00 | 11.49 | 2.28 | 23.32 | 14.06 | 0.00 | 0.00 | 5.63 | 0.00 | 0.00 | 100.00 | 0.02 |
| 187 | 0.00 | 20.12 | 0.00 | 3.04 | 1.77 | 0.00 | 0.00 | 0.00 | 0.00 | 14.91 | 3.08 | 1.37 | 0.00 | 11.93 | 2.36 | 26.83 | 14.59 | 0.00 | 0.00 | 0.00 | 0.00 | 0.00 | 100.00 | 0.02 |
| 188 | 0.00 | 19.75 | 0.00 | 2.98 | 1.74 | 0.00 | 0.00 | 0.00 | 0.00 | 12.45 | 7.06 | 1.34 | 0.00 | 11.70 | 2.32 | 26.34 | 14.32 | 0.00 | 0.00 | 0.00 | 0.00 | 0.00 | 100.00 | 0.02 |
| 189 | 0.00 | 19.39 | 0.00 | 3.21 | 1.74 | 0.00 | 0.00 | 0.00 | 0.00 | 12.48 | 7.07 | 1.35 | 0.00 | 11.72 | 2.32 | 26.38 | 14.34 | 0.00 | 0.00 | 0.00 | 0.00 | 0.00 | 100.00 | 0.02 |
| 190 | 0.00 | 19.78 | 0.00 | 3.13 | 1.76 | 0.00 | 0.00 | 0.00 | 0.00 | 13.85 | 4.82 | 1.36 | 0.00 | 11.84 | 2.35 | 26.63 | 14.48 | 0.00 | 0.00 | 0.00 | 0.00 | 0.00 | 100.00 | 0.02 |
| 191 | 0.00 | 20.17 | 0.00 | 3.00 | 1.75 | 0.00 | 0.00 | 0.00 | 0.00 | 14.73 | 1.69 | 3.35 | 0.00 | 11.78 | 2.33 | 26.50 | 14.70 | 0.00 | 0.00 | 0.00 | 0.00 | 0.00 | 100.00 | 0.02 |
| 192 | 0.00 | 19.54 | 0.00 | 2.95 | 1.43 | 0.00 | 0.00 | 0.00 | 0.00 | 13.04 | 1.66 | 3.30 | 0.00 | 15.76 | 2.29 | 21.77 | 18.26 | 0.00 | 0.00 | 0.00 | 0.00 | 0.00 | 100.00 | 0.02 |

TABLE 2

| | | | | | | | | | (SiO₂ + |
|---|---|---|---|---|---|---|---|---|---|
| | | | | | | | | (SiO₂ + | B₂O₃)/ |
| | | | | | | | | B₂O₃)/ | (TiO₂ + |
| | | | | | | TiO₂ + | | (TiO₂ + | Nb₂O₅ + |
| | | | | | | Nb₂O₅ + | ZrO₂/ | Nb₂O₅ + | Ta₂O₅ + |
| | | | Re₂O₃/ | | | Ta₂O₅ + | (La₂O₃ + | Ta₂O₅ + | WO₃ + |
| | La₂O₃/ | B₂O₃/ | (B₂O₃ + | | BaO + | WO₃ + | Gd₂O₃ + | WO₃ + | Bi₂O₃ + |
| No. | B₂O₃ | La₂O₃ | Re₂O₃) | Re₂O₃ | Re₂O₃ | Bi₂O₃ | Y2O₃) | Bi₂O₃) | ZrO₂) |
| 1 | 2.32 | 0.43 | 0.70 | 3.28 | 16.64 | 42.33 | 0.71 | 0.52 | 0.49 |
| 2 | 3.71 | 0.27 | 0.79 | 7.66 | 15.14 | 38.32 | 0.43 | 0.64 | 0.58 |
| 3 | 2.32 | 0.43 | 0.70 | 3.32 | 16.87 | 41.52 | 0.71 | 0.54 | 0.51 |
| 4 | 2.32 | 0.43 | 0.70 | 3.23 | 16.41 | 43.12 | 0.71 | 0.51 | 0.48 |
| 5 | 2.32 | 0.43 | 0.70 | 3.19 | 16.19 | 43.89 | 0.71 | 0.49 | 0.47 |
| 6 | 2.32 | 0.43 | 0.70 | 3.10 | 15.77 | 45.36 | 0.71 | 0.46 | 0.44 |
| 7 | 2.32 | 0.43 | 0.70 | 3.44 | 17.49 | 39.39 | 0.71 | 0.59 | 0.55 |
| 8 | 2.32 | 0.43 | 0.70 | 3.28 | 16.70 | 41.42 | 0.71 | 0.53 | 0.51 |
| 9 | 2.32 | 0.43 | 0.70 | 3.29 | 16.75 | 40.49 | 0.71 | 0.55 | 0.52 |
| 10 | 2.32 | 0.43 | 0.70 | 3.26 | 16.59 | 41.14 | 0.71 | 0.53 | 0.51 |
| 11 | 2.32 | 0.43 | 0.70 | 3.24 | 16.48 | 40.89 | 0.71 | 0.53 | 0.51 |
| 12 | 2.32 | 0.43 | 0.70 | 3.24 | 16.50 | 40.93 | 0.71 | 0.50 | 0.47 |
| 13 | 6.53 | 0.15 | 0.87 | 3.22 | 16.39 | 40.66 | 0.71 | 0.51 | 0.49 |
| 14 | 2.32 | 0.43 | 0.70 | 3.20 | 16.31 | 40.46 | 0.71 | 0.53 | 0.51 |
| 15 | 2.32 | 0.43 | 0.70 | 3.19 | 16.26 | 41.69 | 0.71 | 0.52 | 0.49 |
| 16 | 2.32 | 0.43 | 0.70 | 3.17 | 12.27 | 46.48 | 0.71 | 0.46 | 0.44 |
| 17 | 2.32 | 0.43 | 0.70 | 3.17 | 12.26 | 46.43 | 0.71 | 0.49 | 0.47 |
| 18 | 2.32 | 0.43 | 0.70 | 3.28 | 14.69 | 41.41 | 0.71 | 0.53 | 0.51 |
| 19 | 2.32 | 0.43 | 0.70 | 3.32 | 12.84 | 41.94 | 0.71 | 0.53 | 0.51 |
| 20 | 2.32 | 0.43 | 0.70 | 3.28 | 14.68 | 41.39 | 0.71 | 0.55 | 0.52 |
| 21 | 2.32 | 0.43 | 0.70 | 3.32 | 12.83 | 41.90 | 0.71 | 0.57 | 0.54 |
| 22 | 2.32 | 0.43 | 0.70 | 3.17 | 16.14 | 40.04 | 0.71 | 0.53 | 0.51 |
| 23 | 3.83 | 0.26 | 0.79 | 5.34 | 16.59 | 40.84 | 0.43 | 0.53 | 0.51 |
| 24 | 5.34 | 0.19 | 0.84 | 7.44 | 16.69 | 40.79 | 0.31 | 0.53 | 0.51 |
| 25 | 3.83 | 0.26 | 0.79 | 5.27 | 18.34 | 40.33 | 0.43 | 0.53 | 0.51 |
| 26 | 2.32 | 0.43 | 0.70 | 3.21 | 16.34 | 40.54 | 1.21 | 0.53 | 0.49 |
| 27 | 3.83 | 0.26 | 0.79 | 5.32 | 18.50 | 40.68 | 0.13 | 0.53 | 0.53 |
| 28 | 2.32 | 0.43 | 0.70 | 3.22 | 16.38 | 40.64 | 0.71 | 0.53 | 0.51 |
| 29 | 2.32 | 0.43 | 0.70 | 3.26 | 14.59 | 41.15 | 0.71 | 0.53 | 0.51 |
| 30 | 2.32 | 0.43 | 0.70 | 3.20 | 18.24 | 40.38 | 0.71 | 0.53 | 0.51 |
| 31 | 5.34 | 0.19 | 0.84 | 7.25 | 20.14 | 39.79 | 0.31 | 0.53 | 0.51 |
| 32 | 1.75 | 0.57 | 0.64 | 3.25 | 16.54 | 41.02 | 0.71 | 0.53 | 0.50 |
| 33 | 3.42 | 0.29 | 0.77 | 3.23 | 16.43 | 40.75 | 0.71 | 0.54 | 0.51 |
| 34 | 2.32 | 0.43 | 0.70 | 3.23 | 16.43 | 40.75 | 0.71 | 0.53 | 0.51 |
| 35 | 3.83 | 0.26 | 0.79 | 5.34 | 16.58 | 40.82 | 0.43 | 0.55 | 0.52 |
| 36 | 2.89 | 0.35 | 0.74 | 5.36 | 16.63 | 40.95 | 0.43 | 0.55 | 0.52 |
| 37 | 3.83 | 0.26 | 0.79 | 5.36 | 16.64 | 40.97 | 0.43 | 0.53 | 0.51 |
| 38 | 2.32 | 0.43 | 0.70 | 3.27 | 16.66 | 41.33 | 0.71 | 0.53 | 0.51 |
| 39 | 2.32 | 0.43 | 0.70 | 3.14 | 15.97 | 39.62 | 0.71 | 0.53 | 0.51 |
| 40 | 2.32 | 0.43 | 0.70 | 3.11 | 15.85 | 39.32 | 0.71 | 0.53 | 0.51 |
| 41 | 3.83 | 0.26 | 0.79 | 5.17 | 17.96 | 39.50 | 0.43 | 0.53 | 0.51 |
| 42 | 2.58 | 0.39 | 0.72 | 5.23 | 16.24 | 42.17 | 0.43 | 0.50 | 0.48 |
| 43 | 5.34 | 0.19 | 0.84 | 7.11 | 19.74 | 38.98 | 0.31 | 0.53 | 0.51 |
| 44 | 3.83 | 0.26 | 0.79 | 5.10 | 17.75 | 39.04 | 0.43 | 0.53 | 0.51 |
| 45 | 3.83 | 0.26 | 0.79 | 5.05 | 17.55 | 38.58 | 0.43 | 0.53 | 0.51 |
| 46 | 3.83 | 0.26 | 0.79 | 5.10 | 17.73 | 40.29 | 0.43 | 0.52 | 0.49 |
| 47 | 3.83 | 0.26 | 0.79 | 5.03 | 17.50 | 41.06 | 0.43 | 0.50 | 0.48 |
| 48 | 5.34 | 0.19 | 0.84 | 7.15 | 19.86 | 37.58 | 0.31 | 0.56 | 0.53 |
| 49 | 5.34 | 0.19 | 0.84 | 7.11 | 19.73 | 37.99 | 0.31 | 0.55 | 0.52 |
| 50 | 6.84 | 0.15 | 0.87 | 9.00 | 21.46 | 38.47 | 0.24 | 0.53 | 0.51 |
| 51 | 8.35 | 0.12 | 0.89 | 10.84 | 23.15 | 37.98 | 0.20 | 0.53 | 0.51 |
| 52 | 5.34 | 0.19 | 0.84 | 7.14 | 19.84 | 39.18 | 0.10 | 0.53 | 0.53 |
| 53 | 4.59 | 0.22 | 0.82 | 7.15 | 19.86 | 38.39 | 0.31 | 0.55 | 0.52 |
| 54 | 4.59 | 0.22 | 0.82 | 7.13 | 19.79 | 38.59 | 0.31 | 0.55 | 0.52 |
| 55 | 4.59 | 0.22 | 0.82 | 7.15 | 19.84 | 39.19 | 0.20 | 0.54 | 0.52 |
| 56 | 5.34 | 0.19 | 0.84 | 6.93 | 19.23 | 40.54 | 0.31 | 0.50 | 0.48 |
| 57 | 3.60 | 0.28 | 0.78 | 7.19 | 18.06 | 41.60 | 0.31 | 0.50 | 0.48 |
| 58 | 2.58 | 0.39 | 0.77 | 6.61 | 17.55 | 41.87 | 0.34 | 0.50 | 0.48 |
| 59 | 3.24 | 0.31 | 0.76 | 7.21 | 18.11 | 41.22 | 0.31 | 0.52 | 0.49 |
| 60 | 3.60 | 0.28 | 0.78 | 7.20 | 18.08 | 41.16 | 0.31 | 0.52 | 0.49 |
| 61 | 3.60 | 0.28 | 0.78 | 7.24 | 16.25 | 41.86 | 0.31 | 0.50 | 0.48 |
| 62 | 3.24 | 0.31 | 0.76 | 7.24 | 18.17 | 41.03 | 0.31 | 0.52 | 0.49 |
| 63 | 3.60 | 0.28 | 0.78 | 7.23 | 18.14 | 40.96 | 0.31 | 0.52 | 0.50 |
| 64 | 3.24 | 0.31 | 0.76 | 7.23 | 18.16 | 41.84 | 0.20 | 0.51 | 0.49 |
| 65 | 3.60 | 0.28 | 0.78 | 7.22 | 18.13 | 41.77 | 0.20 | 0.51 | 0.50 |
| 66 | 3.60 | 0.28 | 0.78 | 7.21 | 18.10 | 41.69 | 0.31 | 0.50 | 0.48 |
| 67 | 3.60 | 0.28 | 0.78 | 7.25 | 18.21 | 41.94 | 0.31 | 0.50 | 0.48 |
| 68 | 3.60 | 0.28 | 0.78 | 7.30 | 16.38 | 42.20 | 0.31 | 0.50 | 0.48 |
| 69 | 3.60 | 0.28 | 0.81 | 8.65 | 17.65 | 41.82 | 0.26 | 0.50 | 0.48 |
| 70 | 3.60 | 0.28 | 0.78 | 7.22 | 18.13 | 41.77 | 0.31 | 0.50 | 0.48 |
| 71 | 3.60 | 0.28 | 0.78 | 7.25 | 18.20 | 41.94 | 0.31 | 0.50 | 0.48 |
| 72 | 3.60 | 0.28 | 0.78 | 7.40 | 14.64 | 42.81 | 0.31 | 0.50 | 0.48 |
| 73 | 3.60 | 0.28 | 0.78 | 7.51 | 12.86 | 43.44 | 0.31 | 0.50 | 0.48 |
| 74 | 5.12 | 0.20 | 0.84 | 10.23 | 18.21 | 41.53 | 0.22 | 0.50 | 0.48 |
| 75 | 5.63 | 0.18 | 0.85 | 11.24 | 18.26 | 41.51 | 0.20 | 0.50 | 0.48 |
| 76 | 5.12 | 0.20 | 0.84 | 10.17 | 19.05 | 41.28 | 0.22 | 0.50 | 0.48 |
| 77 | 3.60 | 0.28 | 0.78 | 7.30 | 18.33 | 41.39 | 0.31 | 0.52 | 0.50 |
| 78 | 5.63 | 0.18 | 0.85 | 11.10 | 19.93 | 41.01 | 0.20 | 0.50 | 0.48 |
| 79 | 5.63 | 0.18 | 0.85 | 11.17 | 19.10 | 41.26 | 0.20 | 0.50 | 0.48 |
| 80 | 5.63 | 0.18 | 0.85 | 11.15 | 20.01 | 41.18 | 0.13 | 0.50 | 0.49 |
| 81 | 5.63 | 0.18 | 0.85 | 11.15 | 20.02 | 40.38 | 0.20 | 0.52 | 0.49 |
| 82 | 3.92 | 0.25 | 0.80 | 11.58 | 14.88 | 42.77 | 0.20 | 0.53 | 0.50 |
| 83 | 5.63 | 0.18 | 0.85 | 11.50 | 14.78 | 42.49 | 0.20 | 0.54 | 0.51 |
| 84 | 2.58 | 0.39 | 0.72 | 5.23 | 16.24 | 42.17 | 0.43 | 0.50 | 0.48 |
| 85 | 3.60 | 0.28 | 0.78 | 7.19 | 18.06 | 41.60 | 0.31 | 0.50 | 0.48 |
| 86 | 3.92 | 0.25 | 0.80 | 11.57 | 14.87 | 42.75 | 0.20 | 0.54 | 0.52 |
| 87 | 3.92 | 0.25 | 0.80 | 11.57 | 14.86 | 42.72 | 0.20 | 0.56 | 0.53 |
| 88 | 3.41 | 0.29 | 0.77 | 11.61 | 14.92 | 42.89 | 0.20 | 0.54 | 0.51 |
| 89 | 3.01 | 0.33 | 0.75 | 11.64 | 14.96 | 43.00 | 0.20 | 0.55 | 0.52 |
| 90 | 2.70 | 0.37 | 0.73 | 11.67 | 15.00 | 43.12 | 0.20 | 0.56 | 0.53 |
| 91 | 3.92 | 0.25 | 0.80 | 11.44 | 16.64 | 42.24 | 0.20 | 0.53 | 0.50 |
| 92 | 3.92 | 0.25 | 0.80 | 11.30 | 18.35 | 41.73 | 0.20 | 0.53 | 0.50 |
| 93 | 3.92 | 0.25 | 0.80 | 11.16 | 20.03 | 41.22 | 0.20 | 0.53 | 0.50 |
| 94 | 3.92 | 0.25 | 0.80 | 11.51 | 14.79 | 42.52 | 0.20 | 0.54 | 0.52 |
| 95 | 3.92 | 0.25 | 0.80 | 11.65 | 14.96 | 43.02 | 0.20 | 0.51 | 0.48 |
| 96 | 3.41 | 0.29 | 0.77 | 11.55 | 14.84 | 42.66 | 0.20 | 0.54 | 0.51 |
| 97 | 3.01 | 0.33 | 0.75 | 11.52 | 14.80 | 42.55 | 0.20 | 0.55 | 0.52 |
| 98 | 2.70 | 0.37 | 0.73 | 11.49 | 14.76 | 42.44 | 0.20 | 0.56 | 0.53 |
| 99 | 4.63 | 0.22 | 0.82 | 11.61 | 14.91 | 42.88 | 0.20 | 0.52 | 0.49 |
| 100 | 3.92 | 0.25 | 0.80 | 11.50 | 14.77 | 43.16 | 0.20 | 0.52 | 0.49 |
| 101 | 3.92 | 0.25 | 0.80 | 11.42 | 14.68 | 43.54 | 0.20 | 0.51 | 0.48 |
| 102 | 3.92 | 0.25 | 0.80 | 11.35 | 14.58 | 43.91 | 0.20 | 0.50 | 0.48 |
| 103 | 3.92 | 0.25 | 0.80 | 11.66 | 14.98 | 42.38 | 0.20 | 0.53 | 0.51 |
| 104 | 3.92 | 0.25 | 0.80 | 11.74 | 15.08 | 41.98 | 0.20 | 0.54 | 0.51 |
| 105 | 3.92 | 0.25 | 0.80 | 11.82 | 15.19 | 41.58 | 0.20 | 0.55 | 0.52 |
| 106 | 3.92 | 0.25 | 0.80 | 11.76 | 15.10 | 41.69 | 0.20 | 0.55 | 0.52 |
| 107 | 3.92 | 0.25 | 0.80 | 11.72 | 13.07 | 43.31 | 0.20 | 0.53 | 0.50 |
| 108 | 3.92 | 0.25 | 0.80 | 11.65 | 12.99 | 43.04 | 0.20 | 0.53 | 0.50 |
| 109 | 3.92 | 0.25 | 0.80 | 11.65 | 14.97 | 43.03 | 0.20 | 0.53 | 0.50 |
| 110 | 3.01 | 0.33 | 0.75 | 11.65 | 14.97 | 43.05 | 0.20 | 0.51 | 0.48 |
| 111 | 2.44 | 0.41 | 0.71 | 11.73 | 15.07 | 43.33 | 0.20 | 0.50 | 0.47 |
| 112 | 5.63 | 0.18 | 0.85 | 11.50 | 14.78 | 42.49 | 0.20 | 0.54 | 0.51 |
| 113 | 9.96 | 0.10 | 0.91 | 11.43 | 14.68 | 42.22 | 0.20 | 0.56 | 0.53 |
| 114 | #DIV/0! | 0.00 | 1.00 | 6.93 | 22.09 | 44.26 | 0.67 | 0.42 | 0.38 |
| 115 | 3.92 | 0.25 | 0.80 | 11.47 | 14.74 | 42.38 | 0.20 | 0.53 | 0.50 |
| 116 | 3.92 | 0.25 | 0.80 | 11.37 | 14.61 | 42.00 | 0.20 | 0.53 | 0.50 |
| 117 | 3.92 | 0.25 | 0.80 | 11.61 | 14.91 | 41.85 | 0.20 | 0.56 | 0.53 |
| 118 | 3.41 | 0.29 | 0.77 | 11.65 | 14.96 | 41.99 | 0.20 | 0.55 | 0.52 |
| 119 | #DIV/0! | 0.00 | 1.00 | 4.64 | 16.41 | 47.11 | 1.07 | 0.42 | 0.38 |
| 120 | 3.92 | 0.25 | 0.80 | 11.53 | 14.81 | 42.59 | 0.20 | 0.53 | 0.50 |
| 121 | 3.92 | 0.25 | 0.80 | 11.45 | 14.71 | 42.29 | 0.20 | 0.53 | 0.50 |
| 122 | 3.92 | 0.25 | 0.80 | 11.55 | 14.84 | 42.68 | 0.20 | 0.53 | 0.50 |
| 123 | 3.92 | 0.25 | 0.80 | 11.50 | 14.77 | 43.16 | 0.20 | 0.52 | 0.49 |
| 124 | 3.92 | 0.25 | 0.80 | 11.68 | 15.00 | 42.09 | 0.20 | 0.54 | 0.51 |
| 125 | 3.92 | 0.25 | 0.80 | 12.08 | 13.47 | 41.79 | 0.20 | 0.56 | 0.53 |
| 126 | #DIV/0! | 0.00 | 1.00 | 4.70 | 12.60 | 47.72 | 1.07 | 0.42 | 0.38 |
| 127 | 3.92 | 0.25 | 0.80 | 11.69 | 15.02 | 41.45 | 0.20 | 0.57 | 0.54 |
| 128 | 3.41 | 0.29 | 0.77 | 11.73 | 15.07 | 41.59 | 0.20 | 0.56 | 0.53 |
| 129 | 3.92 | 0.25 | 0.80 | 11.59 | 12.93 | 41.80 | 0.20 | 0.54 | 0.51 |
| 130 | #DIV/0! | 0.00 | 1.00 | 4.76 | 8.70 | 48.35 | 1.07 | 0.42 | 0.38 |
| 131 | 3.92 | 0.25 | 0.80 | 11.83 | 13.19 | 41.97 | 0.20 | 0.55 | 0.52 |
| 132 | 3.92 | 0.25 | 0.80 | 11.89 | 11.89 | 42.15 | 0.20 | 0.55 | 0.52 |
| 133 | 3.92 | 0.25 | 0.80 | 11.84 | 15.21 | 41.29 | 0.20 | 0.56 | 0.53 |
| 134 | 3.92 | 0.25 | 0.80 | 11.92 | 15.32 | 40.88 | 0.20 | 0.57 | 0.54 |
| 135 | 3.92 | 0.25 | 0.80 | 11.88 | 11.88 | 42.12 | 0.20 | 0.54 | 0.51 |
| 136 | 4.25 | 0.24 | 0.81 | 11.86 | 11.86 | 42.05 | 0.20 | 0.54 | 0.51 |
| 137 | 3.92 | 0.25 | 0.80 | 11.73 | 11.73 | 41.58 | 0.20 | 0.55 | 0.52 |
| 138 | 3.92 | 0.25 | 0.80 | 11.95 | 11.95 | 42.38 | 0.20 | 0.55 | 0.52 |
| 139 | 3.92 | 0.25 | 0.80 | 11.77 | 15.12 | 40.01 | 0.33 | 0.57 | 0.52 |
| 140 | 3.92 | 0.25 | 0.80 | 11.74 | 15.09 | 43.37 | 0.06 | 0.53 | 0.52 |
| 141 | 3.92 | 0.25 | 0.80 | 11.69 | 15.02 | 41.47 | 0.20 | 0.55 | 0.52 |
| 142 | 3.92 | 0.25 | 0.80 | 11.55 | 16.80 | 40.96 | 0.20 | 0.55 | 0.52 |
| 143 | 4.63 | 0.22 | 0.82 | 11.72 | 15.05 | 41.56 | 0.20 | 0.56 | 0.53 |
| 144 | 5.63 | 0.18 | 0.85 | 11.68 | 15.01 | 41.42 | 0.20 | 0.56 | 0.53 |
| 145 | 3.41 | 0.29 | 0.77 | 11.80 | 15.15 | 41.83 | 0.20 | 0.54 | 0.51 |
| 146 | 3.01 | 0.33 | 0.75 | 11.83 | 15.20 | 41.97 | 0.20 | 0.53 | 0.50 |
| 147 | 3.92 | 0.25 | 0.80 | 11.79 | 15.14 | 38.33 | 0.47 | 0.60 | 0.52 |
| 148 | 3.92 | 0.25 | 0.80 | 11.35 | 18.44 | 40.24 | 0.20 | 0.55 | 0.52 |
| 149 | 3.92 | 0.25 | 0.80 | 11.92 | 13.29 | 42.28 | 0.20 | 0.55 | 0.52 |
| 150 | 3.92 | 0.25 | 0.80 | 11.67 | 14.99 | 41.39 | 0.20 | 0.55 | 0.52 |
| 151 | 3.92 | 0.25 | 0.80 | 11.53 | 16.77 | 40.88 | 0.20 | 0.55 | 0.52 |
| 152 | 3.92 | 0.25 | 0.80 | 11.76 | 15.11 | 41.72 | 0.20 | 0.54 | 0.51 |
| 153 | 4.25 | 0.24 | 0.81 | 11.74 | 15.09 | 41.65 | 0.20 | 0.54 | 0.51 |
| 154 | 3.92 | 0.25 | 0.80 | 11.59 | 14.89 | 41.09 | 0.20 | 0.55 | 0.52 |
| 155 | 3.92 | 0.25 | 0.80 | 11.85 | 15.23 | 42.04 | 0.06 | 0.57 | 0.56 |
| 156 | 3.92 | 0.25 | 0.80 | 11.66 | 14.98 | 41.35 | 0.33 | 0.53 | 0.48 |
| 157 | 3.92 | 0.25 | 0.80 | 11.77 | 15.12 | 38.26 | 0.50 | 0.59 | 0.51 |
| 158 | 3.65 | 0.27 | 0.78 | 11.81 | 15.17 | 38.39 | 0.47 | 0.59 | 0.52 |
| 159 | 3.92 | 0.25 | 0.80 | 11.70 | 15.04 | 38.06 | 0.54 | 0.60 | 0.51 |
| 160 | 3.92 | 0.25 | 0.80 | 11.95 | 15.36 | 37.46 | 0.47 | 0.62 | 0.54 |
| 161 | 3.92 | 0.25 | 0.80 | 11.85 | 15.22 | 38.53 | 0.47 | 0.60 | 0.52 |
| 162 | 3.92 | 0.25 | 0.80 | 11.88 | 15.27 | 38.64 | 0.47 | 0.60 | 0.52 |
| 163 | 3.92 | 0.25 | 0.80 | 11.77 | 15.12 | 38.26 | 0.50 | 0.60 | 0.52 |
| 164 | 3.92 | 0.25 | 0.80 | 11.75 | 15.09 | 38.20 | 0.53 | 0.59 | 0.51 |
| 165 | 3.92 | 0.25 | 0.80 | 11.34 | 14.57 | 43.76 | 0.20 | 0.50 | 0.48 |
| 166 | 3.92 | 0.25 | 0.80 | 11.49 | 14.77 | 43.00 | 0.20 | 0.52 | 0.49 |
| 167 | 3.92 | 0.25 | 0.80 | 11.31 | 14.53 | 43.92 | 0.20 | 0.50 | 0.48 |
| 168 | 3.92 | 0.25 | 0.80 | 11.46 | 14.72 | 43.16 | 0.20 | 0.52 | 0.49 |
| 169 | 3.92 | 0.25 | 0.80 | 11.85 | 15.22 | 41.14 | 0.20 | 0.56 | 0.53 |
| 170 | 3.92 | 0.25 | 0.80 | 11.74 | 16.08 | 40.77 | 0.20 | 0.56 | 0.53 |
| 171 | 3.92 | 0.25 | 0.80 | 11.82 | 15.18 | 41.03 | 0.20 | 0.56 | 0.53 |
| 172 | 3.65 | 0.27 | 0.78 | 11.83 | 15.20 | 41.09 | 0.20 | 0.56 | 0.53 |
| 173 | 3.92 | 0.25 | 0.80 | 11.95 | 15.36 | 40.98 | 0.20 | 0.55 | 0.52 |
| 174 | 3.92 | 0.25 | 0.80 | 11.83 | 15.20 | 39.79 | 0.33 | 0.57 | 0.52 |
| 175 | 4.13 | 0.24 | 0.81 | 11.81 | 15.18 | 39.86 | 0.33 | 0.57 | 0.52 |
| 176 | 3.92 | 0.25 | 0.80 | 11.89 | 15.28 | 40.42 | 0.27 | 0.56 | 0.52 |
| 177 | 3.92 | 0.25 | 0.80 | 12.00 | 15.42 | 40.97 | 0.20 | 0.55 | 0.52 |
| 178 | 3.92 | 0.25 | 0.80 | 12.05 | 15.49 | 40.88 | 0.20 | 0.54 | 0.51 |
| 179 | 3.92 | 0.25 | 0.80 | 11.82 | 15.19 | 39.15 | 0.40 | 0.58 | 0.52 |
| 180 | 3.92 | 0.25 | 0.80 | 11.82 | 15.19 | 38.44 | 0.47 | 0.59 | 0.51 |
| 181 | 3.92 | 0.25 | 0.80 | 11.91 | 15.30 | 40.05 | 0.30 | 0.56 | 0.52 |
| 182 | 3.92 | 0.25 | 0.80 | 11.93 | 15.33 | 39.68 | 0.33 | 0.56 | 0.51 |
| 183 | 3.92 | 0.25 | 0.80 | 11.96 | 15.36 | 39.32 | 0.37 | 0.57 | 0.51 |
| 184 | 3.92 | 0.25 | 0.80 | 11.98 | 15.39 | 38.95 | 0.40 | 0.57 | 0.50 |
| 185 | 3.92 | 0.25 | 0.80 | 11.27 | 14.48 | 45.50 | 0.20 | 0.48 | 0.46 |
| 186 | 3.92 | 0.25 | 0.80 | 11.49 | 14.77 | 43.00 | 0.20 | 0.52 | 0.49 |
| 187 | 3.92 | 0.25 | 0.80 | 11.93 | 13.30 | 41.42 | 0.20 | 0.56 | 0.53 |
| 188 | 3.93 | 0.25 | 0.80 | 11.70 | 13.04 | 40.66 | 0.20 | 0.56 | 0.53 |
| 189 | 3.65 | 0.27 | 0.78 | 11.72 | 13.07 | 40.72 | 0.20 | 0.56 | 0.53 |
| 190 | 3.78 | 0.26 | 0.79 | 11.84 | 13.20 | 41.11 | 0.20 | 0.56 | 0.53 |
| 191 | 3.93 | 0.25 | 0.80 | 11.78 | 15.13 | 41.20 | 0.20 | 0.56 | 0.53 |
| 192 | 5.34 | 0.19 | 0.84 | 15.76 | 19.06 | 40.03 | 0.15 | 0.56 | 0.53 |

TABLE 3

| | | | | | | | | | (CaO + | (SiO₂ + |
|---|---|---|---|---|---|---|---|---|---|---|
| | | | | | | | | CaO/ | MgO)/ | B₂O₃)/ |
| | SrO + | | | | | MgO + | (ZnO + | (MgO + | (MgO + | (MgO + |
| | BaO + | | | | | CaO + | SrO + | CaO + | CaO + | CaO + |
| | La₂O₃ + | | | SiO₂/ | | SrO + | BaO)/ | SrO + | SrO + | SrO + |
| | Gd₂O₃ + | BaO/ | SiO₂ + | (SiO₂ + | B₂O₃/ | BaO + | (MgO + | BaO + | BaO + | BaO + |
| No. | Y₂O₃ | La₂O₃ | B₂O₃ | B₂O₃) | SiO₂ | ZnO | CaO) | ZnO) | ZnO) | ZnO) |
| 1 | 18.33 | 4.08 | 22.08 | 0.94 | 0.07 | 26.93 | 1.27 | 0.44 | 0.44 | 0.82 |
| 2 | 15.86 | 0.98 | 24.33 | 0.92 | 0.09 | 24.55 | 0.50 | 0.67 | 0.67 | 0.99 |
| 3 | 18.59 | 4.08 | 22.39 | 0.94 | 0.07 | 27.30 | 1.27 | 0.44 | 0.44 | 0.82 |
| 4 | 18.08 | 4.08 | 21.78 | 0.94 | 0.07 | 26.56 | 1.27 | 0.44 | 0.44 | 0.82 |
| 5 | 17.84 | 4.08 | 21.49 | 0.94 | 0.07 | 26.20 | 1.27 | 0.44 | 0.44 | 0.82 |
| 6 | 17.37 | 4.09 | 20.93 | 0.94 | 0.07 | 25.52 | 1.27 | 0.44 | 0.44 | 0.82 |
| 7 | 19.27 | 4.09 | 23.21 | 0.94 | 0.07 | 28.31 | 1.27 | 0.44 | 0.44 | 0.82 |
| 8 | 18.39 | 4.09 | 22.15 | 0.94 | 0.07 | 27.75 | 1.20 | 0.46 | 0.46 | 0.80 |
| 9 | 18.45 | 4.09 | 22.22 | 0.94 | 0.07 | 28.58 | 1.13 | 0.47 | 0.47 | 0.78 |
| 10 | 18.27 | 4.09 | 22.01 | 0.94 | 0.07 | 29.03 | 1.07 | 0.48 | 0.48 | 0.76 |
| 11 | 18.16 | 4.09 | 21.87 | 0.94 | 0.07 | 30.24 | 0.97 | 0.51 | 0.51 | 0.72 |
| 12 | 18.18 | 4.09 | 20.34 | 0.93 | 0.07 | 31.73 | 0.89 | 0.53 | 0.53 | 0.64 |
| 13 | 18.06 | 4.09 | 20.86 | 0.98 | 0.02 | 31.52 | 0.89 | 0.53 | 0.53 | 0.66 |
| 14 | 17.96 | 4.09 | 21.64 | 0.94 | 0.07 | 31.36 | 0.89 | 0.53 | 0.53 | 0.69 |
| 15 | 17.91 | 4.09 | 21.58 | 0.94 | 0.07 | 29.83 | 0.97 | 0.51 | 0.51 | 0.72 |
| 16 | 13.91 | 2.86 | 21.44 | 0.94 | 0.07 | 23.68 | 0.83 | 0.55 | 0.55 | 0.91 |
| 17 | 13.89 | 2.86 | 22.94 | 0.94 | 0.06 | 22.23 | 0.93 | 0.52 | 0.52 | 1.03 |
| 18 | 16.38 | 3.48 | 22.15 | 0.94 | 0.07 | 29.35 | 0.81 | 0.55 | 0.55 | 0.75 |
| 19 | 14.55 | 2.86 | 22.44 | 0.94 | 0.07 | 28.44 | 0.65 | 0.61 | 0.61 | 0.79 |
| 20 | 16.37 | 3.48 | 22.93 | 0.94 | 0.07 | 28.60 | 0.84 | 0.54 | 0.54 | 0.80 |
| 21 | 14.54 | 2.86 | 24.01 | 0.94 | 0.06 | 26.92 | 0.71 | 0.58 | 0.58 | 0.89 |
| 22 | 17.78 | 4.09 | 21.42 | 0.94 | 0.07 | 32.45 | 0.82 | 0.55 | 0.55 | 0.66 |
| 23 | 18.26 | 2.11 | 21.85 | 0.94 | 0.07 | 28.22 | 0.84 | 0.54 | 0.54 | 0.77 |
| 24 | 18.36 | 1.24 | 21.82 | 0.94 | 0.07 | 26.21 | 0.71 | 0.58 | 0.58 | 0.83 |
| 25 | 19.99 | 2.48 | 21.57 | 0.94 | 0.07 | 29.11 | 1.02 | 0.49 | 0.49 | 0.74 |
| 26 | 18.00 | 4.09 | 21.68 | 0.94 | 0.07 | 29.26 | 1.02 | 0.49 | 0.49 | 0.74 |
| 27 | 20.16 | 2.48 | 21.76 | 0.94 | 0.07 | 30.09 | 0.97 | 0.51 | 0.51 | 0.72 |
| 28 | 19.38 | 4.09 | 21.74 | 0.94 | 0.07 | 30.67 | 1.11 | 0.47 | 0.47 | 0.71 |
| 29 | 17.63 | 3.48 | 22.01 | 0.94 | 0.07 | 29.79 | 0.93 | 0.52 | 0.52 | 0.74 |
| 30 | 19.89 | 4.70 | 21.60 | 0.94 | 0.07 | 31.11 | 1.16 | 0.46 | 0.46 | 0.69 |
| 31 | 21.77 | 1.78 | 21.28 | 0.94 | 0.07 | 28.02 | 1.08 | 0.48 | 0.48 | 0.76 |
| 32 | 18.22 | 4.09 | 21.62 | 0.91 | 0.09 | 30.34 | 0.97 | 0.51 | 0.51 | 0.71 |
| 33 | 18.10 | 4.09 | 22.13 | 0.96 | 0.04 | 30.14 | 0.97 | 0.51 | 0.51 | 0.73 |
| 34 | 18.10 | 4.09 | 21.80 | 0.94 | 0.07 | 30.47 | 1.09 | 0.48 | 0.48 | 0.72 |
| 35 | 18.25 | 2.11 | 22.61 | 0.94 | 0.07 | 27.48 | 0.89 | 0.53 | 0.53 | 0.82 |
| 36 | 18.31 | 2.11 | 22.36 | 0.92 | 0.09 | 27.57 | 0.89 | 0.53 | 0.53 | 0.81 |
| 37 | 18.32 | 2.11 | 21.92 | 0.94 | 0.07 | 27.59 | 0.89 | 0.53 | 0.53 | 0.79 |
| 38 | 18.35 | 4.09 | 22.11 | 0.94 | 0.07 | 29.10 | 1.08 | 0.48 | 0.48 | 0.76 |
| 39 | 17.59 | 4.09 | 21.20 | 0.94 | 0.07 | 33.53 | 0.76 | 0.57 | 0.57 | 0.63 |
| 40 | 17.46 | 4.09 | 21.04 | 0.94 | 0.07 | 34.30 | 0.72 | 0.58 | 0.58 | 0.61 |
| 41 | 19.58 | 2.48 | 21.13 | 0.94 | 0.07 | 31.32 | 0.85 | 0.54 | 0.54 | 0.67 |
| 42 | 17.88 | 2.11 | 21.29 | 0.90 | 0.11 | 27.64 | 0.84 | 0.54 | 0.54 | 0.77 |
| 43 | 21.33 | 1.78 | 20.85 | 0.94 | 0.07 | 30.21 | 0.89 | 0.53 | 0.53 | 0.69 |
| 44 | 21.91 | 2.48 | 20.88 | 0.94 | 0.07 | 32.13 | 1.10 | 0.48 | 0.48 | 0.65 |
| 45 | 24.18 | 2.48 | 20.64 | 0.94 | 0.07 | 32.91 | 1.39 | 0.42 | 0.42 | 0.63 |
| 46 | 19.32 | 2.48 | 20.85 | 0.94 | 0.07 | 30.91 | 0.85 | 0.54 | 0.54 | 0.67 |
| 47 | 19.07 | 2.48 | 20.58 | 0.94 | 0.07 | 30.51 | 0.85 | 0.54 | 0.54 | 0.67 |
| 48 | 21.47 | 1.78 | 20.99 | 0.94 | 0.07 | 31.42 | 0.95 | 0.51 | 0.51 | 0.67 |
| 49 | 21.33 | 1.78 | 20.85 | 0.94 | 0.07 | 31.21 | 0.95 | 0.51 | 0.51 | 0.67 |
| 50 | 23.04 | 1.39 | 20.58 | 0.94 | 0.07 | 29.14 | 0.93 | 0.52 | 0.52 | 0.71 |
| 51 | 24.70 | 1.13 | 20.32 | 0.94 | 0.07 | 28.09 | 0.97 | 0.51 | 0.51 | 0.72 |
| 52 | 21.44 | 1.78 | 20.96 | 0.94 | 0.07 | 31.38 | 0.95 | 0.51 | 0.51 | 0.67 |
| 53 | 21.46 | 1.78 | 21.20 | 0.93 | 0.08 | 30.40 | 0.89 | 0.53 | 0.53 | 0.70 |
| 54 | 21.39 | 1.78 | 21.13 | 0.93 | 0.08 | 30.30 | 0.89 | 0.53 | 0.53 | 0.70 |
| 55 | 21.45 | 1.78 | 21.18 | 0.93 | 0.08 | 30.38 | 0.89 | 0.53 | 0.53 | 0.70 |
| 56 | 20.79 | 1.78 | 20.32 | 0.94 | 0.07 | 29.44 | 0.89 | 0.53 | 0.53 | 0.69 |
| 57 | 19.67 | 1.51 | 21.01 | 0.90 | 0.11 | 26.57 | 0.89 | 0.53 | 0.53 | 0.79 |
| 58 | 19.17 | 2.11 | 21.14 | 0.90 | 0.11 | 26.73 | 0.89 | 0.53 | 0.53 | 0.79 |
| 59 | 19.73 | 1.51 | 21.29 | 0.90 | 0.12 | 26.64 | 0.89 | 0.53 | 0.53 | 0.80 |
| 60 | 19.70 | 1.51 | 21.41 | 0.91 | 0.10 | 26.60 | 0.89 | 0.53 | 0.53 | 0.80 |
| 61 | 19.17 | 1.24 | 21.14 | 0.90 | 0.11 | 26.11 | 0.84 | 0.54 | 0.54 | 0.81 |
| 62 | 19.80 | 1.51 | 21.36 | 0.90 | 0.12 | 26.73 | 0.89 | 0.53 | 0.53 | 0.80 |
| 63 | 19.76 | 1.51 | 21.48 | 0.91 | 0.10 | 26.69 | 0.89 | 0.53 | 0.53 | 0.80 |
| 64 | 19.78 | 1.51 | 21.34 | 0.90 | 0.12 | 26.71 | 0.89 | 0.53 | 0.53 | 0.80 |
| 65 | 19.75 | 1.51 | 21.47 | 0.91 | 0.10 | 26.67 | 0.89 | 0.53 | 0.53 | 0.80 |
| 66 | 19.71 | 1.51 | 21.05 | 0.90 | 0.11 | 26.42 | 0.90 | 0.51 | 0.53 | 0.80 |
| 67 | 18.53 | 1.51 | 21.18 | 0.90 | 0.11 | 25.98 | 0.77 | 0.55 | 0.57 | 0.82 |
| 68 | 18.01 | 1.24 | 21.31 | 0.90 | 0.11 | 25.51 | 0.72 | 0.56 | 0.58 | 0.84 |
| 69 | 19.27 | 1.24 | 21.11 | 0.90 | 0.11 | 24.78 | 0.75 | 0.57 | 0.57 | 0.85 |
| 70 | 19.75 | 1.51 | 21.09 | 0.90 | 0.11 | 26.28 | 0.91 | 0.48 | 0.52 | 0.80 |
| 71 | 19.83 | 1.51 | 21.17 | 0.90 | 0.11 | 25.98 | 0.94 | 0.44 | 0.52 | 0.81 |
| 72 | 16.30 | 0.98 | 21.62 | 0.90 | 0.11 | 24.43 | 0.57 | 0.59 | 0.64 | 0.88 |
| 73 | 14.55 | 0.71 | 21.94 | 0.90 | 0.11 | 23.32 | 0.43 | 0.63 | 0.70 | 0.94 |
| 74 | 19.82 | 0.78 | 20.97 | 0.90 | 0.11 | 23.65 | 0.68 | 0.59 | 0.59 | 0.89 |
| 75 | 19.87 | 0.62 | 20.96 | 0.90 | 0.11 | 22.68 | 0.61 | 0.62 | 0.62 | 0.92 |
| 76 | 20.65 | 0.87 | 20.84 | 0.90 | 0.11 | 24.11 | 0.77 | 0.57 | 0.57 | 0.86 |
| 77 | 19.97 | 1.51 | 21.70 | 0.91 | 0.10 | 25.54 | 0.98 | 0.50 | 0.50 | 0.85 |
| 78 | 21.52 | 0.79 | 20.71 | 0.90 | 0.11 | 23.61 | 0.79 | 0.56 | 0.56 | 0.88 |
| 79 | 20.70 | 0.71 | 20.83 | 0.90 | 0.11 | 23.15 | 0.70 | 0.59 | 0.59 | 0.90 |
| 80 | 21.60 | 0.79 | 20.79 | 0.90 | 0.11 | 24.05 | 0.77 | 0.57 | 0.57 | 0.86 |
| 81 | 21.62 | 0.79 | 20.81 | 0.90 | 0.11 | 24.07 | 0.77 | 0.57 | 0.57 | 0.86 |
| 82 | 16.53 | 0.28 | 22.49 | 0.87 | 0.15 | 19.44 | 0.34 | 0.75 | 0.75 | 1.16 |
| 83 | 16.43 | 0.28 | 22.99 | 0.91 | 0.10 | 19.31 | 0.34 | 0.75 | 0.75 | 1.19 |
| 84 | 17.88 | 2.11 | 21.29 | 0.90 | 0.11 | 27.64 | 0.84 | 0.54 | 0.54 | 0.77 |
| 85 | 19.67 | 1.51 | 21.01 | 0.90 | 0.11 | 26.57 | 0.89 | 0.53 | 0.53 | 0.79 |
| 86 | 16.52 | 0.28 | 23.25 | 0.87 | 0.15 | 18.71 | 0.36 | 0.74 | 0.74 | 1.24 |
| 87 | 16.52 | 0.28 | 24.01 | 0.88 | 0.14 | 17.98 | 0.38 | 0.72 | 0.72 | 1.34 |
| 88 | 16.58 | 0.28 | 23.00 | 0.85 | 0.17 | 18.77 | 0.36 | 0.74 | 0.74 | 1.23 |
| 89 | 16.62 | 0.28 | 23.51 | 0.84 | 0.20 | 18.09 | 0.38 | 0.72 | 0.72 | 1.30 |
| 90 | 16.67 | 0.28 | 24.03 | 0.82 | 0.22 | 17.42 | 0.40 | 0.71 | 0.71 | 1.38 |
| 91 | 18.27 | 0.45 | 22.21 | 0.87 | 0.15 | 20.43 | 0.50 | 0.67 | 0.67 | 1.09 |
| 92 | 19.97 | 0.62 | 21.94 | 0.87 | 0.15 | 21.40 | 0.68 | 0.59 | 0.59 | 1.03 |
| 93 | 21.63 | 0.79 | 21.68 | 0.87 | 0.15 | 22.34 | 0.88 | 0.53 | 0.53 | 0.97 |
| 94 | 16.44 | 0.28 | 23.13 | 0.87 | 0.15 | 19.32 | 0.34 | 0.75 | 0.75 | 1.20 |
| 95 | 16.63 | 0.28 | 21.84 | 0.86 | 0.16 | 19.55 | 0.34 | 0.75 | 0.75 | 1.12 |
| 96 | 16.49 | 0.28 | 22.88 | 0.85 | 0.17 | 19.39 | 0.34 | 0.75 | 0.75 | 1.18 |
| 97 | 16.45 | 0.28 | 23.26 | 0.84 | 0.20 | 19.34 | 0.34 | 0.75 | 0.75 | 1.20 |
| 98 | 16.41 | 0.28 | 23.65 | 0.82 | 0.22 | 19.29 | 0.34 | 0.75 | 0.75 | 1.23 |
| 99 | 16.58 | 0.28 | 22.10 | 0.89 | 0.13 | 19.48 | 0.34 | 0.75 | 0.75 | 1.13 |
| 100 | 16.42 | 0.28 | 22.34 | 0.87 | 0.15 | 19.30 | 0.34 | 0.75 | 0.75 | 1.16 |
| 101 | 16.31 | 0.28 | 22.19 | 0.87 | 0.15 | 19.17 | 0.34 | 0.75 | 0.75 | 1.16 |
| 102 | 16.20 | 0.28 | 22.04 | 0.87 | 0.15 | 19.05 | 0.34 | 0.75 | 0.75 | 1.16 |
| 103 | 16.65 | 0.28 | 22.64 | 0.87 | 0.15 | 19.57 | 0.34 | 0.75 | 0.75 | 1.16 |
| 104 | 16.76 | 0.28 | 22.80 | 0.87 | 0.15 | 19.70 | 0.34 | 0.75 | 0.75 | 1.16 |
| 105 | 16.88 | 0.28 | 22.96 | 0.87 | 0.15 | 19.84 | 0.34 | 0.75 | 0.75 | 1.16 |
| 106 | 16.79 | 0.28 | 22.84 | 0.87 | 0.15 | 19.73 | 0.34 | 0.75 | 0.75 | 1.16 |
| 107 | 14.75 | 0.11 | 22.77 | 0.87 | 0.15 | 18.42 | 0.20 | 0.84 | 0.84 | 1.24 |
| 108 | 16.00 | 0.11 | 22.63 | 0.87 | 0.15 | 18.92 | 0.30 | 0.77 | 0.77 | 1.20 |
| 109 | 15.30 | 0.28 | 22.63 | 0.87 | 0.15 | 18.94 | 0.24 | 0.81 | 0.81 | 1.19 |
| 110 | 16.64 | 0.28 | 21.98 | 0.82 | 0.21 | 19.56 | 0.34 | 0.75 | 0.75 | 1.12 |
| 111 | 16.75 | 0.28 | 21.47 | 0.78 | 0.29 | 19.69 | 0.34 | 0.75 | 0.75 | 1.09 |
| 112 | 16.43 | 0.28 | 22.99 | 0.91 | 0.10 | 19.31 | 0.34 | 0.75 | 0.75 | 1.19 |
| 113 | 16.32 | 0.28 | 23.48 | 0.95 | 0.05 | 19.19 | 0.34 | 0.75 | 0.75 | 1.22 |
| 114 | 22.09 | 2.19 | 18.65 | 1.00 | 0.00 | 20.70 | 2.73 | 0.27 | 0.27 | 0.90 |
| 115 | 16.38 | 0.28 | 22.29 | 0.87 | 0.15 | 19.26 | 0.34 | 0.75 | 0.75 | 1.16 |
| 116 | 16.24 | 0.28 | 22.09 | 0.87 | 0.15 | 19.09 | 0.34 | 0.75 | 0.75 | 1.16 |
| 117 | 16.58 | 0.28 | 23.32 | 0.87 | 0.15 | 19.48 | 0.34 | 0.75 | 0.75 | 1.20 |
| 118 | 16.63 | 0.28 | 23.07 | 0.85 | 0.17 | 19.55 | 0.34 | 0.75 | 0.75 | 1.18 |
| 119 | 16.41 | 2.54 | 19.85 | 1.00 | 0.00 | 17.67 | 1.99 | 0.33 | 0.33 | 1.12 |
| 120 | 16.47 | 0.28 | 22.40 | 0.87 | 0.15 | 19.36 | 0.34 | 0.75 | 0.75 | 1.16 |
| 121 | 17.66 | 0.28 | 22.24 | 0.87 | 0.15 | 20.53 | 0.43 | 0.70 | 0.70 | 1.08 |
| 122 | 16.50 | 0.28 | 22.44 | 0.87 | 0.15 | 19.40 | 0.34 | 0.75 | 0.75 | 1.16 |
| 123 | 16.42 | 0.28 | 22.34 | 0.87 | 0.15 | 19.30 | 0.34 | 0.75 | 0.75 | 1.16 |
| 124 | 16.67 | 0.28 | 22.68 | 0.87 | 0.15 | 19.60 | 0.34 | 0.75 | 0.75 | 1.16 |
| 125 | 15.20 | 0.11 | 23.47 | 0.87 | 0.15 | 18.77 | 0.20 | 0.81 | 0.83 | 1.25 |
| 126 | 15.32 | 1.68 | 20.11 | 1.00 | 0.00 | 16.60 | 1.78 | 0.36 | 0.36 | 1.21 |
| 127 | 16.69 | 0.28 | 23.48 | 0.87 | 0.15 | 19.62 | 0.34 | 0.75 | 0.75 | 1.20 |
| 128 | 16.74 | 0.28 | 23.23 | 0.85 | 0.17 | 19.68 | 0.34 | 0.75 | 0.75 | 1.18 |
| 129 | 17.25 | 0.11 | 22.52 | 0.87 | 0.15 | 20.16 | 0.39 | 0.72 | 0.72 | 1.12 |
| 130 | 14.20 | 0.83 | 20.38 | 1.00 | 0.00 | 15.50 | 1.56 | 0.39 | 0.39 | 1.31 |
| 131 | 16.24 | 0.11 | 22.98 | 0.87 | 0.15 | 19.21 | 0.30 | 0.77 | 0.77 | 1.20 |
| 132 | 15.87 | 0.00 | 23.09 | 0.87 | 0.15 | 18.85 | 0.27 | 0.79 | 0.79 | 1.22 |
| 133 | 16.90 | 0.28 | 22.99 | 0.87 | 0.15 | 19.87 | 0.34 | 0.75 | 0.75 | 1.16 |
| 134 | 17.02 | 0.28 | 23.16 | 0.87 | 0.15 | 20.01 | 0.34 | 0.75 | 0.75 | 1.16 |
| 135 | 15.86 | 0.00 | 22.67 | 0.87 | 0.15 | 18.84 | 0.27 | 0.79 | 0.79 | 1.20 |
| 136 | 15.84 | 0.00 | 22.80 | 0.88 | 0.14 | 18.81 | 0.27 | 0.79 | 0.79 | 1.21 |
| 137 | 17.01 | 0.00 | 22.77 | 0.87 | 0.15 | 19.95 | 0.36 | 0.74 | 0.74 | 1.14 |
| 138 | 15.96 | 0.00 | 23.21 | 0.87 | 0.15 | 18.21 | 0.28 | 0.78 | 0.78 | 1.27 |
| 139 | 16.81 | 0.28 | 22.86 | 0.87 | 0.15 | 19.76 | 0.34 | 0.75 | 0.75 | 1.16 |
| 140 | 16.77 | 0.28 | 22.81 | 0.87 | 0.15 | 19.71 | 0.34 | 0.75 | 0.75 | 1.16 |
| 141 | 16.70 | 0.28 | 22.71 | 0.87 | 0.15 | 20.36 | 0.33 | 0.75 | 0.75 | 1.12 |
| 142 | 18.45 | 0.45 | 22.43 | 0.87 | 0.15 | 21.35 | 0.48 | 0.68 | 0.68 | 1.05 |
| 143 | 16.73 | 0.28 | 23.09 | 0.89 | 0.12 | 19.67 | 0.34 | 0.75 | 0.75 | 1.17 |
| 144 | 16.68 | 0.28 | 23.34 | 0.91 | 0.10 | 19.60 | 0.34 | 0.75 | 0.75 | 1.19 |
| 145 | 16.84 | 0.28 | 22.58 | 0.85 | 0.18 | 19.80 | 0.34 | 0.75 | 0.75 | 1.14 |
| 146 | 16.90 | 0.28 | 22.32 | 0.82 | 0.21 | 19.86 | 0.34 | 0.75 | 0.75 | 1.12 |
| 147 | 16.83 | 0.28 | 22.89 | 0.87 | 0.15 | 19.78 | 0.34 | 0.75 | 0.75 | 1.16 |
| 148 | 20.06 | 0.62 | 22.04 | 0.87 | 0.15 | 22.91 | 0.61 | 0.62 | 0.62 | 0.96 |
| 149 | 15.00 | 0.11 | 23.16 | 0.87 | 0.15 | 17.98 | 0.21 | 0.83 | 0.83 | 1.29 |
| 150 | 16.67 | 0.28 | 22.67 | 0.87 | 0.15 | 20.32 | 0.33 | 0.75 | 0.75 | 1.12 |
| 151 | 18.42 | 0.45 | 22.39 | 0.87 | 0.15 | 21.31 | 0.48 | 0.68 | 0.68 | 1.05 |
| 152 | 16.80 | 0.28 | 22.46 | 0.87 | 0.15 | 19.75 | 0.34 | 0.75 | 0.75 | 1.14 |
| 153 | 16.77 | 0.28 | 22.58 | 0.88 | 0.14 | 19.71 | 0.34 | 0.75 | 0.75 | 1.15 |
| 154 | 16.55 | 0.28 | 22.51 | 0.87 | 0.15 | 20.89 | 0.31 | 0.76 | 0.76 | 1.08 |
| 155 | 16.93 | 0.28 | 23.81 | 0.87 | 0.15 | 19.90 | 0.34 | 0.75 | 0.75 | 1.20 |
| 156 | 16.65 | 0.28 | 21.87 | 0.86 | 0.16 | 19.57 | 0.34 | 0.75 | 0.75 | 1.12 |
| 157 | 16.80 | 0.28 | 22.70 | 0.87 | 0.15 | 19.75 | 0.34 | 0.75 | 0.75 | 1.15 |
| 158 | 16.86 | 0.28 | 22.77 | 0.86 | 0.17 | 19.82 | 0.34 | 0.75 | 0.75 | 1.15 |
| 159 | 16.71 | 0.28 | 22.73 | 0.87 | 0.15 | 19.65 | 0.34 | 0.75 | 0.75 | 1.16 |
| 160 | 17.07 | 0.28 | 23.21 | 0.87 | 0.15 | 20.06 | 0.34 | 0.75 | 0.75 | 1.16 |
| 161 | 16.92 | 0.28 | 23.02 | 0.87 | 0.15 | 19.15 | 0.36 | 0.74 | 0.74 | 1.20 |
| 162 | 16.97 | 0.28 | 23.08 | 0.87 | 0.15 | 18.84 | 0.37 | 0.73 | 0.73 | 1.23 |
| 163 | 16.80 | 0.28 | 22.85 | 0.87 | 0.15 | 19.60 | 0.35 | 0.74 | 0.74 | 1.17 |
| 164 | 16.77 | 0.28 | 22.50 | 0.87 | 0.15 | 19.72 | 0.34 | 0.75 | 0.75 | 1.14 |
| 165 | 16.19 | 0.28 | 22.03 | 0.87 | 0.15 | 19.03 | 0.34 | 0.75 | 0.75 | 1.16 |
| 166 | 16.41 | 0.28 | 22.32 | 0.87 | 0.15 | 19.29 | 0.34 | 0.75 | 0.75 | 1.16 |
| 167 | 16.15 | 0.28 | 21.96 | 0.87 | 0.15 | 18.98 | 0.34 | 0.75 | 0.75 | 1.16 |
| 168 | 16.37 | 0.28 | 22.26 | 0.87 | 0.15 | 19.24 | 0.34 | 0.75 | 0.75 | 1.16 |
| 169 | 16.92 | 0.28 | 23.01 | 0.87 | 0.15 | 19.89 | 0.34 | 0.75 | 0.75 | 1.16 |
| 170 | 17.76 | 0.37 | 22.80 | 0.87 | 0.15 | 20.71 | 0.41 | 0.71 | 0.71 | 1.10 |
| 171 | 16.87 | 0.28 | 22.95 | 0.87 | 0.15 | 20.20 | 0.33 | 0.75 | 0.75 | 1.14 |
| 172 | 16.90 | 0.28 | 23.21 | 0.86 | 0.16 | 19.86 | 0.34 | 0.75 | 0.75 | 1.17 |
| 173 | 17.07 | 0.28 | 22.66 | 0.87 | 0.16 | 20.06 | 0.34 | 0.75 | 0.75 | 1.13 |
| 174 | 16.90 | 0.28 | 22.79 | 0.87 | 0.15 | 19.86 | 0.34 | 0.75 | 0.75 | 1.15 |
| 175 | 16.87 | 0.28 | 22.79 | 0.87 | 0.14 | 19.83 | 0.34 | 0.75 | 0.75 | 1.15 |
| 176 | 16.98 | 0.28 | 22.70 | 0.87 | 0.15 | 19.96 | 0.34 | 0.75 | 0.75 | 1.14 |
| 177 | 17.14 | 0.28 | 22.43 | 0.86 | 0.16 | 20.14 | 0.34 | 0.75 | 0.75 | 1.11 |
| 178 | 17.21 | 0.28 | 22.25 | 0.86 | 0.16 | 20.23 | 0.34 | 0.75 | 0.75 | 1.10 |
| 179 | 16.89 | 0.28 | 22.65 | 0.87 | 0.15 | 19.85 | 0.34 | 0.75 | 0.75 | 1.14 |
| 180 | 16.88 | 0.28 | 22.57 | 0.87 | 0.15 | 19.84 | 0.34 | 0.75 | 0.75 | 1.14 |
| 181 | 17.01 | 0.28 | 22.54 | 0.87 | 0.16 | 20.00 | 0.34 | 0.75 | 0.75 | 1.13 |
| 182 | 17.04 | 0.28 | 22.38 | 0.86 | 0.16 | 20.03 | 0.34 | 0.75 | 0.75 | 1.12 |
| 183 | 17.07 | 0.28 | 22.23 | 0.86 | 0.16 | 20.07 | 0.34 | 0.75 | 0.75 | 1.11 |
| 184 | 17.10 | 0.28 | 22.07 | 0.86 | 0.16 | 20.10 | 0.34 | 0.75 | 0.75 | 1.10 |
| 185 | 16.10 | 0.28 | 21.89 | 0.87 | 0.15 | 17.52 | 0.38 | 0.72 | 0.72 | 1.25 |
| 186 | 16.41 | 0.28 | 22.32 | 0.87 | 0.15 | 19.29 | 0.34 | 0.75 | 0.75 | 1.16 |
| 187 | 16.38 | 0.11 | 23.16 | 0.87 | 0.15 | 19.36 | 0.30 | 0.77 | 0.77 | 1.20 |
| 188 | 20.10 | 0.11 | 22.73 | 0.87 | 0.15 | 20.85 | 0.67 | 0.60 | 0.60 | 1.09 |
| 189 | 20.14 | 0.12 | 22.61 | 0.86 | 0.17 | 20.89 | 0.67 | 0.60 | 0.60 | 1.08 |
| 190 | 18.02 | 0.11 | 22.91 | 0.86 | 0.16 | 20.03 | 0.45 | 0.69 | 0.69 | 1.14 |
| 191 | 16.82 | 0.28 | 23.17 | 0.87 | 0.15 | 19.77 | 0.34 | 0.75 | 0.75 | 1.17 |
| 192 | 20.72 | 0.21 | 22.48 | 0.87 | 0.15 | 17.99 | 0.38 | 0.72 | 0.72 | 1.25 |

TABLE 4

| | | | | | | (La₂O₃ + | | | |
|---|---|---|---|---|---|---|---|---|---|
| | | | | | | Gd₂O₃ + | | | |
| | | | | | | Y₂O₃)/ | | | |
| | | | | | | (MgO + | | | |
| | | | | | | CaO + | | | |
| | | | | | | SrO + | | | (MgO + |
| | | | | | | BaO + | | ZrO₂/ | CaO + |
| | | | | | | ZnO + | | (La₂O₃ + | SrO + |
| | (SiO₂ + | | | | Re₂O₃/ | La₂O₃ + | B₂O₃/ | Gd₂O₃ + | BaO + |
| | B₂O₃)/ | La₂O₃/ | Gd₂O₃/ | Y₂O₃/ | (BaO + | Gd₂O₃ + | (BaO + | Y₂O₃ + | ZnO)/ |
| No. | Re₂O₃ | Re₂O₃ | Re₂O₃ | Re₂O₃ | Re₂O₃) | Y₂O₃) | Re₂O₃) | ZrO₂) | Re₂O₃ |
| 1 | 6.74 | 1.00 | 0.00 | 0.00 | 0.20 | 0.11 | 0.08 | 0.42 | 8.21 |
| 2 | 3.18 | 1.00 | 0.00 | 0.00 | 0.51 | 0.24 | 0.14 | 0.30 | 3.20 |
| 3 | 6.74 | 1.00 | 0.00 | 0.00 | 0.20 | 0.11 | 0.08 | 0.42 | 8.21 |
| 4 | 6.74 | 1.00 | 0.00 | 0.00 | 0.20 | 0.11 | 0.08 | 0.42 | 8.21 |
| 5 | 6.74 | 1.00 | 0.00 | 0.00 | 0.20 | 0.11 | 0.08 | 0.42 | 8.21 |
| 6 | 6.75 | 1.00 | 0.00 | 0.00 | 0.20 | 0.11 | 0.08 | 0.42 | 8.24 |
| 7 | 6.75 | 1.00 | 0.00 | 0.00 | 0.20 | 0.11 | 0.08 | 0.42 | 8.24 |
| 8 | 6.75 | 1.00 | 0.00 | 0.00 | 0.20 | 0.11 | 0.08 | 0.42 | 8.46 |
| 9 | 6.75 | 1.00 | 0.00 | 0.00 | 0.20 | 0.10 | 0.08 | 0.42 | 8.68 |
| 10 | 6.75 | 1.00 | 0.00 | 0.00 | 0.20 | 0.10 | 0.08 | 0.42 | 8.91 |
| 11 | 6.75 | 1.00 | 0.00 | 0.00 | 0.20 | 0.10 | 0.08 | 0.42 | 9.34 |
| 12 | 6.27 | 1.00 | 0.00 | 0.00 | 0.20 | 0.09 | 0.08 | 0.42 | 9.79 |
| 13 | 6.48 | 1.00 | 0.00 | 0.00 | 0.20 | 0.09 | 0.03 | 0.42 | 9.79 |
| 14 | 6.75 | 1.00 | 0.00 | 0.00 | 0.20 | 0.09 | 0.08 | 0.42 | 9.79 |
| 15 | 6.75 | 1.00 | 0.00 | 0.00 | 0.20 | 0.10 | 0.08 | 0.42 | 9.34 |
| 16 | 6.75 | 1.00 | 0.00 | 0.00 | 0.26 | 0.12 | 0.11 | 0.42 | 7.46 |
| 17 | 7.23 | 1.00 | 0.00 | 0.00 | 0.26 | 0.12 | 0.11 | 0.42 | 7.01 |
| 18 | 6.75 | 1.00 | 0.00 | 0.00 | 0.22 | 0.10 | 0.10 | 0.42 | 8.95 |
| 19 | 6.75 | 1.00 | 0.00 | 0.00 | 0.26 | 0.10 | 0.11 | 0.42 | 8.56 |
| 20 | 6.99 | 1.00 | 0.00 | 0.00 | 0.22 | 0.10 | 0.10 | 0.42 | 8.73 |
| 21 | 7.23 | 1.00 | 0.00 | 0.00 | 0.26 | 0.11 | 0.11 | 0.42 | 8.11 |
| 22 | 6.75 | 1.00 | 0.00 | 0.00 | 0.20 | 0.09 | 0.08 | 0.42 | 10.23 |
| 23 | 4.09 | 1.00 | 0.00 | 0.00 | 0.32 | 0.16 | 0.08 | 0.30 | 5.28 |
| 24 | 2.93 | 1.00 | 0.00 | 0.00 | 0.45 | 0.22 | 0.08 | 0.24 | 3.52 |
| 25 | 4.09 | 1.00 | 0.00 | 0.00 | 0.29 | 0.15 | 0.08 | 0.30 | 5.52 |
| 26 | 6.75 | 1.00 | 0.00 | 0.00 | 0.20 | 0.10 | 0.08 | 0.55 | 9.11 |
| 27 | 4.09 | 1.00 | 0.00 | 0.00 | 0.29 | 0.15 | 0.08 | 0.12 | 5.66 |
| 28 | 6.75 | 1.00 | 0.00 | 0.00 | 0.20 | 0.09 | 0.08 | 0.42 | 9.53 |
| 29 | 6.75 | 1.00 | 0.00 | 0.00 | 0.22 | 0.10 | 0.10 | 0.42 | 9.14 |
| 30 | 6.75 | 1.00 | 0.00 | 0.00 | 0.18 | 0.09 | 0.08 | 0.42 | 9.73 |
| 31 | 2.93 | 1.00 | 0.00 | 0.00 | 0.36 | 0.21 | 0.07 | 0.24 | 3.86 |
| 32 | 6.65 | 1.00 | 0.00 | 0.00 | 0.20 | 0.10 | 0.11 | 0.42 | 9.34 |
| 33 | 6.85 | 1.00 | 0.00 | 0.00 | 0.20 | 0.10 | 0.06 | 0.42 | 9.34 |
| 34 | 6.75 | 1.00 | 0.00 | 0.00 | 0.20 | 0.10 | 0.08 | 0.42 | 9.44 |
| 35 | 4.24 | 1.00 | 0.00 | 0.00 | 0.32 | 0.16 | 0.08 | 0.30 | 5.15 |
| 36 | 4.17 | 1.00 | 0.00 | 0.00 | 0.32 | 0.16 | 0.11 | 0.30 | 5.15 |
| 37 | 4.09 | 1.00 | 0.00 | 0.00 | 0.32 | 0.16 | 0.08 | 0.30 | 5.15 |
| 38 | 6.75 | 1.00 | 0.00 | 0.00 | 0.20 | 0.10 | 0.08 | 0.42 | 8.89 |
| 39 | 6.75 | 1.00 | 0.00 | 0.00 | 0.20 | 0.09 | 0.08 | 0.42 | 10.68 |
| 40 | 6.75 | 1.00 | 0.00 | 0.00 | 0.20 | 0.08 | 0.08 | 0.42 | 11.01 |
| 41 | 4.09 | 1.00 | 0.00 | 0.00 | 0.29 | 0.14 | 0.08 | 0.30 | 6.06 |
| 42 | 4.07 | 1.00 | 0.00 | 0.00 | 0.32 | 0.16 | 0.12 | 0.30 | 5.28 |
| 43 | 2.93 | 1.00 | 0.00 | 0.00 | 0.36 | 0.19 | 0.07 | 0.24 | 4.25 |
| 44 | 4.09 | 1.00 | 0.00 | 0.00 | 0.29 | 0.14 | 0.08 | 0.30 | 6.29 |
| 45 | 4.09 | 1.00 | 0.00 | 0.00 | 0.29 | 0.13 | 0.08 | 0.30 | 6.52 |
| 46 | 4.09 | 1.00 | 0.00 | 0.00 | 0.29 | 0.14 | 0.08 | 0.30 | 6.06 |
| 47 | 4.09 | 1.00 | 0.00 | 0.00 | 0.29 | 0.14 | 0.08 | 0.30 | 6.06 |
| 48 | 2.93 | 1.00 | 0.00 | 0.00 | 0.36 | 0.19 | 0.07 | 0.24 | 4.39 |
| 49 | 2.93 | 1.00 | 0.00 | 0.00 | 0.36 | 0.19 | 0.07 | 0.24 | 4.39 |
| 50 | 2.29 | 1.00 | 0.00 | 0.00 | 0.42 | 0.24 | 0.06 | 0.19 | 3.24 |
| 51 | 1.87 | 1.00 | 0.00 | 0.00 | 0.47 | 0.28 | 0.06 | 0.17 | 2.59 |
| 52 | 2.93 | 1.00 | 0.00 | 0.00 | 0.36 | 0.19 | 0.07 | 0.09 | 4.39 |
| 53 | 2.96 | 1.00 | 0.00 | 0.00 | 0.36 | 0.19 | 0.08 | 0.24 | 4.25 |
| 54 | 2.96 | 1.00 | 0.00 | 0.00 | 0.36 | 0.19 | 0.08 | 0.24 | 4.25 |
| 55 | 2.96 | 1.00 | 0.00 | 0.00 | 0.36 | 0.19 | 0.08 | 0.17 | 4.25 |
| 56 | 2.93 | 1.00 | 0.00 | 0.00 | 0.36 | 0.19 | 0.07 | 0.24 | 4.25 |
| 57 | 2.92 | 1.00 | 0.00 | 0.00 | 0.40 | 0.21 | 0.11 | 0.24 | 3.69 |
| 58 | 3.20 | 0.79 | 0.00 | 0.21 | 0.38 | 0.20 | 0.11 | 0.25 | 4.04 |
| 59 | 2.95 | 1.00 | 0.00 | 0.00 | 0.40 | 0.21 | 0.12 | 0.24 | 3.69 |
| 60 | 2.97 | 1.00 | 0.00 | 0.00 | 0.40 | 0.21 | 0.11 | 0.24 | 3.69 |
| 61 | 2.92 | 1.00 | 0.00 | 0.00 | 0.45 | 0.22 | 0.12 | 0.24 | 3.61 |
| 62 | 2.95 | 1.00 | 0.00 | 0.00 | 0.40 | 0.21 | 0.12 | 0.24 | 3.69 |
| 63 | 2.97 | 1.00 | 0.00 | 0.00 | 0.40 | 0.21 | 0.11 | 0.24 | 3.69 |
| 64 | 2.95 | 1.00 | 0.00 | 0.00 | 0.40 | 0.21 | 0.12 | 0.17 | 3.69 |
| 65 | 2.97 | 1.00 | 0.00 | 0.00 | 0.40 | 0.21 | 0.11 | 0.17 | 3.69 |
| 66 | 2.92 | 1.00 | 0.00 | 0.00 | 0.40 | 0.21 | 0.11 | 0.24 | 3.67 |
| 67 | 2.92 | 1.00 | 0.00 | 0.00 | 0.40 | 0.22 | 0.11 | 0.24 | 3.58 |
| 68 | 2.92 | 1.00 | 0.00 | 0.00 | 0.45 | 0.22 | 0.12 | 0.24 | 3.50 |
| 69 | 2.44 | 0.84 | 0.00 | 0.16 | 0.49 | 0.26 | 0.11 | 0.21 | 2.87 |
| 70 | 2.92 | 1.00 | 0.00 | 0.00 | 0.40 | 0.22 | 0.11 | 0.24 | 3.64 |
| 71 | 2.92 | 1.00 | 0.00 | 0.00 | 0.40 | 0.22 | 0.11 | 0.24 | 3.58 |
| 72 | 2.92 | 1.00 | 0.00 | 0.00 | 0.51 | 0.23 | 0.14 | 0.24 | 3.30 |
| 73 | 2.92 | 1.00 | 0.00 | 0.00 | 0.58 | 0.24 | 0.16 | 0.24 | 3.10 |
| 74 | 2.05 | 1.00 | 0.00 | 0.00 | 0.56 | 0.30 | 0.11 | 0.18 | 2.31 |
| 75 | 1.87 | 1.00 | 0.00 | 0.00 | 0.62 | 0.33 | 0.11 | 0.17 | 2.02 |
| 76 | 2.05 | 1.00 | 0.00 | 0.00 | 0.53 | 0.30 | 0.10 | 0.18 | 2.37 |
| 77 | 2.97 | 1.00 | 0.00 | 0.00 | 0.40 | 0.22 | 0.11 | 0.24 | 3.50 |
| 78 | 1.87 | 1.00 | 0.00 | 0.00 | 0.56 | 0.32 | 0.10 | 0.17 | 2.13 |
| 79 | 1.87 | 1.00 | 0.00 | 0.00 | 0.58 | 0.33 | 0.10 | 0.17 | 2.07 |
| 80 | 1.87 | 1.00 | 0.00 | 0.00 | 0.56 | 0.32 | 0.10 | 0.11 | 2.16 |
| 81 | 1.87 | 1.00 | 0.00 | 0.00 | 0.56 | 0.32 | 0.10 | 0.17 | 2.16 |
| 82 | 1.94 | 1.00 | 0.00 | 0.00 | 0.78 | 0.37 | 0.20 | 0.17 | 1.68 |
| 83 | 2.00 | 1.00 | 0.00 | 0.00 | 0.78 | 0.37 | 0.14 | 0.17 | 1.68 |
| 84 | 4.07 | 1.00 | 0.00 | 0.00 | 0.32 | 0.16 | 0.12 | 0.30 | 5.28 |
| 85 | 2.92 | 1.00 | 0.00 | 0.00 | 0.40 | 0.21 | 0.11 | 0.24 | 3.69 |
| 86 | 2.01 | 1.00 | 0.00 | 0.00 | 0.78 | 0.38 | 0.20 | 0.17 | 1.62 |
| 87 | 2.08 | 1.00 | 0.00 | 0.00 | 0.78 | 0.39 | 0.20 | 0.17 | 1.55 |
| 88 | 1.98 | 1.00 | 0.00 | 0.00 | 0.78 | 0.38 | 0.23 | 0.17 | 1.62 |
| 89 | 2.02 | 1.00 | 0.00 | 0.00 | 0.78 | 0.39 | 0.26 | 0.17 | 1.55 |
| 90 | 2.06 | 1.00 | 0.00 | 0.00 | 0.78 | 0.40 | 0.29 | 0.17 | 1.49 |
| 91 | 1.94 | 1.00 | 0.00 | 0.00 | 0.69 | 0.36 | 0.18 | 0.17 | 1.79 |
| 92 | 1.94 | 1.00 | 0.00 | 0.00 | 0.62 | 0.35 | 0.16 | 0.17 | 1.89 |
| 93 | 1.94 | 1.00 | 0.00 | 0.00 | 0.56 | 0.33 | 0.14 | 0.17 | 2.00 |
| 94 | 2.01 | 1.00 | 0.00 | 0.00 | 0.78 | 0.37 | 0.20 | 0.17 | 1.68 |
| 95 | 1.88 | 1.00 | 0.00 | 0.00 | 0.78 | 0.37 | 0.20 | 0.17 | 1.68 |
| 96 | 1.98 | 1.00 | 0.00 | 0.00 | 0.78 | 0.37 | 0.23 | 0.17 | 1.68 |
| 97 | 2.02 | 1.00 | 0.00 | 0.00 | 0.78 | 0.37 | 0.26 | 0.17 | 1.68 |
| 98 | 2.06 | 1.00 | 0.00 | 0.00 | 0.78 | 0.37 | 0.29 | 0.17 | 1.68 |
| 99 | 1.90 | 1.00 | 0.00 | 0.00 | 0.78 | 0.37 | 0.17 | 0.17 | 1.68 |
| 100 | 1.94 | 1.00 | 0.00 | 0.00 | 0.78 | 0.37 | 0.20 | 0.17 | 1.68 |
| 101 | 1.94 | 1.00 | 0.00 | 0.00 | 0.78 | 0.37 | 0.20 | 0.17 | 1.68 |
| 102 | 1.94 | 1.00 | 0.00 | 0.00 | 0.78 | 0.37 | 0.20 | 0.17 | 1.68 |
| 103 | 1.94 | 1.00 | 0.00 | 0.00 | 0.78 | 0.37 | 0.20 | 0.17 | 1.68 |
| 104 | 1.94 | 1.00 | 0.00 | 0.00 | 0.78 | 0.37 | 0.20 | 0.17 | 1.68 |
| 105 | 1.94 | 1.00 | 0.00 | 0.00 | 0.78 | 0.37 | 0.20 | 0.17 | 1.68 |
| 106 | 1.94 | 1.00 | 0.00 | 0.00 | 0.78 | 0.37 | 0.20 | 0.17 | 1.68 |
| 107 | 1.94 | 1.00 | 0.00 | 0.00 | 0.90 | 0.39 | 0.23 | 0.17 | 1.57 |
| 108 | 1.94 | 1.00 | 0.00 | 0.00 | 0.90 | 0.38 | 0.23 | 0.17 | 1.62 |
| 109 | 1.94 | 1.00 | 0.00 | 0.00 | 0.78 | 0.38 | 0.20 | 0.17 | 1.63 |
| 110 | 1.89 | 1.00 | 0.00 | 0.00 | 0.78 | 0.37 | 0.26 | 0.17 | 1.68 |
| 111 | 1.83 | 1.00 | 0.00 | 0.00 | 0.78 | 0.37 | 0.32 | 0.17 | 1.68 |
| 112 | 2.00 | 1.00 | 0.00 | 0.00 | 0.78 | 0.37 | 0.14 | 0.17 | 1.68 |
| 113 | 2.05 | 1.00 | 0.00 | 0.00 | 0.78 | 0.37 | 0.08 | 0.17 | 1.68 |
| 114 | 2.69 | 1.00 | 0.00 | 0.00 | 0.31 | 0.25 | 0.00 | 0.40 | 2.99 |
| 115 | 1.94 | 1.00 | 0.00 | 0.00 | 0.78 | 0.37 | 0.20 | 0.17 | 1.68 |
| 116 | 1.94 | 1.00 | 0.00 | 0.00 | 0.78 | 0.37 | 0.20 | 0.17 | 1.68 |
| 117 | 2.01 | 1.00 | 0.00 | 0.00 | 0.78 | 0.37 | 0.20 | 0.17 | 1.68 |
| 118 | 1.98 | 1.00 | 0.00 | 0.00 | 0.78 | 0.37 | 0.23 | 0.17 | 1.68 |
| 119 | 4.28 | 1.00 | 0.00 | 0.00 | 0.28 | 0.21 | 0.00 | 0.52 | 3.81 |
| 120 | 1.94 | 1.00 | 0.00 | 0.00 | 0.78 | 0.37 | 0.20 | 0.17 | 1.68 |
| 121 | 1.94 | 1.00 | 0.00 | 0.00 | 0.78 | 0.36 | 0.20 | 0.17 | 1.79 |
| 122 | 1.94 | 1.00 | 0.00 | 0.00 | 0.78 | 0.37 | 0.20 | 0.17 | 1.68 |
| 123 | 1.94 | 1.00 | 0.00 | 0.00 | 0.78 | 0.37 | 0.20 | 0.17 | 1.68 |
| 124 | 1.94 | 1.00 | 0.00 | 0.00 | 0.78 | 0.37 | 0.20 | 0.17 | 1.68 |
| 125 | 1.94 | 1.00 | 0.00 | 0.00 | 0.90 | 0.39 | 0.23 | 0.17 | 1.55 |
| 126 | 4.28 | 1.00 | 0.00 | 0.00 | 0.37 | 0.22 | 0.00 | 0.52 | 3.53 |
| 127 | 2.01 | 1.00 | 0.00 | 0.00 | 0.78 | 0.37 | 0.20 | 0.17 | 1.68 |
| 128 | 1.98 | 1.00 | 0.00 | 0.00 | 0.78 | 0.37 | 0.23 | 0.17 | 1.68 |
| 129 | 1.94 | 1.00 | 0.00 | 0.00 | 0.90 | 0.37 | 0.23 | 0.17 | 1.74 |
| 130 | 4.28 | 1.00 | 0.00 | 0.00 | 0.55 | 0.23 | 0.00 | 0.52 | 3.26 |
| 131 | 1.94 | 1.00 | 0.00 | 0.00 | 0.90 | 0.38 | 0.23 | 0.17 | 1.62 |
| 132 | 1.94 | 1.00 | 0.00 | 0.00 | 1.00 | 0.39 | 0.25 | 0.17 | 1.59 |
| 133 | 1.94 | 1.00 | 0.00 | 0.00 | 0.78 | 0.37 | 0.20 | 0.17 | 1.68 |
| 134 | 1.94 | 1.00 | 0.00 | 0.00 | 0.78 | 0.37 | 0.20 | 0.17 | 1.68 |
| 135 | 1.91 | 1.00 | 0.00 | 0.00 | 1.00 | 0.39 | 0.25 | 0.17 | 1.59 |
| 136 | 1.92 | 1.00 | 0.00 | 0.00 | 1.00 | 0.39 | 0.24 | 0.17 | 1.59 |
| 137 | 1.94 | 1.00 | 0.00 | 0.00 | 1.00 | 0.37 | 0.25 | 0.17 | 1.70 |
| 138 | 1.94 | 1.00 | 0.00 | 0.00 | 1.00 | 0.40 | 0.25 | 0.17 | 1.52 |
| 139 | 1.94 | 1.00 | 0.00 | 0.00 | 0.78 | 0.37 | 0.20 | 0.25 | 1.68 |
| 140 | 1.94 | 1.00 | 0.00 | 0.00 | 0.78 | 0.37 | 0.20 | 0.06 | 1.68 |
| 141 | 1.94 | 1.00 | 0.00 | 0.00 | 0.78 | 0.36 | 0.20 | 0.17 | 1.74 |
| 142 | 1.94 | 1.00 | 0.00 | 0.00 | 0.69 | 0.35 | 0.18 | 0.17 | 1.85 |
| 143 | 1.97 | 1.00 | 0.00 | 0.00 | 0.78 | 0.37 | 0.17 | 0.17 | 1.68 |
| 144 | 2.00 | 1.00 | 0.00 | 0.00 | 0.78 | 0.37 | 0.14 | 0.17 | 1.68 |
| 145 | 1.91 | 1.00 | 0.00 | 0.00 | 0.78 | 0.37 | 0.23 | 0.17 | 1.68 |
| 146 | 1.89 | 1.00 | 0.00 | 0.00 | 0.78 | 0.37 | 0.26 | 0.17 | 1.68 |
| 147 | 1.94 | 1.00 | 0.00 | 0.00 | 0.78 | 0.37 | 0.20 | 0.32 | 1.68 |
| 148 | 1.94 | 1.00 | 0.00 | 0.00 | 0.62 | 0.33 | 0.16 | 0.17 | 2.02 |
| 149 | 1.94 | 1.00 | 0.00 | 0.00 | 0.90 | 0.40 | 0.23 | 0.17 | 1.51 |
| 150 | 1.94 | 1.00 | 0.00 | 0.00 | 0.78 | 0.36 | 0.20 | 0.17 | 1.74 |
| 151 | 1.94 | 1.00 | 0.00 | 0.00 | 0.69 | 0.35 | 0.18 | 0.17 | 1.85 |
| 152 | 1.91 | 1.00 | 0.00 | 0.00 | 0.78 | 0.37 | 0.20 | 0.17 | 1.68 |
| 153 | 1.92 | 1.00 | 0.00 | 0.00 | 0.78 | 0.37 | 0.18 | 0.17 | 1.68 |
| 154 | 1.94 | 1.00 | 0.00 | 0.00 | 0.78 | 0.36 | 0.20 | 0.17 | 1.80 |
| 155 | 2.01 | 1.00 | 0.00 | 0.00 | 0.78 | 0.37 | 0.20 | 0.06 | 1.68 |
| 156 | 1.88 | 1.00 | 0.00 | 0.00 | 0.78 | 0.37 | 0.20 | 0.25 | 1.68 |
| 157 | 1.93 | 1.00 | 0.00 | 0.00 | 0.78 | 0.37 | 0.20 | 0.33 | 1.68 |
| 158 | 1.93 | 1.00 | 0.00 | 0.00 | 0.78 | 0.37 | 0.21 | 0.32 | 1.68 |
| 159 | 1.94 | 1.00 | 0.00 | 0.00 | 0.78 | 0.37 | 0.20 | 0.35 | 1.68 |
| 160 | 1.94 | 1.00 | 0.00 | 0.00 | 0.78 | 0.37 | 0.20 | 0.32 | 1.68 |
| 161 | 1.94 | 1.00 | 0.00 | 0.00 | 0.78 | 0.38 | 0.20 | 0.32 | 1.62 |
| 162 | 1.94 | 1.00 | 0.00 | 0.00 | 0.78 | 0.39 | 0.20 | 0.32 | 1.59 |
| 163 | 1.94 | 1.00 | 0.00 | 0.00 | 0.78 | 0.38 | 0.20 | 0.33 | 1.67 |
| 164 | 1.92 | 1.00 | 0.00 | 0.00 | 0.78 | 0.37 | 0.20 | 0.34 | 1.68 |
| 165 | 1.94 | 1.00 | 0.00 | 0.00 | 0.78 | 0.37 | 0.20 | 0.17 | 1.68 |
| 166 | 1.94 | 1.00 | 0.00 | 0.00 | 0.78 | 0.37 | 0.20 | 0.17 | 1.68 |
| 167 | 1.94 | 1.00 | 0.00 | 0.00 | 0.78 | 0.37 | 0.20 | 0.17 | 1.68 |
| 168 | 1.94 | 1.00 | 0.00 | 0.00 | 0.78 | 0.37 | 0.20 | 0.17 | 1.68 |
| 169 | 1.94 | 1.00 | 0.00 | 0.00 | 0.78 | 0.37 | 0.20 | 0.17 | 1.68 |
| 170 | 1.94 | 1.00 | 0.00 | 0.00 | 0.73 | 0.36 | 0.19 | 0.17 | 1.76 |
| 171 | 1.94 | 1.00 | 0.00 | 0.00 | 0.78 | 0.37 | 0.20 | 0.17 | 1.71 |
| 172 | 1.96 | 1.00 | 0.00 | 0.00 | 0.78 | 0.37 | 0.21 | 0.17 | 1.68 |
| 173 | 1.90 | 1.00 | 0.00 | 0.00 | 0.78 | 0.37 | 0.20 | 0.17 | 1.68 |
| 174 | 1.93 | 1.00 | 0.00 | 0.00 | 0.78 | 0.37 | 0.20 | 0.25 | 1.68 |
| 175 | 1.93 | 1.00 | 0.00 | 0.00 | 0.78 | 0.37 | 0.19 | 0.25 | 1.68 |
| 176 | 1.91 | 1.00 | 0.00 | 0.00 | 0.78 | 0.37 | 0.20 | 0.21 | 1.68 |
| 177 | 1.87 | 1.00 | 0.00 | 0.00 | 0.78 | 0.37 | 0.20 | 0.17 | 1.68 |
| 178 | 1.85 | 1.00 | 0.00 | 0.00 | 0.78 | 0.37 | 0.20 | 0.17 | 1.68 |
| 179 | 1.92 | 1.00 | 0.00 | 0.00 | 0.78 | 0.37 | 0.20 | 0.29 | 1.68 |
| 180 | 1.91 | 1.00 | 0.00 | 0.00 | 0.78 | 0.37 | 0.20 | 0.32 | 1.68 |
| 181 | 1.89 | 1.00 | 0.00 | 0.00 | 0.78 | 0.37 | 0.20 | 0.23 | 1.68 |
| 182 | 1.88 | 1.00 | 0.00 | 0.00 | 0.78 | 0.37 | 0.20 | 0.25 | 1.68 |
| 183 | 1.86 | 1.00 | 0.00 | 0.00 | 0.78 | 0.37 | 0.20 | 0.27 | 1.68 |
| 184 | 1.84 | 1.00 | 0.00 | 0.00 | 0.78 | 0.37 | 0.20 | 0.29 | 1.68 |
| 185 | 1.94 | 1.00 | 0.00 | 0.00 | 0.78 | 0.39 | 0.20 | 0.17 | 1.55 |
| 186 | 1.94 | 1.00 | 0.00 | 0.00 | 0.78 | 0.37 | 0.20 | 0.17 | 1.68 |
| 187 | 1.20 | 1.00 | 0.00 | 0.00 | 0.90 | 0.38 | 0.23 | 0.17 | 1.62 |
| 188 | 1.09 | 1.00 | 0.00 | 0.00 | 0.90 | 0.36 | 0.23 | 0.17 | 1.78 |
| 189 | 1.08 | 1.00 | 0.00 | 0.00 | 0.90 | 0.36 | 0.25 | 0.17 | 1.78 |
| 190 | 1.14 | 1.00 | 0.00 | 0.00 | 0.90 | 0.37 | 0.24 | 0.17 | 1.69 |
| 191 | 1.17 | 1.00 | 0.00 | 0.00 | 0.78 | 0.37 | 0.20 | 0.17 | 1.68 |
| 192 | 1.25 | 1.00 | 0.00 | 0.00 | 0.83 | 0.47 | 0.15 | 0.13 | 1.14 |

TABLE 5

| | | | (Li₂O + | | | | |
|---|---|---|---|---|---|---|---|
| | | | Na₂O + | | | | |
| | | Li₂O + | K₂O + | | (Li₂O + | | (Li₂O + |
| | | Na₂O + | Cs₂O + | | Na₂O + | | Na₂O + |
| | | K₂O + | MgO + | | K₂O)/ | | K₂O)/ |
| | | Cs₂O + | CaO + | | (MgO + | (Li₂O + | (TiO₂ + |
| | Li₂O + | MgO + | SrO + | Li₂O/ | CaO + | Na₂O + | Nb₂O₅ + |
| | Na₂O + | CaO + | BaO)/ | (Li₂O + | SrO + | K₂O)/ | Ta₂O₅ + |
| | K₂O + | SrO + | (SiO₂ + | Na₂O + | BaO + | (SiO₂ + | WO₃ + |
| No. | Cs₂O | BaO | B₂O₃) | K₂O) | ZnO) | B₂O₃) | Bi₂O₃) |
| 1 | 3.05 | 29.97 | 1.36 | 0.48 | 0.11 | 0.14 | 0.07 |
| 2 | 1.85 | 26.40 | 1.08 | 0.63 | 0.08 | 0.08 | 0.05 |
| 3 | 3.09 | 30.39 | 1.36 | 0.48 | 0.11 | 0.14 | 0.07 |
| 4 | 3.01 | 29.56 | 1.36 | 0.48 | 0.11 | 0.14 | 0.07 |
| 5 | 2.97 | 29.17 | 1.36 | 0.48 | 0.11 | 0.14 | 0.07 |
| 6 | 2.89 | 28.40 | 1.36 | 0.48 | 0.11 | 0.14 | 0.06 |
| 7 | 3.20 | 31.51 | 1.36 | 0.48 | 0.11 | 0.14 | 0.08 |
| 8 | 3.06 | 30.81 | 1.39 | 0.48 | 0.11 | 0.14 | 0.07 |
| 9 | 3.07 | 31.64 | 1.42 | 0.48 | 0.11 | 0.14 | 0.08 |
| 10 | 2.23 | 31.26 | 1.42 | 0.65 | 0.08 | 0.10 | 0.05 |
| 11 | 1.45 | 31.69 | 1.45 | 1.00 | 0.05 | 0.07 | 0.04 |
| 12 | 1.45 | 33.17 | 1.63 | 1.00 | 0.05 | 0.07 | 0.04 |
| 13 | 1.44 | 32.96 | 1.58 | 1.00 | 0.05 | 0.07 | 0.04 |
| 14 | 1.05 | 32.41 | 1.50 | 1.00 | 0.03 | 0.05 | 0.03 |
| 15 | 1.43 | 31.26 | 1.45 | 1.00 | 0.05 | 0.07 | 0.03 |
| 16 | 2.96 | 26.64 | 1.24 | 0.48 | 0.12 | 0.14 | 0.06 |
| 17 | 2.95 | 25.19 | 1.10 | 0.48 | 0.13 | 0.13 | 0.06 |
| 18 | 1.46 | 30.82 | 1.39 | 1.00 | 0.05 | 0.07 | 0.04 |
| 19 | 1.48 | 29.92 | 1.33 | 1.00 | 0.05 | 0.07 | 0.04 |
| 20 | 1.46 | 30.07 | 1.31 | 1.00 | 0.05 | 0.06 | 0.04 |
| 21 | 1.48 | 28.40 | 1.18 | 1.00 | 0.06 | 0.06 | 0.04 |
| 22 | 0.66 | 33.11 | 1.55 | 1.00 | 0.02 | 0.03 | 0.02 |
| 23 | 1.44 | 29.67 | 1.36 | 1.00 | 0.05 | 0.07 | 0.04 |
| 24 | 1.44 | 27.65 | 1.27 | 1.00 | 0.06 | 0.07 | 0.04 |
| 25 | 1.43 | 30.54 | 1.42 | 1.00 | 0.05 | 0.07 | 0.04 |
| 26 | 1.43 | 30.70 | 1.42 | 1.00 | 0.05 | 0.07 | 0.04 |
| 27 | 1.44 | 31.53 | 1.45 | 1.00 | 0.05 | 0.07 | 0.04 |
| 28 | 1.44 | 32.11 | 1.48 | 1.00 | 0.05 | 0.07 | 0.04 |
| 29 | 1.46 | 31.25 | 1.42 | 1.00 | 0.05 | 0.07 | 0.04 |
| 30 | 1.43 | 32.54 | 1.51 | 1.00 | 0.05 | 0.07 | 0.04 |
| 31 | 1.41 | 29.42 | 1.38 | 1.00 | 0.05 | 0.07 | 0.04 |
| 32 | 1.45 | 31.79 | 1.47 | 1.00 | 0.05 | 0.07 | 0.04 |
| 33 | 1.44 | 31.58 | 1.43 | 1.00 | 0.05 | 0.07 | 0.04 |
| 34 | 1.44 | 30.86 | 1.42 | 1.00 | 0.05 | 0.07 | 0.04 |
| 35 | 1.44 | 28.93 | 1.28 | 1.00 | 0.05 | 0.06 | 0.04 |
| 36 | 1.45 | 29.02 | 1.30 | 1.00 | 0.05 | 0.06 | 0.04 |
| 37 | 1.85 | 29.44 | 1.34 | 0.78 | 0.07 | 0.08 | 0.05 |
| 38 | 1.85 | 30.95 | 1.40 | 1.00 | 0.06 | 0.08 | 0.04 |
| 39 | 0.28 | 33.80 | 1.59 | 1.00 | 0.01 | 0.01 | 0.01 |
| 40 | 0.00 | 34.30 | 1.63 | #DIV/0! | 0.00 | 0.00 | 0.00 |
| 41 | 0.65 | 31.97 | 1.51 | 1.00 | 0.02 | 0.03 | 0.02 |
| 42 | 1.41 | 29.05 | 1.36 | 1.00 | 0.05 | 0.07 | 0.03 |
| 43 | 0.64 | 30.86 | 1.48 | 1.00 | 0.02 | 0.03 | 0.02 |
| 44 | 0.64 | 32.77 | 1.57 | 1.00 | 0.02 | 0.03 | 0.02 |
| 45 | 0.63 | 33.55 | 1.63 | 1.00 | 0.02 | 0.03 | 0.02 |
| 46 | 0.64 | 31.55 | 1.51 | 1.00 | 0.02 | 0.03 | 0.02 |
| 47 | 0.63 | 31.14 | 1.51 | 1.00 | 0.02 | 0.03 | 0.02 |
| 48 | 0.65 | 31.05 | 1.48 | 1.00 | 0.02 | 0.03 | 0.02 |
| 49 | 0.64 | 30.85 | 1.48 | 1.00 | 0.02 | 0.03 | 0.02 |
| 50 | 0.63 | 29.77 | 1.45 | 1.00 | 0.02 | 0.03 | 0.02 |
| 51 | 0.62 | 28.71 | 1.41 | 1.00 | 0.02 | 0.03 | 0.02 |
| 52 | 0.64 | 31.02 | 1.48 | 1.00 | 0.02 | 0.03 | 0.02 |
| 53 | 0.65 | 31.04 | 1.46 | 1.00 | 0.02 | 0.03 | 0.02 |
| 54 | 0.64 | 30.94 | 1.46 | 1.00 | 0.02 | 0.03 | 0.02 |
| 55 | 0.64 | 31.02 | 1.46 | 1.00 | 0.02 | 0.03 | 0.02 |
| 56 | 0.62 | 30.07 | 1.48 | 1.00 | 0.02 | 0.03 | 0.02 |
| 57 | 1.40 | 27.96 | 1.33 | 1.00 | 0.05 | 0.07 | 0.03 |
| 58 | 1.40 | 28.14 | 1.33 | 1.00 | 0.05 | 0.07 | 0.03 |
| 59 | 1.40 | 28.04 | 1.32 | 1.00 | 0.05 | 0.07 | 0.03 |
| 60 | 1.40 | 28.00 | 1.31 | 1.00 | 0.05 | 0.07 | 0.03 |
| 61 | 1.40 | 27.51 | 1.30 | 1.00 | 0.05 | 0.07 | 0.03 |
| 62 | 1.40 | 28.13 | 1.32 | 1.00 | 0.05 | 0.07 | 0.03 |
| 63 | 1.40 | 28.09 | 1.31 | 1.00 | 0.05 | 0.07 | 0.03 |
| 64 | 1.40 | 28.12 | 1.32 | 1.00 | 0.05 | 0.07 | 0.03 |
| 65 | 1.40 | 28.07 | 1.31 | 1.00 | 0.05 | 0.07 | 0.03 |
| 66 | 1.40 | 27.82 | 1.32 | 1.00 | 0.05 | 0.07 | 0.03 |
| 67 | 1.41 | 27.39 | 1.29 | 1.00 | 0.05 | 0.07 | 0.03 |
| 68 | 1.42 | 26.93 | 1.26 | 1.00 | 0.06 | 0.07 | 0.03 |
| 69 | 1.40 | 26.18 | 1.24 | 1.00 | 0.06 | 0.07 | 0.03 |
| 70 | 1.40 | 27.68 | 1.31 | 1.00 | 0.05 | 0.07 | 0.03 |
| 71 | 1.41 | 27.39 | 1.29 | 1.00 | 0.05 | 0.07 | 0.03 |
| 72 | 1.44 | 25.87 | 1.20 | 1.00 | 0.06 | 0.07 | 0.03 |
| 73 | 1.46 | 24.78 | 1.13 | 1.00 | 0.06 | 0.07 | 0.03 |
| 74 | 1.39 | 25.04 | 1.19 | 1.00 | 0.06 | 0.07 | 0.03 |
| 75 | 1.39 | 24.07 | 1.15 | 1.00 | 0.06 | 0.07 | 0.03 |
| 76 | 1.38 | 25.50 | 1.22 | 1.00 | 0.06 | 0.07 | 0.03 |
| 77 | 1.80 | 27.34 | 1.26 | 1.00 | 0.07 | 0.08 | 0.04 |
| 78 | 1.38 | 24.98 | 1.21 | 1.00 | 0.06 | 0.07 | 0.03 |
| 79 | 1.38 | 24.53 | 1.18 | 1.00 | 0.06 | 0.07 | 0.03 |
| 80 | 1.38 | 25.43 | 1.22 | 1.00 | 0.06 | 0.07 | 0.03 |
| 81 | 1.38 | 25.45 | 1.22 | 1.00 | 0.06 | 0.07 | 0.03 |
| 82 | 1.43 | 20.87 | 0.93 | 1.00 | 0.07 | 0.06 | 0.03 |
| 83 | 1.43 | 20.74 | 0.90 | 1.00 | 0.07 | 0.06 | 0.03 |
| 84 | 1.41 | 29.05 | 1.36 | 1.00 | 0.05 | 0.07 | 0.03 |
| 85 | 1.40 | 27.96 | 1.33 | 1.00 | 0.05 | 0.07 | 0.03 |
| 86 | 1.43 | 20.14 | 0.87 | 1.00 | 0.08 | 0.06 | 0.03 |
| 87 | 1.43 | 19.41 | 0.81 | 1.00 | 0.08 | 0.06 | 0.03 |
| 88 | 1.44 | 20.20 | 0.88 | 1.00 | 0.08 | 0.06 | 0.03 |
| 89 | 1.44 | 19.54 | 0.83 | 1.00 | 0.08 | 0.06 | 0.03 |
| 90 | 1.45 | 18.86 | 0.79 | 1.00 | 0.08 | 0.06 | 0.03 |
| 91 | 1.42 | 21.85 | 0.98 | 1.00 | 0.07 | 0.06 | 0.03 |
| 92 | 1.40 | 22.80 | 1.04 | 1.00 | 0.07 | 0.06 | 0.03 |
| 93 | 1.38 | 23.73 | 1.09 | 1.00 | 0.06 | 0.06 | 0.03 |
| 94 | 1.24 | 20.56 | 0.89 | 1.00 | 0.06 | 0.05 | 0.03 |
| 95 | 1.64 | 21.18 | 0.97 | 1.00 | 0.08 | 0.07 | 0.04 |
| 96 | 1.24 | 20.63 | 0.90 | 1.00 | 0.06 | 0.05 | 0.03 |
| 97 | 1.05 | 20.38 | 0.88 | 1.00 | 0.05 | 0.04 | 0.02 |
| 98 | 0.85 | 20.14 | 0.85 | 1.00 | 0.04 | 0.04 | 0.02 |
| 99 | 1.63 | 21.12 | 0.96 | 1.00 | 0.08 | 0.07 | 0.04 |
| 100 | 1.42 | 20.73 | 0.93 | 1.00 | 0.07 | 0.06 | 0.03 |
| 101 | 1.42 | 20.59 | 0.93 | 1.00 | 0.07 | 0.06 | 0.03 |
| 102 | 1.41 | 20.45 | 0.93 | 1.00 | 0.07 | 0.06 | 0.03 |
| 103 | 1.44 | 21.01 | 0.93 | 1.00 | 0.07 | 0.06 | 0.03 |
| 104 | 1.45 | 21.16 | 0.93 | 1.00 | 0.07 | 0.06 | 0.03 |
| 105 | 1.46 | 21.30 | 0.93 | 1.00 | 0.07 | 0.06 | 0.04 |
| 106 | 1.65 | 21.39 | 0.94 | 1.00 | 0.08 | 0.07 | 0.04 |
| 107 | 1.45 | 19.87 | 0.87 | 1.00 | 0.08 | 0.06 | 0.03 |
| 108 | 1.44 | 20.36 | 0.90 | 1.00 | 0.08 | 0.06 | 0.03 |
| 109 | 1.44 | 20.38 | 0.90 | 1.00 | 0.08 | 0.06 | 0.03 |
| 110 | 1.44 | 21.01 | 0.96 | 1.00 | 0.07 | 0.07 | 0.03 |
| 111 | 1.45 | 21.14 | 0.98 | 1.00 | 0.07 | 0.07 | 0.03 |
| 112 | 1.43 | 20.74 | 0.90 | 1.00 | 0.07 | 0.06 | 0.03 |
| 113 | 1.42 | 20.60 | 0.88 | 1.00 | 0.07 | 0.06 | 0.03 |
| 114 | 3.90 | 24.61 | 1.32 | 1.00 | 0.19 | 0.21 | 0.09 |
| 115 | 1.42 | 20.68 | 0.93 | 1.00 | 0.07 | 0.06 | 0.03 |
| 116 | 1.41 | 20.50 | 0.93 | 1.00 | 0.07 | 0.06 | 0.03 |
| 117 | 1.44 | 20.92 | 0.90 | 1.00 | 0.07 | 0.06 | 0.03 |
| 118 | 1.44 | 20.99 | 0.91 | 1.00 | 0.07 | 0.06 | 0.03 |
| 119 | 4.83 | 22.50 | 1.13 | 1.00 | 0.27 | 0.24 | 0.10 |
| 120 | 1.84 | 21.19 | 0.95 | 0.67 | 0.10 | 0.08 | 0.04 |
| 121 | 1.23 | 21.76 | 0.98 | 1.00 | 0.06 | 0.06 | 0.03 |
| 122 | 1.64 | 21.03 | 0.94 | 0.76 | 0.08 | 0.07 | 0.04 |
| 123 | 1.42 | 20.73 | 0.93 | 1.00 | 0.07 | 0.06 | 0.03 |
| 124 | 1.64 | 21.24 | 0.94 | 1.00 | 0.08 | 0.07 | 0.04 |
| 125 | 1.50 | 20.26 | 0.86 | 1.00 | 0.08 | 0.06 | 0.04 |
| 126 | 4.89 | 21.49 | 1.07 | 1.00 | 0.29 | 0.24 | 0.10 |
| 127 | 1.45 | 21.07 | 0.90 | 1.00 | 0.07 | 0.06 | 0.03 |
| 128 | 1.45 | 21.14 | 0.91 | 1.00 | 0.07 | 0.06 | 0.03 |
| 129 | 1.63 | 21.78 | 0.97 | 1.00 | 0.08 | 0.07 | 0.04 |
| 130 | 4.96 | 20.45 | 1.00 | 1.00 | 0.32 | 0.24 | 0.10 |
| 131 | 1.66 | 20.87 | 0.91 | 1.00 | 0.09 | 0.07 | 0.04 |
| 132 | 1.67 | 20.52 | 0.89 | 1.00 | 0.09 | 0.07 | 0.04 |
| 133 | 1.66 | 21.53 | 0.94 | 1.00 | 0.08 | 0.07 | 0.04 |
| 134 | 1.67 | 21.69 | 0.94 | 1.00 | 0.08 | 0.07 | 0.04 |
| 135 | 1.67 | 20.51 | 0.90 | 1.00 | 0.09 | 0.07 | 0.04 |
| 136 | 1.67 | 20.47 | 0.90 | 1.00 | 0.09 | 0.07 | 0.04 |
| 137 | 1.65 | 21.59 | 0.95 | 1.00 | 0.08 | 0.07 | 0.04 |
| 138 | 1.88 | 20.09 | 0.87 | 1.00 | 0.10 | 0.08 | 0.04 |
| 139 | 1.65 | 21.41 | 0.94 | 1.00 | 0.08 | 0.07 | 0.04 |
| 140 | 1.65 | 21.36 | 0.94 | 1.00 | 0.08 | 0.07 | 0.04 |
| 141 | 1.45 | 21.80 | 0.96 | 1.00 | 0.07 | 0.06 | 0.03 |
| 142 | 1.43 | 22.78 | 1.02 | 1.00 | 0.07 | 0.06 | 0.03 |
| 143 | 1.65 | 21.32 | 0.92 | 1.00 | 0.08 | 0.07 | 0.04 |
| 144 | 1.64 | 21.25 | 0.91 | 1.00 | 0.08 | 0.07 | 0.04 |
| 145 | 1.66 | 21.46 | 0.95 | 1.00 | 0.08 | 0.07 | 0.04 |
| 146 | 1.66 | 21.53 | 0.96 | 1.00 | 0.08 | 0.07 | 0.04 |
| 147 | 1.66 | 21.44 | 0.94 | 1.00 | 0.08 | 0.07 | 0.04 |
| 148 | 1.22 | 24.12 | 1.09 | 1.00 | 0.05 | 0.06 | 0.03 |
| 149 | 2.30 | 20.28 | 0.88 | 0.73 | 0.13 | 0.10 | 0.05 |
| 150 | 1.64 | 21.96 | 0.97 | 1.00 | 0.08 | 0.07 | 0.04 |
| 151 | 1.62 | 22.93 | 1.02 | 1.00 | 0.08 | 0.07 | 0.04 |
| 152 | 1.65 | 21.40 | 0.95 | 1.00 | 0.08 | 0.07 | 0.04 |
| 153 | 1.65 | 21.36 | 0.95 | 1.00 | 0.08 | 0.07 | 0.04 |
| 154 | 1.63 | 22.52 | 1.00 | 1.00 | 0.08 | 0.07 | 0.04 |
| 155 | 1.66 | 21.56 | 0.91 | 1.00 | 0.08 | 0.07 | 0.04 |
| 156 | 1.64 | 21.21 | 0.97 | 1.00 | 0.08 | 0.07 | 0.04 |
| 157 | 1.65 | 21.40 | 0.94 | 1.00 | 0.08 | 0.07 | 0.04 |
| 158 | 1.66 | 21.47 | 0.94 | 1.00 | 0.08 | 0.07 | 0.04 |
| 159 | 1.55 | 21.19 | 0.93 | 1.00 | 0.08 | 0.07 | 0.04 |
| 160 | 1.68 | 21.74 | 0.94 | 1.00 | 0.08 | 0.07 | 0.04 |
| 161 | 1.86 | 21.01 | 0.91 | 1.00 | 0.10 | 0.08 | 0.05 |
| 162 | 1.96 | 20.80 | 0.90 | 1.00 | 0.10 | 0.09 | 0.05 |
| 163 | 1.65 | 21.26 | 0.93 | 1.00 | 0.08 | 0.07 | 0.04 |
| 164 | 1.65 | 21.37 | 0.95 | 1.00 | 0.08 | 0.07 | 0.04 |
| 165 | 1.59 | 20.63 | 0.94 | 1.00 | 0.08 | 0.07 | 0.04 |
| 166 | 1.61 | 20.91 | 0.94 | 1.00 | 0.08 | 0.07 | 0.04 |
| 167 | 1.59 | 20.57 | 0.94 | 1.00 | 0.08 | 0.07 | 0.04 |
| 168 | 1.61 | 20.85 | 0.94 | 1.00 | 0.08 | 0.07 | 0.04 |
| 169 | 1.76 | 21.65 | 0.94 | 1.00 | 0.09 | 0.08 | 0.04 |
| 170 | 1.65 | 22.35 | 0.98 | 1.00 | 0.08 | 0.07 | 0.04 |
| 171 | 1.66 | 21.86 | 0.95 | 1.00 | 0.08 | 0.07 | 0.04 |
| 172 | 1.66 | 21.52 | 0.93 | 1.00 | 0.08 | 0.07 | 0.04 |
| 173 | 1.98 | 22.04 | 0.97 | 1.00 | 0.10 | 0.09 | 0.05 |
| 174 | 1.76 | 21.62 | 0.95 | 1.00 | 0.09 | 0.08 | 0.04 |
| 175 | 1.76 | 21.58 | 0.95 | 1.00 | 0.09 | 0.08 | 0.04 |
| 176 | 1.87 | 21.83 | 0.96 | 1.00 | 0.09 | 0.08 | 0.05 |
| 177 | 2.08 | 22.23 | 0.99 | 1.00 | 0.10 | 0.09 | 0.05 |
| 178 | 2.19 | 22.43 | 1.01 | 1.00 | 0.11 | 0.10 | 0.05 |
| 179 | 1.76 | 21.61 | 0.95 | 1.00 | 0.09 | 0.08 | 0.04 |
| 180 | 1.76 | 21.60 | 0.96 | 1.00 | 0.09 | 0.08 | 0.05 |
| 181 | 1.92 | 21.91 | 0.97 | 1.00 | 0.10 | 0.09 | 0.05 |
| 182 | 1.97 | 22.00 | 0.98 | 1.00 | 0.10 | 0.09 | 0.05 |
| 183 | 2.03 | 22.09 | 0.99 | 1.00 | 0.10 | 0.09 | 0.05 |
| 184 | 2.08 | 22.18 | 1.01 | 1.00 | 0.10 | 0.09 | 0.05 |
| 185 | 1.58 | 19.10 | 0.87 | 1.00 | 0.09 | 0.07 | 0.03 |
| 186 | 1.61 | 20.91 | 0.94 | 1.00 | 0.08 | 0.07 | 0.04 |
| 187 | 1.77 | 21.13 | 0.91 | 1.00 | 0.09 | 0.08 | 0.04 |
| 188 | 1.74 | 22.59 | 0.99 | 1.00 | 0.08 | 0.08 | 0.04 |
| 189 | 1.74 | 22.63 | 1.00 | 1.00 | 0.08 | 0.08 | 0.04 |
| 190 | 1.76 | 21.79 | 0.95 | 1.00 | 0.09 | 0.08 | 0.04 |
| 191 | 1.75 | 21.52 | 0.93 | 1.00 | 0.09 | 0.08 | 0.04 |
| 192 | 1.43 | 19.43 | 0.86 | 1.00 | 0.08 | 0.06 | 0.04 |

TABLE 6

| | (MgO + | | | | | | |
|---|---|---|---|---|---|---|---|
| | CaO + | | | | | | |
| | SrO + | (La₂O₃ + | | | | | |
| | BaO + | Gd₂O₃ + | | | | | |
| | ZnO)/ | Y₂O₃)/ | TiO₂/ | Nb₂O₅/ | Ta₂O₅/ | WO₃/ | Bi₂O₃/ |
| | (TiO₂ + | (TiO₂ + | (TiO₂ + | (TiO₂ + | (TiO₂ + | (TiO₂ + | (TiO₂ + |
| | Nb₂O₅ + | Nb₂O₅ + | Nb₂O₅ + | Nb₂O₅ + | Nb₂O₅ + | Nb₂O₅ + | Nb₂O₅ + |
| | Ta₂O₅ + | Ta₂O₅ + | Ta₂O₅ + | Ta₂O₅ + | Ta₂O₅ + | Ta₂O₅ + | Ta₂O₅ + |
| | WO₃ + | WO₃ + | WO₃ + | WO₃ + | WO₃ + | WO₃ + | WO₃ + |
| No. | Bi₂O₃) | Bi₂O₃) | Bi₂O₃) | Bi₂O₃) | Bi₂O₃) | Bi₂O₃) | Bi₂O₃) |
| 1 | 0.64 | 0.08 | 0.48 | 0.52 | 0.00 | 0.00 | 0.00 |
| 2 | 0.64 | 0.20 | 0.39 | 0.61 | 0.00 | 0.00 | 0.00 |
| 3 | 0.66 | 0.08 | 0.54 | 0.46 | 0.00 | 0.00 | 0.00 |
| 4 | 0.62 | 0.07 | 0.41 | 0.59 | 0.00 | 0.00 | 0.00 |
| 5 | 0.60 | 0.07 | 0.35 | 0.65 | 0.00 | 0.00 | 0.00 |
| 6 | 0.56 | 0.07 | 0.25 | 0.75 | 0.00 | 0.00 | 0.00 |
| 7 | 0.72 | 0.09 | 0.73 | 0.27 | 0.00 | 0.00 | 0.00 |
| 8 | 0.67 | 0.08 | 0.46 | 0.54 | 0.00 | 0.00 | 0.00 |
| 9 | 0.71 | 0.08 | 0.45 | 0.55 | 0.00 | 0.00 | 0.00 |
| 10 | 0.71 | 0.08 | 0.46 | 0.54 | 0.00 | 0.00 | 0.00 |
| 11 | 0.74 | 0.08 | 0.46 | 0.54 | 0.00 | 0.00 | 0.00 |
| 12 | 0.78 | 0.08 | 0.46 | 0.54 | 0.00 | 0.00 | 0.00 |
| 13 | 0.78 | 0.08 | 0.46 | 0.54 | 0.00 | 0.00 | 0.00 |
| 14 | 0.78 | 0.08 | 0.46 | 0.54 | 0.00 | 0.00 | 0.00 |
| 15 | 0.72 | 0.08 | 0.40 | 0.60 | 0.00 | 0.00 | 0.00 |
| 16 | 0.51 | 0.07 | 0.25 | 0.75 | 0.00 | 0.00 | 0.00 |
| 17 | 0.48 | 0.07 | 0.25 | 0.75 | 0.00 | 0.00 | 0.00 |
| 18 | 0.71 | 0.08 | 0.46 | 0.54 | 0.00 | 0.00 | 0.00 |
| 19 | 0.68 | 0.08 | 0.46 | 0.54 | 0.00 | 0.00 | 0.00 |
| 20 | 0.69 | 0.08 | 0.46 | 0.54 | 0.00 | 0.00 | 0.00 |
| 21 | 0.64 | 0.08 | 0.46 | 0.54 | 0.00 | 0.00 | 0.00 |
| 22 | 0.81 | 0.08 | 0.46 | 0.54 | 0.00 | 0.00 | 0.00 |
| 23 | 0.69 | 0.13 | 0.46 | 0.54 | 0.00 | 0.00 | 0.00 |
| 24 | 0.64 | 0.18 | 0.46 | 0.54 | 0.00 | 0.00 | 0.00 |
| 25 | 0.72 | 0.13 | 0.46 | 0.54 | 0.00 | 0.00 | 0.00 |
| 26 | 0.72 | 0.08 | 0.46 | 0.54 | 0.00 | 0.00 | 0.00 |
| 27 | 0.74 | 0.13 | 0.46 | 0.54 | 0.00 | 0.00 | 0.00 |
| 28 | 0.75 | 0.08 | 0.46 | 0.54 | 0.00 | 0.00 | 0.00 |
| 29 | 0.72 | 0.08 | 0.46 | 0.54 | 0.00 | 0.00 | 0.00 |
| 30 | 0.77 | 0.08 | 0.46 | 0.54 | 0.00 | 0.00 | 0.00 |
| 31 | 0.70 | 0.18 | 0.46 | 0.54 | 0.00 | 0.00 | 0.00 |
| 32 | 0.74 | 0.08 | 0.46 | 0.54 | 0.00 | 0.00 | 0.00 |
| 33 | 0.74 | 0.08 | 0.46 | 0.54 | 0.00 | 0.00 | 0.00 |
| 34 | 0.75 | 0.08 | 0.46 | 0.54 | 0.00 | 0.00 | 0.00 |
| 35 | 0.67 | 0.13 | 0.46 | 0.54 | 0.00 | 0.00 | 0.00 |
| 36 | 0.67 | 0.13 | 0.46 | 0.54 | 0.00 | 0.00 | 0.00 |
| 37 | 0.67 | 0.13 | 0.46 | 0.54 | 0.00 | 0.00 | 0.00 |
| 38 | 0.70 | 0.08 | 0.46 | 0.54 | 0.00 | 0.00 | 0.00 |
| 39 | 0.85 | 0.08 | 0.46 | 0.54 | 0.00 | 0.00 | 0.00 |
| 40 | 0.87 | 0.08 | 0.46 | 0.54 | 0.00 | 0.00 | 0.00 |
| 41 | 0.79 | 0.13 | 0.46 | 0.54 | 0.00 | 0.00 | 0.00 |
| 42 | 0.66 | 0.12 | 0.33 | 0.67 | 0.00 | 0.00 | 0.00 |
| 43 | 0.78 | 0.18 | 0.46 | 0.54 | 0.00 | 0.00 | 0.00 |
| 44 | 0.82 | 0.13 | 0.46 | 0.54 | 0.00 | 0.00 | 0.00 |
| 45 | 0.85 | 0.13 | 0.46 | 0.54 | 0.00 | 0.00 | 0.00 |
| 46 | 0.77 | 0.13 | 0.40 | 0.60 | 0.00 | 0.00 | 0.00 |
| 47 | 0.74 | 0.12 | 0.34 | 0.66 | 0.00 | 0.00 | 0.00 |
| 48 | 0.84 | 0.19 | 0.48 | 0.52 | 0.00 | 0.00 | 0.00 |
| 49 | 0.82 | 0.19 | 0.45 | 0.55 | 0.00 | 0.00 | 0.00 |
| 50 | 0.76 | 0.23 | 0.46 | 0.54 | 0.00 | 0.00 | 0.00 |
| 51 | 0.74 | 0.29 | 0.46 | 0.54 | 0.00 | 0.00 | 0.00 |
| 52 | 0.80 | 0.18 | 0.46 | 0.54 | 0.00 | 0.00 | 0.00 |
| 53 | 0.79 | 0.19 | 0.47 | 0.53 | 0.00 | 0.00 | 0.00 |
| 54 | 0.79 | 0.18 | 0.46 | 0.54 | 0.00 | 0.00 | 0.00 |
| 55 | 0.78 | 0.18 | 0.46 | 0.54 | 0.00 | 0.00 | 0.00 |
| 56 | 0.73 | 0.17 | 0.34 | 0.66 | 0.00 | 0.00 | 0.00 |
| 57 | 0.64 | 0.17 | 0.33 | 0.67 | 0.00 | 0.00 | 0.00 |
| 58 | 0.64 | 0.16 | 0.33 | 0.67 | 0.00 | 0.00 | 0.00 |
| 59 | 0.65 | 0.18 | 0.32 | 0.68 | 0.00 | 0.00 | 0.00 |
| 60 | 0.65 | 0.18 | 0.32 | 0.68 | 0.00 | 0.00 | 0.00 |
| 61 | 0.62 | 0.17 | 0.33 | 0.67 | 0.00 | 0.00 | 0.00 |
| 62 | 0.65 | 0.18 | 0.34 | 0.66 | 0.00 | 0.00 | 0.00 |
| 63 | 0.65 | 0.18 | 0.34 | 0.66 | 0.00 | 0.00 | 0.00 |
| 64 | 0.64 | 0.17 | 0.33 | 0.67 | 0.00 | 0.00 | 0.00 |
| 65 | 0.64 | 0.17 | 0.33 | 0.67 | 0.00 | 0.00 | 0.00 |
| 66 | 0.63 | 0.17 | 0.33 | 0.67 | 0.00 | 0.00 | 0.00 |
| 67 | 0.62 | 0.17 | 0.33 | 0.67 | 0.00 | 0.00 | 0.00 |
| 68 | 0.60 | 0.17 | 0.33 | 0.67 | 0.00 | 0.00 | 0.00 |
| 69 | 0.59 | 0.21 | 0.33 | 0.67 | 0.00 | 0.00 | 0.00 |
| 70 | 0.63 | 0.17 | 0.33 | 0.67 | 0.00 | 0.00 | 0.00 |
| 71 | 0.62 | 0.17 | 0.33 | 0.67 | 0.00 | 0.00 | 0.00 |
| 72 | 0.57 | 0.17 | 0.33 | 0.67 | 0.00 | 0.00 | 0.00 |
| 73 | 0.54 | 0.17 | 0.33 | 0.67 | 0.00 | 0.00 | 0.00 |
| 74 | 0.57 | 0.25 | 0.33 | 0.67 | 0.00 | 0.00 | 0.00 |
| 75 | 0.55 | 0.27 | 0.33 | 0.67 | 0.00 | 0.00 | 0.00 |
| 76 | 0.58 | 0.25 | 0.33 | 0.67 | 0.00 | 0.00 | 0.00 |
| 77 | 0.62 | 0.18 | 0.34 | 0.66 | 0.00 | 0.00 | 0.00 |
| 78 | 0.58 | 0.27 | 0.33 | 0.67 | 0.00 | 0.00 | 0.00 |
| 79 | 0.56 | 0.27 | 0.33 | 0.67 | 0.00 | 0.00 | 0.00 |
| 80 | 0.58 | 0.27 | 0.33 | 0.67 | 0.00 | 0.00 | 0.00 |
| 81 | 0.60 | 0.28 | 0.34 | 0.66 | 0.00 | 0.00 | 0.00 |
| 82 | 0.45 | 0.27 | 0.33 | 0.67 | 0.00 | 0.00 | 0.00 |
| 83 | 0.45 | 0.27 | 0.33 | 0.67 | 0.00 | 0.00 | 0.00 |
| 84 | 0.66 | 0.12 | 0.33 | 0.67 | 0.00 | 0.00 | 0.00 |
| 85 | 0.64 | 0.17 | 0.33 | 0.67 | 0.00 | 0.00 | 0.00 |
| 86 | 0.44 | 0.27 | 0.33 | 0.67 | 0.00 | 0.00 | 0.00 |
| 87 | 0.42 | 0.27 | 0.33 | 0.67 | 0.00 | 0.00 | 0.00 |
| 88 | 0.44 | 0.27 | 0.33 | 0.67 | 0.00 | 0.00 | 0.00 |
| 89 | 0.42 | 0.27 | 0.33 | 0.67 | 0.00 | 0.00 | 0.00 |
| 90 | 0.40 | 0.27 | 0.33 | 0.67 | 0.00 | 0.00 | 0.00 |
| 91 | 0.48 | 0.27 | 0.33 | 0.67 | 0.00 | 0.00 | 0.00 |
| 92 | 0.51 | 0.27 | 0.33 | 0.67 | 0.00 | 0.00 | 0.00 |
| 93 | 0.54 | 0.27 | 0.33 | 0.67 | 0.00 | 0.00 | 0.00 |
| 94 | 0.45 | 0.27 | 0.33 | 0.67 | 0.00 | 0.00 | 0.00 |
| 95 | 0.45 | 0.27 | 0.33 | 0.67 | 0.00 | 0.00 | 0.00 |
| 96 | 0.45 | 0.27 | 0.33 | 0.67 | 0.00 | 0.00 | 0.00 |
| 97 | 0.45 | 0.27 | 0.33 | 0.67 | 0.00 | 0.00 | 0.00 |
| 98 | 0.45 | 0.27 | 0.33 | 0.67 | 0.00 | 0.00 | 0.00 |
| 99 | 0.45 | 0.27 | 0.33 | 0.67 | 0.00 | 0.00 | 0.00 |
| 100 | 0.45 | 0.27 | 0.30 | 0.70 | 0.00 | 0.00 | 0.00 |
| 101 | 0.44 | 0.26 | 0.27 | 0.73 | 0.00 | 0.00 | 0.00 |
| 102 | 0.43 | 0.26 | 0.25 | 0.75 | 0.00 | 0.00 | 0.00 |
| 103 | 0.46 | 0.28 | 0.36 | 0.64 | 0.00 | 0.00 | 0.00 |
| 104 | 0.47 | 0.28 | 0.39 | 0.61 | 0.00 | 0.00 | 0.00 |
| 105 | 0.48 | 0.28 | 0.42 | 0.58 | 0.00 | 0.00 | 0.00 |
| 106 | 0.47 | 0.28 | 0.34 | 0.66 | 0.00 | 0.00 | 0.00 |
| 107 | 0.43 | 0.27 | 0.33 | 0.67 | 0.00 | 0.00 | 0.00 |
| 108 | 0.44 | 0.27 | 0.33 | 0.67 | 0.00 | 0.00 | 0.00 |
| 109 | 0.44 | 0.27 | 0.33 | 0.67 | 0.00 | 0.00 | 0.00 |
| 110 | 0.45 | 0.27 | 0.33 | 0.67 | 0.00 | 0.00 | 0.00 |
| 111 | 0.45 | 0.27 | 0.33 | 0.67 | 0.00 | 0.00 | 0.00 |
| 112 | 0.45 | 0.27 | 0.33 | 0.67 | 0.00 | 0.00 | 0.00 |
| 113 | 0.45 | 0.27 | 0.33 | 0.67 | 0.00 | 0.00 | 0.00 |
| 114 | 0.47 | 0.16 | 0.09 | 0.91 | 0.00 | 0.00 | 0.00 |
| 115 | 0.45 | 0.27 | 0.33 | 0.67 | 0.00 | 0.00 | 0.00 |
| 116 | 0.45 | 0.27 | 0.33 | 0.67 | 0.00 | 0.00 | 0.00 |
| 117 | 0.47 | 0.28 | 0.31 | 0.69 | 0.00 | 0.00 | 0.00 |
| 118 | 0.47 | 0.28 | 0.31 | 0.69 | 0.00 | 0.00 | 0.00 |
| 119 | 0.38 | 0.10 | 0.09 | 0.91 | 0.00 | 0.00 | 0.00 |
| 120 | 0.45 | 0.27 | 0.33 | 0.67 | 0.00 | 0.00 | 0.00 |
| 121 | 0.49 | 0.27 | 0.33 | 0.67 | 0.00 | 0.00 | 0.00 |
| 122 | 0.45 | 0.27 | 0.33 | 0.67 | 0.00 | 0.00 | 0.00 |
| 123 | 0.45 | 0.27 | 0.30 | 0.70 | 0.00 | 0.00 | 0.00 |
| 124 | 0.47 | 0.28 | 0.31 | 0.69 | 0.00 | 0.00 | 0.00 |
| 125 | 0.45 | 0.29 | 0.46 | 0.54 | 0.00 | 0.00 | 0.00 |
| 126 | 0.35 | 0.10 | 0.09 | 0.91 | 0.00 | 0.00 | 0.00 |
| 127 | 0.47 | 0.28 | 0.34 | 0.66 | 0.00 | 0.00 | 0.00 |
| 128 | 0.47 | 0.28 | 0.34 | 0.66 | 0.00 | 0.00 | 0.00 |
| 129 | 0.48 | 0.28 | 0.31 | 0.69 | 0.00 | 0.00 | 0.00 |
| 130 | 0.32 | 0.10 | 0.09 | 0.91 | 0.00 | 0.00 | 0.00 |
| 131 | 0.46 | 0.28 | 0.34 | 0.66 | 0.00 | 0.00 | 0.00 |
| 132 | 0.45 | 0.28 | 0.34 | 0.66 | 0.00 | 0.00 | 0.00 |
| 133 | 0.48 | 0.29 | 0.38 | 0.62 | 0.00 | 0.00 | 0.00 |
| 134 | 0.49 | 0.29 | 0.41 | 0.59 | 0.00 | 0.00 | 0.00 |
| 135 | 0.45 | 0.28 | 0.34 | 0.66 | 0.00 | 0.00 | 0.00 |
| 136 | 0.45 | 0.28 | 0.34 | 0.66 | 0.00 | 0.00 | 0.00 |
| 137 | 0.48 | 0.28 | 0.34 | 0.66 | 0.00 | 0.00 | 0.00 |
| 138 | 0.43 | 0.28 | 0.34 | 0.66 | 0.00 | 0.00 | 0.00 |
| 139 | 0.49 | 0.29 | 0.36 | 0.64 | 0.00 | 0.00 | 0.00 |
| 140 | 0.45 | 0.27 | 0.33 | 0.67 | 0.00 | 0.00 | 0.00 |
| 141 | 0.49 | 0.28 | 0.34 | 0.66 | 0.00 | 0.00 | 0.00 |
| 142 | 0.52 | 0.28 | 0.34 | 0.66 | 0.00 | 0.00 | 0.00 |
| 143 | 0.47 | 0.28 | 0.34 | 0.66 | 0.00 | 0.00 | 0.00 |
| 144 | 0.47 | 0.28 | 0.34 | 0.66 | 0.00 | 0.00 | 0.00 |
| 145 | 0.47 | 0.28 | 0.34 | 0.66 | 0.00 | 0.00 | 0.00 |
| 146 | 0.47 | 0.28 | 0.34 | 0.66 | 0.00 | 0.00 | 0.00 |
| 147 | 0.52 | 0.31 | 0.38 | 0.62 | 0.00 | 0.00 | 0.00 |
| 148 | 0.57 | 0.28 | 0.34 | 0.66 | 0.00 | 0.00 | 0.00 |
| 149 | 0.43 | 0.28 | 0.34 | 0.66 | 0.00 | 0.00 | 0.00 |
| 150 | 0.49 | 0.28 | 0.34 | 0.66 | 0.00 | 0.00 | 0.00 |
| 151 | 0.52 | 0.28 | 0.34 | 0.66 | 0.00 | 0.00 | 0.00 |
| 152 | 0.47 | 0.28 | 0.34 | 0.66 | 0.00 | 0.00 | 0.00 |
| 153 | 0.47 | 0.28 | 0.34 | 0.66 | 0.00 | 0.00 | 0.00 |
| 154 | 0.51 | 0.28 | 0.34 | 0.66 | 0.00 | 0.00 | 0.00 |
| 155 | 0.47 | 0.28 | 0.34 | 0.66 | 0.00 | 0.00 | 0.00 |
| 156 | 0.47 | 0.28 | 0.34 | 0.66 | 0.00 | 0.00 | 0.00 |
| 157 | 0.52 | 0.31 | 0.38 | 0.62 | 0.00 | 0.00 | 0.00 |
| 158 | 0.52 | 0.31 | 0.38 | 0.62 | 0.00 | 0.00 | 0.00 |
| 159 | 0.52 | 0.31 | 0.38 | 0.62 | 0.00 | 0.00 | 0.00 |
| 160 | 0.54 | 0.32 | 0.45 | 0.55 | 0.00 | 0.00 | 0.00 |
| 161 | 0.50 | 0.31 | 0.38 | 0.62 | 0.00 | 0.00 | 0.00 |
| 162 | 0.49 | 0.31 | 0.38 | 0.62 | 0.00 | 0.00 | 0.00 |
| 163 | 0.51 | 0.31 | 0.38 | 0.62 | 0.00 | 0.00 | 0.00 |
| 164 | 0.52 | 0.31 | 0.38 | 0.62 | 0.00 | 0.00 | 0.00 |
| 165 | 0.43 | 0.26 | 0.27 | 0.60 | 0.13 | 0.00 | 0.00 |
| 166 | 0.45 | 0.27 | 0.33 | 0.54 | 0.13 | 0.00 | 0.00 |
| 167 | 0.43 | 0.26 | 0.27 | 0.60 | 0.00 | 0.13 | 0.00 |
| 168 | 0.45 | 0.27 | 0.32 | 0.54 | 0.00 | 0.14 | 0.00 |
| 169 | 0.48 | 0.29 | 0.35 | 0.65 | 0.00 | 0.00 | 0.00 |
| 170 | 0.51 | 0.29 | 0.35 | 0.65 | 0.00 | 0.00 | 0.00 |
| 171 | 0.49 | 0.29 | 0.35 | 0.65 | 0.00 | 0.00 | 0.00 |
| 172 | 0.48 | 0.29 | 0.35 | 0.65 | 0.00 | 0.00 | 0.00 |
| 173 | 0.49 | 0.29 | 0.36 | 0.64 | 0.00 | 0.00 | 0.00 |
| 174 | 0.50 | 0.30 | 0.36 | 0.64 | 0.00 | 0.00 | 0.00 |
| 175 | 0.50 | 0.30 | 0.36 | 0.64 | 0.00 | 0.00 | 0.00 |
| 176 | 0.49 | 0.29 | 0.36 | 0.64 | 0.00 | 0.00 | 0.00 |
| 177 | 0.49 | 0.29 | 0.36 | 0.64 | 0.00 | 0.00 | 0.00 |
| 178 | 0.49 | 0.29 | 0.36 | 0.64 | 0.00 | 0.00 | 0.00 |
| 179 | 0.51 | 0.30 | 0.37 | 0.63 | 0.00 | 0.00 | 0.00 |
| 180 | 0.52 | 0.31 | 0.38 | 0.62 | 0.00 | 0.00 | 0.00 |
| 181 | 0.50 | 0.30 | 0.36 | 0.64 | 0.00 | 0.00 | 0.00 |
| 182 | 0.50 | 0.30 | 0.37 | 0.63 | 0.00 | 0.00 | 0.00 |
| 183 | 0.51 | 0.30 | 0.37 | 0.63 | 0.00 | 0.00 | 0.00 |
| 184 | 0.52 | 0.31 | 0.38 | 0.62 | 0.00 | 0.00 | 0.00 |
| 185 | 0.39 | 0.25 | 0.30 | 0.58 | 0.12 | 0.00 | 0.00 |
| 186 | 0.45 | 0.27 | 0.33 | 0.54 | 0.13 | 0.00 | 0.00 |
| 187 | 0.47 | 0.29 | 0.35 | 0.65 | 0.00 | 0.00 | 0.00 |
| 188 | 0.51 | 0.29 | 0.35 | 0.65 | 0.00 | 0.00 | 0.00 |
| 189 | 0.51 | 0.29 | 0.35 | 0.65 | 0.00 | 0.00 | 0.00 |
| 190 | 0.49 | 0.29 | 0.35 | 0.65 | 0.00 | 0.00 | 0.00 |
| 191 | 0.48 | 0.29 | 0.36 | 0.64 | 0.00 | 0.00 | 0.00 |
| 192 | 0.45 | 0.39 | 0.46 | 0.54 | 0.00 | 0.00 | 0.00 |

TABLE 7

| | (SiO₂ + | | | | | |
|---|---|---|---|---|---|---|
| | B₂O₃ + | | | | | |
| | Na₂O + | | | | | |
| | K₂O + | | | | | |
| | MgO + | | | | | |
| | CaO + | | | | | |
| | SrO + | | | | | |
| | BaO + | | | | | |
| | ZnO)/ | | | | | |
| | (Li₂O + | | | | | |
| | La₂O₃ + | | | | | |
| | Gd₂O₃ + | | (MgO + | | | |
| | Y₂O₃ + | ZrO₂/ | GaO + | | (SiO₂ + | |
| | ZrO₂ + | (TiO₂ + | SrO + | | CaO)/ | ZrO₂/ |
| | TiO₂ + | Nb₂O₅ + | BaO)/ | | (TiO₂ + | (TiO₂ + |
| | Nb₂O₅ + | Ta₂O₅ + | (TiO₂ + | | Nb₂O₅ + | Nb₂O₅ + |
| | Ta₂O₅ + | WO₃ + | Nb₂O₅ + | Re₂O₃/ | Ta₂O₅ + | Ta₂O₅ + |
| | WO₃ + | Bi₂O₃ + | WO₃ + | (Re₂O₃ + | WO₃ + | WO₃ + |
| No. | Bi₂O₃) | ZrO₂) | ZnO) | SiO₂) | Bi₂O₃) | Bi₂O₃) |
| 1 | 1.02 | 0.05 | 0.64 | 0.14 | 0.77 | 0.06 |
| 2 | 0.98 | 0.08 | 0.64 | 0.26 | 1.01 | 0.09 |
| 3 | 1.05 | 0.05 | 0.66 | 0.14 | 0.79 | 0.06 |
| 4 | 1.00 | 0.05 | 0.62 | 0.14 | 0.74 | 0.05 |
| 5 | 0.97 | 0.05 | 0.60 | 0.14 | 0.72 | 0.05 |
| 6 | 0.92 | 0.05 | 0.56 | 0.14 | 0.68 | 0.05 |
| 7 | 1.14 | 0.06 | 0.72 | 0.14 | 0.87 | 0.06 |
| 8 | 1.06 | 0.05 | 0.67 | 0.14 | 0.81 | 0.06 |
| 9 | 1.10 | 0.05 | 0.71 | 0.14 | 0.85 | 0.06 |
| 10 | 1.08 | 0.05 | 0.71 | 0.14 | 0.84 | 0.06 |
| 11 | 1.09 | 0.05 | 0.74 | 0.14 | 0.88 | 0.06 |
| 12 | 1.09 | 0.05 | 0.78 | 0.15 | 0.87 | 0.06 |
| 13 | 1.10 | 0.05 | 0.78 | 0.14 | 0.91 | 0.06 |
| 14 | 1.13 | 0.05 | 0.78 | 0.14 | 0.91 | 0.06 |
| 15 | 1.06 | 0.05 | 0.72 | 0.14 | 0.85 | 0.05 |
| 16 | 0.87 | 0.05 | 0.51 | 0.14 | 0.71 | 0.05 |
| 17 | 0.88 | 0.05 | 0.48 | 0.13 | 0.71 | 0.05 |
| 18 | 1.06 | 0.05 | 0.71 | 0.14 | 0.89 | 0.06 |
| 19 | 1.04 | 0.05 | 0.68 | 0.14 | 0.91 | 0.06 |
| 20 | 1.06 | 0.05 | 0.69 | 0.13 | 0.89 | 0.06 |
| 21 | 1.04 | 0.05 | 0.64 | 0.13 | 0.91 | 0.06 |
| 22 | 1.17 | 0.05 | 0.81 | 0.14 | 0.95 | 0.06 |
| 23 | 1.00 | 0.05 | 0.69 | 0.21 | 0.88 | 0.06 |
| 24 | 0.92 | 0.05 | 0.64 | 0.27 | 0.88 | 0.06 |
| 25 | 1.03 | 0.05 | 0.72 | 0.21 | 0.86 | 0.06 |
| 26 | 1.04 | 0.09 | 0.72 | 0.14 | 0.86 | 0.10 |
| 27 | 1.08 | 0.02 | 0.74 | 0.21 | 0.88 | 0.02 |
| 28 | 1.10 | 0.05 | 0.75 | 0.14 | 0.86 | 0.06 |
| 29 | 1.07 | 0.05 | 0.72 | 0.14 | 0.88 | 0.06 |
| 30 | 1.11 | 0.05 | 0.77 | 0.14 | 0.86 | 0.06 |
| 31 | 0.97 | 0.05 | 0.70 | 0.27 | 0.84 | 0.06 |
| 32 | 1.08 | 0.05 | 0.74 | 0.14 | 0.86 | 0.06 |
| 33 | 1.10 | 0.05 | 0.74 | 0.13 | 0.89 | 0.06 |
| 34 | 1.10 | 0.05 | 0.70 | 0.14 | 0.86 | 0.06 |
| 35 | 1.00 | 0.05 | 0.67 | 0.20 | 0.88 | 0.06 |
| 36 | 1.00 | 0.05 | 0.67 | 0.21 | 0.86 | 0.06 |
| 37 | 1.00 | 0.05 | 0.67 | 0.21 | 0.86 | 0.06 |
| 38 | 1.05 | 0.05 | 0.70 | 0.14 | 0.84 | 0.06 |
| 39 | 1.21 | 0.05 | 0.85 | 0.14 | 0.98 | 0.06 |
| 40 | 1.24 | 0.05 | 0.87 | 0.14 | 1.01 | 0.06 |
| 41 | 1.10 | 0.05 | 0.79 | 0.21 | 0.93 | 0.06 |
| 42 | 0.96 | 0.05 | 0.66 | 0.21 | 0.81 | 0.05 |
| 43 | 1.04 | 0.05 | 0.78 | 0.27 | 0.91 | 0.06 |
| 44 | 1.13 | 0.05 | 0.82 | 0.21 | 0.89 | 0.06 |
| 45 | 1.15 | 0.05 | 0.85 | 0.21 | 0.86 | 0.06 |
| 46 | 1.07 | 0.05 | 0.77 | 0.21 | 0.90 | 0.05 |
| 47 | 1.04 | 0.05 | 0.74 | 0.21 | 0.87 | 0.05 |
| 48 | 1.10 | 0.06 | 0.79 | 0.27 | 0.95 | 0.06 |
| 49 | 1.09 | 0.05 | 0.77 | 0.27 | 0.93 | 0.06 |
| 50 | 0.99 | 0.05 | 0.76 | 0.32 | 0.89 | 0.06 |
| 51 | 0.94 | 0.05 | 0.74 | 0.36 | 0.88 | 0.06 |
| 52 | 1.10 | 0.02 | 0.76 | 0.27 | 0.91 | 0.02 |
| 53 | 1.07 | 0.05 | 0.79 | 0.27 | 0.93 | 0.06 |
| 54 | 1.06 | 0.05 | 0.79 | 0.27 | 0.92 | 0.06 |
| 55 | 1.06 | 0.04 | 0.78 | 0.27 | 0.91 | 0.04 |
| 56 | 0.99 | 0.05 | 0.73 | 0.27 | 0.85 | 0.05 |
| 57 | 0.91 | 0.05 | 0.64 | 0.27 | 0.80 | 0.05 |
| 58 | 0.92 | 0.05 | 0.64 | 0.26 | 0.80 | 0.05 |
| 59 | 0.92 | 0.05 | 0.65 | 0.27 | 0.81 | 0.05 |
| 60 | 0.92 | 0.05 | 0.65 | 0.27 | 0.81 | 0.05 |
| 61 | 0.90 | 0.05 | 0.62 | 0.27 | 0.80 | 0.05 |
| 62 | 0.93 | 0.05 | 0.65 | 0.27 | 0.81 | 0.05 |
| 63 | 0.93 | 0.05 | 0.65 | 0.27 | 0.82 | 0.05 |
| 64 | 0.93 | 0.03 | 0.64 | 0.27 | 0.80 | 0.04 |
| 65 | 0.93 | 0.03 | 0.64 | 0.27 | 0.80 | 0.04 |
| 66 | 0.90 | 0.05 | 0.63 | 0.27 | 0.78 | 0.05 |
| 67 | 0.89 | 0.05 | 0.62 | 0.27 | 0.80 | 0.05 |
| 68 | 0.88 | 0.05 | 0.60 | 0.27 | 0.80 | 0.05 |
| 69 | 0.85 | 0.05 | 0.59 | 0.31 | 0.80 | 0.05 |
| 70 | 0.90 | 0.05 | 0.63 | 0.27 | 0.76 | 0.05 |
| 71 | 0.89 | 0.05 | 0.62 | 0.27 | 0.73 | 0.05 |
| 72 | 0.85 | 0.05 | 0.57 | 0.27 | 0.80 | 0.05 |
| 73 | 0.83 | 0.05 | 0.54 | 0.27 | 0.80 | 0.05 |
| 74 | 0.81 | 0.05 | 0.57 | 0.35 | 0.80 | 0.05 |
| 75 | 0.77 | 0.05 | 0.55 | 0.37 | 0.80 | 0.05 |
| 76 | 0.82 | 0.05 | 0.58 | 0.35 | 0.79 | 0.05 |
| 77 | 0.90 | 0.05 | 0.62 | 0.27 | 0.79 | 0.05 |
| 78 | 0.80 | 0.05 | 0.58 | 0.37 | 0.78 | 0.05 |
| 79 | 0.79 | 0.05 | 0.56 | 0.37 | 0.79 | 0.05 |
| 80 | 0.81 | 0.03 | 0.58 | 0.37 | 0.79 | 0.04 |
| 81 | 0.81 | 0.05 | 0.60 | 0.37 | 0.80 | 0.05 |
| 82 | 0.72 | 0.05 | 0.45 | 0.37 | 0.80 | 0.05 |
| 83 | 0.73 | 0.05 | 0.45 | 0.35 | 0.83 | 0.05 |
| 84 | 0.96 | 0.05 | 0.66 | 0.21 | 0.81 | 0.05 |
| 85 | 0.91 | 0.05 | 0.64 | 0.27 | 0.80 | 0.05 |
| 86 | 0.72 | 0.05 | 0.44 | 0.36 | 0.80 | 0.05 |
| 87 | 0.72 | 0.05 | 0.42 | 0.35 | 0.80 | 0.05 |
| 88 | 0.72 | 0.05 | 0.44 | 0.37 | 0.78 | 0.05 |
| 89 | 0.71 | 0.05 | 0.42 | 0.37 | 0.76 | 0.05 |
| 90 | 0.71 | 0.05 | 0.40 | 0.37 | 0.74 | 0.05 |
| 91 | 0.74 | 0.05 | 0.48 | 0.37 | 0.78 | 0.05 |
| 92 | 0.76 | 0.05 | 0.51 | 0.37 | 0.76 | 0.05 |
| 93 | 0.79 | 0.05 | 0.54 | 0.37 | 0.74 | 0.05 |
| 94 | 0.74 | 0.05 | 0.45 | 0.36 | 0.81 | 0.05 |
| 95 | 0.71 | 0.05 | 0.45 | 0.38 | 0.78 | 0.05 |
| 96 | 0.73 | 0.05 | 0.45 | 0.37 | 0.80 | 0.05 |
| 97 | 0.74 | 0.05 | 0.45 | 0.37 | 0.80 | 0.05 |
| 98 | 0.75 | 0.05 | 0.45 | 0.37 | 0.80 | 0.05 |
| 99 | 0.71 | 0.05 | 0.45 | 0.37 | 0.80 | 0.05 |
| 100 | 0.71 | 0.05 | 0.45 | 0.37 | 0.78 | 0.05 |
| 101 | 0.71 | 0.05 | 0.44 | 0.37 | 0.77 | 0.05 |
| 102 | 0.70 | 0.05 | 0.43 | 0.37 | 0.76 | 0.05 |
| 103 | 0.73 | 0.05 | 0.46 | 0.37 | 0.81 | 0.05 |
| 104 | 0.74 | 0.05 | 0.47 | 0.37 | 0.82 | 0.06 |
| 105 | 0.75 | 0.05 | 0.48 | 0.37 | 0.84 | 0.06 |
| 106 | 0.74 | 0.05 | 0.47 | 0.37 | 0.83 | 0.06 |
| 107 | 0.70 | 0.05 | 0.43 | 0.37 | 0.81 | 0.05 |
| 108 | 0.71 | 0.05 | 0.44 | 0.37 | 0.80 | 0.05 |
| 109 | 0.71 | 0.05 | 0.44 | 0.37 | 0.81 | 0.05 |
| 110 | 0.71 | 0.05 | 0.45 | 0.39 | 0.76 | 0.05 |
| 111 | 0.70 | 0.05 | 0.45 | 0.41 | 0.72 | 0.05 |
| 112 | 0.73 | 0.05 | 0.45 | 0.35 | 0.83 | 0.05 |
| 113 | 0.74 | 0.05 | 0.45 | 0.34 | 0.87 | 0.05 |
| 114 | 0.66 | 0.10 | 0.47 | 0.27 | 0.55 | 0.11 |
| 115 | 0.72 | 0.05 | 0.45 | 0.37 | 0.80 | 0.05 |
| 116 | 0.72 | 0.05 | 0.45 | 0.37 | 0.80 | 0.05 |
| 117 | 0.75 | 0.05 | 0.47 | 0.36 | 0.83 | 0.05 |
| 118 | 0.74 | 0.05 | 0.47 | 0.37 | 0.81 | 0.05 |
| 119 | 0.61 | 0.10 | 0.38 | 0.19 | 0.55 | 0.11 |
| 120 | 0.73 | 0.05 | 0.45 | 0.37 | 0.80 | 0.05 |
| 121 | 0.75 | 0.05 | 0.49 | 0.37 | 0.80 | 0.05 |
| 122 | 0.73 | 0.05 | 0.45 | 0.37 | 0.80 | 0.05 |
| 123 | 0.71 | 0.05 | 0.45 | 0.37 | 0.78 | 0.05 |
| 124 | 0.73 | 0.05 | 0.47 | 0.37 | 0.81 | 0.05 |
| 125 | 0.73 | 0.05 | 0.45 | 0.37 | 0.85 | 0.06 |
| 126 | 0.59 | 0.10 | 0.35 | 0.19 | 0.55 | 0.11 |
| 127 | 0.76 | 0.05 | 0.47 | 0.36 | 0.85 | 0.06 |
| 128 | 0.75 | 0.05 | 0.47 | 0.37 | 0.83 | 0.06 |
| 129 | 0.74 | 0.05 | 0.48 | 0.37 | 0.81 | 0.05 |
| 130 | 0.57 | 0.10 | 0.32 | 0.19 | 0.55 | 0.11 |
| 131 | 0.73 | 0.05 | 0.46 | 0.37 | 0.83 | 0.06 |
| 132 | 0.72 | 0.05 | 0.45 | 0.37 | 0.83 | 0.06 |
| 133 | 0.75 | 0.05 | 0.48 | 0.37 | 0.84 | 0.06 |
| 134 | 0.76 | 0.05 | 0.49 | 0.37 | 0.86 | 0.06 |
| 135 | 0.72 | 0.05 | 0.45 | 0.38 | 0.82 | 0.06 |
| 136 | 0.72 | 0.05 | 0.45 | 0.37 | 0.83 | 0.06 |
| 137 | 0.75 | 0.05 | 0.48 | 0.37 | 0.83 | 0.06 |
| 138 | 0.71 | 0.05 | 0.43 | 0.37 | 0.81 | 0.06 |
| 139 | 0.74 | 0.09 | 0.49 | 0.37 | 0.86 | 0.10 |
| 140 | 0.74 | 0.02 | 0.45 | 0.37 | 0.80 | 0.02 |
| 141 | 0.76 | 0.05 | 0.49 | 0.37 | 0.85 | 0.06 |
| 142 | 0.78 | 0.05 | 0.52 | 0.37 | 0.83 | 0.06 |
| 143 | 0.75 | 0.05 | 0.47 | 0.36 | 0.85 | 0.06 |
| 144 | 0.75 | 0.05 | 0.47 | 0.35 | 0.87 | 0.06 |
| 145 | 0.74 | 0.05 | 0.47 | 0.38 | 0.81 | 0.06 |
| 146 | 0.73 | 0.05 | 0.47 | 0.39 | 0.79 | 0.06 |
| 147 | 0.74 | 0.13 | 0.52 | 0.37 | 0.90 | 0.14 |
| 148 | 0.82 | 0.05 | 0.57 | 0.37 | 0.83 | 0.06 |
| 149 | 0.72 | 0.05 | 0.43 | 0.37 | 0.83 | 0.06 |
| 150 | 0.75 | 0.05 | 0.49 | 0.37 | 0.85 | 0.06 |
| 151 | 0.78 | 0.05 | 0.52 | 0.37 | 0.83 | 0.06 |
| 152 | 0.73 | 0.05 | 0.47 | 0.38 | 0.82 | 0.06 |
| 153 | 0.74 | 0.05 | 0.47 | 0.37 | 0.83 | 0.06 |
| 154 | 0.77 | 0.05 | 0.51 | 0.37 | 0.86 | 0.06 |
| 155 | 0.78 | 0.02 | 0.47 | 0.36 | 0.85 | 0.02 |
| 156 | 0.71 | 0.09 | 0.47 | 0.38 | 0.81 | 0.09 |
| 157 | 0.74 | 0.13 | 0.52 | 0.37 | 0.90 | 0.15 |
| 158 | 0.74 | 0.13 | 0.52 | 0.38 | 0.89 | 0.14 |
| 159 | 0.74 | 0.14 | 0.52 | 0.37 | 0.90 | 0.17 |
| 160 | 0.76 | 0.13 | 0.54 | 0.37 | 0.94 | 0.15 |
| 161 | 0.73 | 0.13 | 0.50 | 0.37 | 0.88 | 0.14 |
| 162 | 0.72 | 0.13 | 0.49 | 0.37 | 0.87 | 0.14 |
| 163 | 0.74 | 0.13 | 0.51 | 0.37 | 0.90 | 0.15 |
| 164 | 0.73 | 0.14 | 0.52 | 0.38 | 0.90 | 0.16 |
| 165 | 0.70 | 0.05 | 0.50 | 0.37 | 0.76 | 0.05 |
| 166 | 0.71 | 0.05 | 0.52 | 0.37 | 0.79 | 0.05 |
| 167 | 0.69 | 0.05 | 0.43 | 0.37 | 0.76 | 0.05 |
| 168 | 0.71 | 0.05 | 0.45 | 0.37 | 0.78 | 0.05 |
| 169 | 0.75 | 0.05 | 0.48 | 0.37 | 0.85 | 0.06 |
| 170 | 0.77 | 0.05 | 0.51 | 0.37 | 0.85 | 0.06 |
| 171 | 0.76 | 0.05 | 0.49 | 0.37 | 0.86 | 0.06 |
| 172 | 0.76 | 0.05 | 0.48 | 0.37 | 0.85 | 0.06 |
| 173 | 0.75 | 0.05 | 0.49 | 0.38 | 0.84 | 0.06 |
| 174 | 0.74 | 0.09 | 0.50 | 0.37 | 0.87 | 0.10 |
| 175 | 0.74 | 0.09 | 0.50 | 0.37 | 0.87 | 0.10 |
| 176 | 0.74 | 0.07 | 0.49 | 0.38 | 0.85 | 0.08 |
| 177 | 0.74 | 0.05 | 0.49 | 0.38 | 0.84 | 0.06 |
| 178 | 0.74 | 0.06 | 0.49 | 0.39 | 0.84 | 0.06 |
| 179 | 0.74 | 0.11 | 0.51 | 0.38 | 0.88 | 0.12 |
| 180 | 0.74 | 0.13 | 0.52 | 0.38 | 0.89 | 0.14 |
| 181 | 0.74 | 0.08 | 0.50 | 0.38 | 0.86 | 0.09 |
| 182 | 0.74 | 0.09 | 0.50 | 0.38 | 0.86 | 0.10 |
| 183 | 0.73 | 0.10 | 0.51 | 0.38 | 0.87 | 0.11 |
| 184 | 0.73 | 0.11 | 0.52 | 0.39 | 0.87 | 0.12 |
| 185 | 0.65 | 0.05 | 0.44 | 0.37 | 0.70 | 0.05 |
| 186 | 0.71 | 0.05 | 0.52 | 0.37 | 0.79 | 0.05 |
| 187 | 0.74 | 0.05 | 0.47 | 0.37 | 0.85 | 0.06 |
| 188 | 0.77 | 0.05 | 0.51 | 0.37 | 0.79 | 0.06 |
| 189 | 0.77 | 0.05 | 0.51 | 0.38 | 0.78 | 0.06 |
| 190 | 0.75 | 0.05 | 0.49 | 0.37 | 0.82 | 0.06 |
| 191 | 0.75 | 0.05 | 0.48 | 0.37 | 0.85 | 0.06 |
| 192 | 0.68 | 0.05 | 0.45 | 0.45 | 0.81 | 0.06 |

TABLE 8

| No. | d | nd | ν d | λ 5(nm) | Tg(° C.) | LT(° C.) | d/nd |
|---|---|---|---|---|---|---|---|
| 1 | 3.807 | 1.90254 | 25.51 | 372 | 640.8 | 1169.3 | 2.001 |
| 2 | 3.770 | 1.87701 | 27.97 | 366 | 661.3 | 1193.1 | 2.009 |
| 3 | 3.779 | 1.90274 | 25.31 | 372 | 644.4 | 1211.4 | 1.986 |
| 4 | 3.835 | 1.90243 | 25.67 | 370 | 646.1 | 1160.7 | 2.016 |
| 5 | 3.862 | 1.90215 | 25.85 | 369 | 642.6 | 1156.3 | 2.030 |
| 6 | 3.910 | 1.90256 | 26.20 | 375 | 644.6 | 1132.9 | 2.055 |
| 7 | 3.710 | 1.90346 | 24.85 | 375 | 644.8 | 1245.3 | 1.949 |
| 8 | 3.797 | 1.89539 | 26.01 | 371 | 638.1 | 1160.2 | 2.003 |
| 9 | 3.797 | 1.88805 | 26.54 | 371 | 638.1 | 1160.2 | 2.011 |
| 10 | 3.820 | 1.89835 | 26.17 | 370 | 654.5 | 1181.3 | 2.012 |
| 11 | 3.825 | 1.90112 | 26.33 | 370 | 665.0 | 1192.2 | 2.012 |
| 12 | 3.837 | 1.90539 | 26.45 | 369 | 653.9 | 1168.1 | 2.014 |
| 13 | 3.833 | 1.90175 | 26.58 | 369 | 674.5 | 1190.3 | 2.016 |
| 14 | 3.830 | 1.90009 | 26.52 | 369 | 679.6 | 1206.3 | 2.016 |
| 15 | 3.852 | 1.90083 | 26.52 | 369 | 663.8 | 1174.2 | 2.026 |
| 16 | 3.847 | 1.90163 | 26.15 | 367 | 640.3 | 1218.5 | 2.023 |
| 17 | 3.819 | 1.89549 | 26.04 | 368 | 642.7 | 1224.1 | 2.015 |
| 18 | 3.788 | 1.90146 | 26.28 | 370 | 654.7 | 1199.8 | 1.992 |
| 19 | 3.759 | 1.90157 | 26.24 | 370 | 663.5 | 1208.2 | 1.977 |
| 20 | 3.783 | 1.89899 | 26.23 | 370 | 664.4 | 1201.3 | 1.992 |
| 21 | 3.737 | 1.89617 | 26.15 | 372 | 664.2 | 1210.3 | 1.971 |
| 22 | 3.819 | 1.89756 | 26.77 | 370 | 692.4 | 1214.2 | 2.013 |
| 23 | 3.827 | 1.90451 | 26.33 | 370 | 649.8 | 1194.4 | 2.009 |
| 24 | 3.844 | 1.90804 | 26.32 | 371 | 669.0 | 1202.1 | 2.015 |
| 25 | 3.866 | 1.90445 | 26.36 | 370 | 669.3 | 1185.2 | 2.030 |
| 26 | 3.838 | 1.90564 | 26.18 | 371 | 656.4 | 1198.3 | 2.014 |
| 27 | 3.844 | 1.89977 | 26.53 | 370 | 666.1 | 1186.2 | 2.023 |
| 28 | 3.840 | 1.90083 | 26.35 | 370 | 665.3 | 1185.9 | 2.020 |
| 29 | 3.811 | 1.90098 | 26.31 | 370 | 666.3 | 1192.2 | 2.005 |
| 30 | 3.848 | 1.90081 | 26.38 | 370 | 653.3 | 1182.5 | 2.024 |
| 31 | 3.908 | 1.90781 | 26.40 | 370 | 655.8 | 1173.7 | 2.048 |
| 32 | 3.828 | 1.90296 | 26.26 | 371 | 659.0 | 1185.8 | 2.012 |
| 33 | 3.820 | 1.89910 | 26.40 | 370 | 670.0 | 1196.7 | 2.011 |
| 34 | 3.835 | 1.90328 | 26.21 | 370 | 641.2 | 1183.7 | 2.015 |
| 35 | 3.819 | 1.90236 | 26.26 | 371 | 655.7 | 1194.2 | 2.008 |
| 36 | 3.832 | 1.90433 | 26.19 | 371 | 662.5 | 1188.0 | 2.012 |
| 37 | 3.832 | 1.90340 | 26.23 | 370 | 661.7 | 1186.2 | 2.013 |
| 38 | 3.817 | 1.90202 | 26.13 | 370 | 648.9 | 1176.8 | 2.007 |
| 39 | 3.824 | 1.89465 | 27.00 | 369 | 707.7 | 1217.6 | 2.018 |
| 40 | 3.821 | 1.89135 | 27.21 | 369 | 725.0 | 1225.5 | 2.020 |
| 41 | 3.871 | 1.90110 | 26.81 | 369 | 692.0 | 1219.9 | 2.036 |
| 42 | 3.879 | 1.90184 | 26.87 | 368 | 651.1 | 1176.3 | 2.040 |
| 43 | 3.907 | 1.90421 | 26.83 | 370 | 689.3 | 1226.2 | 2.052 |
| 44 | 3.902 | 1.90042 | 26.84 | 369 | 686.6 | 1188.2 | 2.053 |
| 45 | 3.936 | 1.89977 | 26.89 | 369 | 692.5 | 1233.1 | 2.072 |
| 46 | 3.892 | 1.90078 | 27.00 | 370 | 693.0 | 1213.7 | 2.048 |
| 47 | 3.919 | 1.90058 | 27.19 | 368 | 688.4 | 1205.9 | 2.062 |
| 48 | 3.910 | 1.89967 | 27.11 | 368 | 680.2 | 1197.2 | 2.058 |
| 49 | 3.925 | 1.89960 | 27.21 | 368 | 684.2 | 1221.2 | 2.066 |
| 50 | 3.944 | 1.90756 | 26.87 | 370 | 697.4 | 1223.3 | 2.068 |
| 51 | 3.984 | 1.91053 | 26.90 | 369 | 695.6 | 1222.5 | 2.085 |
| 52 | 3.907 | 1.90224 | 26.93 | 369 | 684.9 | 1235.4 | 2.054 |
| 53 | 3.899 | 1.90076 | 26.98 | 369 | 686.4 | 1215.6 | 2.051 |
| 54 | 3.895 | 1.90087 | 27.01 | 369 | 689.1 | 1212.6 | 2.049 |
| 55 | 3.890 | 1.90210 | 26.83 | 370 | 690.2 | 1197.5 | 2.045 |
| 56 | 3.957 | 1.90410 | 27.21 | 367 | 692.3 | 1212.4 | 2.078 |
| 57 | 3.928 | 1.90513 | 26.91 | 367 | 659.7 | 1177.9 | 2.062 |
| 58 | 3.902 | 1.90415 | 26.89 | 367 | 652.5 | 1194.4 | 2.049 |
| 59 | 3.918 | 1.90140 | 27.13 | 367 | 653.5 | 1170.9 | 2.061 |
| 60 | 3.919 | 1.90024 | 27.17 | 366 | 658.9 | 1171.6 | 2.062 |
| 61 | 3.914 | 1.90504 | 26.90 | 367 | 659.2 | 1179.1 | 2.055 |
| 62 | 3.908 | 1.90137 | 27.07 | 367 | 648.3 | 1177.7 | 2.055 |
| 63 | 3.908 | 1.90025 | 27.11 | 367 | 656.2 | 1179.0 | 2.057 |
| 64 | 3.914 | 1.90246 | 26.94 | 367 | 658.9 | 1171.6 | 2.057 |
| 65 | 3.912 | 1.90141 | 26.97 | 367 | 657.2 | 1170.6 | 2.057 |
| 66 | 3.921 | 1.90539 | 26.86 | 368 | 652.6 | 1173.7 | 2.058 |
| 67 | 3.905 | 1.90557 | 26.85 | 368 | 647.4 | 1177.5 | 2.049 |
| 68 | 3.896 | 1.90539 | 26.83 | 368 | 654.6 | 1181.2 | 2.045 |
| 69 | 3.917 | 1.90729 | 26.90 | 367 | 622.1 | 1200.8 | 2.054 |
| 70 | 3.921 | 1.90540 | 26.81 | 368 | 648.0 | 1177.6 | 2.058 |
| 71 | 3.924 | 1.90535 | 26.72 | 369 | 646.2 | 1183.3 | 2.059 |
| 72 | 3.866 | 1.90544 | 26.75 | 368 | 653.4 | 1189.9 | 2.029 |
| 73 | 3.835 | 1.90566 | 26.66 | 369 | 651.6 | 1199.3 | 2.012 |
| 74 | 3.931 | 1.91004 | 26.91 | 368 | 657.6 | 1203.9 | 2.058 |
| 75 | 3.937 | 1.91164 | 26.92 | 368 | 659.8 | 1209.6 | 2.059 |
| 76 | 3.955 | 1.90979 | 26.95 | 367 | 659.7 | 1199.3 | 2.071 |
| 77 | 3.909 | 1.90119 | 26.92 | 367 | 649.0 | 1181.9 | 2.056 |
| 78 | 3.967 | 1.91145 | 26.97 | 368 | 656.1 | 1209.3 | 2.075 |
| 79 | 3.953 | 1.91153 | 26.94 | 367 | 654.1 | 1208.0 | 2.068 |
| 80 | 3.966 | 1.90918 | 27.03 | 367 | 660.6 | 1199.8 | 2.077 |
| 81 | 3.967 | 1.90792 | 27.16 | 367 | 660.6 | 1191.2 | 2.079 |
| 82 | 3.859 | 1.91000 | 26.64 | 370 | 646.8 | 1227.0 | 2.020 |
| 83 | 3.849 | 1.90581 | 26.79 | 368 | 643.2 | 1223.3 | 2.020 |
| 84 | 3.888 | 1.90255 | 26.85 | 367 | 657.3 | 1179.1 | 2.044 |
| 85 | 3.929 | 1.90566 | 26.90 | 367 | 658.3 | 1181.8 | 2.062 |
| 86 | 3.846 | 1.90704 | 26.62 | 370 | 640.8 | 1225.7 | 2.017 |
| 87 | 3.832 | 1.90353 | 26.58 | 370 | 649.2 | 1226.0 | 2.013 |
| 88 | 3.859 | 1.90940 | 26.51 | 371 | 648.3 | 1220.2 | 2.021 |
| 89 | 3.843 | 1.90834 | 26.41 | 371 | 642.8 | 1225.5 | 2.014 |
| 90 | 3.839 | 1.90694 | 26.29 | 371 | 642.2 | 1225.0 | 2.013 |
| 91 | 3.894 | 1.91041 | 26.64 | 370 | 639.7 | 1214.7 | 2.038 |
| 92 | 3.926 | 1.91042 | 26.66 | 370 | 652.6 | 1207.0 | 2.055 |
| 93 | 3.963 | 1.91032 | 26.70 | 369 | 655.3 | 1201.7 | 2.075 |
| 94 | 3.847 | 1.90673 | 26.68 | 370 | 650.6 | 1224.7 | 2.018 |
| 95 | 3.877 | 1.91394 | 26.58 | 370 | 648.1 | 1210.4 | 2.026 |
| 96 | 3.852 | 1.90899 | 26.59 | 371 | 649.7 | 1220.7 | 2.018 |
| 97 | 3.847 | 1.90739 | 26.58 | 371 | 651.6 | 1225.0 | 2.017 |
| 98 | 3.848 | 1.90574 | 26.59 | 371 | 661.8 | 1228.5 | 2.019 |
| 99 | 3.874 | 1.91183 | 26.62 | 369 | 652.2 | 1211.3 | 2.026 |
| 100 | 3.870 | 1.91014 | 26.71 | 370 | 649.4 | 1224.0 | 2.026 |
| 51 | 3.984 | 1.91053 | 26.90 | 369 | 695.6 | 1222.5 | 2.085 |
| 52 | 3.907 | 1.90224 | 26.93 | 369 | 684.9 | 1235.4 | 2.054 |
| 53 | 3.899 | 1.90076 | 26.98 | 369 | 686.4 | 1215.6 | 2.051 |
| 54 | 3.895 | 1.90087 | 27.01 | 369 | 689.1 | 1212.6 | 2.049 |
| 55 | 3.890 | 1.90210 | 26.83 | 370 | 690.2 | 1197.5 | 2.045 |
| 101 | 3.884 | 1.90548 | 26.69 | 368 | 648.1 | 1225.3 | 2.038 |
| 102 | 3.902 | 1.90944 | 26.95 | 368 | 651.1 | 1242.0 | 2.044 |
| 103 | 3.847 | 1.91090 | 26.48 | 371 | 646.9 | 1207.6 | 2.013 |
| 104 | 3.838 | 1.91133 | 26.37 | 371 | 651.1 | 1187.0 | 2.008 |
| 105 | 3.824 | 1.91147 | 26.28 | 372 | 649.2 | 1179.4 | 2.001 |
| 106 | 3.850 | 1.90443 | 26.94 | 369 | 650.3 | 1212.6 | 2.022 |
| 107 | 3.831 | 1.91036 | 26.56 | 370 | 654.3 | 1225.7 | 2.005 |
| 108 | 3.853 | 1.92274 | 26.53 | 370 | 652.3 | 1218.0 | 2.004 |
| 109 | 3.849 | 1.91054 | 26.56 | 370 | 654.7 | 1218.3 | 2.015 |
| 110 | 3.869 | 1.91455 | 26.46 | 370 | 643.1 | 1206.3 | 2.021 |
| 111 | 3.883 | 1.91915 | 26.37 | 370 | 642.0 | 1201.3 | 2.023 |
| 112 | 3.852 | 1.90602 | 26.73 | 369 | 661.6 | 1224.6 | 2.021 |
| 113 | 3.843 | 1.90173 | 26.89 | 369 | 670.2 | 1227.7 | 2.021 |
| 114 | 4.083 | 1.90351 | 27.47 | 356 | 628.3 | 1219.3 | 2.145 |
| 115 | 3.845 | 1.90442 | 26.69 | 370 | 645.6 | 1220.9 | 2.019 |
| 116 | 3.827 | 1.89848 | 26.89 | 370 | 656.1 | 1181.1 | 2.016 |
| 117 | 3.849 | 1.90043 | 27.08 | 369 | 648.9 | 1215.3 | 2.025 |
| 118 | 3.858 | 1.90265 | 27.02 | 369 | 652.9 | 1218.4 | 2.028 |
| 119 | 3.945 | 1.89914 | 27.00 | 358 | 612.4 | 1173.8 | 2.077 |
| 120 | 3.867 | 1.90874 | 26.63 | 370 | 655.5 | 1214.4 | 2.026 |
| 121 | 3.887 | 1.91009 | 26.70 | 370 | 659.8 | 1213.8 | 2.035 |
| 122 | 3.850 | 1.90681 | 26.65 | 371 | 651.3 | 1221.0 | 2.019 |
| 123 | 3.880 | 1.91004 | 26.82 | 369 | 652.0 | 1218.3 | 2.031 |
| 124 | 3.862 | 1.90380 | 27.06 | 367 | 646.6 | 1212.3 | 2.029 |
| 125 | 3.785 | 1.91191 | 26.11 | 373 | 650.7 | 1182.6 | 1.980 |
| 126 | 3.905 | 1.89849 | 27.06 | 358 | 601.4 | 1180.3 | 2.057 |
| 127 | 3.836 | 1.90077 | 27.03 | 368 | 653.4 | 1205.8 | 2.018 |
| 128 | 3.845 | 1.90293 | 26.95 | 368 | 650.0 | 1201.9 | 2.021 |
| 129 | 3.864 | 1.90183 | 27.19 | 367 | 650.9 | 1211.7 | 2.032 |
| 130 | 3.873 | 1.89771 | 26.90 | 358 | 607.7 | 1189.2 | 2.041 |
| 131 | 3.822 | 1.90414 | 26.93 | 368 | 648.4 | 1207.1 | 2.007 |
| 132 | 3.811 | 1.90390 | 26.92 | 368 | 650.4 | 1204.1 | 2.002 |
| 133 | 3.823 | 1.90458 | 26.84 | 368 | 651.2 | 1196.5 | 2.007 |
| 134 | 3.813 | 1.90493 | 26.72 | 369 | 647.7 | 1182.7 | 2.002 |
| 135 | 3.807 | 1.90307 | 26.93 | 368 | 648.5 | 1201.9 | 2.000 |
| 136 | 3.806 | 1.90205 | 26.96 | 368 | 649.8 | 1207.3 | 2.001 |
| 137 | 3.827 | 1.90209 | 27.11 | 367 | 651.2 | 1202.9 | 2.012 |
| 138 | 3.811 | 1.90418 | 26.83 | 368 | 639.3 | 1202.6 | 2.001 |
| 139 | 3.838 | 1.90189 | 27.24 | | 656.4 | 1192.6 | 2.018 |
| 140 | 3.834 | 1.90677 | 26.66 | 369 | 650.1 | 1210.9 | 2.011 |
| 141 | 3.842 | 1.90385 | 27.04 | | 650.6 | 1204.2 | 2.018 |
| 142 | 3.874 | 1.90387 | 27.07 | 368 | 653.9 | 1203.9 | 2.035 |
| 143 | 3.828 | 1.90201 | 27.01 | | 647.0 | 1208.8 | 2.013 |
| 144 | 3.826 | 1.89988 | 27.09 | | 651.6 | 1211.2 | 2.014 |
| 145 | 3.843 | 1.90625 | 26.88 | 368 | 644.3 | 1202.7 | 2.016 |
| 146 | 3.849 | 1.90823 | 26.82 | 368 | 641.9 | 1201.7 | 2.017 |
| 147 | 3.841 | 1.89945 | 27.53 | 368 | 654.3 | 1192.1 | 2.022 |
| 148 | 3.904 | 1.90331 | 27.20 | | 658.4 | 1199.6 | 2.051 |
| 149 | 3.792 | 1.90086 | 26.86 | 368 | 646.3 | 1209.2 | 1.995 |
| 150 | 3.837 | 1.90280 | 27.11 | 367 | 650.1 | 1203.7 | 2.016 |
| 151 | 3.866 | 1.90289 | 27.14 | 367 | 647.5 | 1199.0 | 2.032 |
| 152 | 3.835 | 1.90460 | 26.94 | 368 | 649.2 | 1207.4 | 2.014 |
| 153 | 3.836 | 1.90373 | 26.97 | 368 | 653.4 | 1208.4 | 2.015 |
| 154 | 3.836 | 1.90137 | 27.29 | 367 | 652.0 | 1199.2 | 2.017 |
| 155 | 3.805 | 1.89684 | 27.07 | 368 | 644.5 | 1207.9 | 2.006 |
| 156 | 3.871 | 1.91164 | 26.83 | 368 | 647.8 | 1205.8 | 2.025 |
| 157 | 3.850 | 1.90110 | 27.51 | 366 | 650.0 | 1194.9 | 2.025 |
| 158 | 3.847 | 1.90059 | 27.49 | 366 | 650 | 1190 | 2.024 |
| 159 | 3.856 | 1.90141 | 27.5 | 367 | 651.8 | 1192.1 | 2.028 |
| 160 | 3.82 | 1.90029 | 27.3 | 368 | 652.5 | 1213.8 | 2.010 |
| 161 | 3.839 | 1.89979 | 27.43 | 367 | 647.4 | 1182.5 | 2.021 |
| 162 | 3.84 | 1.90006 | 27.38 | 367 | 648.1 | 1183.5 | 2.021 |
| 163 | 3.848 | 1.90019 | 27.5 | 366 | 652.2 | 1192.9 | 2.025 |
| 164 | 3.86 | 1.90255 | 27.48 | 366 | 643.8 | 1196 | 2.029 |
| 165 | 3.947 | 1.90152 | 27.44 | 366 | 650.7 | 1257.5 | 2.076 |
| 166 | 3.924 | 1.90208 | 27.22 | 368 | 651.4 | 1238.5 | 2.063 |
| 167 | 3.938 | 1.89905 | 27.3 | 368 | 639.3 | 1213 | 2.074 |
| 168 | 3.915 | 1.89978 | 27.08 | 369 | 642.6 | 1190.4 | 2.061 |
| 169 | 3.828 | 1.90091 | 27.13 | 368 | 640.1 | 1201.1 | 2.014 |
| 170 | 3.843 | 1.90066 | 27.18 | 368 | 645.4 | 1200.8 | 2.022 |
| 171 | 3.831 | 1.9007 | 27.17 | 368 | 647.2 | 1203.1 | 2.016 |
| 172 | 3.828 | 1.90021 | 27.12 | 368 | 642.5 | 1202.8 | 2.015 |
| 173 | 3.825 | 1.90132 | 27.19 | 367 | 635.6 | 1192.8 | 2.012 |
| 174 | 3.836 | 1.90108 | 27.31 | 367 | 644.3 | 1192.8 | 2.018 |
| 175 | 3.838 | 1.90108 | 27.3 | 367 | 653.9 | 1183.2 | 2.019 |
| 176 | 3.833 | 1.90149 | 27.23 | 367 | 646.4 | 1192.6 | 2.016 |
| 177 | 3.83 | 1.90195 | 27.19 | 367 | 635.7 | 1190.5 | 2.014 |
| 178 | 3.832 | 1.90201 | 27.23 | 367 | 637.3 | 1185 | 2.015 |
| 179 | 3.84 | 1.90118 | 27.39 | 367 | 648.6 | 1192.5 | 2.020 |
| 180 | 3.849 | 1.90097 | 27.49 | 366 | 647.1 | 1195.2 | 2.025 |
| 181 | 3.838 | 1.90154 | 27.3 | 367 | 645.8 | 1188.9 | 2.018 |
| 182 | 3.836 | 1.90175 | 27.35 | 367 | 640.4 | 1186.5 | 2.017 |
| 183 | 3.842 | 1.9019 | 27.41 | 366 | 636.1 | 1201.9 | 2.020 |
| 184 | 3.846 | 1.90213 | 27.47 | 366 | 646.9 | 1220.5 | 2.022 |
| 185 | 3.953 | 1.91567 | 26.33 | 367 | 652.5 | 1258.2 | 2.064 |
| 186 | 3.926 | 1.90218 | 27.2 | 368 | 650.9 | 1238.9 | 2.064 |
| 187 | 3.800 | 1.90048 | 27.11 | 369 | 648.0 | 1150.2 | 1.999 |
| 188 | 3.870 | 1.89999 | 27.16 | 369 | 647.4 | 1142.5 | 2.037 |
| 189 | 3.878 | 1.90099 | 27.13 | 369 | 646.9 | 1144.0 | 2.040 |
| 190 | 3.834 | 1.90077 | 27.12 | 369 | 646.5 | 1143.2 | 2.017 |
| 191 | 3.905 | 1.91845 | 26.07 | 368 | 664.8 | 1215.3 | 2.035 |
| 192 | 3.827 | 1.90059 | 27.08 | 367 | 640.1 | 1161.6 | 2.014 |

When the specific resistance of the glass No. 169 was measured by the following method, the specific resistance at 1,250° C. was 3.5 Ωcm, and the specific resistance at 1,200° C. was 5.2 Ωcm. 100 ml of glass was put into a platinum crucible, the glass was moved into a furnace set to a liquidus temperature of the glass or higher and 1,550° C. or lower together with the crucible, and the glass was melted. Then, two pre-calibrated platinum electrodes having a diameter of 5 mm were immersed in a glass melt, and the value of the specific resistance was measured at each of a plurality of measurement temperatures as described above. At each measurement temperature, after a soaking time, an AC voltage of 50 mV/20 KHz was applied to cause a current to flow through the glass, and the specific resistance was measured. From the measurement results obtained in this manner, the value of the specific resistance of the glass at each of the above temperatures (1,250° C. or 1,200° C.) was obtained by the method described above.

### Example 2

Using various glasses obtained in Example 1, a glass block (glass gob) for press molding was produced. This glass block was heated and softened in air, and press-molded with a press molding die to produce a lens blank (optical element blank). The produced lens blank was removed from the press molding die, annealed and subjected to machining including polishing, and a spherical lens comprised of various glasses produced in Example 1 was produced.

### Example 3

A desired amount of the molten glass produced in Example 1 was press-molded with a press molding die to produce a lens blank (optical element blank). The produced lens blank was removed from the press molding die, annealed, and subjected to machining including polishing, and a spherical lens comprised of various glasses produced in Example 1 was produced.

### Example 4

A glass block (optical element blank) produced by solidifying the molten glass produced in Example 1 was annealed and subjected to machining including polishing, and a spherical lens comprised of various glasses produced in Example 1 was produced.

### Example 5

The spherical lenses produced in Examples 2 to 4 were bonded to a spherical lens comprised of another type of glass to produce a cemented lens.

### Example 6

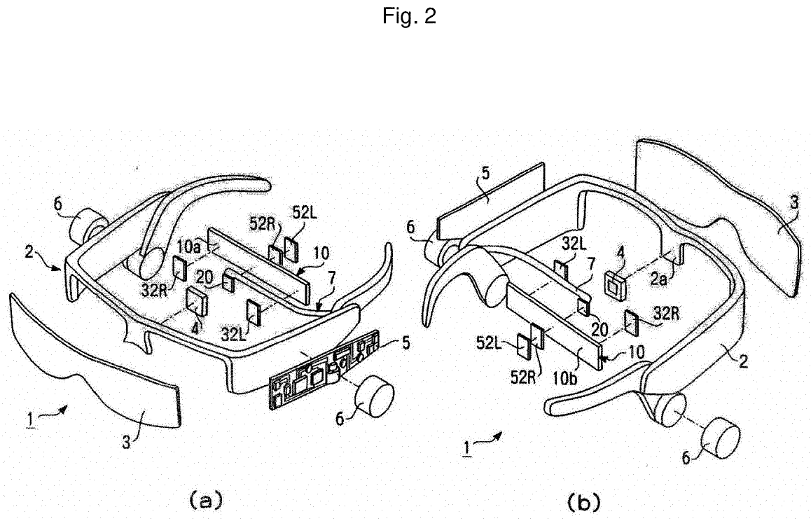

FIG. 2 is a schematic configuration diagram of a head mounted display which is an example of an imaging device including an image display element and a light guide plate. A head mounted display 1 having the configuration shown in FIG. 2 was produced by the following method.

Each optical glass shown in Table 1 is processed into a rectangular thin plate having a length of 50 mm, a width of 20 mm and a thickness of 1.0 mm to obtain a light guide plate 10.

This light guide plate is attached to the head mounted display 1 (hereinafter abbreviated to as an “HMD 1”) shown in FIG. 2. FIG. 2(a) is a front-side perspective view of the HMD 1, and FIG. 2(b) is a back-side perspective view of the HMD 1. As shown in FIG. 2(a) and FIG. 1(b), an eyeglass lens 3 is attached to the front part of an eyeglass frame 2 mounted on the user's head. A backlight 4 for illuminating an image is attached to a mounting part 2a of the eyeglass frame 2. A signal processing device 5 for projecting an image and a speaker 6 for reproducing sound are provided on a temple part of the eyeglass frame 2. A flexible printed circuits (FPC) 7 constituting a wiring drawn from the circuit of the signal processing device 5 is wired along the eyeglass frame 2. A display element unit (for example, liquid crystal display element) 20 is wired to the center position of both eyes of the user by the FPC 7, and held so that a substantially central part of the display element unit 20 is disposed on the optical axis of the backlight 4. The display element unit 20 is fixed relative to the light guide plate 10 so that it is located in a substantially central part of the light guide plate 10. In addition, at a position located in front of the user's eyes, holographic optical elements (HOEs) 32R and 32L (first optical element) are closely fixed on a first surface 10a of the light guide plate 10 by adhesion or the like. HOEs 52R and 52L are laminated on a second surface 10b of the light guide plate 10 at positions facing the display element unit 20 with the light guide plate 10 interposed therebetween.

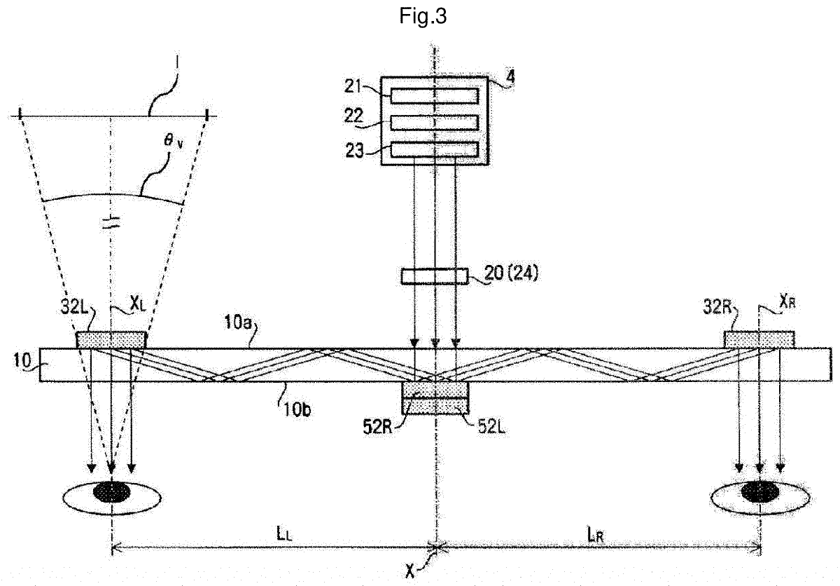

FIG. 3 is a side view schematically showing the configuration of the HMD 1 shown in FIG. 2. In FIG. 3, in order to clarify the drawings, only the main part is shown, and the eyeglass frame 2 and the like are not shown. As shown in FIG. 3, the HMD 1 has a laterally symmetrical structure with a center line X connecting an image display element 24 and the center of the light guide plate 10 therebetween. In addition, light of each wavelength incident on the light guide plate 10 from the image display element 24 is divided into two parts and guided to the user's right eye and left eye as will be described below. The optical paths of light of respective wavelengths guided to the eyes are also substantially symmetrical with the center line X therebetween.

As shown in FIG. 3, the backlight 4 includes a laser light source 21, a diffuse optical system 22, and a microlens array 23. The display element unit 20 is an image generation unit having the image display element 24, and is driven by, for example, a field sequential method. The laser light source 21 has a laser light source corresponding to each wavelength of R (a wavelength of 436 nm), G (a wavelength of 546 nm), and B (a wavelength of 633 nm), and sequentially emits light of each wavelength at a high speed. Light of each wavelength is incident on the diffuse optical system 22 and the microlens array 23, is converted into a uniform and highly directional parallel light flux having no unevenness in light intensity, and is vertically incident on the display panel surface of the image display element 24.

The image display element 24 is, for example, a transmissive liquid crystal (LCDT-LCOS) panel that is driven by the field sequential method. The image display element 24 modulates light of each wavelength according to an image signal generated by an image engine (not shown) of the signal processing device 5. Light of each wavelength modulated by pixels of the effective region of the image display element 24 is incident on the light guide plate 10 with a predetermined light flux cross section (having substantially the same shape as the effective region). The image display element 24 can be replaced with another form of display element, for example, a digital mirror device (DMD), a reflective liquid crystal (LCOS) panel, microelectro mechanical systems (MEMS), an organic electro-luminescence (EL) element, and an inorganic EL element.

The display element unit 20 is not limited to the field sequential type display element, and may be an image generation unit of a simultaneous type display element (a display element having an RGB color filter having a predetermined array on the front surface of the emission surface). In this case, for example, a white light source is used as the light source.

As shown in FIG. 3, light of each wavelength modulated by the image display element 24 is sequentially incident on the inside of the light guide plate 10 from the first surface 10a. The HOEs 52R and 52L (second optical element) are laminated on the second surface 10b of the light guide plate 10. The HOEs 52R and 52L are, for example, a reflective volume phase type HOE having a rectangular shape, and have a configuration in which three photopolymers in which interference fringes corresponding to light of each wavelength of R, G, and B are recorded are laminated. That is, the HOEs 52R and 52L are configured to have a wavelength selection function of diffracting light of each wavelength of R, G, and B and transmitting light of other wavelengths.

The HOEs 32R and 32L are also a reflective volume phase type HOE, and have the same layer structure as the HOEs 52R and 52L. For example, the HOEs 32R and 32L and 52R and 52L may have substantially the same pitch of interference fringe patterns.

The HOEs 52R and 52L of which the centers are aligned and interference fringe patterns are inverted by 180 (deg) are laminated. Then, in the laminated state, firm fixing is performed on the second surface 10b of the light guide plate 10 by adhesion or the like so that the center thereof matches the center line X. Light of each wavelength modulated by the image display element 24 is sequentially incident on the HOEs 52R and 52L via the light guide plate 10.

The HOEs 52R and 52L perform diffraction by imparting a predetermined angle in order to guide sequentially incident light of each wavelength to the right eye and the left eye. Light of each wavelength diffracted by the HOEs 52R and 52L is repeatedly totally reflected at the interface between the light guide plate 10 and air, propagates through the inside of the light guide plate 10, and is incident on the HOEs 32R and 32L. Here, the HOEs 52R and 52L impart the same diffraction angle to light of each wavelength. Therefore, light of all wavelengths incident at substantially the same position with respect to the light guide plate 10 (in other words, emitted from substantially the same coordinates within the effective region of the image display element 24) propagates through substantially the same optical path inside the light guide plate 10 and is incident on the HOEs 32R and 32L at substantially the same position. According to another perspective, the HOEs 52R and 52L diffract light of each wavelength of RGB so that the pixel positional relationship within the effective region of an image displayed in the effective region of the image display element 24 is reliably reproduced on the HOEs 32R and 32L.

As described above, in this example, the HOEs 52R and 52L perform diffraction so that light of all wavelengths emitted from substantially the same coordinates within the effective region of the image display element 24 is incident on the HOEs 32R and 32L at substantially the same position. In addition, the HOEs 52R and 52L may be configured to diffract light of all wavelengths that are relatively shifted within the effective region of the image display element 24 and originally form the same pixel so that the light is incident on the HOEs 32R and 32L at substantially the same position.

Light of each wavelength incident on the HOEs 32R and 32L is diffracted by the HOEs 32R and 32L and sequentially emitted substantially vertically to the outside from the second surface 10b of the light guide plate 10. Light of each wavelength emitted as substantially parallel light in this manner forms an image on the user's right eye retina and left eye retina as an imaginary image I of the image generated by the image display element 24. In addition, a condenser function may be applied to the HOEs 32R and 32L so that the user can observe the imaginary image I of the enlarged image. That is, light incident on the peripheral region of the HOEs 32R and 32L may be emitted at such an angle that it is closer to the center of the pupil and may form an image on the user's retina. In addition, in order to allow the user to observe the imaginary image I of the enlarged image, the HOEs 52R and 52L may diffract light of each wavelength of RGB so that the pixel positional relationship on the HOEs 32R and 32L has an enlarged similar shape with respect to the pixel positional relationship within the effective region of the image displayed in the effective region of the image display element 24.

Since the air-equivalent optical path length of light that travels in the light guide plate 10 is shorter as the refractive index is higher, when each of the above optical glasses having a high refractive index is used, an apparent viewing angle with respect to the width of the image display element 24 can increase. In addition, since the refractive index is high but the specific gravity is kept low, it is possible to provide a light guide plate which is lightweight and has the above effect.

When the light guide plate 10 obtained in this manner was incorporated into the HMD 1, and the image was evaluated at the position of the eye point, it was possible to observe a high-brightness and high-contrast image with a wide viewing angle.

The light guide plate comprised of each of the above optical glasses can be used for a see-through transmissive head mounted display or a non-transmissive head mounted display.

Since the light guide plate is comprised of a glass with a high refractive index and a low specific gravity, these head mounted displays have an excellent sense of immersion due to a wide viewing angle and are used in combination with an information terminal, and are suitable as image display devices that are used for providing augmented reality (AR) or the like and used for watching movies and games, and providing virtual reality (VR) or the like.

In this example, the head mounted display has been exemplified, but the light guide plate may be attached to other image display devices.

Finally, the above aspects will be summarized.

According to one aspect, there is provided an optical glass (Glass 1) in which, based on mass, the SiO₂ content is 10.00% or more, the CaO content is 5.00% or more, a total content (La₂O₃+Gd₂O₃+Y₂O₃) of La₂O₃, Gd₂O₃ and Y₂O₃ is more than 0%, a total content (BaO+La₂O₃+Gd₂O₃+Y₂O₃) of BaO, La₂O₃, Gd₂O₃ and Y₂O₃ is 30.00% or less, and a mass ratio ((SiO₂+B₂O₃)/(TiO₂+Nb₂O₅+Ta₂O₅+WO₃+Bi₂O₃)) of a total content of SiO₂ and B₂O₃ relative to a total content of TiO₂, Nb₂O₅, Ta₂O₅, WO₃ and Bi₂O₃ is 0.75 or less.

In one embodiment, in Glass 1, the mass ratio (La₂O₃/B₂O₃) of the La₂O₃ content relative to the B₂O₃ content can be 1.30 or more.

In one embodiment, in Glass 1, the mass ratio (B₂O₃/La₂O₃) of the B₂O₃ content relative to the La₂O₃ content can be 0.79 or less.

In one embodiment, in Glass 1, the mass ratio ((La₂O₃+Gd₂O₃+Y₂O₃)/(B₂O₃+La₂O₃+Gd₂O₃+Y₂O₃)) of a total content of La₂O₃, Gd₂O₃ and Y₂O₃ relative to a total content of B₂O₃, La₂O₃, Gd₂O₃ and Y₂O₃ can be 0.57 or more.

In one embodiment, in Glass 1, a total content of BaO, La₂O₃, Gd₂O₃ and Y₂O₃ can be 30.00 mass % or less.

According to one aspect, there is provided an optical glass (Glass 2) in which the SiO₂ content is 10.00% or more, the CaO content is 5.00% or more, a total content (La₂O₃+Gd₂O₃+Y₂O₃) of La₂O₃, Gd₂O₃ and Y₂O₃ is 2.96% or more, a total content (BaO+La₂O₃+Gd₂O₃+Y₂O₃) of BaO, La₂O₃, Gd₂O₃ and Y₂O₃ is 30.00% or less, a mass ratio ((SiO₂+B₂O₃)/(TiO₂+Nb₂O₅+Ta₂O₅+WO₃+Bi₂O₃)) of a total content of SiO₂ and B₂O₃ relative to a total content of TiO₂, Nb₂O₅, Ta₂O₅, WO₃ and Bi₂O₃ is 0.75 or less, and a mass ratio ((SiO₂+CaO)/(TiO₂+Nb₂O₅+Ta₂O₅+WO₃+Bi₂O₃)) of a total content of SiO₂ and CaO relative to a total content of TiO₂, Nb₂O₅, Ta₂O₅, WO₃ and Bi₂O₃ is less than 1.09.

In one embodiment, in Glass 2, the mass ratio (La₂O₃/B₂O₃) of the La₂O₃ content relative to the B₂O₃ content can be 1.30 or more.

In one embodiment, in Glass 2, the mass ratio (B₂O₃/La₂O₃) of the B₂O₃ content relative to the La₂O₃ content can be 0.79 or less.

In one embodiment, in Glass 2, the mass ratio ((La₂O₃+Gd₂O₃+Y₂O₃)/(B₂O₃+La₂O₃+Gd₂O₃+Y₂O₃)) of a total content of La₂O₃, Gd₂O₃ and Y₂O₃ relative to a total content of B₂O₃, La₂O₃, Gd₂O₃ and Y₂O₃ can be 0.57 or more.

In one embodiment, in Glass 2, a total content of BaO, La₂O₃, Gd₂O₃ and Y₂O₃ can be 30.00 mass % or less.

According to one aspect, there is provided an optical glass (Glass 3) in which, based on mass, the ZrO₂ content is 7.63% or less, a mass ratio (ZrO₂/(La₂O₃+Gd₂O₃+Y₂O₃)) of the ZrO₂ content relative to a total content of La₂O₃, Gd₂O₃ and Y₂O₃ is 3.30 or less, a mass ratio (B₂O₃/SiO₂) of the B₂O₃ content relative to the SiO₂ content is less than 1.00, a mass ratio ((SiO₂+CaO)/(TiO₂+Nb₂O₅+Ta₂O₅+WO₃+Bi₂O₃)) of a total content of SiO₂ and CaO relative to a total content of TiO₂, Nb₂O₅, Ta₂O₅, WO₃ and Bi₂O₃ is 1.09 or less, and a mass ratio ((ZnO+SrO+BaO)/(MgO+CaO)) of a total content of ZnO, SrO and BaO relative to a total content of MgO and CaO is 1.98 or less.

In one embodiment, in Glass 3, the CaO content can be 3.00% or more.

In one embodiment, in Glass 3, the Li₂O content can be 5.00% or less.

In one embodiment, in Glass 3, the mass ratio ((La₂O₃+Gd₂O₃+Y₂O₃)/(B₂O₃+La₂O₃+Gd₂O₃+Y₂O₃)) of a total content of La₂O₃, Gd₂O₃ and Y₂O₃ relative to a total content of B₂O₃, La₂O₃, Gd₂O₃ and Y₂O₃ can be 0.57 or more.

In one embodiment, in Glass 3, the mass ratio (CaO/(MgO+CaO+SrO+BaO+ZnO)) of the CaO content relative to a total content of MgO, CaO, SrO, BaO and ZnO can be 0.35 or more.

In one embodiment, in Glass 3, the mass ratio (CaO+MgO/(MgO+CaO+SrO+BaO+ZnO)) of a total content of CaO and MgO relative to a total content of MgO, CaO, SrO, BaO and ZnO can be 0.35 or more.

Glasses 1 to 3 can be optical glasses having a high refractive index and a low specific gravity.

Glasses 1 to 3 can be optical glasses having dispersibility useful as an optical element material and having a low specific gravity.

In one embodiment, the refractive index nd of Glasses 1 to 3 can be 1.860 or more.

In one embodiment, the Abbe number vd of Glasses 1 to 3 can be in a range of 22.00 to 30.00.

In one embodiment, the specific gravity d of Glasses 1 to 3 can be 4.100 or less.

In one embodiment, the ratio (d/nd) of the specific gravity d to the refractive index nd of Glasses 1 to 3 can be 4.35 or less.

According to one aspect, an optical element comprised of any of the optical glasses, Glasses 1 to 3 is provided.

According to one aspect, a light guide plate comprised of any of the optical glasses, Glasses 1 to 3 is provided.

According to one aspect, an image display device including an image display element and the above light guide plate is provided.

The embodiments disclosed herein are only examples in all respects and should not be considered as restrictive. The scope of the present invention is not limited to the above description but is limited by the scope of claims, and is intended to encompass equivalents to and all modifications within the scope of the claims.

For example, the optical glass according to one aspect of the present invention can be obtained by performing composition adjustment described in the specification on the glass composition exemplified above.

In addition, of course, it is possible to arbitrarily combine two or more of the items exemplified in this specification or described as preferable ranges.

1. An optical glass,
wherein, based on mass,
an SiO₂ content is 10.00% or more,
a CaO content is 5.00% or more,
a total content (La₂O₃+Gd₂O₃+Y₂O₃) of La₂O₃, Gd₂O₃ and Y₂O₃ is more than 0%,
a total content (BaO+La₂O₃+Gd₂O₃+Y₂O₃) of BaO, La₂O₃, Gd₂O₃ and Y₂O₃ is 30.00% or less, and
a mass ratio ((SiO₂+B₂O₃)/(TiO₂+Nb₂O₅+Ta₂O₅+WO₃+Bi₂O₃)) of a total content of SiO₂ and B₂O₃ relative to a total content of TiO₂, Nb₂O₅, Ta₂O₅, WO₃ and Bi₂O₃ is 0.75 or less.

2. The optical glass according to claim 1,
wherein a mass ratio (La₂O₃/B₂O₃) of an La₂O₃ content relative to a B₂O₃ content is 1.30 or more.

3. The optical glass according to claim 1,
wherein a mass ratio (B₂O₃/La₂O₃) of a B₂O₃ content relative to an La₂O₃ content is 0.79 or less.

4. The optical glass according to claim 1,
wherein a mass ratio ((La₂O₃+Gd₂O₃+Y₂O₃)/(B₂O₃+La₂O₃+Gd₂O₃+Y₂O₃)) of a total content of La₂O₃, Gd₂O₃ and Y₂O₃ relative to a total content of B₂O₃, La₂O₃, Gd₂O₃ and Y₂O₃ is 0.57 or more.

5. The optical glass according to claim 1,
wherein a total content of BaO, La₂O₃, Gd₂O₃ and Y₂O₃ is 30.00 mass % or less.

6. An optical glass,
wherein, based on mass,
an SiO₂ content is 10.00% or more,
a CaO content is 5.00% or more,
a total content (La₂O₃+Gd₂O₃+Y₂O₃) of La₂O₃, Gd₂O₃ and Y₂O₃ is 2.96% or more,
a total content (BaO+La₂O₃+Gd₂O₃+Y₂O₃) of BaO, La₂O₃, Gd₂O₃ and Y₂O₃ is 30.00% or less,
a mass ratio ((SiO₂+B₂O₃)/(TiO₂+Nb₂O₅+Ta₂O₅+WO₃+Bi₂O₃)) of a total content of SiO₂ and B₂O₃ relative to a total content of TiO₂, Nb₂O₅, Ta₂O₅, WO₃ and Bi₂O₃ is 0.75 or less, and
a mass ratio ((SiO₂+CaO)/(TiO₂+Nb₂O₅+Ta₂O₅+WO₃+Bi₂O₃)) of a total content of SiO₂ and CaO relative to a total content of TiO₂, Nb₂O₅, Ta₂O₅, WO₃ and Bi₂O₃ is less than 1.09.

7. The optical glass according to claim 6,
wherein a mass ratio (La₂O₃/B₂O₃) of an La₂O₃ content relative to a B₂O₃ content is 1.30 or more.

8. The optical glass according to claim 6,
wherein a mass ratio (B₂O₃/La₂O₃) of a B₂O₃ content relative to an La₂O₃ content is 0.79 or less.

9. The optical glass according to claim 6,
wherein a mass ratio ((La₂O₃+Gd₂O₃+Y₂O₃)/(B₂O₃+La₂O₃+Gd₂O₃+Y₂O₃)) of a total content of La₂O₃, Gd₂O₃ and Y₂O₃ relative to a total content of B₂O₃, La₂O₃, Gd₂O₃ and Y₂O₃ is 0.57 or more.

10. The optical glass according to claim 6,
wherein a total content of BaO, La₂O₃, Gd₂O₃ and Y₂O₃ is 30.00 mass % or less.

11. An optical glass,
wherein, based on mass,
a ZrO₂ content is 7.63% or less,
a mass ratio (ZrO₂/(La₂O₃+Gd₂O₃+Y₂O₃)) of a ZrO₂ content relative to a total content of La₂O₃, Gd₂O₃ and Y₂O₃ is 3.30 or less,
a mass ratio (B₂O₃/SiO₂) of a B₂O₃ content relative to an SiO₂ content is less than 1.00,
a mass ratio ((SiO₂+CaO)/(TiO₂+Nb₂O₅+Ta₂O₅+WO₃+Bi₂O₃)) of a total content of SiO₂ and CaO relative to a total content of TiO₂, Nb₂O₅, Ta₂O₅, WO₃ and Bi₂O₃ is 1.09 or less, and
a mass ratio ((ZnO+SrO+BaO)/(MgO+CaO)) of a total content of ZnO, SrO and BaO relative to a total content of MgO and CaO is 1.98 or less.

12. The optical glass according to claim 11,
wherein a CaO content is 3.00% or more.

13. The optical glass according to claim 11,
wherein an Li₂O content is 5.00% or less.

14. The optical glass according to claim 11,
wherein a mass ratio ((La₂O₃+Gd₂O₃+Y₂O₃)/(B₂O₃+La₂O₃+Gd₂O₃+Y₂O₃)) of a total content of La₂O₃, Gd₂O₃ and Y₂O₃ relative to a total content of B₂O₃, La₂O₃, Gd₂O₃ and Y₂O₃ is 0.57 or more.

15. The optical glass according to claim 11,
wherein a mass ratio (CaO/(MgO+CaO+SrO+BaO+ZnO)) of a CaO content relative to a total content of MgO, CaO, SrO, BaO and ZnO is 0.35 or more.

16. The optical glass according to claim 11,
wherein a mass ratio (CaO+MgO)/(MgO+CaO+SrO+BaO+ZnO)) of a total content of CaO and MgO relative to a total content of MgO, CaO, SrO, BaO and ZnO is 0.35 or more.

17. The optical glass according to claim 1,
wherein the optical glass satisfies one or more of (1) to (4) below:
(1) a refractive index nd is 1.860 or more,
(2) an Abbe number vd ranges from 22.00 to 30.00,
(3) a specific gravity d is 4.100 or less,
(4) d/nd, a ratio of a specific gravity d to a refractive index nd, is 4.35 or less.

18-20. (canceled)

21. An optical element comprised of the optical glass according to claim 1.

22. A light guide plate comprised of the optical glass according to claim 1.

23. An image display device,
which comprises an image display element and a light guide plate, wherein the light guide plate is the light guide plate according to claim 22.

24. The optical glass according to claim 6,
wherein the optical glass satisfies one or more of (1) to (4) below:
(1) a refractive index nd is 1.860 or more,
(2) an Abbe number vd ranges from 22.00 to 30.00,
(3) a specific gravity d is 4.100 or less,
(4) d/nd, a ratio of a specific gravity d to a refractive index nd, is 4.35 or less.

25. The optical glass according to claim 11,
wherein the optical glass satisfies one or more of (1) to (4) below:
(1) a refractive index nd is 1.860 or more,
(2) an Abbe number vd ranges from 22.00 to 30.00,
(3) a specific gravity d is 4.100 or less,
(4) d/nd, a ratio of a specific gravity d to a refractive index nd, is 4.35 or less.
